(19) United States
(12) Patent Application Publication
(10) Pub. No.: US 2024/0200967 A1
(43) Pub. Date: Jun. 20, 2024

(54) USER INTERFACES FOR SUPPLEMENTAL MAPS

(71) Applicant: Apple Inc., Cupertino, CA (US)

(72) Inventors: Vincent P. ARROYO, Union City, CA (US); Giovanni S. LUIS, Manhattan Beach, CA (US); James KILLICK, Tucson, AZ (US); Yuval KOSSOVSKY, Wexford, PA (US); Guillaume CROUIGNEAU, Versailles (FR); Sebastian A. ARAYA, San Francisco, CA (US); Daniel E. MARUSICH, San Carlos, CA (US); Neil M. APPEL, San Francisco, CA (US); Gregory S. ROBBIN, Mountain View, CA (US); Brian R. FRICK, Mt. Pleasant, SC (US); Hollie R. FIGUEROA, Cupertino, CA (US); Konstantin SINITSYN, Carlsbad, CA (US); Ryan W. APUY, San Francisco, CA (US); Linghao LI, Cupertino, CA (US); Boon Tat Khoo, Singapore (SG)

(21) Appl. No.: 18/473,256

(22) Filed: Sep. 24, 2023

Related U.S. Application Data
(60) Provisional application No. 63/377,011, filed on Sep. 24, 2022.
(60) Provisional application No. 63/584,875, filed on Sep. 23, 2023.
(60) Provisional application No. 63/584,876, filed on Sep. 23, 2023.

(51) Int. Cl. G01C 21/36

(52) U.S. Cl. CPC G01C 21/3682; G01C 21/3667

(57) ABSTRACT

In some embodiments, an electronic device displays supplemental map information in a primary map application. In some embodiments, an electronic device displays curated navigation directions using supplemental maps. In some embodiments, an electronic device displays virtual views of a physical location or environment using supplemental maps. In some embodiments, an electronic device displays media content in a map application. In some embodiments, an electronic device displays map information in a media content application. In some embodiments, an electronic device adds annotations to maps which are shared to a second electronic device. In some embodiments, an electronic device facilitates a way to obtain access to supplemental maps via a map store user interface. In some embodiments, an electronic device displays one or more routes associated with a supplemental map. In some embodiments, an electronic device utilizes one or more artificial intelligence modules to generate a supplemental map.

### CROSS-REFERENCE TO RELATED APPLICATIONS

This application claims the benefit of U.S. Provisional Application No. 63/377,011, filed Sep. 24, 2022, U.S. Provisional Application No. 63/584,875, filed Sep. 23, 2023, and U.S. Provisional Application No. 63/584,876, filed Sep. 23, 2023, the contents of which are herein incorporated by reference in their entireties for all purposes.

### FIELD OF THE DISCLOSURE

This specification relates generally to electronic devices that display supplemental maps.

### BACKGROUND

User interaction with electronic devices has increased significantly in recent years. These devices can be devices such as computers, tablet computers, televisions, multimedia devices, mobile devices, and the like.

In some circumstances, users wish to view and/or access information related to physical locations that is not contained in a primary map including such physical locations. An electronic device can provide a user with user interfaces for performing such actions associated with a location.

### SUMMARY

Some embodiments described in this disclosure are directed to user interfaces for accessing and/or viewing supplemental maps for one or more physical locations. Enhancing these interactions improves the user's experience with the device and decreases user interaction time, which is particularly important where input devices are battery-operated.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6J illustrate exemplary ways in which an electronic device displays supplemental map information in a primary map application in accordance with some embodiments.

FIG. 7 is a flow diagram illustrating a method for displaying supplemental map information in a primary map application in accordance with some embodiments.

FIGS. 8A-8J illustrate exemplary ways in which an electronic device displays curated navigation directions using supplemental maps in accordance with some embodiments.

FIG. 9 is a flow diagram illustrating a method for displaying curated navigation directions using supplemental maps in accordance with some embodiments.

FIGS. 10A-10J illustrate exemplary ways in which an electronic device displays virtual views of a physical location or environment using supplemental maps in accordance with some embodiments.

FIG. 11 is a flow diagram illustrating a method for displaying virtual views of a physical location or environment using supplemental maps in accordance with some embodiments.

FIGS. 12A-12P illustrate exemplary ways in which an electronic device displays media content in a map application in accordance with some embodiments.

FIG. 13 is a flow diagram illustrating a method for displaying media content in a map application in accordance with some embodiments.

FIGS. 14A-14M illustrate exemplary ways in which an electronic device displays map information in a media content application in accordance with some embodiments.

FIG. 15 is a flow diagram illustrating a method for displaying map information in a media content application in accordance with some embodiments.

FIGS. 16A-16J illustrate exemplary ways in which an electronic device adds annotations to maps which are shared to a second electronic device, different from an electronic device in accordance with some embodiments.

FIG. 17 is a flow diagram illustrating a method for adding annotations to maps which are shared to a second electronic device, different from an electronic device in accordance with some embodiments.

FIGS. 18A-18FF illustrate exemplary ways in which an electronic device facilitates a way to obtain access to supplemental maps via a map store user interface in accordance with some embodiments.

FIG. 19 is a flow diagram illustrating a method for facilitating a way to obtain access to supplemental maps via a map store user interface in accordance with some embodiments.

FIGS. 20A-20R illustrate exemplary ways in which an electronic device displays one or more routes associated with a supplemental map in accordance with some embodiments.

FIG. 21 is a flow diagram illustrating a method for displaying one or more routes associated with a supplemental map in accordance with some embodiments.

FIGS. 22A-22B illustrate exemplary ways in which an electronic device incorporates one or more artificial intelligence models when generating a supplemental map.

FIG. 23 is a flow diagram illustrating a method for generating supplemental maps using one or more artificial intelligence models in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient user interfaces and mechanisms for user interaction for accessing supplemental map information. Such techniques can reduce the cognitive burden on a user who uses such devices and/or protect the privacy and/or security of sensitive incidents while continuing to effectively alert the user of the presence of such sensitive incidents. Further, such techniques can reduce processor and battery power otherwise wasted on redundant user inputs.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

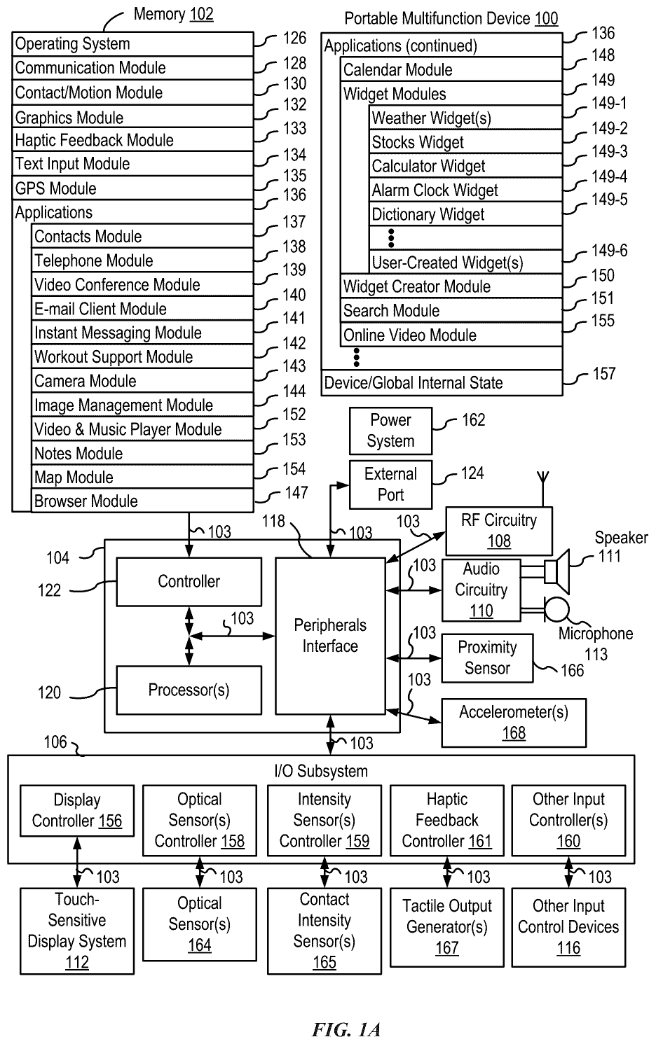

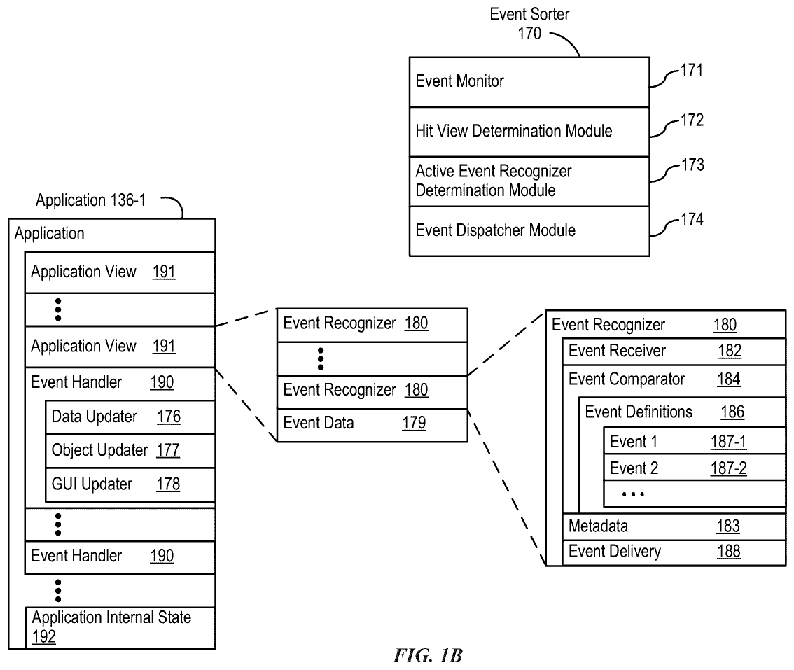

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

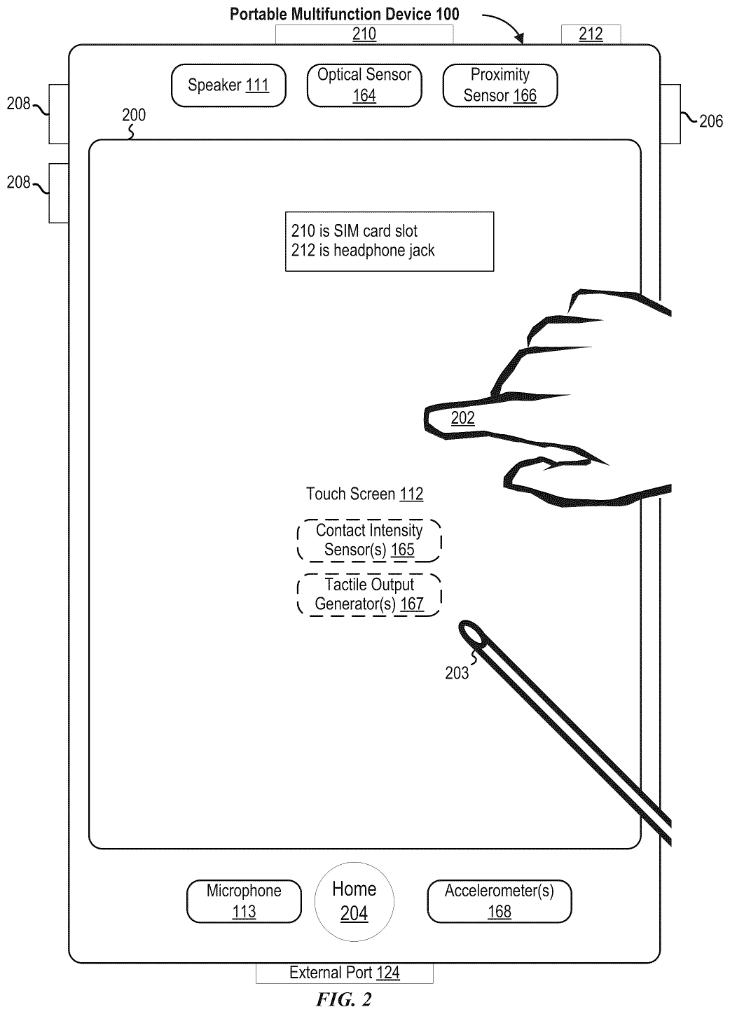

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures) as input. In some embodiments, the one or more input devices are integrated with the computer system. In some embodiments, the one or more input devices are separate from the computer system.

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

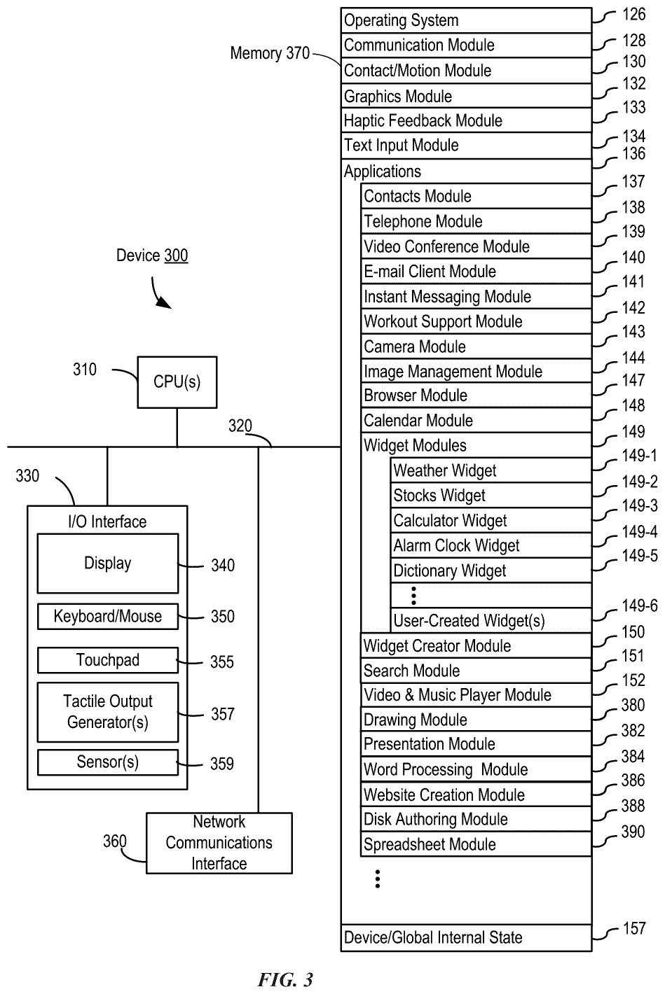

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

In some embodiments, stylus 203 is an active device and includes one or more electronic circuitry. For example, stylus 203 includes one or more sensors, and one or more communication circuitry (such as communication module 128 and/or RF circuitry 108). In some embodiments, stylus 203 includes one or more processors and power systems (e.g., similar to power system 162). In some embodiments, stylus 203 includes an accelerometer (such as accelerometer 168), magnetometer, and/or gyroscope that is able to determine the position, angle, location, and/or other physical characteristics of stylus 203 (e.g., such as whether the stylus is placed down, angled toward or away from a device, and/or near or far from a device). In some embodiments, stylus 203 is in communication with an electronic device (e.g., via communication circuitry, over a wireless communication protocol such as Bluetooth) and transmits sensor data to the electronic device. In some embodiments, stylus 203 is able to determine (e.g., via the accelerometer or other sensors) whether the user is holding the device. In some embodiments, stylus 203 can accept tap inputs (e.g., single tap or double tap) on stylus 203 (e.g., received by the accelerometer or other sensors) from the user and interpret the input as a command or request to perform a function or change to a different input mode.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or programs (e.g., sets of instructions) need not be implemented as separate software programs, procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

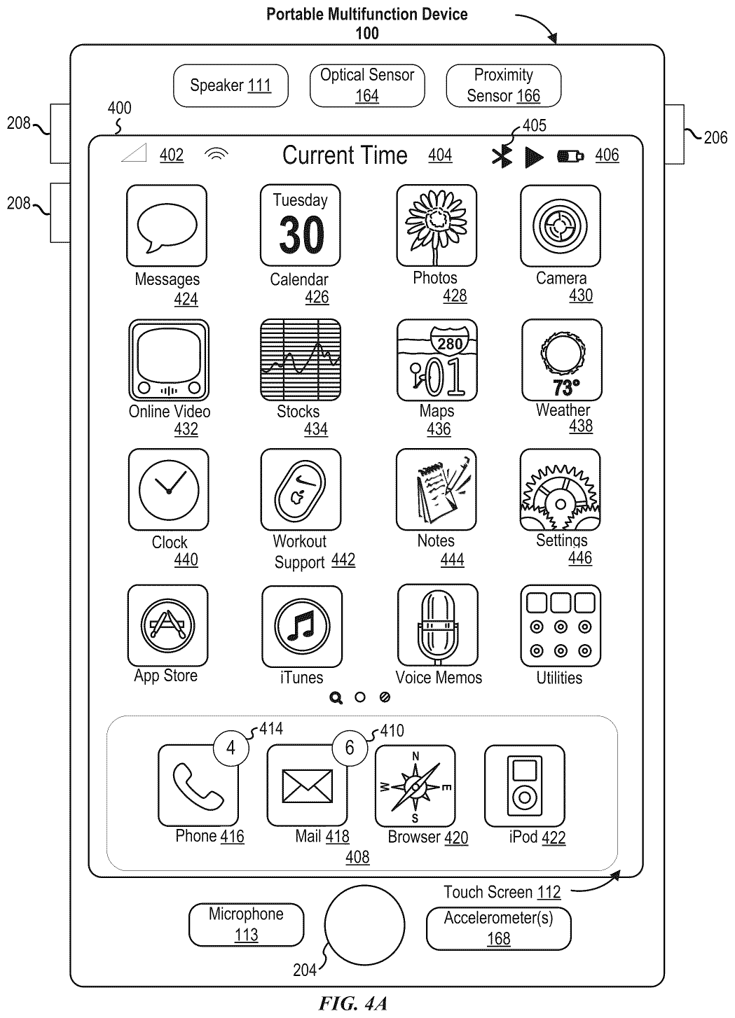

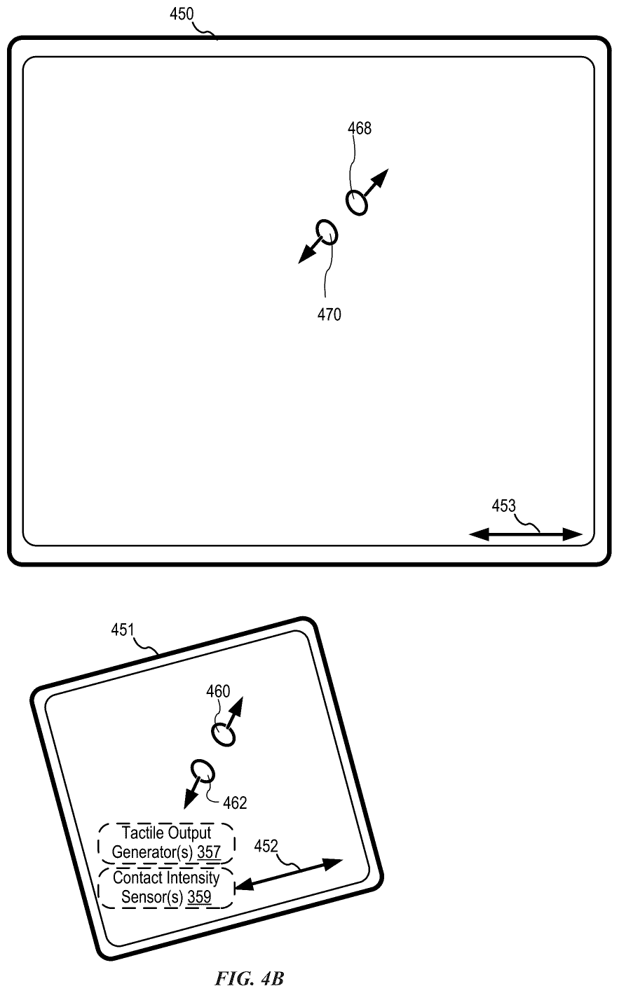

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

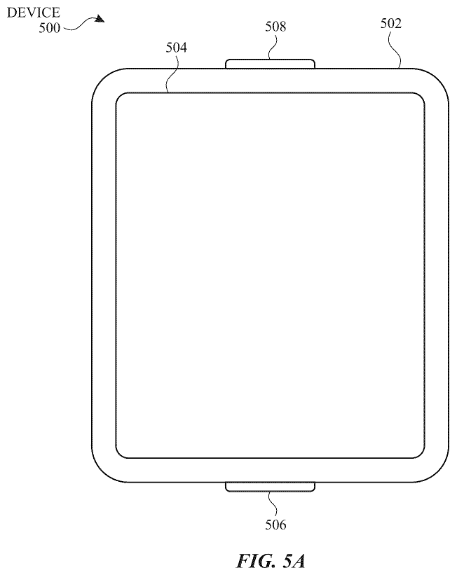

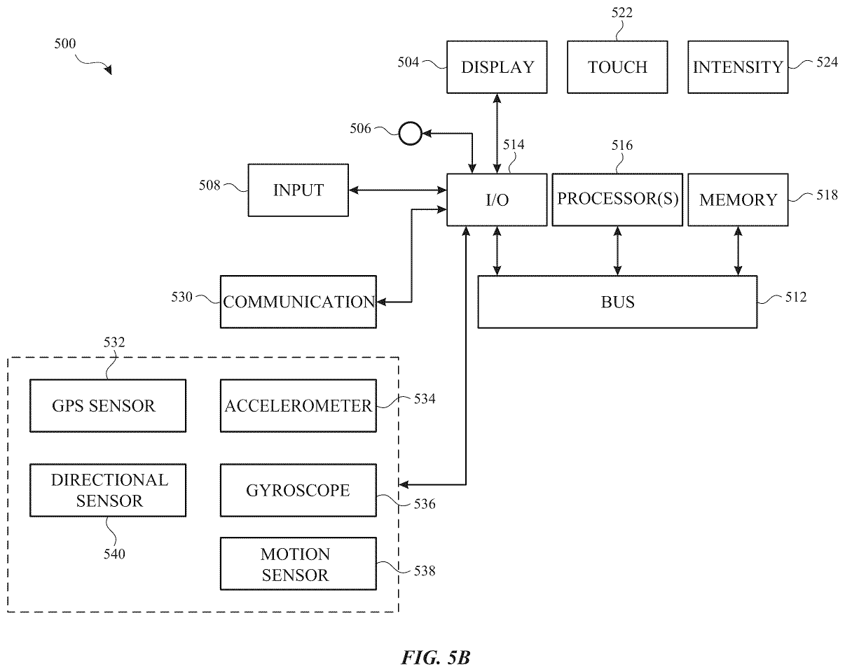

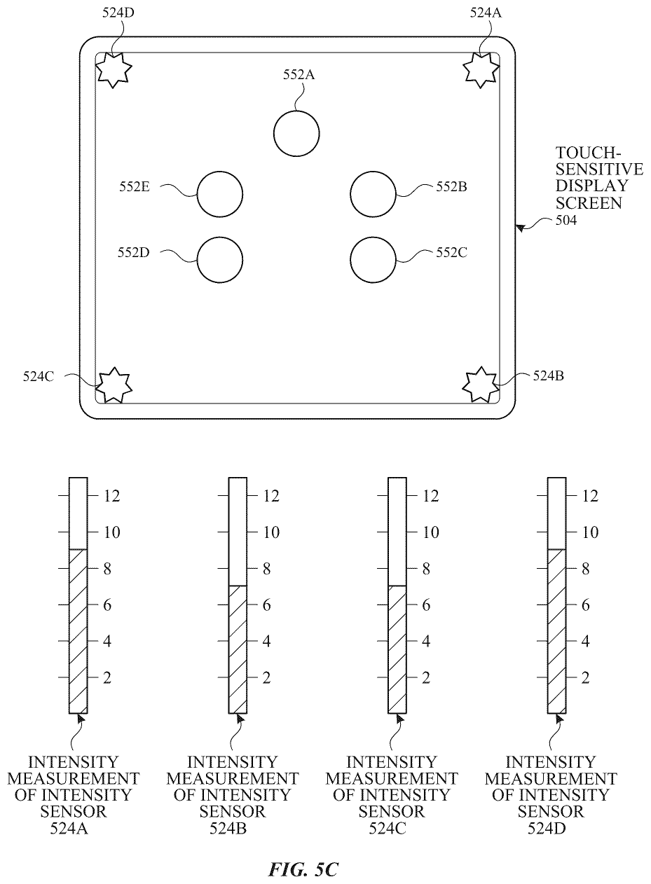

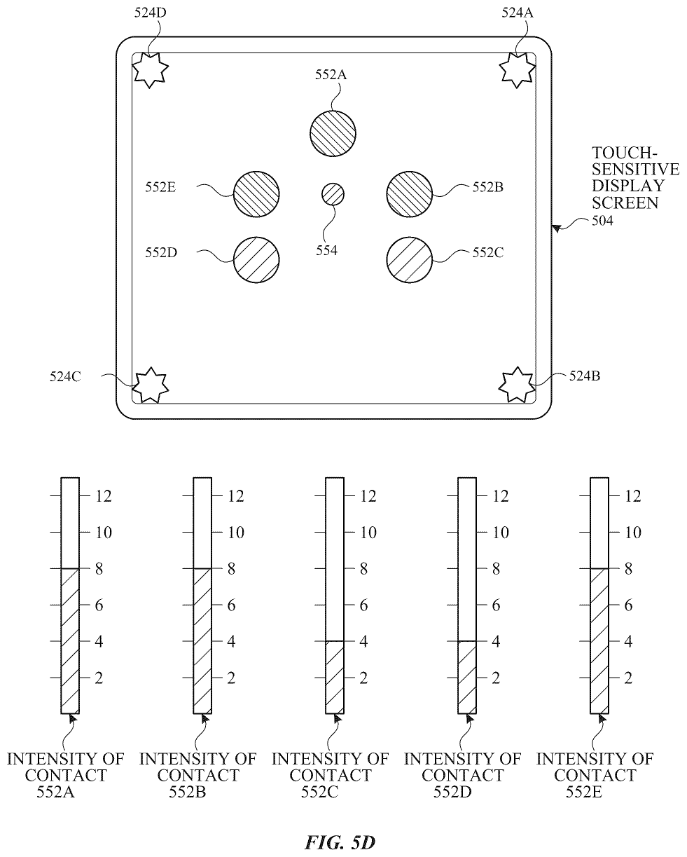

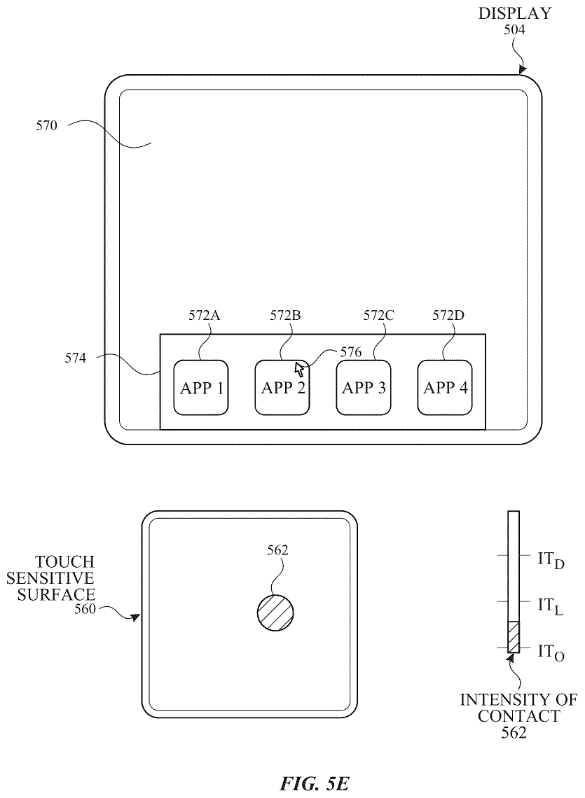

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

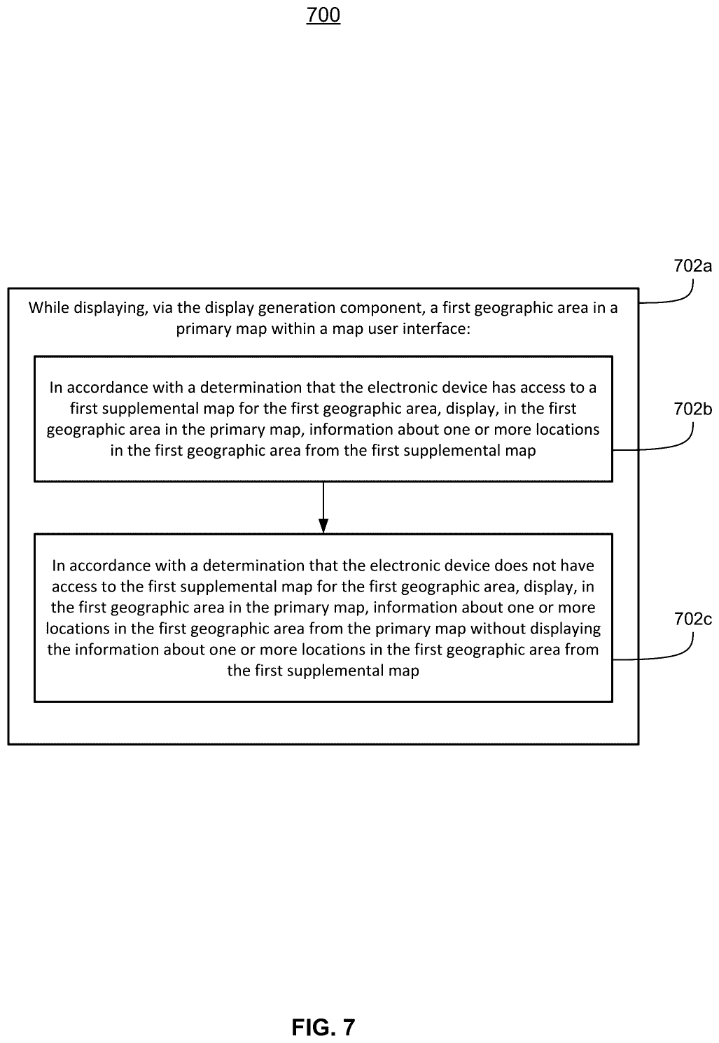

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1100, 1300, 1500, 1700, 1900, 2100, and/or 2300 (FIGS. 7, 9, 11, 13, 15, 17, 19, 21, and/or 23). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### User Interfaces and Associated Processes

### User Interfaces for Displaying Supplemental Map Information in a Primary Map

Users interact with electronic devices in many different manners, including interacting with maps and maps applications for viewing information about various locations. In some embodiments, an electronic device displays a map in a primary map application, where the map includes information about various locations or regions based on data included in the primary map. The embodiments described below provide ways in which an electronic device supplements such information with information from one or more supplemental maps, thus enhancing the user's interaction with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

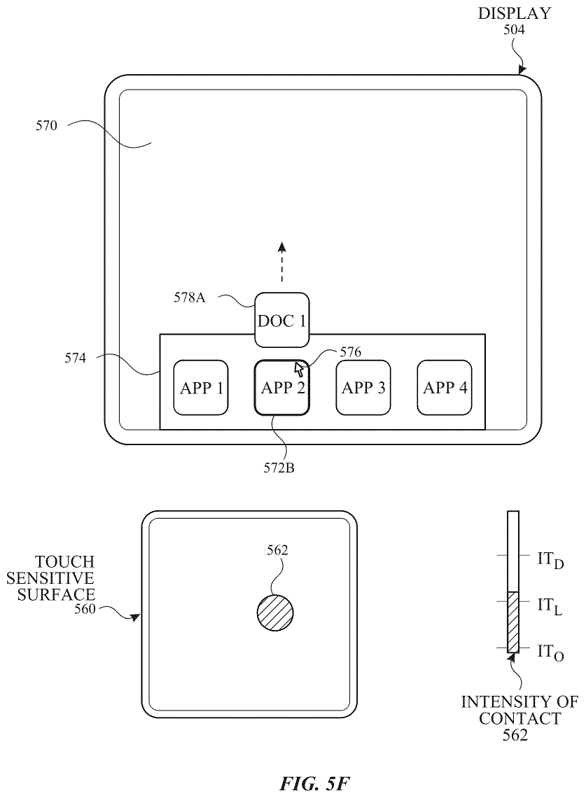

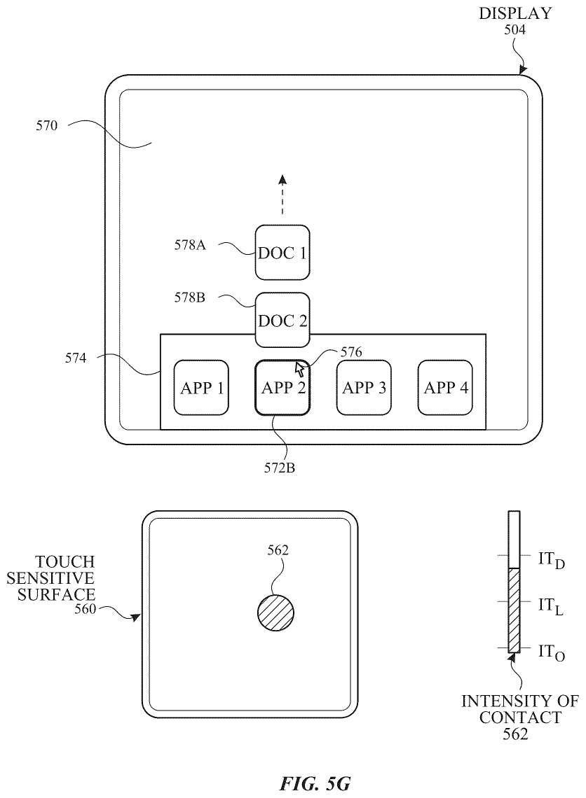

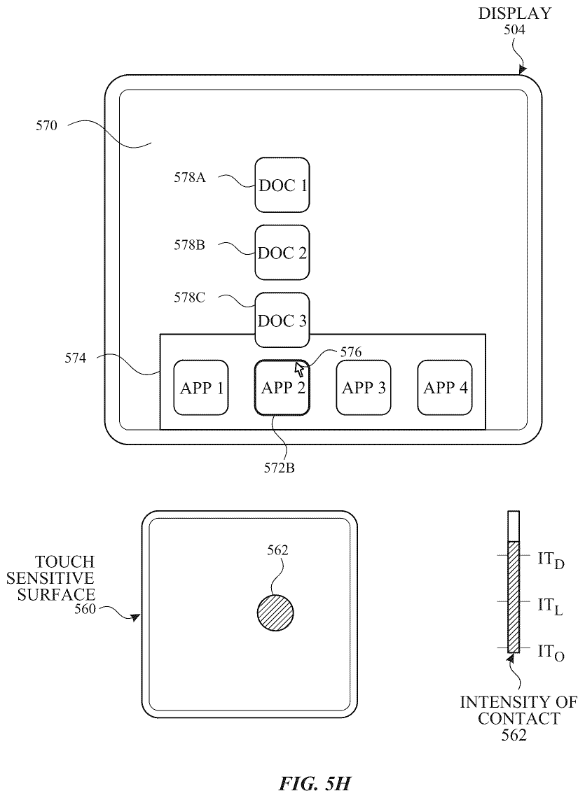

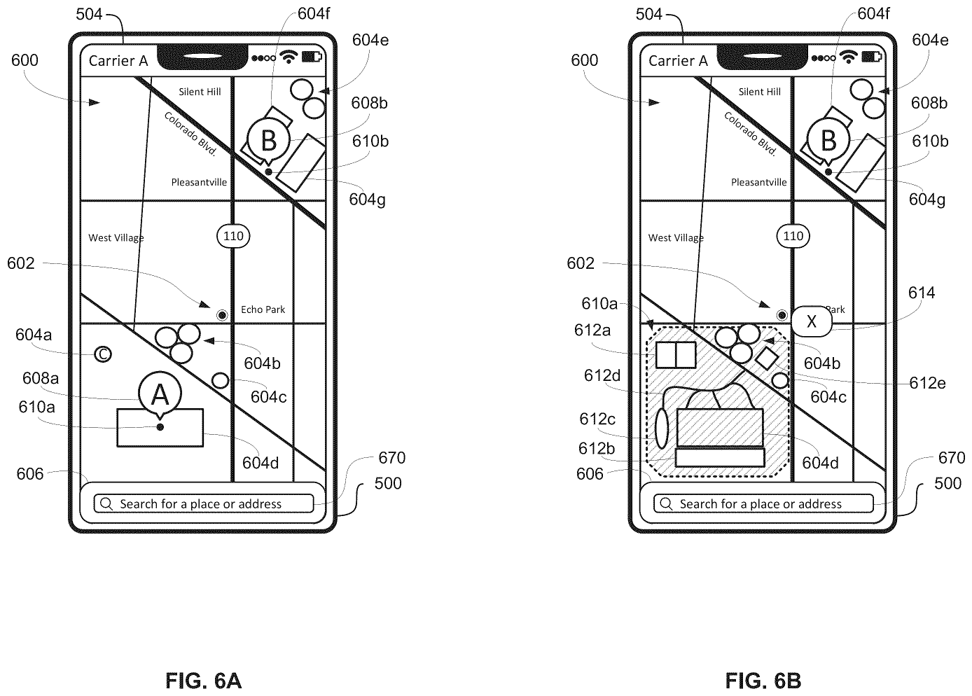

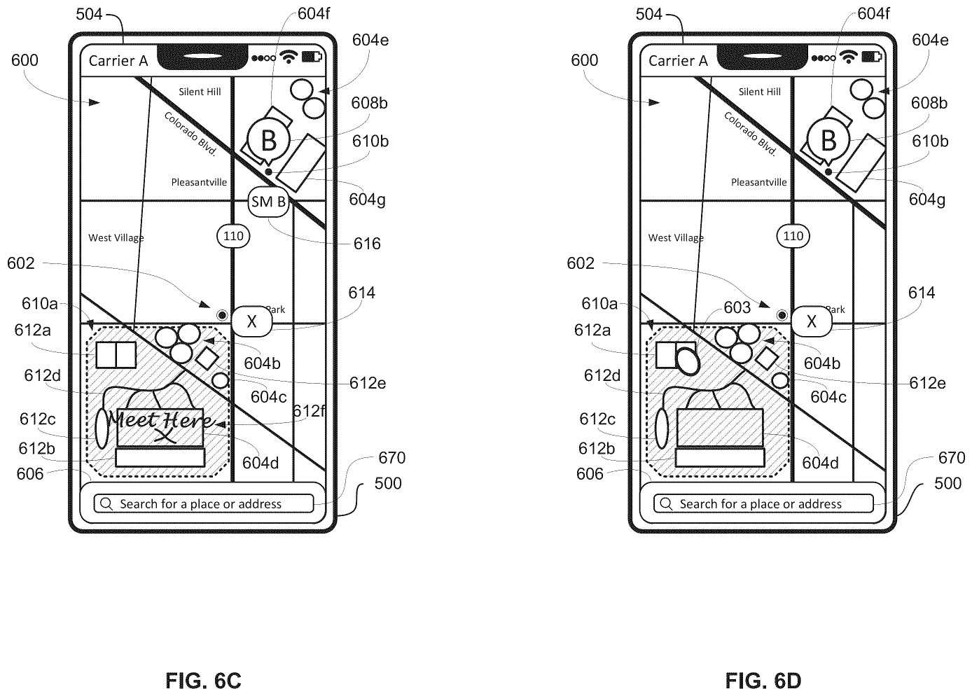

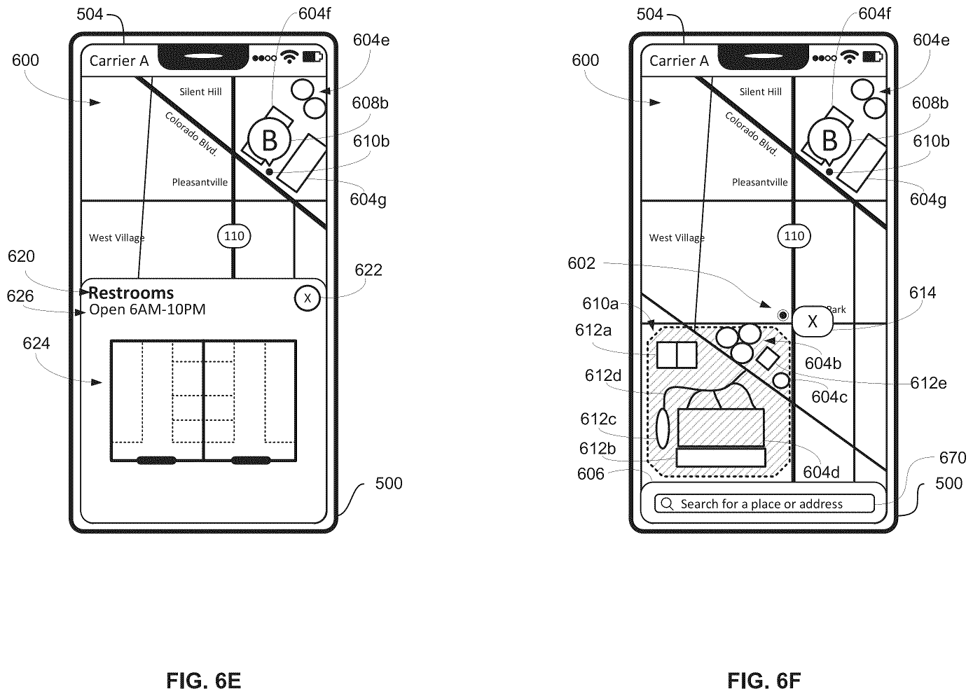

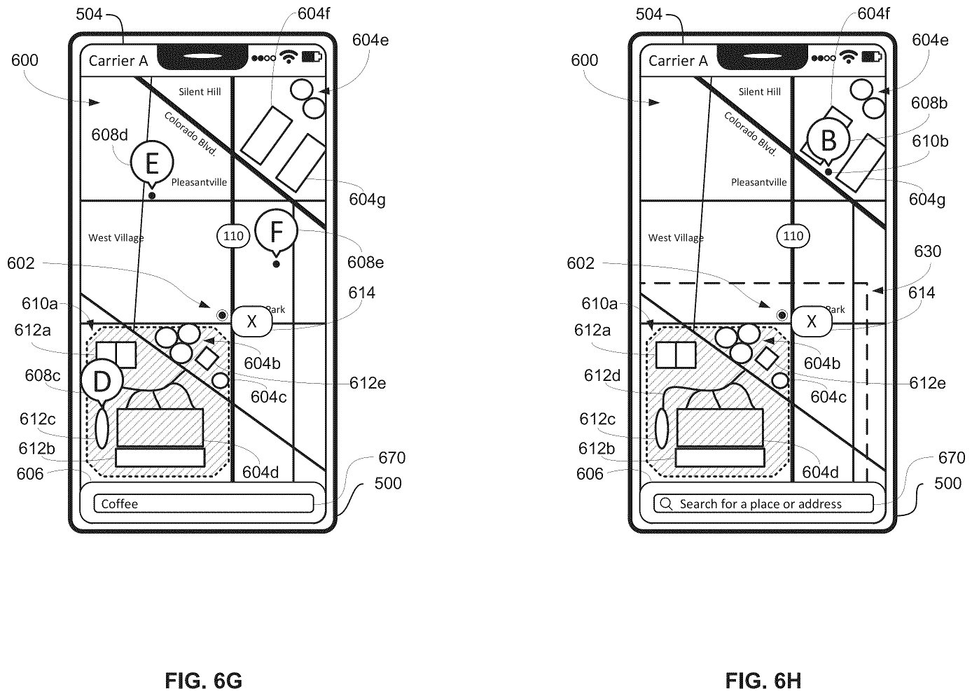

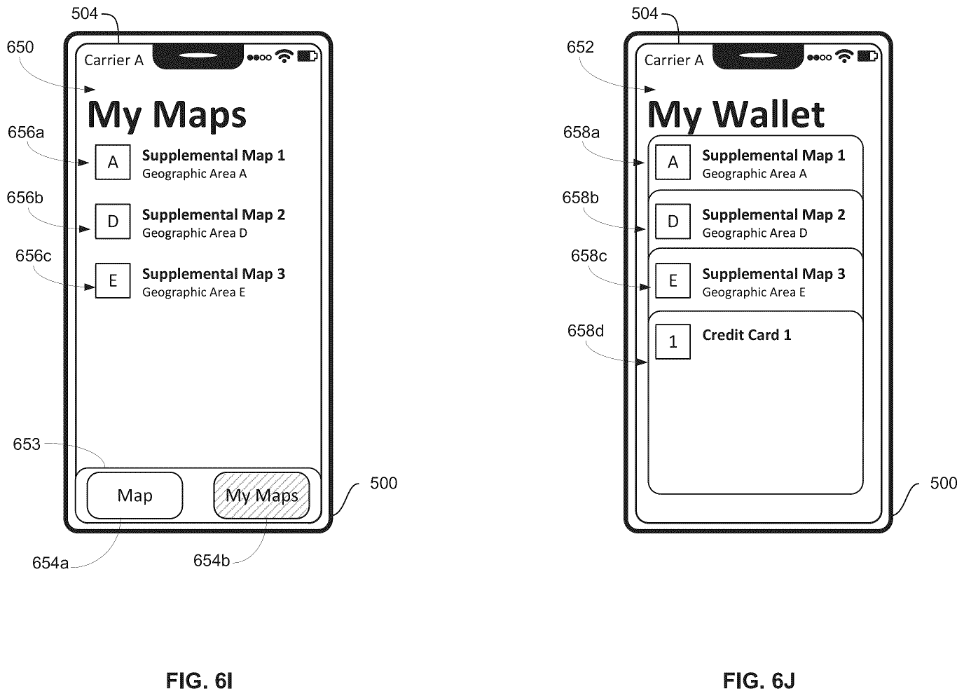

FIGS. 6A-6J illustrate exemplary ways in which an electronic device displays supplemental map information in a primary map application. The embodiments in these figures are used to illustrate the processes described below, including the processes described with reference to FIG. 7. Although FIGS. 6A-6J illustrate various examples of ways an electronic device is able to perform the processes described below with respect to FIG. 7, it should be understood that these examples are not meant to be limiting, and the electronic device is able to perform one or more processes described below with reference to FIG. 7 in ways not expressly described with reference to FIGS. 6A-6J.

FIG. 6A illustrates an exemplary device 500 displaying a user interface. In some embodiments, the user interface is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

In some embodiments, an electronic device (e.g., device 500) can include a primary map application. For example, the primary map application can present maps, routes, location metadata, and/or imagery (e.g., captured photos) associated with various geographical locations, points of interest, etc. The primary map application can obtain map data that includes data defining maps, map objects, routes, points of interest, imagery, etc., from a server. For example, the map data can be received as map tiles that include map data for geographical areas corresponding to the respective map tiles. The map data can include, among other things, data defining roads and/or road segments, metadata for points of interest and other locations, three-dimensional models of the buildings, infrastructure, and other objects found at the various locations, and/or images captured at the various locations. The primary map application can request, from the server through a network (e.g., local area network, cellular data network, wireless network, the Internet, wide area network, etc.), map data (e.g., map tiles) associated with locations that the electronic device frequently visits. The primary map application can store the map data in a map database. The primary map application can use the map data stored in map database and/or other map data received from the server to provide the maps application features described herein (e.g., navigation routes, maps, navigation route previews, etc.).

In some implementations, a system can include the server. For example, the server can be a computing device, or multiple computing devices, configured to store, generate, and/or serve map data to various user devices (e.g. device 500), as described herein. For example, the functionality described herein with reference to the server can be performed by a single computing device or can be distributed amongst multiple computing devices.

As shown in FIG. 6A, the electronic device 500 presents a maps user interface 600 (e.g., of a primary map application installed on device 500) on touch screen 504. In FIG. 6A, the maps user interface 600 is currently presenting primary map information for one or more geographic areas (e.g., geographic areas corresponding to location 610a, associated with representation 608a, and location 610b, associated with representation 608b). Location 610a optionally corresponds to a park, and location 610b optionally corresponds to a high school. Representation 608a is optionally an icon, image, or other graphical element that depicts and/or is associated with the park, and representation 608b is optionally an icon, image, or other graphical element that depicts and/or is associated with the high school. Current location indicator 602 indicates the current location of the electronic device 500 in the area depicted by the map in the maps user interface 600.

In FIG. 6A, device 500 is displaying information from a primary map (e.g., displaying the base map layer) as described with reference to method 700. The information from the primary map for location 610a includes a representation 604d of a grass field at the park, representations 604b of trees at the park, representation 604a of a public restroom at the park, representation 604c of a gazebo at the park, and a representation of a road that passes through the park, in addition to passing through areas outside of the park. The information from the primary map for location 610b includes representations 604f and 604g of buildings at the high school, and representations 604e of trees at the high school. Additional or alternative representations of additional or alternative primary map features are also contemplated.

In FIG. 6A, device 500 optionally does not have access to supplemental maps for locations 610a and/or 610b, or display of supplemental map information for locations 610a and/or 610b has been disabled. As described in more detail with reference to method 600, a supplemental map is optionally an additional map for a particular geographic area that includes details about locations within the geographic area, such as businesses, parks, stages, restaurants and/or snack stands that are not included in the primary map. In some embodiments, the supplemental map does not include information for a second geographic area that is included in the primary map. In some embodiments, device 500 is able to purchase or gain access to supplemental maps in ways described with reference to methods 700, 900 and/or 1100, such as via purchasing one or more supplemental maps from a supplemental map store (e.g., analogous to an application store on device 500 for purchasing access to applications).

In FIG. 6B, device 500 does have access to a supplemental map for location 610a and display of the supplemental map information for location 610a has been enabled. As shown in FIG. 6B, information from the supplemental map is one or more of overlaid on the primary map, overlaid on the information from the primary map, or replacing information from the primary map. For example, in FIG. 6B, user interface 600 no longer includes representation 608a and/or location indicator 610a. However, representation 604d of the field remains, as well as representations 604b of trees and representation 604c of the gazebo. The supplemental map in FIG. 6B replaces representation 604a of the public restroom with a different representation 612a of the restroom, and also adds representation 612c of a snack stand, representation 612b of a stage, representation 612d of a pedestrian pathway, and representation 612e of a ticket booth at the locations of those entities in the geographic area corresponding to the supplemental map. For example, the supplemental map associated with the geographic area is optionally a supplemental map associated with a weekend concert event that is occurring at the park, and the supplemental map includes information about buildings, features, etc. that are relevant to the concert event, and such information is optionally not included in the primary map.

In some embodiments, device 500 visually distinguishes portions of the primary map that include supplemental map data from portions of the primary map that do not include such supplemental map data. For example, in FIG. 6B, device 500 is displaying region 610a (corresponding to location 610a) with a different color and/or shading than other portions of primary map areas displayed by device 500 in FIG. 6B, and/or is displaying region 610a separated by a visual boundary from other portions of primary map areas displayed by device 500 in FIG. 6B. In some embodiments, device 500 displays a selectable option 614 in association with the supplemental map region 610a that is selectable to cease display of the supplemental map information for region 610a (and redisplay location 610a as shown in FIG. 6A).

In some embodiments, device 500 is able to receive input from a user to annotate supplemental map information, which is then optionally stored with the supplemental map information. For example, in FIG. 6C, device 500 has detected input via touch screen 504 to annotate the supplemental map area 610a with a handwritten note (e.g., “Meet Here” with an “X”). In response, such annotation is optionally stored in the supplemental map, and the user of device 500 is optionally able to provide input to device 500 to share the supplemental map (along with annotations) with one or more contacts (e.g., via messaging). When received by those contacts, the supplemental map information displayed at their devices also optionally includes the annotation made by the user of device 500.

In some embodiments, when a supplemental map is available for a geographic region in a primary map that is being displayed by device 500, but device 500 does not have access to the supplemental map, device 500 displays a selectable option 616 in that region of the primary map that is selectable to initiate a process to gain access to (e.g., purchase and/or download) the supplemental map for that region, such as selectable option 616 for location 610b in FIG. 6C.

In some embodiments, representations of entities from supplemental maps are interactable in one or more of the same ways that representations of entities from the primary map are. For example, in FIG. 6D, device 500 detects selection of representation 612a of the restroom (e.g., via contact 603). In response, in FIG. 6E, device 500 displays information about the restroom obtained from the supplemental map, such as a representation 620 of a name of the restroom, a representation 626 of operating hours for the restroom, and a representation 624 of a map of the restroom. The types and content of the information displayed for the restroom is optionally defined by the supplemental map. The user interface in FIG. 6E also includes a selectable option 622 that is selectable to cease display of the information about the restroom.

In some embodiments, primary map functions such as navigation and searching continue to operate while supplemental map information is displayed, and also optionally account for that supplemental map information. For example, from FIG. 6F to 6G, device 500 receives input to search for “Coffee” as indication in search field 670 in FIG. 6G. In response, device 500 displays representations of results for “Coffee”, including search result representation 608d corresponding to a first coffee shop in the primary map area (e.g., outside of region 610a of the supplemental map), search result representation 608e corresponding to a second coffee shop in the primary map area (e.g., outside of region 610a of the supplemental map), and search result representation 608c corresponding to the snack stand 612c within the region 610a of the supplemental map.

In some embodiments, when device 500 downloads a supplemental map for a geographic region, it also automatically downloads primary map data for a region surrounding the supplemental map region (e.g., extending 1, 5, 10, 100, 1000, 10000, or 100000 meters from the borders of the supplemental map region). In this way, both the supplemental map is available offline, as well as regions surrounding the supplemental map region to facilitate ingress and egress from the supplemental map region during offline operation. For example, in FIG. 6H, device 500 has optionally automatically downloaded primary map data for region 630 in addition to downloading supplemental map data for region 610a.

In some embodiments, device 500 stores and/or displays supplemental maps that it has downloaded and/or to which it has access in a supplemental map repository that is part of the primary map application. For example, in FIG. 6I, device 500 is displaying user interface 650, which is a user interface of the primary map application, and is accessible via selection of element 654b within navigation bar 653. In some embodiments, in response to detecting selection of element 654a, device 500 displays user interface 600 shown in FIGS. 6A-6H. User interface 650 in FIG. 6I includes representations and/or descriptions of the supplemental maps that have been downloaded to device 500 and/or to which device 500 has access, such as representation 656a for a supplemental map of geographic region A, representation 656b for a supplemental map of geographic region D, and representation 656c for a supplemental map of geographic region E. In some embodiments, representation 656a is selectable to display geographic region A with corresponding supplemental map information in a primary map, such as shown with reference to FIGS. 6A-6H. Representation 656b is optionally selectable to display geographic region D with corresponding supplemental map information in the primary map, and representation 656c is optionally selectable to display geographic region E with corresponding supplemental map information in the primary map, such as shown with reference to FIGS. 6A-6H.

In some embodiments, device 500 additionally or alternatively stores and/or displays supplemental maps that it has downloaded and/or to which it has access in a supplemental map repository that is not part of the primary map application—for example, a repository that is part of a digital or electronic wallet application on the electronic device. For example, in FIG. 6J, device 500 is displaying user interface 652, which is a user interface of the digital wallet application on device 500. User interface 652 in FIG. 6J includes representations and/or descriptions of the supplemental maps that have been downloaded to device 500 and/or to which device 500 has access, such as representation 658a for a supplemental map of geographic region A, representation 658b for a supplemental map of geographic region D, and representation 658c for a supplemental map of geographic region E. In some embodiments, representation 658a is selectable to display geographic region A with corresponding supplemental map information in a primary map in the primary map application, such as shown with reference to FIGS. 6A-6H. Representation 658b is optionally selectable to display geographic region D with corresponding supplemental map information in the primary map in the primary map application, and representation 658c is optionally selectable to display geographic region E with corresponding supplemental map information in the primary map in the primary map application, such as shown with reference to FIGS. 6A-6H. User interface 652 optionally additionally includes representations of one or more credit cards, loyalty cards, boarding passes, tickets and/or other elements that are stored in the digital wallet application, which are optionally selectable to perform corresponding transactions using the digital wallet application. For example, in FIG. 6J, user interface 652 also includes representation 658d of Credit Card 1, which is optionally selectable to view information about Credit Card 1 and/or initiate a transaction (e.g., a purchase transaction) using Credit Card 1.

FIG. 7 is a flow diagram illustrating a method 700 for displaying supplemental map information in a primary map application. The method 700 is optionally performed at an electronic device such as device 100, device 300, device 500 as described above with reference to FIGS. 1A-1B, 2-3, 4A-4B and 5A-5H. Some operations in method 700 are, optionally combined and/or the order of some operations is, optionally, changed.

As described below, the method 700 provides ways in which an electronic device displays supplemental map information in a primary map application. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 700 is performed at an electronic device in communication with a display generation component and one or more input devices. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 700 is performed at or by an automobile (e.g., at an infotainment system of an automobile having or in communication with one or more display generation components and/or input devices).

In some embodiments, while displaying, via the display generation component, a first geographic area in a primary map within a map user interface (702a), in accordance with a determination that the electronic device has access to a first supplemental map (e.g., such as supplemental maps described with reference to methods 900 and/or 1100) for the first geographic area (e.g., the electronic device has previously downloaded, purchased access to and/or otherwise obtained access to the first supplemental map), the electronic device displays (702b), in the first geographic area in the primary map, information about one or more locations in the first geographic area from the first supplemental map, such as shown in FIG. 6B. In some embodiments, the map user interface is a user interface of a primary map and/or navigation application that enables a user of the electronic device to view an area of a map and/or configure a route from a beginning location to a first destination on a virtual map. In some embodiments, the first geographic area is an area that is centered on a location of the electronic device. In some embodiments, the first geographic area is an area that is selected by a user of the electronic device (e.g., by panning or scrolling through the virtual map). In some embodiments, a primary map is a map that includes map information (e.g., geographic information, road or highway information, traffic information, point-of-interest information, building information, vegetation information and/or traffic light or traffic signage information) for multiple geographic areas, optionally including the first geographic area. In some embodiments, a supplemental map—as will be described later-includes map information for a subset of the geographic areas for which the primary map includes map information (e.g., if the primary map has map information for twenty geographic areas, the supplemental map optionally includes map information for only one of those geographic areas, or a plurality of those geographic areas without including map information for at least one of those geographic areas). While the electronic device is displaying the first geographic area in the primary map, the electronic device is optionally not displaying a second geographic area in the primary map (that is optionally included in the primary map).

In some embodiments, the first supplemental map is an additional map for the first geographic area that includes details about locations within the first geographic area, such as businesses, parks, stages, restaurants and/or snack stands, discussed in greater detail hereinafter. In some embodiments, the first supplemental map does not include information for a second geographic area that is included in the primary map. In some embodiments, the first supplemental map is interactive, discussed in greater detail hereinafter. In some embodiments, the information from the supplemental map (which is optionally not included in the primary map) is displayed concurrently with and/or overlaid upon the primary map of the first geographic area, which optionally includes information about the locations from the primary map. In some embodiments, the information from the supplemental map is displayed with visual indications to visual differentiate the information from the supplemental map from the information from the primary map. For instance, the information from the supplemental map is optionally displayed with a different color than the information from the primary map, or is highlighted while the information from the primary map is not highlighted or is highlighted at a different level of highlighting. In some embodiments, the supplemental map includes information about the one or more locations that is in addition to (e.g., different or supplemental to) the information about the one or more locations included in the primary map. In some embodiments, the primary map does not include information about the one or more locations, and therefore the only information displayed by the electronic device about the one or more locations is information from the supplemental map. In some embodiments, the information from the supplemental map replaces the information from the primary map for one or more of the one or more locations.

In some embodiments, in accordance with a determination that the electronic device does not have access to the first supplemental map for the first geographic area, the electronic device displays (702c), in the first geographic area in the primary map, information about one or more locations in the first geographic area from the primary map without displaying the information about one or more locations in the first geographic area from the first supplemental map (optionally the same one or more locations as described above, or different one or more locations than described above), such as shown in FIG. 6A. In some embodiments, the information from the primary map is indicated as being part of the primary map by a visual indication. For instance, the visual indication is optionally a specific color and/or highlighting level. Displaying information from a supplemental map within the same user interface as a primary map enables a user to view both information from the primary map and the supplemental map at the same time, thereby reducing the need for subsequent inputs to display such supplemental information.

In some embodiments, while displaying, via the display generation component, the first geographic area in the primary map within the map user interface, in accordance with a determination that the electronic device has access to a second supplemental map (e.g., such as supplemental maps described with reference to methods 900 and/or 1100) for the first geographic area (e.g., the electronic device has previously downloaded, purchased access to and/or otherwise obtained access to the second supplemental map), the electronic device displays, in the first geographic area in the primary map, information about one or more locations in the first geographic area from the second supplemental map (optionally with or without displaying the information about the one or more locations in the first geographic area from the first supplemental map depending on whether the electronic device has access to the first supplemental map as well). In some embodiments, the one or more locations from the second supplemental map have none, one, more than one, or all locations in common with the one or more locations from the first supplemental map. In some embodiments, if the electronic device has access to both the first supplemental map and the second supplemental map, the electronic device concurrently displays the information about the one or more locations in the first geographic area from the first supplemental map and the information about the one or more locations in the first geographic area from the second supplemental map. Displaying information from different supplemental maps within the same user interface as a primary map enables a user to view both information from the primary map and one or more of the different supplemental maps at the same time, thereby reducing the need for subsequent inputs to display such supplemental information.

In some embodiments, displaying the first geographic area in the primary map includes concurrently displaying the first geographic area and a second geographic area, different from the first geographic area, in the primary map. In some embodiments, the second geographic area has one or more of the characteristics of the first geographic area. In some embodiments, the second geographic area is completely separate from (e.g., does not overlap with) the first geographic area.

In some embodiments, displaying the information about the one or more locations in the first geographic area from the first supplemental map includes concurrently displaying the information from the first supplemental map without displaying any information from any supplemental map in the second geographic area (e.g., in accordance with a determination that a supplemental map for the second geographic area is not accessible to the electronic device or the supplemental map information for the second geographic area has been hidden, such as described with reference to the subject matter described in method 700 corresponding to the features of claim 17). Instead, the electronic device optionally displays information only from the primary map in the second geographic area. Concurrently displaying different areas of the primary map that do or do not have corresponding supplemental maps accessible facilitates continued and consistent interaction with the primary map regardless of the accessibility of supplemental maps for the different areas of the primary map, thereby improving the interaction between the user and the electronic device.

In some embodiments, displaying, in the first geographic area in the primary map, the information about the one or more locations in the first geographic area from the first supplemental map includes, in accordance with a determination that the map user interface is in a first transit mode (e.g., a mode in which navigation or transit information or directions are provided in the user interface for a first mode of transportation, such as driving, walking, cycling or public transit), displaying the information about the one or more locations in the first geographic area from the first supplemental map, and in accordance with a determination that the map user interface is in a second transit mode, different from the first transit mode (e.g., a mode in which navigation or transit information or directions are provided in the user interface for a second mode of transportation, different from the first mode of transportation, such as driving, walking, cycling or public transit), displaying the information about the one or more locations in the first geographic area from the first supplemental map. Thus, in some embodiments, the information from the first supplemental map remains available in the primary map regardless of the current transit mode of the user interface. In some embodiments, the navigation and/or transit information and/or directions do are not different depending on whether or not the first supplemental map is accessible to the electronic device. In some embodiments, the navigation and/or transit information and/or directions are different depending on whether or not the first supplemental map is accessible to the electronic device. For example, the navigation and/or transit information and/or directions are optionally based on information from the first supplemental map (e.g., road information, building information, passageway information, or the like) that is optionally not available in the primary map. Presenting supplemental map information across different transit modes of the user interface ensures consistent user interaction and display of map information regardless of the transit mode, thereby improving the interaction between the user and the electronic device.

In some embodiments, displaying, in the first geographic area in the primary map, the information about the one or more locations in the first geographic area from the first supplemental map includes overlaying the information about the one or more locations from the first supplemental map on a representation of the first geographic area from the primary map (e.g., a base map layer, such as a base map layer that includes representations of roads, highways, terrain, buildings, landmarks and/or parks). Thus, in some embodiments, the information from the supplemental map is overlaid on top of the base map layer in the first geographic area. The information from the supplemental map is optionally displayed with at least some translucency such that portions of the base layer under the information are visible. In some embodiments, the information from the supplemental map is optionally not displayed with at least some translucency. Thus, the supplemental map optionally does not include information about the entire visual appearance of the first geographic area in the primary map, but rather only includes information about the information to be overlaid on the primary map in the first geographic area. Overlaying the information from the supplemental map on the primary map ensures consistent user interaction and display of map information, thereby improving the interaction between the user and the electronic device.

In some embodiments, the information about the one or more locations displayed in the first geographic area from the first supplemental map replaces information about the one or more locations from the primary map in the first geographic area (e.g., such that the information about the one or more locations from the primary map is no longer displayed in the primary map when the first supplemental map is accessible to the electronic device). In some embodiments, if the first supplemental map is turned off, such as described with reference to the subject matter described in method 700 corresponding to the features of claim 17, the information about the one or more locations from the primary map is redisplayed in the first geographic area. For example, the primary map optionally displays a first representation of a building or landmark in the first geographic area, and the first supplemental map causes display of a second, different, representation of that building or landmark in the first geographic area. In some embodiments, the second representation of the building or landmark has more detail or is a higher quality rendering (e.g., three-dimensional vs. two-dimensional) of the building or landmark. Replacing information from the primary map with the information from the supplemental map reduces clutter in the user interface, thereby improving the interaction between the user and the electronic device.

In some embodiments, the information about the one or more locations displayed in the first geographic area from the first supplemental map is displayed concurrently with information about the one or more locations from the primary map in the first geographic area. For example, the primary map optionally displays a first representation of a building or landmark in the first geographic area, and the first supplemental map causes display of a second, different, representation of a different building or landmark in the first geographic area. In some embodiments, the first supplemental map augments or adds to the first representation of the building or landmark in the first geographic area (e.g., the primary map includes a green rectangle to represent the grass at a park, and the first supplemental map add a representation of a swing set onto the green rectangle from the primary map). Augmenting information from the primary map with the information from the supplemental map facilitates conveying more information to the user when appropriate, thereby improving the interaction between the user and the electronic device.

In some embodiments, the information about the one or more locations displayed in the first geographic area from the first supplemental map is displayed at one or more locations in the primary map corresponding to positions of the one or more locations in the primary map. For example, the representation of a building from the first supplemental map is displayed at the location of that building in the first geographic area in the primary map. Displaying information from the supplemental map at the correct, corresponding locations in the primary map conveys location information to the user without the need for display of additional content or further inputs from the user to determine such location information, thereby improving the interaction between the user and the electronic device.

In some embodiments, a representation of the first supplemental map is displayed within a supplemental map repository user interface of the electronic device. For example, the representation of the first supplemental map is displayed with (or not with) other representations of other supplemental maps in the supplemental map repository user interface. In some embodiments, the representation is selectable to cause the electronic device to display the map user interface described with reference to the subject matter described in method 700 corresponding to the features of claim 1. Displaying the supplemental map in a supplemental map repository facilitates organization of supplemental maps, thereby improving the interaction between the user and the electronic device.

In some embodiments, the supplemental map repository user interface is a part of a primary map application (e.g., such as described with reference to methods 700, 900 and/or 1100) that is displaying the primary map in the map user interface on the electronic device. For example, the supplemental map repository user interface is optionally a user interface of the primary map application. The primary map application optionally displays a navigation pane that includes selectable options to switch from displaying the map user interface of the subject matter described in method 1100 corresponding to the features of claim 1 to displaying the supplemental map repository user interface. Displaying the supplemental map in a user interface of the map application ensures efficient access to the supplemental map, thereby improving the interaction between the user and the electronic device.

In some embodiments, the supplemental map repository user interface is part of an application different from a primary map application (e.g., as described with reference to the subject matter described in method 700 corresponding to the features of claim 10) that is displaying the primary map in the map user interface on the electronic device. For example, the supplemental map repository user interface is optionally a user interface of an electronic wallet application on the electronic device. One or more electronic payment methods (e.g., credit cards, gift cards, or the like) are optionally accessible from within the wallet application and/or the supplemental map repository user interface. For example, the representation of the first supplemental map is optionally displayed concurrently with a representation of a credit card, that when selected, initiates a process to use the credit card in a transaction. In some embodiments, selection of the representation of the first supplemental map optionally causes the electronic device to cease displaying the user interface of the wallet application and display the map user interface of the subject matter described in method 1100 corresponding to the features of claim 1. Displaying the supplemental map in a user interface of an application other than the map application facilitates access to the information of the supplemental map from a variety of access points, thereby improving the interaction between the user and the electronic device.

In some embodiments, a profile of a boundary of the first geographic area is defined by the first supplemental map. For example, the first supplemental map optionally defines the shape or profile of the boundary of the first geographic area in the primary map. The shape of the first geographic area is optionally a circle, a square, a rectangle, an oval, or an irregular shape (e.g., not a polygon or not a geometric shape). Different supplemental maps optionally define and/or correspond to areas that have different boundaries and/or shapes. Defining the shape of the geographic area by the supplemental map increases flexibility as to the types of supplemental maps that can be created and/or the information that can be included in supplemental maps, thereby improving the interaction between the user and the electronic device.

In some embodiments, the electronic device displays respective area outside of the boundary of the first geographic area in the primary map (wherein the electronic device does not have access to supplemental maps for those respective areas) based on information from the primary map (e.g., and not based on information from the first supplemental map). Thus, the content of the respective areas is optionally defined by the base map of the primary map. Displaying areas of the primary map outside of the supplemental map area with default information from the primary map ensures that map information for areas is available to the user even when supplemental maps for such areas are not accessible to the electronic device, thereby improving the interaction between the user and the electronic device.

In some embodiments, while displaying, via the display generation component, a second geographic area in the primary map within the map user interface, wherein the second geographic area is different from the first geographic area (In some embodiments, the second geographic area has one or more of the characteristics of the first geographic area. In some embodiments, the second geographic area is completely separate from (e.g., does not overlap with) the first geographic area), in accordance with a determination that the electronic device has access to a second supplemental map (e.g., such as supplemental maps described with reference to the subject matter described in method 700 corresponding to the features of claim 1 and/or methods 900 and/or 1100) for the second geographic area (e.g., the electronic device has previously downloaded, purchased access to and/or otherwise obtained access to the second supplemental map), different from the first supplemental map, the electronic device displays, in the second geographic area in the primary map, information about one or more locations in the second geographic area from the second supplemental map, wherein a profile of a boundary of the second geographic area is different from (and/or is independent of) the profile of the boundary of the first geographic area (e.g., such as described with reference to the subject matter described in method 700 corresponding to the features of claim 12). In some embodiments, the information about the one or more locations in the second geographic area from the second supplemental map has one or more of the characteristics of the first information about the one or more locations in the first geographic area from the first supplemental map. Allowing different supplemental maps to define corresponding areas that have different shapes increases flexibility as to the types of supplemental maps that can be created and/or the information that can be included in supplemental maps, thereby improving the interaction between the user and the electronic device.

In some embodiments, the first geographic area and the second geographic area overlap in the primary map. For example, the areas corresponding to the two supplemental maps optionally at least partially overlap. The electronic device optionally displays, in the overlapping area, information from both of the supplemental maps (if it exists), or information from one of the supplemental maps, in one or more of the ways described with reference to the subject matter described in method 700 corresponding to the features of claim 2. Allowing different supplemental maps to correspond to at least partially the same geographic area increases flexibility as to the types of supplemental maps that can be created and/or the information that can be included in supplemental maps, thereby improving the interaction between the user and the electronic device.

In some embodiments, the information about the one or more locations in the first geographic area includes one or more of information about one or more buildings identified in the first supplemental map, information about one or more areas (e.g., venue stages, campgrounds, or the like) identified in the first supplemental map, information about one or more food locations (e.g., food stands, restaurants, convenience stores, supermarkets, gift shops, or the like) identified in the first supplemental map, information about one or more landmarks identified in the first supplemental map, information about one or more restrooms identified in the first supplemental map, or information about media identified in the first supplemental map (e.g., representations of songs, video content, or other content that is associated with the supplemental map—in some embodiments, the representations are selectable to cause the electronic device to play the corresponding media—in some embodiments, the corresponding media is played by the electronic device concurrently with the display of the first geographic area in the primary map). Including various kinds or types of information in the supplemental map increases flexibility as to the types of supplemental maps that can be created and/or the information that can be included in supplemental maps, thereby improving the interaction between the user and the electronic device.

In some embodiments, while displaying, in the first geographic area in the primary map, the information about the one or more locations in the first geographic area from the first supplemental map, the electronic device receives, via the one or more input devices, an input corresponding to a request to cease display of the information from the first supplemental map. For example, receiving an input corresponding to selection of a user interface element displayed in the map user interface.

In some embodiments, in response to receiving the input, the electronic device displays the first geographic area in the primary map without displaying the information about the one or more locations in the first geographic area from the first supplemental map (e.g., the first geographic area in the primary map is now displayed with default base map information from the primary map, such as described with reference to the subject matter described in method 700 corresponding to the features of claim 3). Facilitating cessation of display of information from the supplemental map reduces clutter in the map user interface when such information is not desired, thereby improving the interaction between the user and the electronic device.

In some embodiments, displaying the information about the one or more locations in the first geographic area from the first supplemental map does not require that the electronic device have an active connection (e.g., a cellular or internet connection) to a device external to the electronic device (e.g., a server or computer). In some embodiments, the first supplemental map can be downloaded to the electronic device, and the information from the first supplemental map can be displayed in the first geographic area after the first supplemental map has been downloaded to the electronic device with or without an active internet connection at the electronic device. Allowing for offline use of the supplemental map ensures that supplemental map information can be available even in areas without internet access, thereby improving the interaction between the user and the electronic device.

In some embodiments, while displaying, in the first geographic area in the primary map, the information about the one or more locations in the first geographic area from the first supplemental map, the electronic device receives, via the one or more input devices, an annotation to a first portion of the first geographic area in the primary map. For example, the annotation input is optionally a handwritten input provided by a stylus or the finger of a user on a portion of a touch-sensitive display corresponding to the first portion of the first geographic area. For example, the annotation input is or includes circling a portion of the information in the first geographic area from the first supplemental map and/or the primary map.

In some embodiments, in response to receiving the annotation, the electronic device displays the annotation as part of the information in the first geographic area in the primary map (e.g., at the location(s) to which the annotation was directed). In some embodiments, after receiving the annotation to the first portion of the first geographic area, the electronic device receives, via the one or more input devices, an input corresponding to a request to share the first supplemental map with a second electronic device, different from the first electronic device. For example, a request to text message or email the first supplemental map to the second electronic device.

In some embodiments, in response to receiving the input corresponding to the request to share the first supplemental map, the electronic device initiates a process to transmit the first supplemental map to the second electronic device (e.g., transmit from the electronic device to the second electronic device, or from a server in communication with the electronic device to the second electronic device), wherein the first supplemental map includes the annotation as part of the first geographic area. Therefore, annotations made to supplemental maps are optionally added to the supplemental maps such that when those annotated supplemental maps are displayed at the second electronic device, the annotations made to the supplemental map at the electronic device are displayed in the first geographic area. Incorporating user annotations to supplemental maps increases the flexibility of the types of information that can be shared or stored on supplemental maps, thereby improving the interaction between the user and the electronic device.

In some embodiments, while displaying, via the display generation component, a respective geographic area (e.g., the respective geographic area has one or more of the characteristics of the first geographic area and/or the second geographic area) in the primary map within the map user interface, in accordance with a determination that a respective supplemental map for the respective geographic area is available (and optionally is not yet accessible to and/or downloaded to the electronic device), the electronic device displays, in the respective geographic area in the primary map, a visual indication corresponding to the respective supplemental map. For example, the map user interface includes an icon, button or other indication-optionally at the location of the respective geographic area—that indicates that one or more supplemental maps are available for the respective geographic area. In some embodiments, input directed to the visual indication initiates a process to download and/or access the one or more supplemental maps. In some embodiments, after downloading and/or gaining access to the one or more supplemental maps, display of the respective geographic area in the primary map optionally includes displaying information from the one or more supplemental maps in the respective geographic area, such as described with reference to the subject matter described in method 700 corresponding to the features of claim 1. Displaying a visual indication of the availability of a supplemental map for a geographic area facilitates discovery of the supplemental map and reduces user input needed to location such a supplemental map, thereby improving the interaction between the user and the electronic device.

In some embodiments, while displaying the information about the one or more locations in the first geographic area from the first supplemental map, the electronic device receives, via the one or more input devices, a first user input that corresponds to a selection of a respective location of the one or more locations. For example, an input selecting a representation of a snack stand from the first supplemental map, or an input selecting a representation of a gift shop from the first supplemental map.

In some embodiments, in response to the receiving the first user input, the electronic device displays, via the display generation component, additional information associated with the respective location, wherein the additional information is from the first supplemental map (and is optionally not included in the primary map). For example, the additional information optionally includes information about operating hours for the respective location, directions for visiting the respective location, photos or videos of the respective location, and/or selectable options for contacting and/or navigating to the respective location. Displaying additional information about elements of a supplemental map increases the amount of information available to the user relating to the first geographic area, thereby improving the interaction between the user and the electronic device.

In some embodiments, the additional information associated with the respective location includes an interior map of a structure (e.g., building) associated with the respective location. For example, if the respective location is a grocery store, the additional information optionally includes a map of the interior of the grocery store. If the respective location is a restroom, the additional information optionally includes a map of the interior of the restroom. In some embodiments, the interior map of the structure is not included in and/or accessible from the primary map without the accessibility of the first supplemental map. Displaying additional information about elements of a supplemental map increases the amount of information available to the user relating to the first geographic area, thereby improving the interaction between the user and the electronic device.

In some embodiments, while displaying the primary map in the map user interface, the electronic device receives, via the one or more input devices, an input directed to an element displayed in the map user interface. For example, an input selecting a representation of a snack stand from the first supplemental map, or an input selecting a representation of a gift shop from the first supplemental map.

In some embodiments, in response to receiving the input, in accordance with a determination that the element is included in the information about the one or more locations in the first geographic area from the first supplemental map, the electronic device performs a first operation associated with the element and in accordance with the input. For example, displaying additional information from the first supplemental map (e.g., similar to as described with reference to the subject matter described in method 700 corresponding to the features of claims 21-22) for the selected element.

In some embodiments, in accordance with a determination that the element is not included in the information about the one or more locations in the first geographic area from the first supplemental map, the electronic device performs a second operation associated with the element and in accordance with the input. For example, displaying additional information (e.g., similar to as described with reference to the subject matter described in method 700 corresponding to the features of claims 21-22) from the primary map for the selected element. Thus, in some embodiments, elements that are part of the supplemental map are interactable in one or more of the same ways that elements that are part of the primary map are interactable. Facilitating interaction with elements whether they are from the primary map or the supplemental map ensures consistency in interaction with the map user interface, thereby reducing errors in usage and improving the interaction between the user and the electronic device.

In some embodiments, in accordance with the determination that the electronic device has access to the first supplemental map (e.g., such as supplemental maps described with reference to methods 900 and/or 1100) for the first geographic area, the first geographic area is visually distinguished from a second geographic area in the primary map (e.g., for which the electronic device does not have access to a supplemental map and/or has access to a different supplemental map). In some embodiments, areas of the primary map for which the electronic device has access to a supplemental map are displayed with a respective visual characteristic (e.g., color, opacity, color saturation, tint and/or hue) that has a first value, and areas of the primary map for which the electronic device does not have access to a supplemental map are displayed with the respective visual characteristic that has a second value, different from the first value. In some embodiments, areas that correspond to different supplemental maps are displayed with the respective visual characteristic having different values. Displaying areas for which supplemental maps exist differently from other areas clearly conveys the existence or not of supplemental maps, reducing errors in usage and improving the interaction between the user and the electronic device.

In some embodiments, the information about the one or more locations is not included in the primary map. For example, in some embodiments, supplemental maps include elements (e.g., representations of snack stands or ticket booths) that are not included in the primary map (e.g., the primary map doesn't include such elements in the first geographic area, or at all). Displaying information or types of information in supplemental maps that do not exist in primary maps increases the flexibility of primary maps in conveying information, thereby improving the interaction between the user and the electronic device.

In some embodiments, in accordance with a determination that the first supplemental map is a first respective supplemental map, the information about the one or more locations is first information (e.g., a first type of information), and in accordance with a determination that the first supplemental map is a second respective supplemental map, different from the first respective supplemental map, the information about the one or more locations is second information, different from the first information (e.g., a second type of information). For example, in some embodiments, different supplemental maps include different types of information and/or elements that are not included in the other. For example, one supplemental map optionally includes information about and/or representations of snack stands in the geographic area corresponding to the supplemental map, while a different supplemental map optionally does not include any information about snack stands in the geographic area corresponding to the supplemental map, but does include information about ticket booths in the geographic area corresponding to the supplemental map (and the other supplemental map optionally does not include information about ticket booths). Including different information in different supplemental maps increases the flexibility of primary maps and/or supplemental maps in conveying different types of information, thereby improving the interaction between the user and the electronic device.

In some embodiments, in accordance with a determination that the first supplemental map is updated, the electronic device displays, in the first geographic area in the primary map, updated information about the one or more locations in the first geographic area from the updated first supplemental map. For example, in some embodiments, the first supplemental map can be dynamically updated (e.g., from a server external to the electronic device, such as a server that was the source of the first supplemental map). In some embodiments, the update is performed automatically by the electronic device (e.g., without user input to do so). In some embodiments, the update is performed manually by the electronic device in response to the user providing input to do so. In some embodiments, the first supplemental map includes different information after the update than it did before the update. Allowing for dynamic updating of supplemental maps after they have been accessed by the electronic device gives flexibility to creators of supplemental maps to keep the supplemental maps current, and ensure the information displayed for the supplemental map is current, thereby improving the interaction between the user and the electronic device.

In some embodiments, while displaying, via the display generation component, the first geographic area in the primary map within the map user interface, in accordance with the determination that the electronic device has access to the first supplemental map for the first geographic area and in accordance with a determination that the electronic device has access to a second supplemental map, different from the first supplemental map, for the first geographic area (e.g., the electronic device concurrently has access to two or more supplemental maps that at least partially cover the first geographic area), the electronic device displays, in the first geographic area in the primary map, the information about the one or more locations in the first geographic area from the first supplemental map, and second information about one or more second locations in the first geographic area from the second supplemental map (e.g., the second information optionally has one or more of the characteristics of the information about the one or more locations in the first geographic area from the first supplemental map). In some embodiments, the first geographic area is displayed with concurrent information from both the first and second supplemental maps, such as described with reference to the subject matter described in method 700 corresponding to the features of claim 2. Displaying information from different supplemental maps within the same geographic area enables a user to view all of the relevant information from the supplemental maps at the same time, thereby reducing the need for subsequent inputs to display such supplemental information.

In some embodiments, while displaying, in the first geographic area in the primary map, the information about the one or more locations in the first geographic area from the first supplemental map, the electronic device receives, via the one or more input devices, a user input corresponding to a request to perform a first operation corresponding to a feature of the primary map. For example, the user input corresponds to a request to search the primary map (e.g., for coffee shops or grocery stores), or corresponds to a request to display navigation directions from a first location to a second location.

In some embodiments, in response to receiving the user input, the electronic device performs the first operation. For example, primary map functionalities are optionally not affected by the existence of supplemental maps for one or more areas of the primary map. In some embodiments, the first operation utilizes information from the supplemental maps and/or the primary map. For example, search results for “coffee shop” optionally include locations (e.g., coffee stands) that are included in the supplemental map(s) but not included in the primary map, and also include locations that are included in the primary map but not included in the supplemental map. Similarly, navigation directions are optionally displayed or presented that account for roads or other features that exist in the supplemental map, but do not exist in the primary map-therefore, navigation directions from the same first location to the same second location optionally different depending on whether the relevant geographic area includes or does not include information from a supplemental map. Allowing performance of primary map functions when information from supplemental maps is displayed ensures consistent interaction with the map user interface, thereby reducing errors in usage and reducing the need for inputs to correct such errors.

In some embodiments, before displaying the information about the one or more locations in the first geographic area from the first supplemental map (e.g., before the electronic device has access to and/or has downloaded the first supplemental map), in accordance with a determination that a location of the electronic device relative to the first geographic area satisfies one or more criteria (e.g., the electronic device and/or user is within a threshold distance-such as 1, 5, 10, 100, 1000, 10000 or 100000 meters—of the area corresponding to a supplemental map that is available for access), the electronic device automatically downloads the first supplemental map to the electronic device. In some embodiments, in accordance with a determination that the location of the electronic device relative to the first geographic area does not satisfy the one or more criteria (e.g., the electronic device and/or user is not within the threshold distance of the area corresponding to the supplemental map that is available for access), the electronic device forgoes automatically downloading the first supplemental map to the electronic device. Automatically downloading supplemental maps to the electronic device ensures the availability of the information from those supplemental maps when or if needed.

In some embodiments, the first supplemental map is associated with a respective event that has a start time and an end time (e.g., the first supplemental map is a map for a discrete and/or temporary event, like a trade show, a music festival or a city fair that has a start date and/or time, and an end date and/or time). In some embodiments, in accordance with a determination that the respective event has ended, the electronic device automatically deletes the first supplemental map from the electronic device. For example, in response to the current date and/or time of the electronic device being after the end date and/or time for the event, the electronic device optionally automatically deletes the first supplemental map. In some embodiments, if the first supplemental map is not associated with a temporary event, the electronic device optionally does not automatically delete the first supplemental map. Automatically deleting supplemental maps when their corresponding events have ended reduces storage usage at the electronic device and reduces clutter in the user interface, thereby improving user interaction with the electronic device.

In some embodiments, before displaying the information about the one or more locations in the first geographic area from the first supplemental map (e.g., such as described with reference to the subject matter described in method 700 corresponding to the features of claim 30), in accordance with the determination that the location of the electronic device relative to the first geographic area satisfies the one or more criteria (e.g., such as described with reference to the subject matter described in method 700 corresponding to the features of claim 30), the electronic device automatically downloads primary map information for one or more geographic areas surrounding the first geographic area (e.g., analogously as described with reference to the subject matter described in method 700 corresponding to the features of claim 30). For example, geographic areas surrounding the first geographic area optionally are areas that are within a threshold distance (e.g., 1, 10, 100, 1000, 10000 or 100000 meters) of the outer boundaries of the geographic area.

In some embodiments, in accordance with the determination that the location of the electronic device relative to the first geographic area does not satisfy the one or more criteria (e.g., such as described with reference to the subject matter described in method 700 corresponding to the features of claim 30), the electronic device forgoes automatically downloading the primary map information for the one or more geographic areas surrounding the first geographic area. Automatically downloading primary map information for geographic areas surrounding the area of the supplemental map ensures the availability of the information from the primary map when or if needed (e.g., to aid in entering or exiting the first geographic area via roads, passageways, or the like).

It should be understood that the particular order in which the operations in method 700 and/or FIG. 7 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 7 are, optionally, implemented by components depicted in FIGS. 1A-1B. For example, displaying operations 702b and 702c are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces for Curated Navigation Directions

Users interact with electronic devices in many different manners, including interacting with maps and maps applications for viewing information about various locations. In some embodiments, an electronic device displays information about a region of interest to a user. The embodiments described below provide ways in which an electronic device provides efficient user interfaces for obtaining navigation directions within the region of interest to the user, thus enhancing the user's interaction with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

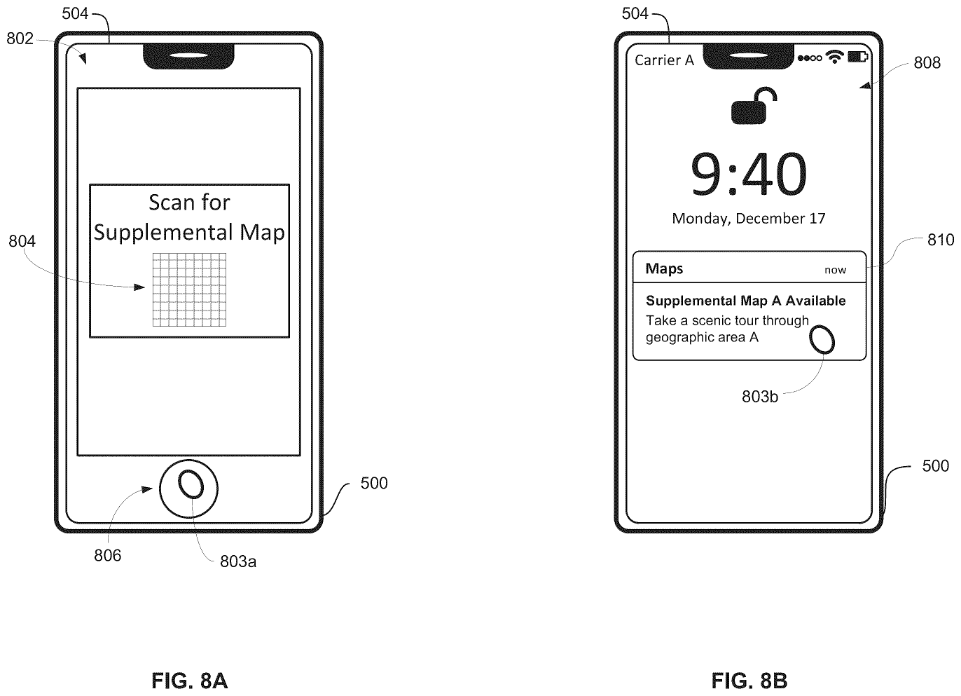

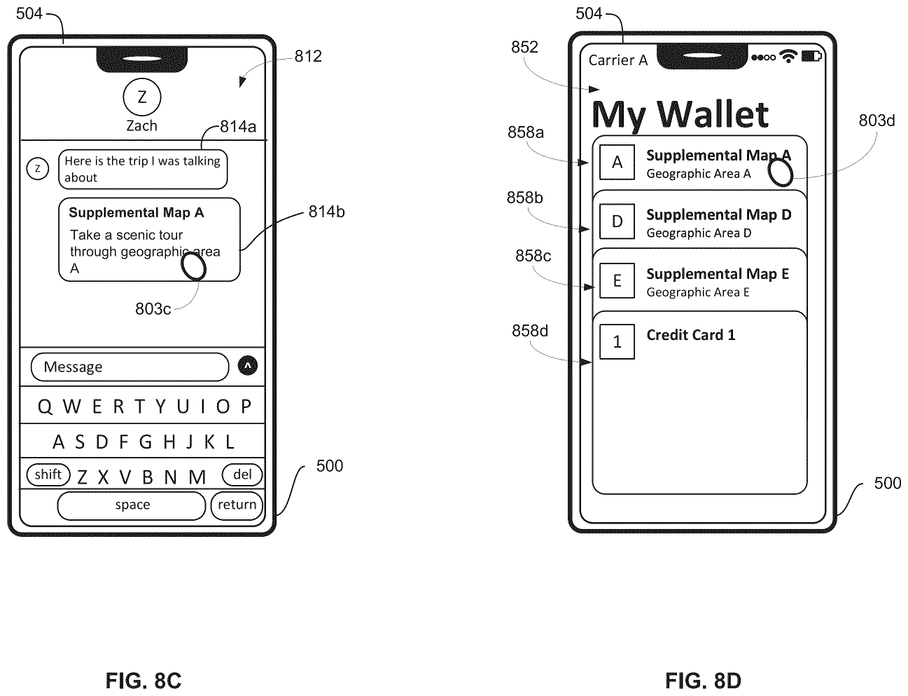

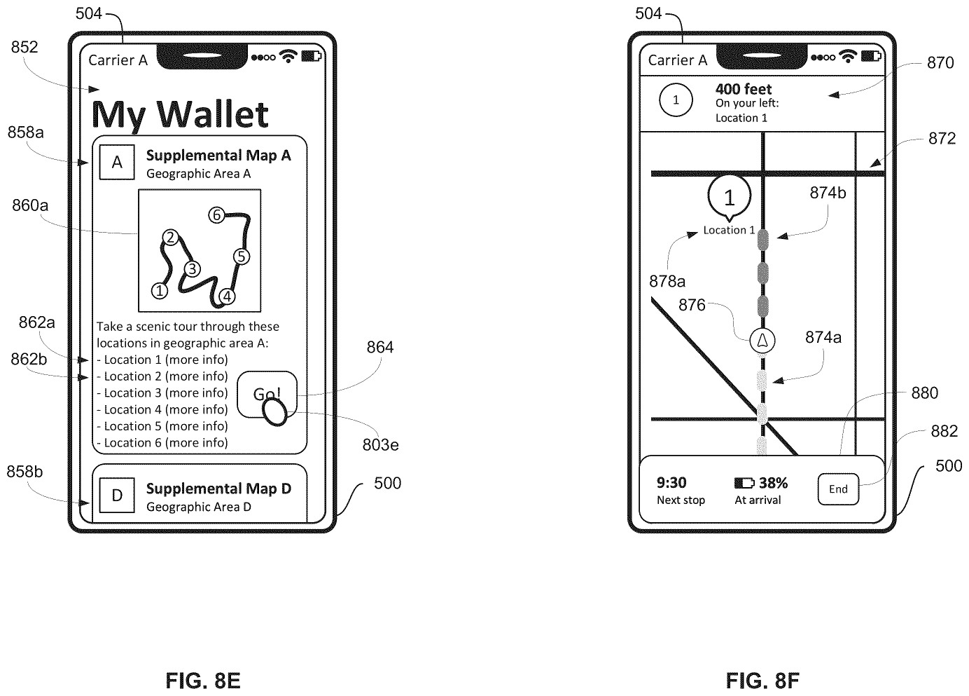

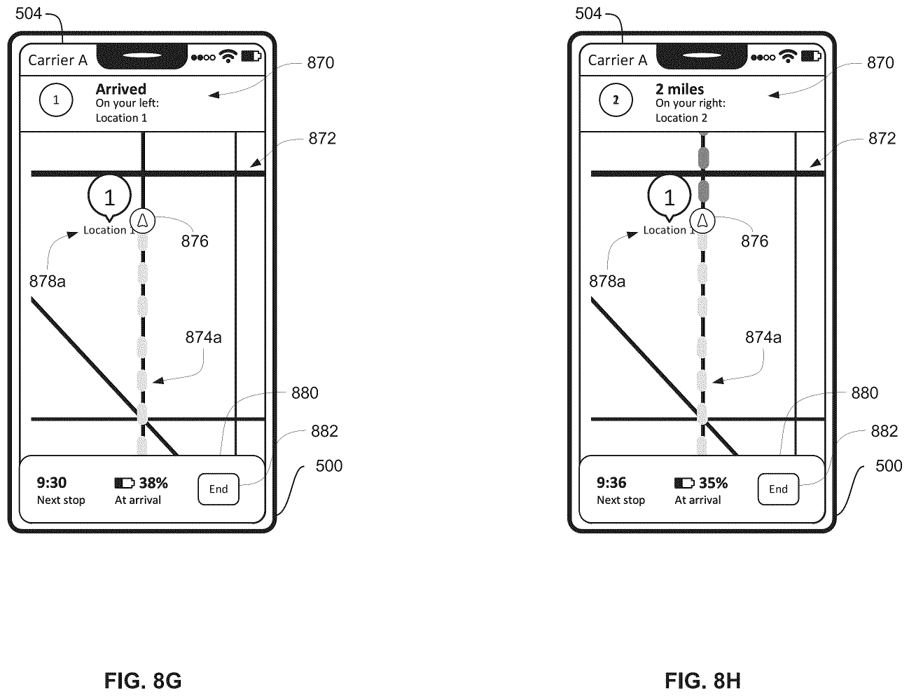

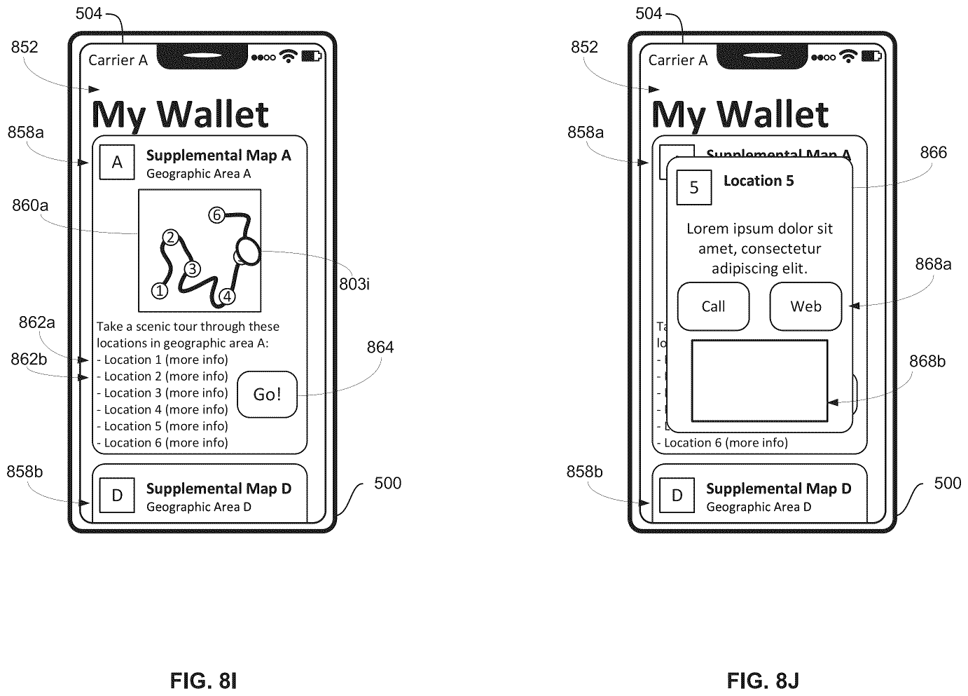

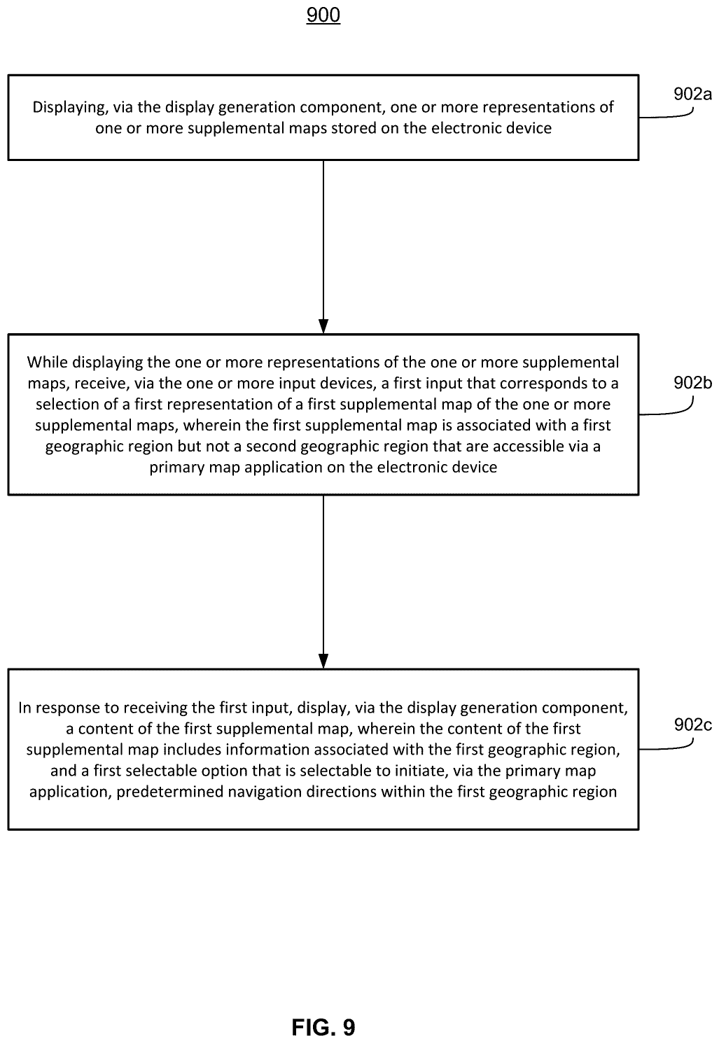

FIGS. 8A-8J illustrate exemplary ways in which an electronic device displays curated navigation directions using supplemental maps. The embodiments in these figures are used to illustrate the processes described below, including the processes described with reference to FIG. 9. Although FIGS. 8A-8J illustrate various examples of ways an electronic device is able to perform the processes described below with respect to FIG. 9, it should be understood that these examples are not meant to be limiting, and the electronic device is able to perform one or more processes described below with reference to FIG. 9 in ways not expressly described with reference to FIGS. 8A-8J.

FIG. 8A illustrates an exemplary device 500 displaying a camera user interface 802 for capturing images using one or more cameras of device 500. In some embodiments, the user interface is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

In some embodiments, device 500 is able to gain access to and/or download a supplemental map via scanning a graphical element such as QR code 804. In FIG. 8A, device 500 detects selection of button 806 (e.g., via contact 803a) while one or more cameras of device 500 capture images of QR code 804, which optionally initiates a process at device 500 to gain access to and/or download the supplemental map associated with QR code 804.

FIG. 8B illustrates an alternative method to gain access to and/or download a supplemental map. For example, in FIG. 8B, device 500 is displaying a lock screen user interface 808. In response to determining that device 500 is within a threshold distance (e.g., 1, 3, 5, 10, 100, 1000, or 1000 m) of a location (e.g., a business, a restaurant, a grocery store, etc.) that is associated with a supplemental map, device 500 in FIG. 8B displays a notification 810 that indicates that a supplemental map for the location is available. For example, notification 810 includes information identifying the name/title of the supplemental map, the content of the supplemental map (e.g., indicating that the supplemental map includes information about a tour in the location/geographic area associated with the supplemental map), and the location and/or region associated with the supplemental map (e.g., geographic area A). Further, in some embodiments, notification 810 is generated by a primary map application on device 500. Details about primary map applications are described with reference to method 900. In FIG. 8B, device 500 detects selection of notification 810 (e.g., via contact 803b), which optionally initiates a process at device 500 to gain access to and/or download the supplemental map associated with notification 810.

FIG. 8C illustrates an alternative method to gain access to and/or download a supplemental map. For example, in FIG. 8C, device 500 is displaying a messaging user interface 812 of a messaging application. User interface 812 in FIG. 8C corresponding to a messaging conversation between the user of device 500 and one or more other contacts (e.g., Zach). In some embodiments, supplemental maps are able to be shared with people by sending them as part of a messaging conversation. For example, in FIG. 8C, Zach has sent, to the messaging conversation, Supplemental Map A. As a result, user interface 812 includes representation 814b of that supplemental map that was transmitted to the messaging conversation. Representation 814b includes information identifying the name/title of the supplemental map, the content of the supplemental map (e.g., indicating that the supplemental map includes information about a tour in the location/geographic area associated with the supplemental map), and the location and/or region associated with the supplemental map (e.g., geographic area A). In FIG. 8C, device 500 detects selection of representation 814b (e.g., via contact 803c), which optionally initiates a process at device 500 to gain access to and/or download the supplemental map associated with representation 814b.

Supplemental maps as described with reference to methods 700, 900 and/or 1100 can be obtained in other ways described in those methods as well, such as via purchasing one or more supplemental maps from a supplemental map store (e.g., analogous to an application store on device 500 for purchasing access to applications).

After device 500 has obtained access to and/or downloaded a supplemental map, device 500 optionally displays that supplemental map in a supplemental map repository. For example, in FIG. 8D, device 500 is displaying user interface 852, which is a user interface of the digital wallet application on device 500. User interface 852 in FIG. 8D includes representations and/or descriptions of the supplemental maps that have been downloaded to device 500 and/or to which device 500 has access, such as representation 858a for a supplemental map of geographic region A (e.g., the supplemental map from FIGS. 8A-8C), representation 858b for a supplemental map of geographic region D, and representation 858c for a supplemental map of geographic region E. In some embodiments, representation 858a is selectable to display geographic region A with corresponding supplemental map information in a primary map in the primary map application, such as shown with reference to FIGS. 6A-6H. Representation 858b is optionally selectable to display geographic region D with corresponding supplemental map information in the primary map in the primary map application, and representation 858c is optionally selectable to display geographic region E with corresponding supplemental map information in the primary map in the primary map application, such as shown with reference to FIGS. 6A-6H. User interface 852 optionally additionally includes representations of one or more credit cards, loyalty cards, boarding passes, tickets and/or other elements that are stored in the digital wallet application, which are optionally selectable to perform corresponding transactions using the digital wallet application. For example, in FIG. 8D, user interface 852 also includes representation 858d of Credit Card 1, which is optionally selectable to view information about Credit Card 1 and/or initiate a transaction (e.g., a purchase transaction) using Credit Card 1.

In some embodiments, supplemental maps display their information separate from (e.g., outside of) a primary map application, depending on the configuration of the supplemental maps. For example, in FIG. 8D, device 500 detects selection of representation 858a (e.g., via contact 803d). In response, in FIG. 8E, device 500 expands and/or unobscures representation 858a to display the content of supplemental map A in user interface 852. In the example of FIG. 8E, supplemental map A is a supplemental map associated with providing curated navigation directions within its geographic area (e.g., geographic area A). For example, representation 858a includes, in addition to the name of the supplemental map (“Supplemental Map A”) and an indication of the geographic area associated with the supplemental map (“Geographic Area A”), a representation 860a of the curated navigation directions and/or representations 862 of locations and/or points of interest that comprise the curated navigation directions (e.g., the stops or waypoints along the way in the curated navigation directions). Representation 860a includes an overview of the navigation route, such as on a map of geographic area A, as well as indications of the locations and/or points of interest that comprise the navigation route (e.g., icons (1), (2), (3), (4), (5) and (6)). In FIG. 8E, representation 858a also include selectable option 864 that is selectable to initiate the curated navigation directions via device 500.

In FIG. 8E, device 500 detects selection of option 864 (e.g., via contact 803e), and in response, initiates navigation directions in a user interface of a primary map application on device 500, as shown in FIG. 8F. In some embodiments, device 500 includes a primary map application. For example, the primary map application can present maps, routes, location metadata, and/or imagery (e.g., captured photos) associated with various geographical locations, points of interest, etc. The primary map application can obtain map data that includes data defining maps, map objects, routes, points of interest, imagery, etc., from a server. For example, the map data can be received as map tiles that include map data for geographical areas corresponding to the respective map tiles. The map data can include, among other things, data defining roads and/or road segments, metadata for points of interest and other locations, three-dimensional models of the buildings, infrastructure, and other objects found at the various locations, and/or images captured at the various locations. The primary map application can request, from the server through a network (e.g., local area network, cellular data network, wireless network, the Internet, wide area network, etc.), map data (e.g., map tiles) associated with locations that the electronic device frequently visits. The primary map application can store the map data in a map database. The primary map application can use the map data stored in map database and/or other map data received from the server to provide the maps application features described herein (e.g., navigation routes, maps, navigation route previews, etc.).

In some implementations, a system can include the server. For example, the server can be a computing device, or multiple computing devices, configured to store, generate, and/or serve map data to various user devices (e.g. device 500), as described herein. For example, the functionality described herein with reference to the server can be performed by a single computing device or can be distributed amongst multiple computing devices.

As shown in FIG. 8F, device 500 is displaying the curated navigation directions of supplemental map A in a user interface of the primary map application. The user interface optionally includes region 870 that indicates the next navigation maneuver in the navigation directions and/or the distance to the next stop in the navigation directions, region 872 that includes a representation of a primary map over which navigation information is overlaid, and region 880 that provides information about the timing of arriving at the next stop in the navigation directions, a battery or fuel level of the vehicle that will remain when arriving at the next stop, and a selectable option 882 that is selectable to end the navigation directions.

The navigation directions optionally direct device 500 through one or more predefined stops or waypoints, as previously described. As such, when initiated such as shown in FIG. 8E, device 500 optionally automatically initiates navigation directions to the first stop in the predefined navigation directions (e.g., location 1). The navigation directions are optionally from the current location of device 500 to the first stop in the predefined navigation directions. As shown in FIG. 8F, the navigation directions have begun, and in region 872 device 500 is displaying representation 878a corresponding to the first stop in the navigation directions, representation 876 that indicates the current location of device 500 on the navigation route and/or map, route line segment 874a that indicates the portion of the route already traversed by device 500, and route line segment 874b that indicates the upcoming or future portion of the route not yet traversed by device 500.

In some embodiments, device 500 automatically initiates navigation directions to the next stop in the curated navigation directions when device 500 reaches a given stop in the curated navigation directions. For example, in FIG. 8G, device 500 has reached the first stop in the navigation directions (e.g., location 1), and in response, in FIG. 8H, device 500 has updated the navigation user interface to provide navigation directions to the next stop (e.g., location 2) in the curated navigation directions, including updating regions 870, 872 and 880 accordingly as shown in FIG. 8H. Device 500 optionally continues to automatically initiate navigation directions to the next stop in the curated navigation directions as device 500 makes progress through the curated navigation directions (e.g., by reaching the various stops in the navigation directions)

In some embodiments, the various representations of the locations of the curated navigation directions are selectable in the supplemental map to display additional information about the selected location. For example, in FIG. 8I, device 500 is displaying representation 858a of the supplemental map A in user interface 852, as described with reference to FIG. 8E. Representations of the locations within representation 860a and/or representations 862 (e.g., 862a corresponding to location 1, 862b corresponding to location 2, etc.) are optionally selectable to display additional information about the selected location in user interface 852. For example, in FIG. 8I, device 500 detects selection of icon (5) corresponding to location 5 in the curated navigation directions. In response, as shown in FIG. 8J, device 500 displays user interface 866, optionally overlaid on user interface 852 and/or representation 858a. User interface 866 is optionally a dedicated user interface for location 5, and includes various information about location 5 such as a described of the location, one or more selectable options 868a that are selectable to perform operations associated with the location (e.g., to call the location, to display a website for the location, etc.), and content 868b associated with the location (e.g., photographs of the location, videos of the location, etc.). The information about location 5 displayed in user interface 866 is optionally populated only from the corresponding supplemental map (and the information optionally does not exist in the primary map for location 5), populated only from the primary map, or populated from both the supplemental map (optionally including at least some information that is not available in the primary map for location 5) and the primary map.

FIG. 9 is a flow diagram illustrating a method 900 for displaying curated navigation directions using supplemental maps. The method 900 is optionally performed at an electronic device such as device 100, device 300, device 500 as described above with reference to FIGS. 1A-1B, 2-3, 4A-4B and 5A-5H. Some operations in method 900 are, optionally combined and/or the order of some operations is, optionally, changed.

As described below, the method 900 provides ways in which an electronic device displays curated navigation directions using supplemental maps. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 900 is performed at an electronic device in communication with a display generation component and one or more input devices. In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 900 is performed at or by an automobile (e.g., at an infotainment system of an automobile having or in communication with one or more display generation components and/or input devices).

In some embodiments, the electronic device displays (902a), via the display generation component, one or more representations of one or more supplemental maps stored on (and/or accessible to) the electronic device, such as in FIG. 8D. In some embodiments, the supplemental maps have one or more of the characteristics of the supplemental maps described with reference to methods 700 and/or 1100. In some embodiments, the one or more representations of the supplemental maps are displayed within a user interface from which access to the supplemental maps can be purchased (e.g., a supplemental map store user interface) and/or a user interface that includes supplemental maps that the electronic device already has obtained access to (e.g., a supplemental map library user interface). In some embodiments, the user interface is a user interface of a map application, such as a map application as described with reference to method 700. In some embodiments, the user interface is not a user interface of the map application, and is a user interface of a separate application associated with supplemental maps. In some embodiments, a respective representation of a respective supplemental map includes an image associated with the corresponding region (also referred to herein as “area”), entity and/or activity associated with the supplemental map and/or text describing or corresponding to the region, entity and/or activity associated with the supplemental map.

In some embodiments, while displaying the one or more representations of the one or more supplemental maps, the electronic device receives (902b), via the one or more input devices, a first input that corresponds to a selection of a first representation of a first supplemental map of the one or more supplemental maps, such as in FIG. 8D (e.g., the first input includes a user input directed to the first representation, such as a tap input, a click input, (e.g., via a mouse or trackpad in communication with the electronic device), a swipe or drag input, and/or a hover input (e.g., in which a hand of the user is maintained above a portion of the electronic device, such as the display generation component, and/or provides a pinch gesture (e.g., in which the index finger and thumb of the hand of the user make contact)) on a location of the display generation component that is associated with the first representation.), wherein the first supplemental map is associated with a first geographic region but not a second geographic region that are accessible via a primary map application on the electronic device. In some embodiments, the primary map application is a map application that has access to and/or displays portions of a primary map, such as described with reference to method 700. In some embodiments, the first supplemental map includes information about and/or is associated with the first geographic region, but does not include information about and/or is not associated with the second geographic region, where the primary map in the primary map application includes information about and/or is associated with both the first geographic region and the second geographic region.

In some embodiments, in response to receiving the first input, the electronic device displays (902c), via the display generation component, a content of the first supplemental map, wherein the content of the first supplemental map includes information associated with the first geographic region, such as in FIG. 8E (In some embodiments, the content of the first supplemental map includes details about locations within the first geographic region but not the second geographic region. In some embodiments, the first supplemental map is displayed alongside and/or overlaid upon the map of the first geographic area. In some embodiments, the first supplemental map is separately displayed and includes details about locations within the first geographic region, such as points of interest in the first geographic region, photos and/or videos of locations in the first geographic region, links to guides of activities to do in the first geographic region, and/or any information associated with the first geographic region such as described with reference to methods 700, 900 and/or 1100. In some embodiments, the first geographic region has one or more of the characteristics of the geographic regions or areas described with reference to methods 700 and/or 1100), and a first selectable option that is selectable to initiate, via the primary map application, predetermined navigation directions within the first geographic region. In some embodiments, the first supplemental map includes information for providing a curated trip and/or navigation directions from location to location through a plurality of locations (e.g., corresponding to points of interest) in the first geographic region. In some embodiments, the plurality of locations are all contained within the first geographic region (e.g., the start, end, and intermediate locations within the plurality of locations are all located within the first geographic region). In some embodiments, the plurality of locations are defined by the first supplemental map (e.g., not user-defined), such that the navigation directions are provided without input from the user specifying any of the locations in the plurality of locations. In some embodiments, supplemental maps for different geographic regions include different information for providing different curated trips and/or navigation directions from location to location through a plurality of locations (e.g., corresponding to points of interest) in those different geographic regions. In some embodiments, the first selectable option is a link is a link to initiate such a curated trip and/or navigation directions. In some embodiments, the electronic device automatically opens the primary map application (e.g., which is optionally not displayed when the content of the first supplemental map is displayed) to initiate and/or display the predetermined navigation directions in the primary map application. In some embodiments, the predetermined navigation directions correspond to a series of related locations, such as restaurants or locations for movies, selected by a creator of the supplemental map, or connected in some way. In some embodiments, the route for the navigation directions is displayed on a virtual map in the primary map application. For instance, the virtual map optionally includes, as a route line overlay on the map, a route corresponding to the predetermined navigation directions. In some embodiments, the first destination is shown on the route within the primary application, with the starting point being the current location of the electronic device. In some embodiments, once the primary map application is displayed, a single input selecting a selectable option to “begin” the navigation directions initiates the navigation directions. In some embodiments, the navigation directions in the primary map application are initiated automatically (e.g., without further user input) in response to detecting selection of the first selectable option in the first supplemental map. Initiating predetermined navigation directions specific to a supplemental map allows for unique and curated trips that require reduced user input.

In some embodiments, while displaying the content of the first supplemental map, the electronic device receives, via the one or more input devices, a second input that corresponds to a selection of the first selectable option. For example, the selection input includes a tap detected on a touch-sensitive display at a location corresponding to the first selectable option. In some embodiments, the selection input includes a click detected at a mouse while a cursor is directed to the first selectable option.

In some embodiments, in response to receiving the second input, the electronic device initiates navigation directions to a first point of interest (and/or first waypoint) within the first geographic region that is part of the predetermined navigation directions within the first geographic region (e.g., without user input selecting or otherwise indicating the first point of interest to be the first destination or stop in the navigation directions). In some embodiments, the navigation directions are provided in the primary map application. In some embodiments, the first point of interest is one or more of churches, schools, town halls, distinctive buildings, post offices, shops, postboxes, telephone boxes, pubs, car parks and lay-bys (and whether free or not), landmarks, or tourist attractions. In some embodiments, the navigation directions are from a current location of the electronic device (whether or not the current location of the electronic device is within the first geographic region) to the first point of interest. In some embodiments, the navigation directions are from a predefined starting location (e.g., defined by the supplemental map) in the first geographic region, independent of a current location of the electronic device, and the navigation directions to the first point of interest optionally do not begin until the current location of the electronic device reaches the predefined starting location. In some embodiments, the order of waypoints (e.g., points of interest) in the navigation directions is defined by the first supplemental map. Automatically initiating navigation directions to the first waypoint in the navigation directions reduces the number of inputs needed to start navigating.

In some embodiments, while the navigation directions to the first point of interest are initiated, the electronic device detects that the electronic device has arrived at the first point of interest (and/or first waypoint). For example, detecting that the electronic device is within a threshold distance, such as 1, 3, 5, 10, 50, 100, 1000 or 10000 meters, of the first point of interest.

In some embodiments, in response to arriving at the first point of interest, the electronic device initiates navigation directions to a second point of interest (and/or waypoint) that is part of the predetermined navigation directions within the first geographic region (e.g., without user input indicating which waypoint and/or point of interest to navigate to next). In some embodiments, the order of waypoints (e.g., points of interest) in the navigation directions is defined by the first supplemental map. Automatically initiating navigation directions to the next waypoint in the navigation directions reduces the number of inputs needed to navigate the predetermined navigation directions.

In some embodiments, the first supplemental map is associated with a plurality of different points of interest (and/or waypoints). In some embodiments, each of the plurality of points of interest is included in the first geographic region. Associating the supplemental map with a plurality of different points of interest reduces the need for interactions with multiple supplemental maps.

In some embodiments, the plurality of points of interest have one or more characteristics in common. For example, the plurality of points of interest are all related to music (e.g., theaters, bars, or venues that all host live music), or are all related to movies (e.g., movie studios, movie theaters, or movie rental stores). Different supplemental maps optionally have their own, different points of interest that are associated with each other in this way (e.g., one supplemental map that is associated with points of interest relating to music, and a different supplemental map that is associated with points of interest relating to movies). Associating a supplemental map with points of interest that have one or more characteristics in common improves organization of points of interest, and reduces the number of inputs needed to locate relevant information in supplemental maps.

In some embodiments, the one or more characteristics in common include a common activity. For example, a supplemental map associated with surfing optionally includes a plurality of points of interest related to surfing, while a different supplemental map associated with hiking optionally includes a plurality of points of interest related to hiking. Associating a supplemental map with points of interest that are related to a common activity improves organization of points of interest, and reduces the number of inputs needed to locate relevant information in supplemental maps.

In some embodiments, the one or more characteristics in common include related locations. For example, a supplemental map associated with a national park optionally includes a plurality of points of interest related to or included in the location of the national park (e.g., hiking points of interest in the part, transit points of interest in the park, bathrooms in the park, campsites in the park and/or tables in the park), while a different supplemental map associated with a theme park optionally includes a plurality of points of interest related to or included in the location of the theme park (e.g., ride locations in the park, bathrooms in the park, restaurants in the park and/or snack stands in the park). Associating a supplemental map with points of interest that are related to a common location improves organization of points of interest, and reduces the number of inputs needed to locate relevant information in supplemental maps.

In some embodiments, the one or more characteristics in common include being selected by a same creator of (and/or entity associated with) the first supplemental map. For example, if a business such as a restaurant or a store creates the first supplemental map, the points of interest included in the supplemental map are optionally related in that they were selected for inclusion by the business. For example, a bar optionally creates a supplemental map that includes points of interest comprising other bars in walking distance of the bar as part of a bar tour (e.g., the predetermined navigations directions). Associating a supplemental map with points of interest that are related to a common creator or entity improves organization of points of interest, and reduces the number of inputs needed to locate relevant information in supplemental maps.

In some embodiments, the one or more characteristics in common include being related to content (e.g., audio, and/or video). For example, a supplemental map associated with music creation in Los Angeles optionally includes points of interest that all have to do with music in Los Angeles (e.g., recording studios in Los Angeles, homes of artists who live in Los Angeles, and/or concert venues in Los Angeles). Associating a supplemental map with points of interest that are related to a common creator or entity improves organization of points of interest, and reduces the number of inputs needed to locate relevant information in supplemental maps.

In some embodiments, the one or more characteristics in common include being part of an interior space of a building. For example, a supplemental map associated with a particular building optionally includes points of interest that are included in that building (e.g., a supplemental map for a grocery store optionally includes points of interest corresponding to the different aisle, shelves and/or food sections in the grocery store, and the supplemental map optionally includes one or more images of the interior of the store that depict one or more of the points of interest). Associating a supplemental map with points of interest that are related to a common interior space of a building improves organization of points of interest, and reduces the number of inputs needed to locate relevant information in supplemental maps.

In some embodiments, the predetermined navigation directions are initiated within a primary map application that is in a respective transit mode (e.g., walking, driving, cycling and/or public transit). In some embodiments, the predetermined navigation directions are provided in a primary map application (e.g., such as described with reference to methods 700, 900 and/or 1100). In some embodiments, the first selectable option is displayed within a user interface of the primary map application, or is displayed in the user interface of an application other than the primary map application—in which case, the electronic device optionally launches or displays the primary map application in response to detecting selection of the first selectable option. In some embodiments, the predetermined navigation directions are provided according to a currently selected transit mode in the primary map application. In some embodiments, the user is able to provide input to change the transit mode used to provide the predetermined navigation directions. In some embodiments, the transit mode used to provide the predetermined navigation directions is defined by the first supplemental map—in some embodiments, this transit mode is a default transit mode in which the primary map application provides the predetermined navigation directions, which the user is optionally able to change after and/or when the primary map application is providing the predetermined navigation directions. In some embodiments, the user is not able to change the transit mode for the predetermined navigation directions that is defined by the first supplemental map. Providing the predetermined navigation directions via the primary map application ensures consistent presentation of navigation directions regardless of whether the navigation directions are from a supplemental map or from usage of the primary map application separate from the supplemental map, thereby reducing errors in usage.

In some embodiments, while displaying the content of the first supplemental map, wherein the content of the first supplemental map includes one or more representations of one or more points of interest associated with the first supplemental map (e.g., points of interest such as described with reference to the subject matter described in method 900 corresponding to the features of claim 39 and/or 40), the electronic device receives, via the one or more input devices, a second input corresponding to selection of a respective representation of a respective point of interest. In some embodiments, the second input has one or more of the characteristics of the inputs described with reference to the subject matter described in method 900 corresponding to the features of claims 39 and/or 40.

In some embodiments, in response to receiving the second input, the electronic device performs an action associated with the respective point of interest (e.g., initiating a call or email to the respective point of interest, causing display of a user interface that includes additional information about the point of interest, or the like). In some embodiments, the action associated with the respective point of interest has one or more of the characteristics of actions that can be taken in response to selection of a representation of a location and/or point of interest in a primary map application, such as described with reference to methods 700, 900 and/or 1100. Allowing interaction with representations of points of interest ensures consistent interaction between the user and map-related user interfaces such as the supplemental map or the primary map, thereby reducing errors in usage.

In some embodiments, performing the action associated with the respective point of interest includes displaying information associated with the respective point of interest. For example, the information associated with the respective point of interest optionally includes one or more of a button that is selectable to initiate navigation directions to the point of interest, a button that is selectable to initiate transactions (e.g., food or item ordering) with the point of interest, information about operating hours of the point of interest, information about reviews for the point of interest and/or photographs or videos of the point of interest. Providing access to additional information about the point of interest reduces the number of inputs needed to access such information, thereby improving interaction between the user and the electronic device.

In some embodiments, while displaying the content of the first supplemental map, in response to receiving an input to display points of interest associated with the first supplemental map in a first format (e.g., selection of a toggle or button to display the points of interest on a map at their respective locations on the map, without displaying the points of interest in a list format), the electronic device displays, within the content of the first supplemental map, the points of interest associated with the first supplemental map in the first format, including displaying representations (e.g., icons, photos, or the like) of the points of interest on a map (e.g., displayed within the content of the first supplemental map) at locations corresponding to the points of interest. In some embodiments, in response to receiving an input to display the points of interest associated with the first supplemental map in a second format, different from the first format (e.g., selection of a toggle or button to display the points of interest in a list format, without displaying the points of interest on a map at their respective locations on the map), the electronic device displays, within the content of the first supplemental map, the points of interest associated with the first supplemental map in the second format, not including displaying the representations of the points of interest on the map. In some embodiments, whether the points of interest are displayed in the first format or the second format, the points of interest are interactable as described with reference to the subject matter described in method 900 corresponding to the features of claims 50-51. In some embodiments, in the second format, the points of interest are displayed in increasing distance from the current location of the electronic device. Providing the user control to change the format in which the points of interest are displayed increases flexibility of the interactions with the first supplemental map, thereby improving interaction between the user and the electronic device.

In some embodiments, the content of the first supplemental map includes media content (e.g., video content that can be played in the supplemental map, and/or audio content that can be played while displaying the supplemental map). In some embodiments, the media content is content associated with one or more of the points of interest associated with the supplemental map. Including media content in a supplemental map reduces the number of inputs needed to access such media content, thereby improving interaction between the user and the electronic device.

In some embodiments, while displaying the content of the first supplemental map, wherein the first supplemental map is associated with one or more points of interest (e.g., as described previously), the electronic device receives, via the one or more input devices, a second input corresponding to selection of a respective point of interest of the one or more points of interest. In some embodiments, the second input has one or more of the characteristics of the inputs described with reference to the subject matter described in method 900 corresponding to the features of claims 39 and/or 40.

In some embodiments, in response to receiving the second input, the electronic device displays, in a user interface different from the content of the first supplemental map (e.g., in a user interface overlaid on the content of the first supplemental map), information associated with the respective point of interest (e.g., information about the respective point of interest as described with reference to method 900). In some embodiments, if the supplemental map is associated with multiple days of predetermined navigation directions (e.g., a driving itinerary that spans multiple days of driving, with each day having its own predetermined navigation directions), the electronic device is able to display different sets of information for the different days of predetermined navigation directions separately in response to input to display such information. Providing access to additional information about the point of interest reduces the number of inputs needed to access such information, thereby improving interaction between the user and the electronic device.

In some embodiments, before (and/or while not) displaying the content of the first supplemental map (e.g., while displaying a user interface of a camera application on the electronic device that facilitates capturing video and/or photos of content captured by one or more cameras of the electronic device), the electronic device captures, via one or more cameras of the electronic device, an image of a graphical element that is associated with the first supplemental map (e.g., a barcode, a QR code, an image, or any other graphical element that is associated with the first supplemental map). In some embodiments, in response to capturing the image of the graphical element, the electronic device initiates a process to display, via the display generation component, the content of the first supplemental map. For example, the electronic device optionally downloads and/or displays the first supplemental map in response to capturing an image of the graphical element, optionally further in response to receiving further user input confirming that the electronic device should download and/or display the first supplemental map. Providing access to the supplemental map via capturing an image of a graphical element reduces the number of inputs needed to access the supplemental map, and reduces errors in selecting the correct supplemental map, thereby improving interaction between the user and the electronic device.

In some embodiments, before (and/or while not) displaying the content of the first supplemental map (e.g., while displaying any user interface of the electronic device, such as a home screen user interface, a wake screen user interface, a user interface of a primary map application, or a user interface of a game application other than the primary map application), in accordance with a determination that a location of the electronic device corresponds to the first geographic area (e.g., the electronic device is within the first geographic area, or is within a threshold distance such as 0.1, 0.5, 1, 5, 10, 100, 1000, 10000 or 100000 meters of the first geographic area), the electronic device displays, via the display generation component, a second selectable option that is selectable to initiate a process to display, via the display generation component, the content of the first supplemental map (e.g., the process optionally having one or more of the characteristics described with reference to the subject matter described in method 900 corresponding to the features of claim 55). In some embodiments, the second selectable option is displayed within or comprises a notification on the electronic device that is optionally displayed and/or remains accessible as long as the location of the electronic device corresponds to the first geographic area. In some embodiments, if the current location additionally or alternatively corresponds a second geographic area other than the first geographic area, the electronic device (optionally concurrently) displays a third selectable option that is selectable to initiate a process to display, via the display generation component, the content of a second supplemental map associated with the second geographic area. Providing access to the supplemental map via a location-based selectable option reduces the number of inputs needed to access the supplemental map, and reduces errors in selecting the correct supplemental map, thereby improving interaction between the user and the electronic device.

In some embodiments, before (and/or while not) displaying the content of the first supplemental map, the electronic device displays, via the display generation component, a messaging user interface corresponding to a messaging conversation (e.g., displaying the transcript of the messaging conversation in a messaging application via which the electronic device is able to transmit to and/or receive messages from and/or display messages in the messaging conversation) that includes a second selectable option that is selectable to initiate a process to display, via the display generation component, the content of the first supplemental map (e.g., the process optionally having one or more of the characteristics described with reference to the subject matter described in method 900 corresponding to the features of claims 55 and/or 56), wherein the second selectable option corresponds to messaging activity (e.g., is displayed as a representation of a message within messaging transcript) the that was transmitted to the messaging conversation by a respective electronic device different from the electronic device (e.g., a user other than the user of the electronic device sent the supplemental map to the user of the electronic device as a message in the messaging application). In some embodiments, the second selectable option is displayed within or comprises a message within the messaging conversation that is optionally displayed and/or remains accessible as long as the message is not deleted from the messaging conversation. Providing access to the supplemental map via a messaging conversation facilitates sharing of supplemental maps amongst different users, thereby improving interaction between the user and the electronic device.

In some embodiments, the predetermined navigation directions include driving directions. For example, at least part or all of the predetermined navigation directions use driving as the transit mode (e.g., in the primary map application). In some embodiments, the transit mode(s) used for segments of or all of the predetermined navigation directions is or are defined by the first supplemental map, without the need for user input to indicate transit modes for those segments of and/or all of the predetermined navigation directions. Therefore, in some embodiments, different supplemental maps that are associated with different types of transit modes (e.g., hiking supplemental maps/points of interest vs. driving supplemental maps/points of interest) optionally cause display of different types of predetermined navigation directions in the primary map application (e.g., hiking directions vs. driving directions). Providing at least part of the navigation directions as driving directions reduces the number of inputs needed to display the driving directions, thereby improving interaction between the user and the electronic device.

In some embodiments, the predetermined navigation directions include hiking directions. For example, at least part or all of the predetermined navigation directions use hiking as the transit mode (e.g., in the primary map application). In some embodiments, the transit mode(s) used for segments of or all of the predetermined navigation directions is or are defined by the first supplemental map, without the need for user input to indicate transit modes for those segments of and/or all of the predetermined navigation directions. Therefore, in some embodiments, different supplemental maps that are associated with different types of transit modes (e.g., hiking supplemental maps/points of interest vs. driving supplemental maps/points of interest) optionally cause display of different types of predetermined navigation directions in the primary map application (e.g., hiking directions vs. driving directions). Providing at least part of the navigation directions as hiking directions reduces the number of inputs needed to display the hiking directions, thereby improving interaction between the user and the electronic device.

It should be understood that the particular order in which the operations in method 900 and/or FIG. 9 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 9 are, optionally, implemented by components depicted in FIGS. 1A-1B. For example, displaying operations 902a and 902c, and receiving operation 902b, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces for Supplemental Maps for Physical Spaces

Users interact with electronic devices in many different manners, including interacting with maps and maps applications for viewing information about various locations. In some embodiments, an electronic device displays information about a physical space that is of interest to a user. The embodiments described below provide ways in which an electronic device provides efficient user interfaces for displaying exploring such physical spaces, thus enhancing the user's interaction with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

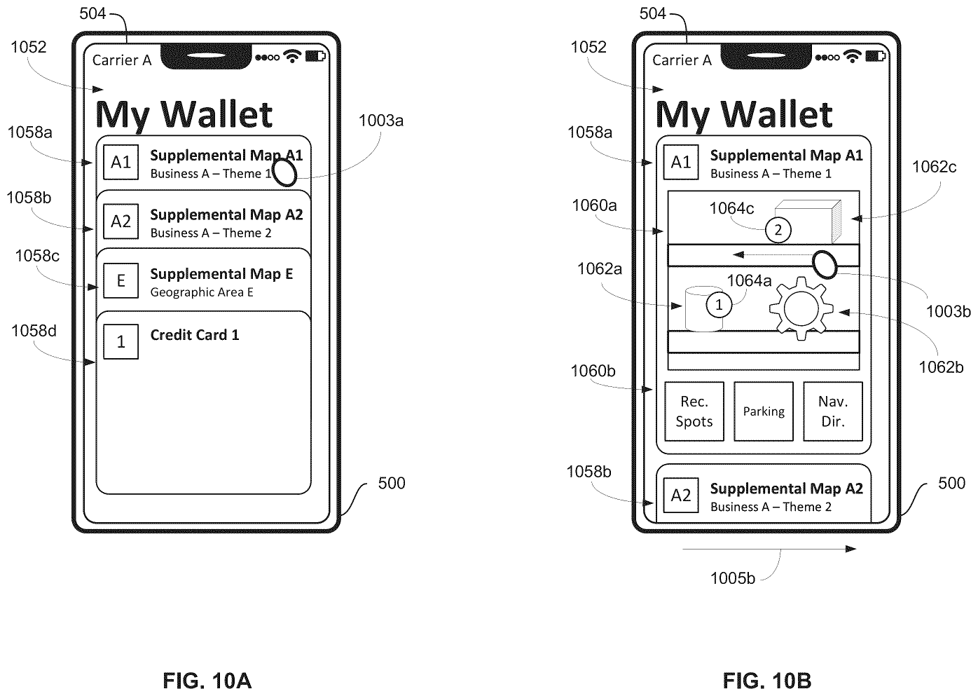

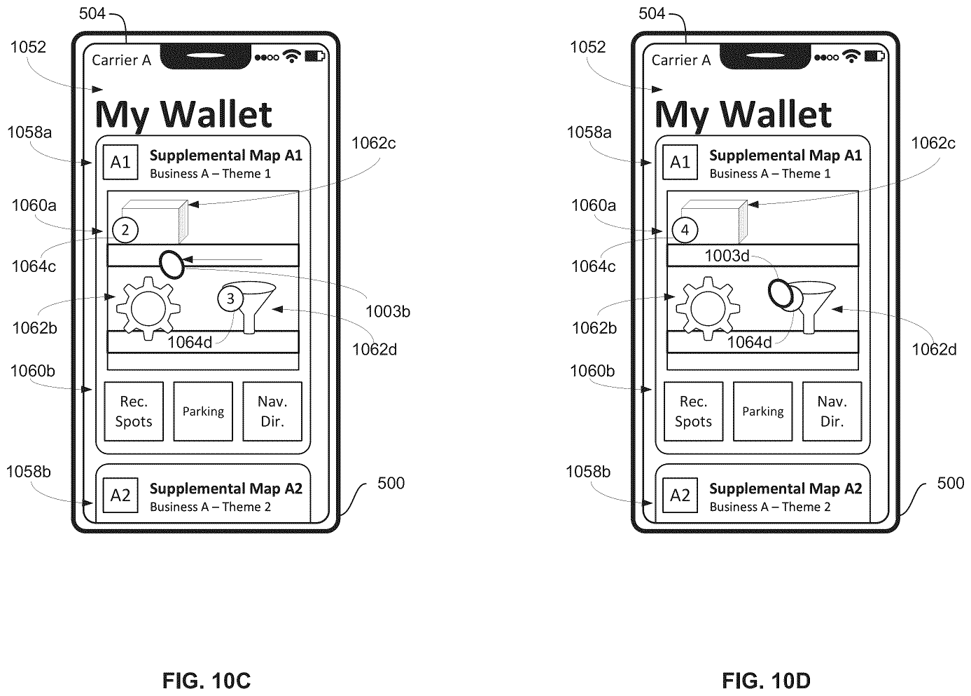

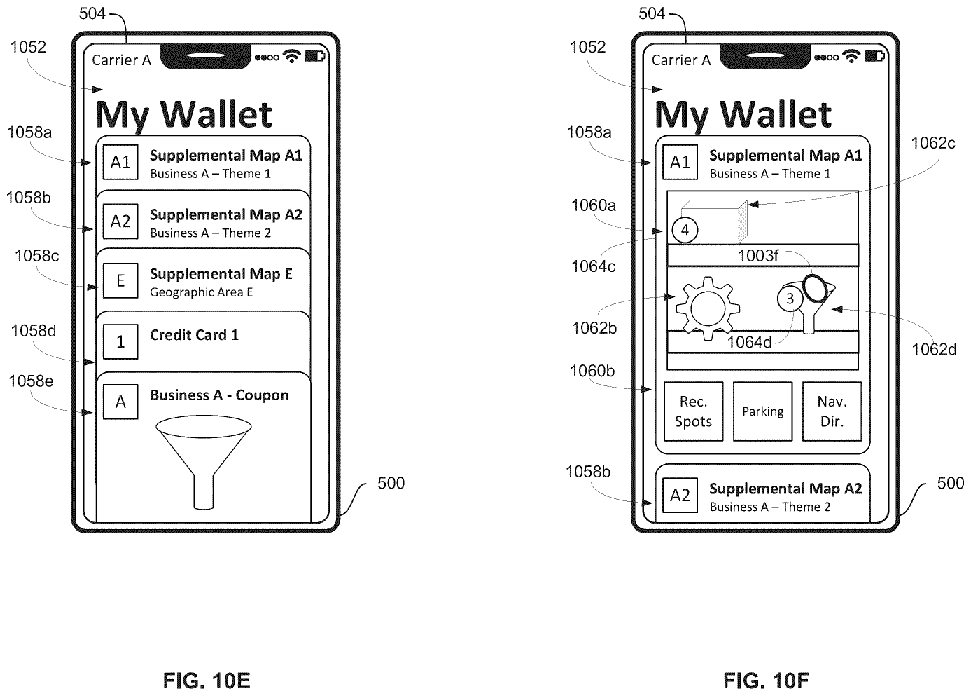

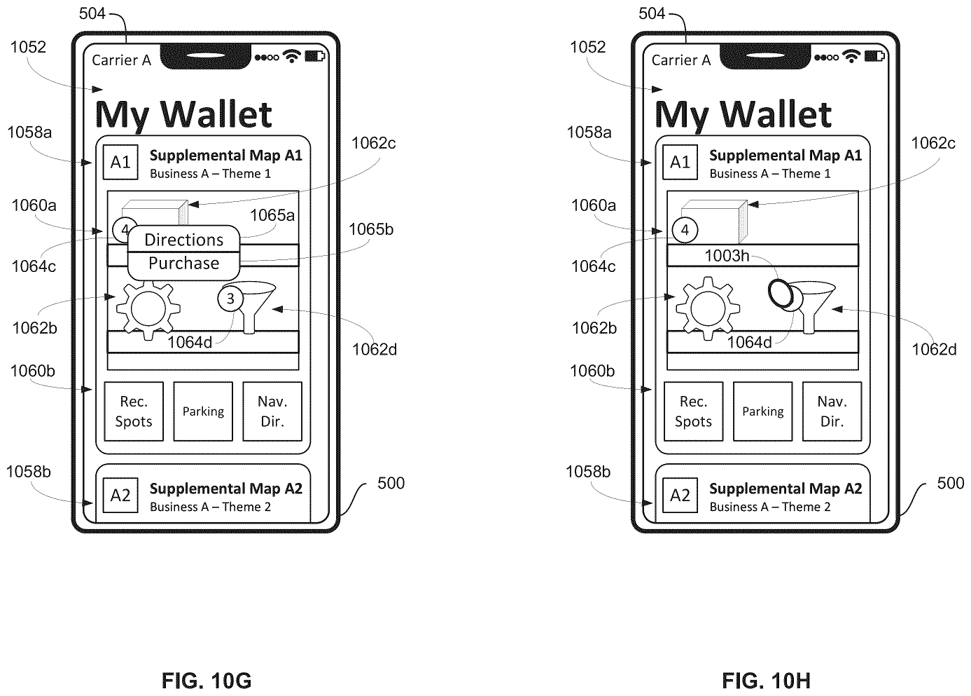

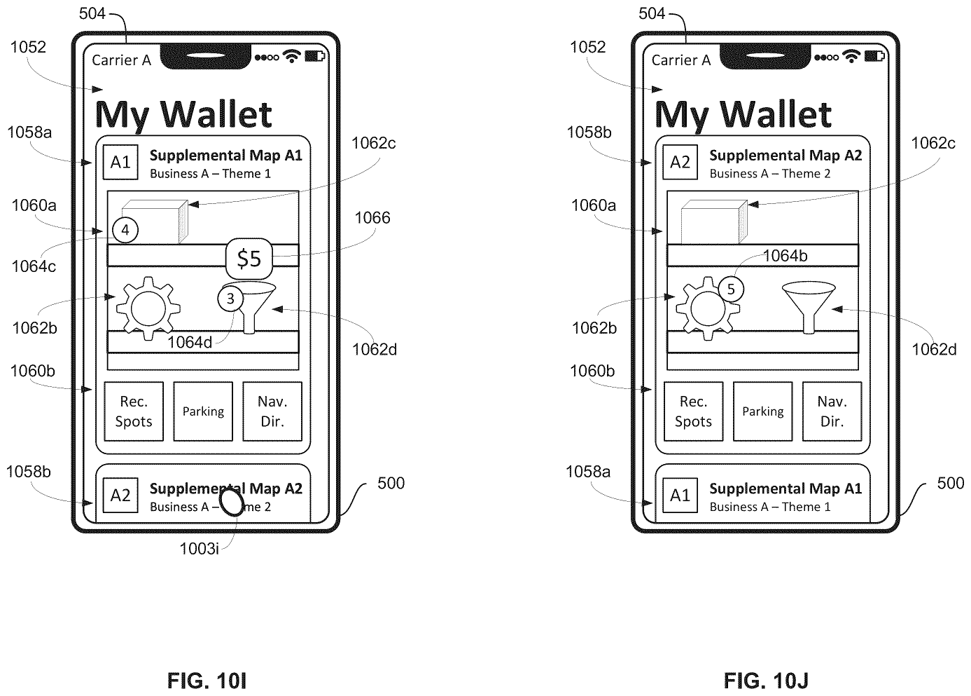

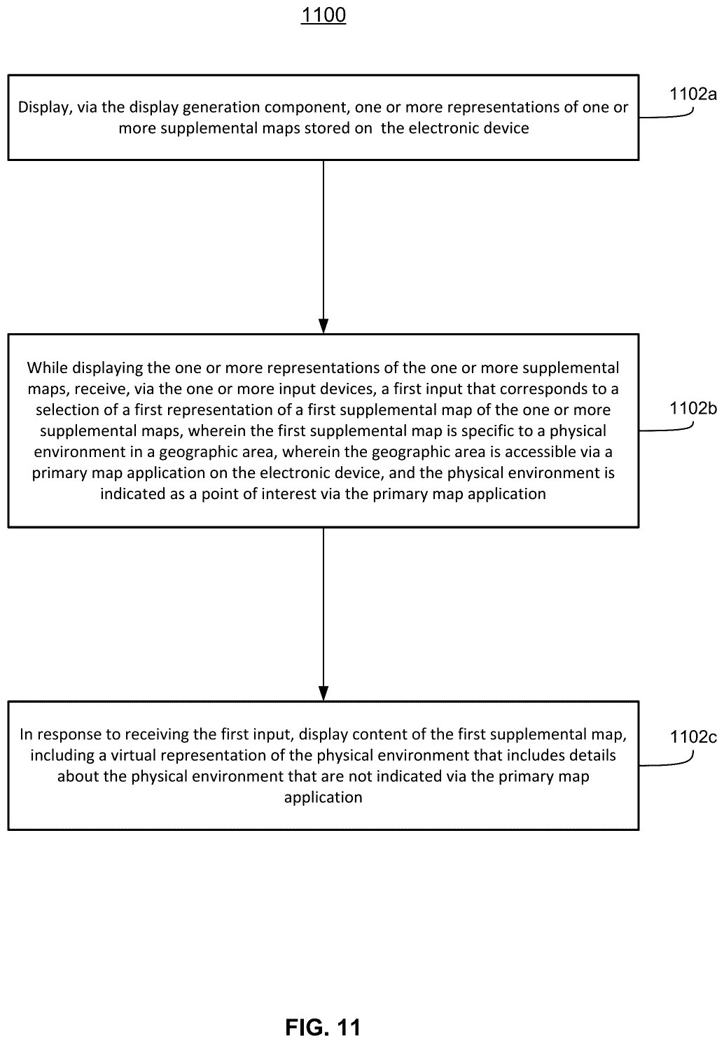

FIGS. 10A-10J illustrate exemplary ways in which an electronic device displays virtual views of a physical location or environment using supplemental maps. The embodiments in these figures are used to illustrate the processes described below, including the processes described with reference to FIG. 11. Although FIGS. 10A-10J illustrate various examples of ways an electronic device is able to perform the processes described below with respect to FIG. 11, it should be understood that these examples are not meant to be limiting, and the electronic device is able to perform one or more processes described below with reference to FIG. 11 in ways not expressly described with reference to FIGS. 10A-10J.

FIG. 10A illustrates an exemplary device 500 displaying user interface 1052, which is a user interface of a digital wallet application on device 500. In some embodiments, the user interface is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

User interface 1052 in FIG. 10A includes representations and/or descriptions of the supplemental maps that have been downloaded to device 500 and/or to which device 500 has access, such as representation 1058a for a supplemental map of Business A having a theme of Theme 1, representation 1058b for a supplemental map of the same Business A having a theme of Theme 2, and representation 1058c for a supplemental map of geographic region E. In some embodiments, representation 1058a is selectable to display Business A with corresponding supplemental map information in a primary map in the primary map application, such as shown with reference to FIGS. 6A-6H. Representation 1058b is optionally selectable to display Business A with corresponding supplemental map information in the primary map in the primary map application, and representation 1058c is optionally selectable to display geographic region E with corresponding supplemental map information in the primary map in the primary map application, such as shown with reference to FIGS. 6A-6H. User interface 1052 optionally additionally includes representations of one or more credit cards, loyalty cards, boarding passes, tickets and/or other elements that are stored in the digital wallet application, which are optionally selectable to perform corresponding transactions using the digital wallet application. For example, in FIG. 10A, user interface 1052 also includes representation 1058d of Credit Card 1, which is optionally selectable to view information about Credit Card 1 and/or initiate a transaction (e.g., a purchase transaction) using Credit Card 1.

In some embodiments, supplemental maps display their information separate from (e.g., outside of) a primary map application, depending on the configuration of the supplemental maps. For example, in FIG. 10A, device 500 detects selection of representation 1058a (e.g., via contact 1003a). In response, in FIG. 10B, device 500 expands and/or unobscures representation 1058a to display the content of supplemental map A in user interface 1052. In the example of FIG. 10B, supplemental map A1 is a supplemental map associated with providing a virtual or augmented reality view of Business A, which is optionally the entity associated with supplemental map A1. For example, representation 1058a includes, in addition to the name of the supplemental map (“Supplemental Map A1”) and an indication of the business or entity associated with the supplemental map and the theme of the supplemental map (“Business A-Theme 1”), a virtual view 1060a of the business and/or selectable options 1060b to perform one or more actions associated with Business A (e.g., defined by the supplemental map). For example, selectable options 1060b optionally include an option that is selectable to display information about locations around Business A that are recommended by Business A (e.g., landmarks, restaurants, bars, etc.), an option that is selectable to display parking information for visiting Business A, and an option that is selectable to initiate navigation directions to Business A (e.g., in the primary map application).

As mentioned previously, virtual view 1060a provides an augmented (e.g., if device 500 is located inside Business A) or virtual (e.g., if device 500 is not located inside Business A and/or is located away from Business A) reality view of the interior of Business A. For example, in FIG. 10B, virtual view 1060a is displaying store inventory inside of Business A on shelves. For ease of description, it is understood that the content described within virtual view 1060a in FIGS. 10B-10J is optionally fully virtual (e.g., the inventory and shelves are virtually displayed) or augmented reality (e.g., the inventory and shelves are live captured images of the inventory and shelves in the field of view of the one or more cameras of device 500, and device 500 augments display of such images with one or more virtual elements, as will be described).

For example, in FIG. 10B, virtual view 1060a includes inventory item 1062a, inventory item 1062b, and inventory item 1062c, which are optionally inventory items inside Business A. As mentioned previously, Supplemental Map A1 is themed with Theme 1 for Business A. Therefore, Supplemental Map A1 optionally highlights or otherwise emphasizes only certain kinds of inventory of Business A (e.g., clothes, if Theme 1 is clothing) over other kinds of inventory of Business A (e.g., sporting goods). For example, in FIG. 10B, virtual view 1060a includes virtual tag 1064a displayed in association with inventory item 1062a, and virtual tag 1064c displayed in association with inventory item 1062c, but does not include a virtual tag displayed in association with inventory item 1062b. This is optionally because inventory items 1062a and 1062c are related to Theme 1 (e.g., clothing), and inventory item 1062b is not. As will be described later, inventory items 1062 and/or virtual tags 1064 are optionally interactable to perform one or more actions with respect to those items.

In some embodiments, virtual view 1060a can be updated to display other portions of Business A and/or other inventory items in Business A. For example, from FIG. 10B to FIG. 10C, device 500 detects a leftward swipe of contact 1003b in virtual view (e.g., in the case that virtual view 1060a is fully virtual) or detects device 500 move rightward in space (e.g., represented by arrow 1005b, in the case that virtual view 1060a is an augmented reality view of the inside of Business A). In response, in FIG. 10C, virtual view 1060a has been updated to display the inventory and/or shelfs to the right of what was displayed in FIG. 10B. For example, virtual view now includes inventory item 1062d, which is displayed in association with virtual tag 1064d, optionally because inventory item 1062d is related to Theme 1.

In some embodiments, virtual tags 1064 optionally correspond to incentives, coupons, prices, etc. for the items with which they are displayed. Therefore, in some embodiments, device 500 dynamically updates the virtual tags 1064 as information is received from Business A indicating that changes to the virtual tags 1064 are warranted. For example, in FIG. 10C, virtual tag 1064c for inventory item 1062c represents a first incentive, coupon, price, etc. for inventory item 1062c. In FIG. 10D, device 500 has dynamically updated virtual tag 1064c for inventory item 1062c to represent a second, different incentive, coupon, price, etc. for inventory item 1062c.

As mentioned previously, in some embodiments, virtual tags 1064 are interactable to perform certain actions. For example, in FIG. 10D, device 500 detects selection of virtual tag 1064d for inventory item 1062d. In response, in FIG. 10E, device 500 has added the coupon and/or incentive associated with virtual tag 1064d to the digital wallet application on device 500. In particular, user interface 1052 has been updated to include representation 1058e corresponding to the coupon from Business A for inventory item 1062d. In some embodiments, representation 1058e is selectable to utilize the incentive or coupon in a transaction to purchase inventory item 1062d.

In some embodiments, inventory items 1062 themselves are interactable in virtual view 1060a. For example, in FIG. 10F, device 500 detects selection of inventory item 1062d (e.g., via a touch and hold of contact 1003f). In response, in FIG. 10G, device 500 displays one or more selectable options 1065 that are selectable to perform operations associated with inventory item 1062d. For example, selectable option 1065a is optionally selectable to initiate directions to inventory item 1062d inside Business A (e.g., via virtual or augmented reality directions displayed in virtual view 1060a), and selectable option 1065b is optionally selectable to initiate a process to purchase inventory item 1062d from Business A (e.g., using the digital wallet of device 500).

In some embodiments, virtual tags 1064 are selectable to display price information for corresponding inventory items. For example, in FIG. 10H, device 500 detects selection of virtual tag 1064d for inventory item 1062d. In response, in FIG. 10I, device 500 updates virtual view 1060a to display price information 1066 for inventory item 1062d, optionally at a location in virtual view 1060a corresponding to the location of inventory item 1062d.

As mentioned previously, in some embodiments, the same entity is associated with multiple supplemental maps, optionally having different themes. For example, in FIG. 10J, device 500 is displaying the content of Supplemental Map A2 in representation 1058b in user interface 1052. Supplemental Map A2 is optionally a second supplement map associated with Business A, but instead of being themed Theme 1 (e.g., relating to clothing), is themed Theme 2 (e.g., relating to sporting goods). Representation 1058b optionally includes the same or different content as representation 1058a described earlier, except that virtual view 1060a optionally emphasizes inventory items related to Theme 2 inside of Business A rather than inventory items related to Theme 1. For example, in FIG. 10J, virtual view 1060a includes the same view of the inside of Business A as in FIG. 10F; however, instead of displaying virtual tags for inventory items 1062c and 1062d, which are related to Theme 1, device 500 in FIG. 10J is displaying virtual tag 1064b for inventory item 1062b, which is related to Theme 2. Functionality of virtual tag 1064b is optionally similar to or the same as the functionalities described with reference to other virtual tags 1064 described previously.

FIG. 11 is a flow diagram illustrating a method 1100 for displaying virtual views of a physical location or environment using supplemental maps. The method 1100 is optionally performed at an electronic device such as device 100, device 300, device 500 as described above with reference to FIGS. 1A-1B, 2-3, 4A-4B and 5A-5H. Some operations in method 1100 are, optionally combined and/or the order of some operations is, optionally, changed.

As described below, the method 1100 provides ways in which an electronic device displays virtual views of a physical location or environment using supplemental maps. The method reduces the cognitive burden on a user when interacting with a user interface of the device of the disclosure, thereby creating a more efficient human-machine interface. For battery-operated electronic devices, increasing the efficiency of the user's interaction with the user interface conserves power and increases the time between battery charges.

In some embodiments, method 1100 is performed at an electronic device in communication with a display generation component and one or more input devices. In some embodiments, the electronic device has one or more of the characteristics of the electronic device of methods 700 and/or 900. In some embodiments, the display generation component has one or more of the characteristics of the display generation component of methods 700 and/or 900. In some embodiments, the one or more input devices have one or more of the characteristics of the one or more input devices of methods 700 and/or 900. In some embodiments, method 1100 is performed at or by an automobile (e.g., at an infotainment system of an automobile having or in communication with one or more display generation components and/or input devices).

In some embodiments, the electronic device displays (1102a), via the display generation component, one or more representations of one or more supplemental maps stored on (and/or accessible to) the electronic device, such as in FIG. 10A. In some embodiments, the supplemental maps have one or more of the characteristics of the supplemental maps described with reference to methods 700 and/or 900. In some embodiments, the one or more representations are displayed in one or more of the ways described with reference to methods 700 and/or 900. In some embodiments, the one or more representations are displayed in one or more of the ways described herein with reference to method 1100.

In some embodiments, while displaying the one or more representations of the one or more supplemental maps, the electronic device receives (1102b), via the one or more input devices, a first input that corresponds to a selection of a first representation of a first supplemental map of the one or more supplemental maps (e.g., such as described with reference to method 900), such as in FIG. 10A, wherein the first supplemental map is specific to a physical environment in a geographic area, wherein the geographic area is accessible via a primary map application on the electronic device (e.g., accessible in a primary map application as described with reference to methods 700 and/or 900, and the geographic area optionally has one or more of the characteristics of the geographic areas or regions described with reference to methods 700 and/or 900), and the physical environment is indicated as a point of interest via the primary map application. In some embodiments, the physical environment is a physical location or a business in the geographic area. In some embodiments, the business is a restaurant or a store. In some embodiments, the physical environment is a park or a landmark. In some embodiments, the physical environment is accessible in the real world by a user of the electronic device, but is not displayed and/or navigable in a primary map (e.g., as described with reference to methods 700 and/or 900) in the primary map application. In some embodiments, the primary map displays a representation of the physical environment on the primary map at the location of the physical environment on the primary map, such as a pin, an icon, a graphic and/or a photo of the physical environment. In some embodiments, user input directed to the representation of the physical environment on the primary map (e.g., a selection input) causes the electronic device to display further information about the physical environment, such as operating hours, the distance from the current location of the electronic device to the physical environment, a link to a website for the physical environment, and/or user reviews for the physical environment.

In some embodiments, in response to receiving the first input, the electronic device displays (1102c) content of the first supplemental map, including a virtual representation of the physical environment that includes details about the physical environment that are not indicated via the primary map application, such as in FIG. 10B. In some embodiments, the content includes a virtual and/or augmented reality representation and/or experience of the physical environment. For instance, if the physical environment is a grocery store, the content optionally includes a virtual representation of the products on the shelves along with prices and/or sales displayed in association with the products. Furthermore, if the physical environment is a surf shop, the content optionally includes a virtual representation of the surf boards and products available for purchase, along with the current prices and/or sales displayed in association with the products. In some embodiments, the details about the physical environment displayed in the virtual representation of the physical environment, and/or the virtual representation of the physical environment itself, is not displayed or accessible in the primary map of the geographic area including the physical environment. In some embodiments, the content of the first supplemental map is displayed in a user interface of the primary map application, or in a user interface that is not a user interface of the primary map application, as described with reference to methods 700 and/or 900. Displaying a supplemental map experience specific to a physical environment allows for users to view details about such physical environments without being present in person at those physical environments.

In some embodiments, while displaying the content of the first supplemental map, the electronic device receives, via the one or more input devices, a second input directed to the content. For example, an input scrolling through the content, an input selecting a button in the content, an input zooming into and/or out of the content, or any other input described with reference to methods 700, 900 and/or 1100.

In some embodiments, in response to receiving the second input, the electronic device performs one or more operations in accordance with the second input and related to the content (e.g., scrolling through the content, performing an operation in response to selection of a button, or zooming into or out of the content). Thus, in some embodiments, the content of the supplemental map is interactive, optionally as defined by the creator, originator and/or distributor of the supplemental map (e.g., the business, entity or establishment associated with the supplemental map). The content of the supplemental map is optionally interactive to cause display of additional content of the supplemental map. Providing interactive content of a supplemental map provides flexibility in interaction with the supplemental map, as well as the ability to facilitate the one or more operations associated with the supplemental map and/or entity associated with the supplemental map.

In some embodiments, the content of the first supplemental map includes a virtual view of the physical environment. For example, at least some content in the supplemental map includes virtual content associated with the physical environment, such as virtual views of an interior of exterior of the business or entity or building associated with the supplemental map. For example, if the entity is a grocery store, the supplemental map optionally includes a virtual view of the interior of the grocery store, including a view of the aisles and/or shelves and/or the inventory on those shelves inside the grocery store. Virtual content optionally corresponds to content that is computer-generated as optionally corresponding to actual physical views or aspects of the entity. Providing a virtual view of the physical environment facilitates conveying relevant information about the physical environment while reducing the number of inputs needed to convey such information.

In some embodiments, while displaying the virtual view of the physical environment, the electronic device receives, via the one or more input devices, a second input corresponding to a request to initiate a real-world tour of the physical environment. For example, selection of a button to initiate a real-world tour of the physical environment, or a voice input requesting a real-world tour of the physical environment.

In some embodiments, in response to receiving the second input, the electronic device initiates the real-world tour of the physical environment, including using the virtual view to guide the real-world tour. In some embodiments, the virtual view displays directions to follow and/or waypoint locations or information in the virtual view for the user to follow in the real-world. In some embodiments, the virtual view is updated in real-time to indicate the progress of the user, in the virtual view, through the tour and/or physical environment. In some embodiments, the virtual view represents virtually what is/would be visible within the physical environment at the current location of the electronic device along the tour. In some embodiments, the virtual view includes augmented reality content for guiding the user on a tour through the physical environment, such as a real-time image of the physical environment captured by one or more cameras of the electronic device, optionally overlaid with directional information (e.g., arrows, path markers, or the like) directing the user through the real-world tour. In some embodiments, the electronic device is (and/or must be) physically located at the physical environment as part of displaying and/or progressing through the real-world tour, and/or is (and/or must be) physically moving in its physical space as part of displaying and/or progressing through the real-world tour. Using the virtual view of the physical environment to guide a real-world tour of the physical environment facilitates exploration of the physical environment while reducing the need for inputs at the electronic device to find information about the physical environment.

In some embodiments, while displaying the virtual view of the physical environment, the electronic device receives, via the one or more input devices, a second input corresponding to a request to initiate a virtual tour of the physical environment. For example, selection of a button to initiate a virtual tour of the physical environment, or a voice input requesting a virtual tour of the physical environment.

In some embodiments, in response to receiving the second input, the electronic device initiates the virtual tour of the physical environment, including using the virtual view to provide the virtual tour. In some embodiments, the virtual view displays progress through the physical environment, virtually, as the virtual tour progresses. In some embodiments, the electronic device receives input from the user to make progress in the virtual tour (e.g., an input to move to the next waypoint in the tour, an input to update display of the virtual view to correspond to a different location in the physical environment, or the like. In some embodiments, the virtual view represents virtually what is/would be visible within the physical environment at the current location in the virtual tour. In some embodiments, the virtual view includes augmented reality content corresponding to the tour through the physical environment, such previously captured images of the physical environment, optionally overlaid with directional information (e.g., arrows, path markers, or the like) directing the user through the virtual tour. In some embodiments, the virtual tour includes virtual reality content (e.g., virtual representations of the above-mentioned physical environment) through which the virtual tour progresses. In some embodiments, the electronic device need not be (and/or is not) physically located at the physical environment as part of displaying and/or progressing through the virtual tour, and/or need not (and/or is not) physically moving in its physical space as part of displaying and/or progressing through the virtual tour. Using the virtual view of the physical environment to guide a virtual tour of the physical environment facilitates exploration of the physical environment while reducing the need for inputs at the electronic device to find information about the physical environment.

In some embodiments, while displaying the virtual view of the physical environment, wherein the virtual view of the physical environment represents a first location in the physical environment (e.g., such as the view down a first aisle in a supermarket, or the view from a particular location in a building lobby, such as described with reference to the subject matter described in method 1100 corresponding to the features of claims 69-70), the electronic device receives, via the one or more input devices, a second input corresponding to a request to update the virtual view to corresponding to a second location in the physical environment. For example, selection of a button to move through the virtual view of the physical environment in a particular direction (e.g., an input to move to the right or to the left), or a voice input requesting movement through the virtual view of the physical environment in a particular direction.

In some embodiments, in response to receiving the second input, the electronic device updates the virtual view of the physical environment to represent the second location in the physical environment (e.g., updating the virtual view of the physical environment to display a location further down the first aisle in the supermarket (e.g., corresponding to an input to move forward through the virtual view by 5 meters), or the view from outside of the building (e.g., corresponding to an input to move outside of the lobby doors by 10 meters). In some embodiments, the electronic device need not be (and/or is not) physically located at the physical environment as part of updating the display of the virtual view of the physical environment, and/or need not (and/or is not) physically moving in its physical space as part of updating the display of the virtual view of the physical environment. Allowing for manual navigation through the virtual view of the physical environment facilitates exploration of the physical environment while avoiding the computing power or time needed to display undesired virtual views of the physical environment.

In some embodiments, the virtual view includes one or more representations of one or more physical objects in the physical environment and one or more virtual objects displayed in association with the one or more physical objects. For example, the virtual view optionally includes augmented (e.g., digital or passive passthrough of the actual physical environment via the display generation component) reality and/or virtual reality representations of store inventory on augmented (e.g., digital or passive passthrough of the actual physical environment via the display generation component) reality and/or virtual reality representations of store shelves. Other examples optionally include augmented reality and/or virtual reality representations of pieces of art in a museum. In some embodiments, the representations of the physical objects are optionally displayed in association with one or more corresponding virtual objects (e.g., the one or more virtual objects optionally overlay the one or more physical objects), as will be described in more detail later. Displaying physical objects in association with corresponding virtual objects clearly conveys the relationship between the virtual objects and the physical objects, thereby reducing errors in interaction with the physical and/or virtual objects and reducing inputs needed to identify such relationship.

In some embodiments, the one or more physical objects are physical items for sale in the physical environment (e.g., the physical environment is the inside of a store, and the physical objects are items for sale in that store), and the one or more virtual objects are virtual tags displayed in association with the one or more physical objects (e.g., sale tags on actual items in the store that are selectable to display sale prices for the items, and/or coupons for items on actual items in the store that are selectable to add those coupons to an electronic wallet application on the electronic device).

In some embodiments, while displaying the virtual view, the electronic device receives, via the one or more input devices, a second input corresponding to selection of a first virtual tag displayed in association with a first physical object. In some embodiments, the second input has one or more of the characteristics of the selection input described with reference to the subject matter described in method 1100 corresponding to the features of claim 66.

In some embodiments, in response to receiving the second input, the electronic device performs a first operation associated with the first physical object (e.g., as will be described below). Providing for operations related to physical objects to be performed via the virtual view of the physical environment reduces the number of inputs needed to otherwise perform such operations and also reduces errors in initiating incorrect operations for incorrect objects.

In some embodiments, performing the first operation corresponds to an incentive related to a transaction associated with first physical object. For example, the first operation is optionally related to a coupon to be used in a future transaction for purchasing the first physical object. In some embodiments, the first operation is related to accounting for and/or activating rewards to be earned in a loyalty account with the business for a future transaction for purchasing the first physical object. Facilitating operations related to incentives for transactions for physical objects via the virtual view of the physical environment reduces the number of inputs needed to otherwise perform such operations and also reduces errors in initiating incorrect operations for incorrect objects.

In some embodiments, at a first time, the incentive related to the transaction associated with the first physical object is a first incentive (e.g., a 50% off offer for the object), and at a second time, different from the first time (e.g., the next day, the next week, the next month, and/or a second time corresponding to a changed loyalty or rewards status of the user with the loyalty program), the incentive related to the transaction associated with the first physical object is a second incentive, different from the first incentive (e.g., a buy two, get one free incentive for the object). Allowing for dynamic incentives to be accessed through the virtual view of the physical environment ensures that the incentives are current and avoids erroneous inputs directed to incentives that are no longer active.

In some embodiments, the operation includes adding the incentive to an electronic wallet associated with the electronic device. In some embodiments, the electronic wallet has one or more of the characteristics of the electronic wallet described with reference to method 700. In some embodiments, an electronic wallet is a financial or other transaction application that runs on devices (e.g., the electronic device). The electronic wallet optionally securely stores payment information and/or passwords for the user. The electronic wallet optionally allows the user to pay with the electronic wallet when shopping using the electronic device. In some embodiments, credit card, debit card, and/or bank account information can be stored in the electronic wallet, and can be used to pay for transactions such as purchases. The electronic wallet optionally stores or provides access to one or more of the following: Gift cards, Membership cards, Loyalty cards, Coupons (e.g., the incentive), Event Tickets, Plane and transit tickets, Hotel reservations, Driver's licenses, Identification cards, or Car keys. Adding incentives for physical objects to an electronic wallet from the virtual view of the physical environment reduces the number of inputs needed to add incentives to the electronic wallet and avoids erroneous inputs directed to adding erroneous incentives to the electronic wallet.

In some embodiments, while displaying the virtual view of the physical environment, the electronic device receives, via the one or more input devices, a second input corresponding to a request to initiate directions to a physical object in the physical environment. For example, selection of a button to initiate directions to the physical object in the physical environment, or a voice input requesting the navigation directions to the physical object in the physical environment.

In some embodiments, in response to receiving the second input, the electronic device initiates the directions to the physical object in the physical environment, including using the virtual view to provide the directions to the physical object. For example, displaying information in the virtual view for guiding the user from their current location and/or the current location of the electronic device to the location of the physical object in the physical environment. In some embodiments, the information is displayed in one or more of the manners, or in one or more analogous manners, as described with reference to the subject matter described in method 1100 corresponding to the features of claims 69-71, except that the navigation directions lead to the physical object in the physical environment. For example, the user optionally navigates the virtual view of the physical environment virtually to locate, virtually, a physical object (e.g., an item for sale) in the physical environment, and in response to the second input, the electronic device provides virtual and/or augmented reality navigation directions, via the virtual view of the physical environment, from the current location of the user and/or the current location of the electronic device to the location of the physical object in the physical environment. Providing navigation directions to a particular object in the physical environment via the virtual view reduces the number of inputs needed to display guiding or other location-related information related to the particular object.

In some embodiments, the first supplemental map includes a predefined content (e.g., music, audio and/or video) playlist. In some embodiments, one or more graphical components of the playlist are displayed in the content of the first supplemental map. In some embodiments, one or more audio components of the playlist are generated by the electronic device while the supplemental map is displayed. In some embodiments, the content of the first supplemental map includes a selectable option that is selectable to cause playback of the content playlist. In some embodiments, the content playlist is created and/or defined by the creator of the first supplemental map. Providing a content playlist in the supplemental map reduces the number of inputs needed to access such content while displaying the supplemental map.

In some embodiments, the content of the first supplemental map includes a selectable option that is selectable to initiate navigation directions to the physical environment from within the primary map application. In some embodiments, the navigation directions are from a current location of the electronic device to the physical environment (e.g., the business) and/or a location defined by the business (e.g., a nearby parking lot, a park where the business is holding an event, or a related business with which the business is in a referral relationship). In some embodiments, the user does not provide the ending location for the navigation directions—the ending location is optionally defined by the supplemental map. Providing a selectable option in the supplemental map for navigation directions reduces the number of inputs needed to access such navigation directions.

In some embodiments, the content of the first supplemental map includes information related to parking surrounding the physical environment (e.g., information about locations of parking lots for accessing the business and/or selectable options for initiating navigation directions to the locations of the parking lots in the primary map application). Providing parking information in the supplemental map reduces the number of inputs needed to access such parking information.

In some embodiments, the content of the first supplemental map includes information related to one or more businesses (e.g., suggested businesses or entities or establishments other than the entity associated with the first supplemental map), activities (e.g., suggested activities such as hiking, biking, or walking tours around or on the way to the business), suggested locations (e.g., suggested locations such as landmarks, scenic points, or rest areas around or on the way to the business), or restaurants surrounding the physical environment (e.g., suggested restaurants, grocery stores, or other food sources around or on the way to the business). Providing such information in the supplemental map reduces the number of inputs needed to access such information.

In some embodiments, the physical environment is concurrently associated with a second supplemental map that is different from the first supplemental map. For example, a given business, entity or establishment is optionally able to create multiple different supplemental maps for their business, entity or establishment. The different supplemental maps optionally include different content as defined by the business, entity or establishment. The different supplemental maps are optionally separately downloaded and/or accessed via the electronic device. In some embodiments, the different supplemental maps are downloaded and/or accessed together (e.g., as a pair or collection of supplemental maps) via the electronic device. In some embodiments, the different supplemental maps correspond to different themes or types of activities or inventory. For example, a store that sells both surfboards and clothing optionally creates a first supplemental map with content related to surfboards in their store, and a second, different, supplemental map with content related to clothes in their store. Allowing for multiple different supplemental maps for the same physical environment allows each supplemental map to use space efficiently for their own purposes, thereby reducing the number of inputs needed for the user to navigate through a given supplemental map to access the desired information.

In some embodiments, the content of the first supplemental map includes one or more types of content (e.g., photos, videos, information about parking, and/or selectable options for navigation directions) that are not included in content of a second supplemental map that is associated with a second physical environment in a second geographic area (e.g., a supplemental map for a different business or entity). Thus, in some embodiments, different supplemental maps for different businesses include different types of content, where one supplemental map optionally includes a selectable option for directions to the business for example, and a different supplemental map for a different business does not include a selectable option for directions to the business but optionally includes information about parking for the different business (which the first supplemental map optionally does not include for the first business). Allowing for different supplemental maps to have different types of content allows each supplemental map to use space efficiently for their own purposes, thereby reducing the number of inputs needed for the user to navigate through a given supplemental map to access the desired information.

In some embodiments, at a first time, the content of the first supplemental map incudes first content, and at a second time, different from the first time, the content of the first supplemental map includes second content but not the first content. Thus, in some embodiments, the content of the supplemental map changes over time. In some embodiments, the electronic device automatically requests and/or receives updates for the content of the supplemental map (e.g., from a server) without the need for user input to do so. In some embodiments, the supplemental map is updated in response to user input for updating the supplemental map. Providing for updates of supplemental maps ensures that supplemental maps include the most recent or correction information, and reduce unnecessary interactions with inaccurate information that may be included in the supplemental map.

In some embodiments, while displaying the content of the first supplemental map, the electronic device receives, via the one or more input devices, a second input corresponding to a request to initiate a transaction with the physical environment. For example, an input to purchase an item in a store from the supplemental map, an input to join a rewards program with the business associated with the supplemental map, or an input to contact (e.g., via email or phone) the business associated with the supplemental map.

In some embodiments, in response to receiving the second input, the electronic device initiates the transaction with the physical environment. In some embodiments, a purchase of an item can be performed from the supplemental map, including payment for the item. In some embodiments, joining a rewards program with the business associated with the supplemental map can be performed from the supplemental map. In some embodiments, contacting the business associated with the supplemental map can be performed from the supplemental map. Facilitating transactions with the entity associated with the supplemental map from the supplemental map reduces the number of inputs needed to perform such transactions.

In some embodiments, before (and/or while not) displaying the content of the first supplemental map (e.g., while displaying any user interface of the electronic device, such as a home screen user interface, a wake screen user interface, a user interface of a primary map application, or a user interface of a game application other than the primary map application), in accordance with a determination that a location of the electronic device corresponds to the physical environment (e.g., the electronic device is within the first geographic area, or is within a threshold distance such as 0.1, 0.5, 1, 5, 10, 100, 1000, 10000 or 100000 meters of the first geographic area), the electronic device displays, via the display generation component, a first selectable option that is selectable to initiate a process to display, via the display generation component, the content of the first supplemental map. For example, the electronic device optionally downloads and/or displays the first supplemental map in response to detecting selection of the first selectable option. In some embodiments, the displaying the first selectable option based on distance from the physical environment has one or more of the characteristics of such display described with reference to method 900. Providing access to the supplemental map via a location-based selectable option reduces the number of inputs needed to access the supplemental map, and reduces errors in selecting the correct supplemental map, thereby improving interaction between the user and the electronic device.

In some embodiments, before (and/or while not) displaying the content of the first supplemental map (e.g., while displaying a user interface of a camera application on the electronic device that facilitates capturing video and/or photos of content captured by one or more cameras of the electronic device), the electronic device captures, via one or more cameras of the electronic device, an image of a graphical element that is associated with the first supplemental map (e.g., a barcode, a QR code, an image, or any other graphical element that is associated with the first supplemental map). In some embodiments, in response to capturing the image of the graphical element, the electronic device initiates a process to display, via the display generation component, the content of the first supplemental map. For example, the electronic device optionally downloads and/or displays the first supplemental map in response to capturing an image of the graphical element, optionally further in response to receiving further user input confirming that the electronic device should download and/or display the first supplemental map. Providing access to the supplemental map via capturing an image of a graphical element reduces the number of inputs needed to access the supplemental map, and reduces errors in selecting the correct supplemental map, thereby improving interaction between the user and the electronic device.

In some embodiments, before (and/or while not) displaying the content of the first supplemental map, and while displaying, via the display generation component, a user interface of the primary map application (e.g., displaying a details user interface for the business associated with the first supplemental map in response to detecting selection of an icon on the map in the primary map application corresponding to the business, where the user interface of the primary map application is not the content of the first supplemental map), wherein the user interface of the primary map application includes information about the physical environment (e.g., hours or operation, reviews, a selectable option that is selectable to display a website of the physical environment and/or a selectable option that is selectable to make a reservation at the physical environment) and includes a first selectable option, the electronic device receives, via the one or more input devices, a second input corresponding to selection of the first selectable option.

In some embodiments, in response to receiving the second input, the electronic device initiates a process to display, via the display generation component, the content of the first supplemental map (optionally outside of the primary map application) (e.g., having one or more of the characteristics of the processes described with reference to the subject matter described in method 1100 corresponding to the features of claims 86-87). Providing access to the supplemental map via the primary map application reduces the number of inputs needed to access the supplemental map, and reduces errors in selecting the correct supplemental map, thereby improving interaction between the user and the electronic device.

In some embodiments, the one or more representations of the one or more supplemental maps are displayed in a user interface of a repository of supplemental maps that are accessible to the electronic device (e.g., such as described with reference to method 700). providing access to the supplemental map from a supplemental map repository facilitates organization of supplemental maps, thereby improving the interaction between the user and the electronic device.

It should be understood that the particular order in which the operations in method 1100 and/or FIG. 11 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 11 are, optionally, implemented by components depicted in FIGS. 1A-1B. For example, displaying operations 1102a and 1102c, and receiving operation 1102b, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces for Displaying Media Content in a Map Application

Users interact with electronic devices in many different manners. In some embodiments, an electronic device presents a geographic area in a map within a map user interface of a map application. In some embodiments, while presenting the geographic area, the electronic device detects that the geographic area is associated with media content. The embodiments described below provide ways in which an electronic device presents media content related to the geographic area within a same user interface as the map user interface. Presenting both map-related information and media content at the same time, without having to navigate away from the map application reduces the need for subsequent inputs to display related media content, thus enhancing the user's interaction with the device. Enhancing interactions with a device reduces the amount of time needed by a user to perform operations, and thus reduces the power usage of the device and increases battery life for battery-powered devices. Presenting media content in the map application and providing the ability to interact with the media content to cause the user interface to display information about the media content provides quick and efficient access to related media content without the need for additional inputs for searching for related media content and avoids erroneous inputs related to searching for such media content. It is understood that people use devices. When a person uses a device, that person is optionally referred to as a user of the device.

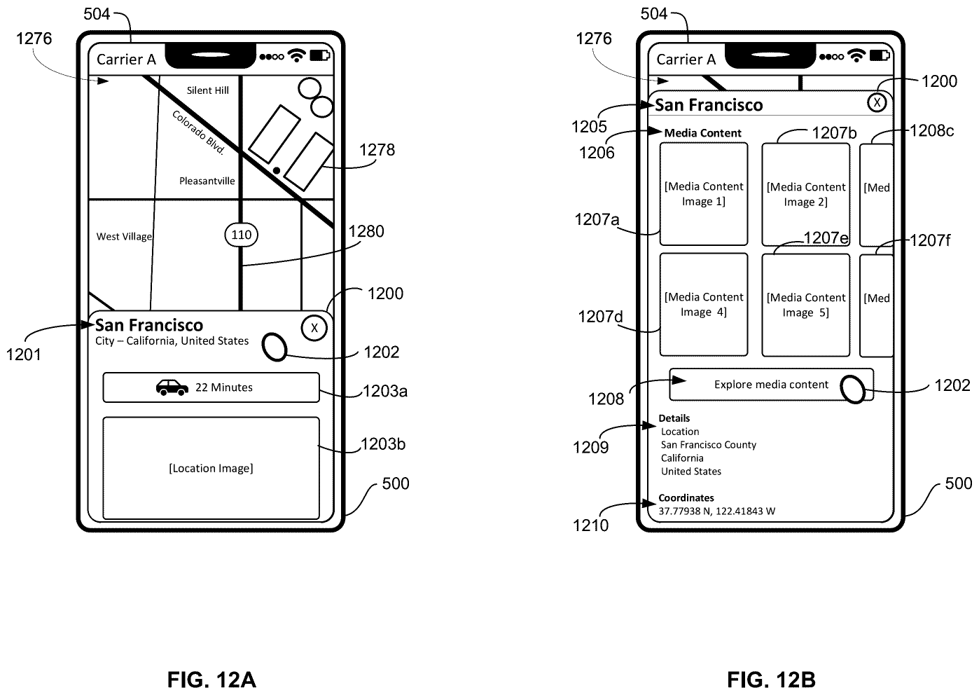

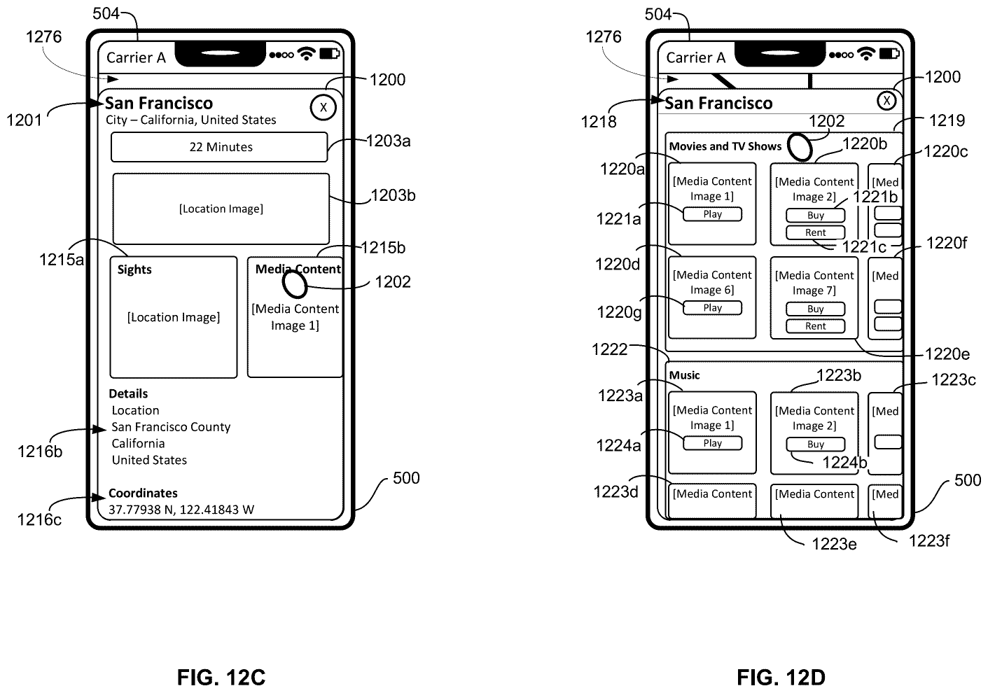

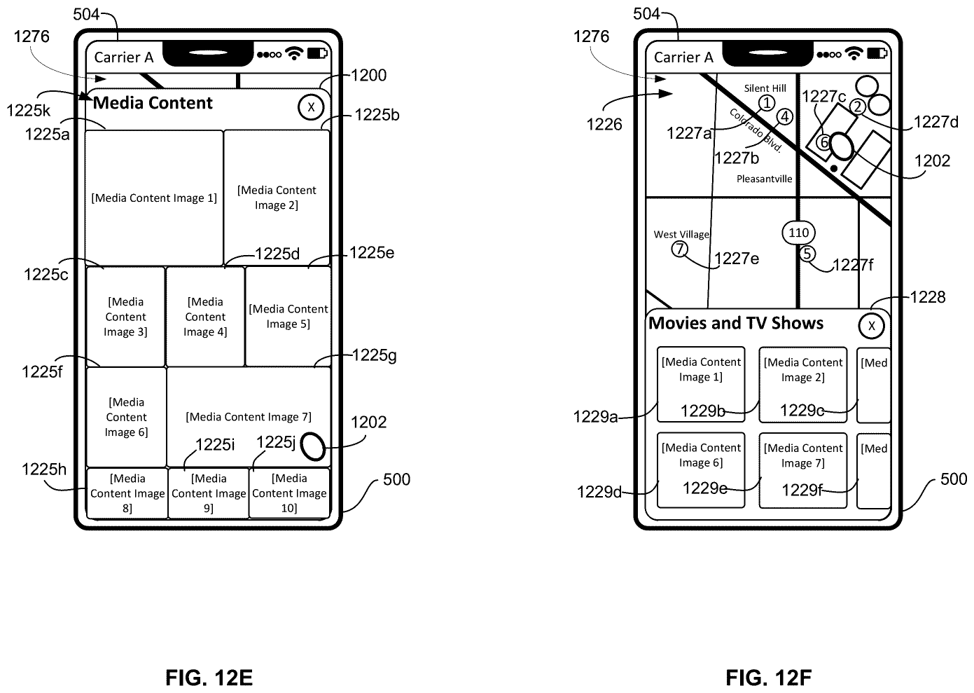

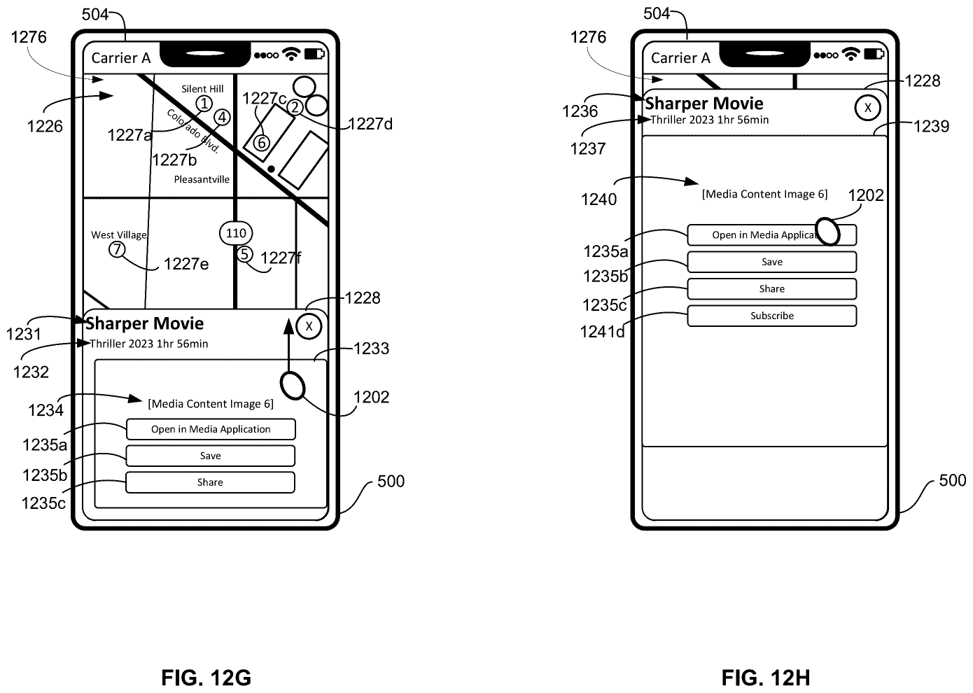

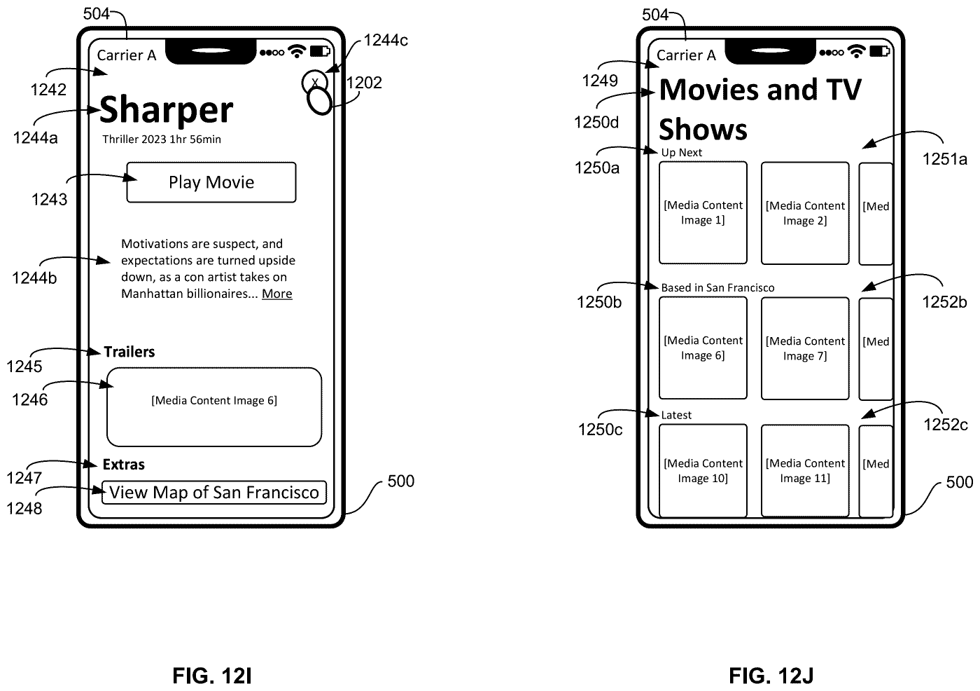

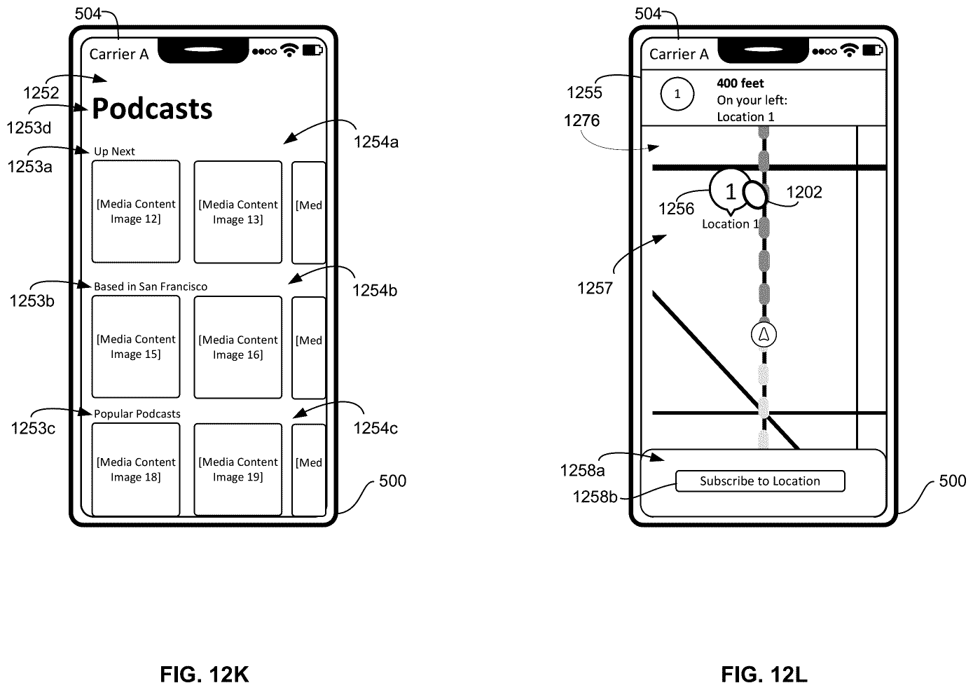

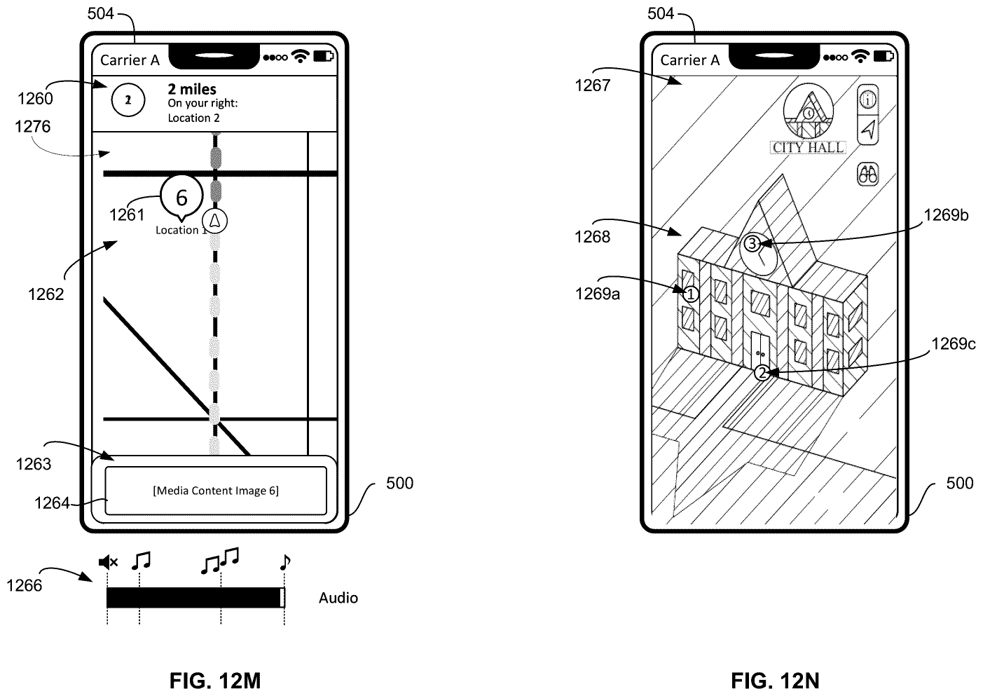

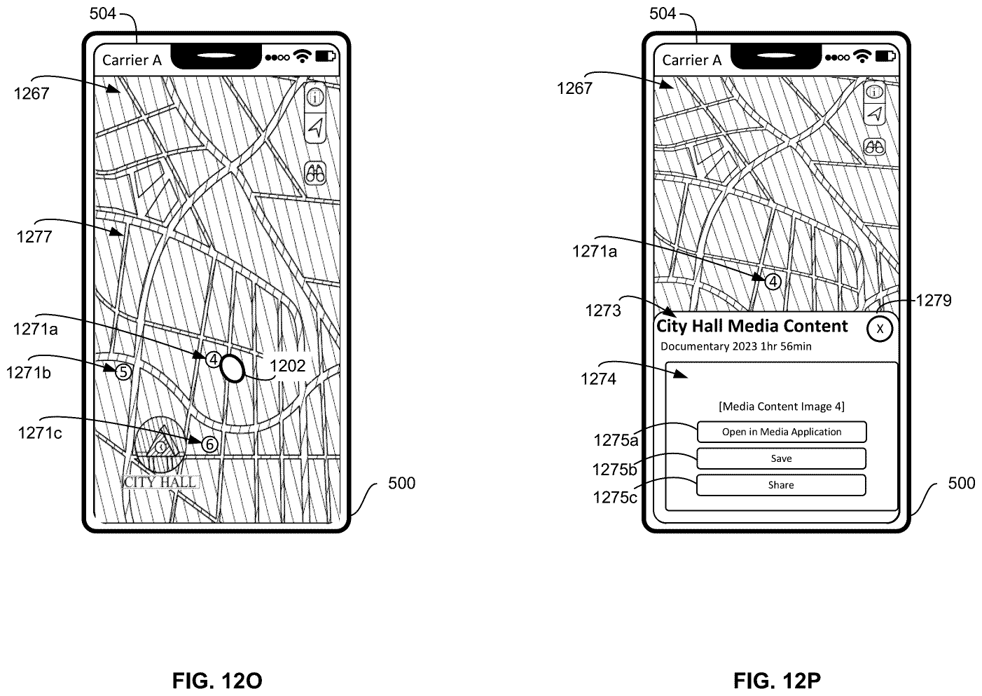

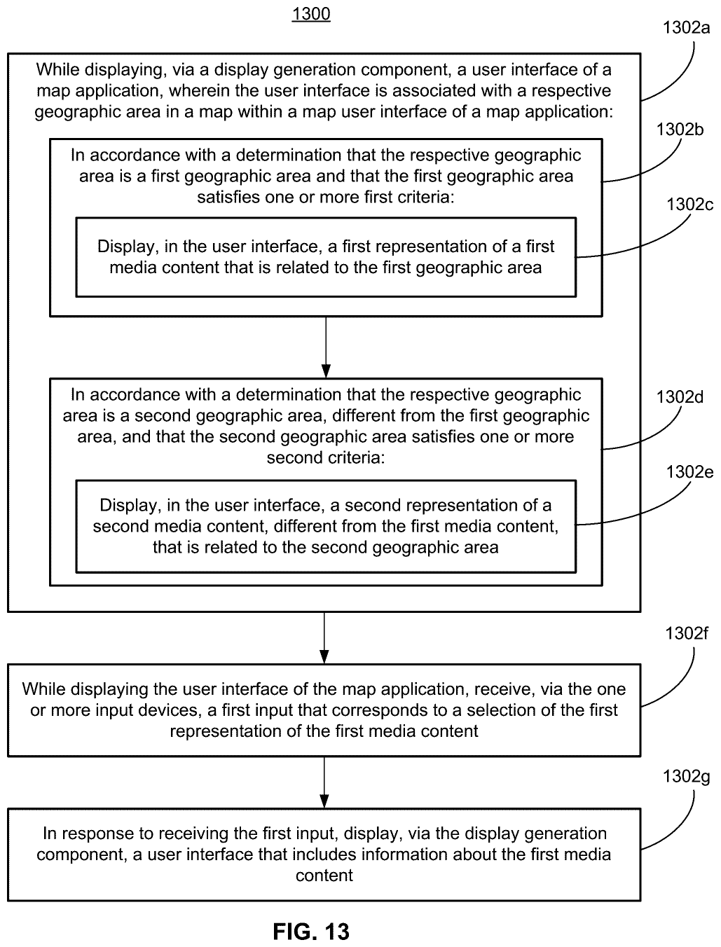

FIGS. 12A-12P illustrate exemplary ways in which an electronic device displays media content in a map application. The embodiments in these figures are used to illustrate the processes described below, including the processes described with reference to FIG. 13. Although FIGS. 12A-12P illustrate various examples of ways an electronic device is able to perform the processes described below with respect to FIG. 13, it should be understood that these examples are not meant to be limiting, and the electronic device is able to perform one or more processes described below with reference to FIG. 13 in ways not expressly described with reference to FIGS. 12A-12P.

FIG. 12A illustrates electronic device 500 displaying a user interface. In some embodiments, the user interface is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

In some embodiments, an electronic device (e.g., electronic device 500) can include a primary map application. For example, the primary map application can present maps, routes, location metadata, and/or imagery (e.g., captured photos) associated with various geographical locations, points of interest, etc. The primary map application can obtain map data that includes data defining maps, map objects, routes, points of interest, imagery, etc., from a server. For example, the map data can be received as map tiles that include map data for geographical areas corresponding to the respective map tiles. The map data can include, among other things, data defining roads and/or road segments, metadata for points of interest and other locations, three-dimensional models of the buildings, infrastructure, and other objects found at the various locations, and/or images captured at the various locations. The primary map application can request, from the server through a network (e.g., local area network, cellular data network, wireless network, the Internet, wide area network, etc.), map data (e.g., map tiles) associated with locations that the electronic device frequently visits. The primary map application can store the map data in a map database. The primary map application can use the map data stored in map database and/or other map data received from the server to provide the maps application features described herein (e.g., navigation routes, maps, navigation route previews, etc.).

In some implementations, a system can include the server. For example, the server can be a computing device, or multiple computing devices, configured to store, generate, and/or provide map data to various user devices (e.g. electronic device 500), as described herein. For example, the functionality described herein with reference to the server can be performed by a single computing device or can be distributed amongst multiple computing devices.

As shown in FIG. 12A, the electronic device 500 presents a map user interface 1276 (e.g., of a primary map application installed on electronic device 500) on display generation component 504. In FIG. 12A, the map user interface 1276 is currently presenting primary map information for one or more geographic areas (e.g., geographic areas associated the city San Francisco). The primary map (e.g., displaying the base map layer) is described with reference to method 1300. In some embodiments, the primary map includes representations of parks, buildings (e.g., representation 1278), and/or roads (e.g., representation 1280) as will be described in subsequent figures. Additional or alternative representations of additional or alternative primary map features are also contemplated.

In some embodiments, the electronic device 500 presents additional information associated with the displayed primary map information for the one or more geographic areas. For example and as shown in FIG. 12A, map user interface 1276 includes user interface element 1200 associated with San Francisco as represented by content 1201. User interface element is displayed as half expanded as shown in FIG. 12A. In some embodiments, user interface element is displayed as fully expanded. Returning to FIG. 12A, user interface element 1200 optionally includes an image 1203b of the one or more geographic areas (e.g., San Francisco). The user interface element also includes a selectable user interface element 1203a that indicates the mode of transportation (e.g., driving) and the length of time (e.g., 22 minutes) to reach San Francisco that is selectable to initiate navigation directions to San Francisco using the mode of transportation, for example. In response to detecting selection of the user interface element 1200 (e.g., with contact 812 in FIG. 12A), the electronic device 500 displays user interface element 1200 as expanded to present media content related to San Francisco as shown in FIG. 12B.

In some embodiments, the electronic device 500 presents media content in a variety of display layouts as will described in the figures that follow. For example, 12B includes displaying media content related to the geographic area San Francisco in a first manner where a plurality of media content, such as first media content user interface object 1207a, second media content user interface object 1207b, third media content user interface object 1208c, fourth media content user interface object 1207d, fifth media content user interface object 1207e, and sixth media content user interface object 1207f are optionally displayed in a section under content header 1206. In some embodiments, the electronic device 500 navigates or scrolls to the section in response to receiving a scrolling input. In some embodiments, the plurality of media content is organized chronologically or non-chronologically (e.g., based on relevance to the geographic area). As shown in FIG. 12B, the media content user interface object includes an image associated with the media content. For example, the image is optionally a movie poster, book cover, or album cover. In some embodiments, and as will be described below, the media content user interface object is selectable to perform an action associated with the media content, such as display information about the media content and/or cause playback of the media content. In some embodiments, the section that includes the plurality of media content is scrollable to reveal other media content user interface objects. For example, in response to a user input corresponding to a request to scroll through the plurality of media content, the electronic device 500 displays media content user interface objects 1208c and 1207f in their entirety as well as other media content user interface objects not currently displayed, instead of partially displaying media content user interface objects 1208c and 1207f as shown in FIG. 12B.

In FIG. 12B, the user interface element 1200 includes additional content, such as location detail information 1209 and location coordinates information 1210. In some embodiments, user interface element 1200 includes a user interface object 1208 selectable to view all media content related to San Francisco as represented by content 1205. For example, the electronic device 500 detects selection (e.g., with contact 1202) of user interface object 1208. In response, the electronic device 500 updates the user interface element 1200 as shown in FIG. 12D to display all media content related to San Francisco instead of a subset of media content as shown in FIG. 12B. The features and characteristics of user interface element 1200 in FIG. 12D will be described later below.

As previously mentioned, the electronic device 500 presents media content in a variety of display layouts. For example, in response to detecting selection of the user interface element 1200 (e.g., with contact 812 in FIG. 12A), the electronic device 500 alternatively displays user interface element 1200 as fully expanded to present media content related to San Francisco in a layout as shown in FIG. 12C, different from the display layout described with reference to FIG. 12B. In FIG. 12C, fully expanded user interface element 1200 includes some of the same content displayed in FIG. 12A when the user interface element 1200 was displayed as half expanded. For example, FIG. 12C optionally includes content 1201, selectable user interface element 1203a, and image 1203b that were included and described with reference to FIG. 12A. FIG. 12C also includes location detail information 1216b and location coordinates information 1216c.

In contrast to the display layout in FIG. 12B, the media content related to San Francisco in FIG. 12C is represented by user interface container element 1215b. In some embodiments, user interface container elements such as user interface container element 1215a and user interface container element 1215b correspond to a respective category of content (e.g., images of sights and/or landmarks in San Francisco, images of food and drink in San Francisco, and/or media content related to San Francisco). For example, user selection of user interface container element 1215a causes the electronic device 500 to optionally display a plurality of images of sights and/or landmarks in San Francisco. In another example, user interface container element 1215b is optionally selectable to display the plurality of media content related to San Francisco. For example, the electronic device 500 detects selection (e.g., with contact 1202) of user interface container element 1215b. In response, the electronic device 500 updates the user interface element 1200 as shown in FIG. 12E to display the plurality of media content related to San Francisco. The features and characteristics of user interface element 1200 in FIG. 12E will be described later below.

Returning now to FIG. 12D, user interface element 1200 is displayed in response to the electronic device 500 detecting selection (e.g., with contact 1202) of user interface object 1208 in FIG. 12B. The user interface element 1200 shown in FIG. 12D includes all media content related to San Francisco as represented by geographic area representation 1218. For example, user interface element 1200 includes user interface media content container element 1219 and user interface media content container element 1222. In some embodiments, user interface media content container elements such as user interface media content container element 1219 and user interface media content container element 1222 include a respective category of media content related to San Francisco (e.g., movies and tv shows, music, electronic books, podcasts, and/or music). In some embodiments, user interface media content container element 1219 and user interface media content container element 1222 include respective user interface media content objects selectable to perform one or more actions as described with reference to method 1300. For example, in FIG. 12D user interface media content container element 1219 includes user interface media content objects 1220a, 1220b, 1220c, 1220d, 1220e, and 1220f. User interface media content container element 1222 includes user interface media content objects 1223a, 1223b, 1223c, 1223d, 1223e, and 1223f. In some embodiments, the user interface media content objects include images representing respective media content. For example, the images optionally include movie posters, book covers, album covers, or artists/performer portraits. In some embodiments, the user interface media content objects are selectable to display more information about the media content as will be described in later figures and with reference to method 1300. In some embodiments, the user interface media content objects include user interface elements, such as user interface elements 1221a, 1221b, 1221c, 1224a, and 1224b, selectable to initiate operations associated with the media content as described with reference to method 1300. For example, in FIG. 12D, user interface media content object 1220a includes user interface element 1221a that is selectable to perform an operation to playback a corresponding respective media content (e.g., play a movie, song, music video, or podcast, open an electronic book, or navigate to a website). In FIG. 12D, user interface element 1221b is selectable to purchase the media content associated with user interface media content object 1220b. User interface media content object 1220b also includes user interface element 1221c selectable to rent the media content associated with user interface media content object 1220b. User interface media content object 1220b in FIG. 12D optionally has one or more of the characteristics of the representation of a first media content described with reference to method 1300.

In some embodiments, electronic device 500 displays representations of media content that are related to the geographic area within map user interface 1276 as will be described in more detail below. For example, in FIG. 12D, the electronic device 500 detects selection (e.g., with contact 1202) of user interface media content container element 1219. In response, the electronic device 500 displays the map user interface 1276 including user interface element 1200 as shown in FIG. 12F to display both map-related information and representations of media content at the same time. In some embodiments, the electronic device 500 displays the map user interface 1276 without detecting selection of user interface media content container element 1219. For example, in response to selection (e.g., with contact 1202) corresponding to a request to minimize or display user interface element 1200 in FIG. 12D as half expanded. The features and characteristics of map user interface 1276 including user interface element 1200 in FIG. 12F will be described later below.

Returning now to FIG. 12E, user interface element 1200 is displayed in response to the electronic device 500 detecting selection (e.g., with contact 1202) of user interface container element 1215b in FIG. 12C. The user interface element 1200 shown in FIG. 12E includes the plurality of media content related to San Francisco, such as first media content user interface object 1225a, second media content user interface object 1225b, third media content user interface object 1225c. fourth media content user interface object 1225d, fifth media content user interface object 1225e, sixth media content user interface object 1225f. seventh media content user interface object 1225g, eighth media content user interface object 1225h, ninth media content user interface object 1225i, and tenth media content user interface object 1225j displayed under content header 1225k. In some embodiments, user interface element 1200 is scrollable to reveal other media content user interface objects. For example, in response to a user input corresponding to a request to scroll, the electronic device 500 optionally displays other media content user interface objects not currently displayed in FIG. 12E. In some embodiments, the plurality of media content is organized chronologically or non-chronologically (e.g., based on relevance to the geographic area). As shown in FIG. 12E, the media content user interface objects include respective images associated with respective media content. For example, the images optionally include image stills of movie scenes, portraits of artists/performers, animations, or music album covers. In some embodiments, and as will be described below, the media content user interface object is selectable to perform an action associated with the media content, such as display information about the media content and/or cause playback of the media content.

Returning now to FIG. 12F, map user interface 1276 including user interface element 1200 is displayed in response to the electronic device 500 detecting selection (e.g., with contact 1202) of user interface media content container element 1219 in FIG. 12D. In FIG. 12F, the map user interface 1276 includes both map-related information and representations of media content. For example, compared to FIG. 12A, the map user interface 1276 of FIG. 12F includes a supplemental map 1226 associated with San Francisco. In some embodiments, supplemental map 1226 includes one or more of the characteristics of the supplemental maps described with reference to methods 700, 900, 1100, 1300, 1500, and/or 1700. In FIG. 12F, supplemental map 1226 includes representations of respective media content, such as a first media content representation 1227a, second media content representation 1227d, fourth media content representation 1227b, fifth media content representation 1227f, sixth media content representation 1227c, and seventh media content representation 1227e that were not displayed in the map user interface 1276 of FIG. 12A. In some embodiments, and as described in method 700, in FIG. 12A, electronic device 500 optionally does not have access to supplemental maps for San Francisco, and/or display supplemental map information for San Francisco has been disabled.

In FIG. 12F, the representations of respective media content are displayed at locations of the supplemental map 1226 that correspond to the one or more locations related to the media content, such as seventh media content representation 1227e displayed in an area corresponding to the West Village neighborhood. In some embodiments, the seventh media content representation 1227e is associated with a seventh media content. In some embodiments, one or more representations of media content are associated with the same media content. For example, the first media content representation 1227a and the fourth media content representation 1227b displayed in an area of the supplemental map corresponding to the landform Silent Hill are both associated with a first media content. The one or more representations of media content displayed in the supplemental map 1226 optionally include one or more of the characteristics of the representations of media content described with reference to method 1300.

In FIG. 12F, the map user interface 1276 includes both map-related information, such as the first media content representation 1227a, the second media content representation 1227d, the fourth media content representation 1227b, the fifth media content representation 1227f, the sixth media content representation 1227c, and the seventh media content representation 1227e displayed in the supplemental map 1226 and representations of media content, such as first media content user interface object 1229a, second media content user interface object 1229b, fourth media content user interface object 1229c, sixth media content user interface object 1229d, seventh media content user interface object 1229e, and fifth media content user interface object 1229f displayed in supplemental map 1226. In some embodiments, the media content representations are selectable to display more information related to the respective media content as described below. In some embodiments, the first media content user interface object 1229a, second media content user interface object 1229b, fourth media content user interface object 1229c, sixth media content user interface object 1229d, seventh media content user interface object 1229e, and fifth media content user interface object 1229f are selectable to perform a respective action associated with the respective media content, such as display information about the respective media content and/or cause playback of the respective media content. As described herein and as shown in FIG. 12F, the media content user interface objects include respective images associated with respective media content. For example, the images optionally include image stills of movie/tv scenes, portraits of actors, animations, or movie/tv posters.

In some embodiments, navigating within the supplemental map 1226 in accordance with user input (e.g., panning or scrolling through the supplemental map 1226) causes the electronic device to change the displayed media content user interface objects in the supplemental map 1226. For example, when the electronic device 500 receives user input to zoom within the supplemental map 1226 such that the map user interface 1276 includes first media content representation 1227a, the second media content representation 1227d, the fourth media content representation 1227b, the fifth media content representation 1227f, the sixth media content representation 1227c, the seventh media content representation 1227e displayed in the supplemental map 1226, the electronic device 500 displays a corresponding user interface element. For example, user interface element 1228 includes media content user interface objects corresponding to the displayed media content representations displayed in the supplemental map 1226, such as first media content user interface object 1229a, second media content user interface object 1229b, fourth media content user interface object 1229c, sixth media content user interface object 1229d, and a second media content user interface object not previously displayed prior to receiving the user input to zoom.

In some embodiments, the representations of media content included in the supplemental map 1226 are selectable to display more information about the respective related media content. For example, as shown from FIG. 12F to FIG. 12G, the sixth media content representation 1227c is selectable to display more information related to the sixth media content. For example, in FIG. 12F, the electronic device 500 detects selection (e.g., with contact 1202) of sixth media content representation 1227c. In response, the electronic device 500 updates user interface element 1228, as shown in FIG. 12G, to include information associated with the sixth media content. In FIG. 12G, user interface element 1228 includes content 1231 comprising a title of the media content, content 1232 comprising a short description of the media content, and user interface media content object 1233. In FIG. 12G, user interface media content object 1233 includes an image 1234 associated with the media content and user interface element 1235a that is selectable to initiate an operation to open the media content in the respective media content application (e.g., electronic device 500 ceases to display the map user interface 1276 of the map application and displays a user interface of the media content application as described later with respect to FIG. 12I).

Returning to FIG. 12G, user interface media content object 1233 also includes user interface element 1235b that is selectable to initiate an operation to save the media content (and/or information about and/or a link to the media content) to the supplemental map 1226 and user interface element 1235c that is selectable to initiate an operation to share the media content (and/or information about and/or a link to the media content) to an electronic device, different from electronic device 500. In some embodiments, user interface element 1228 includes other user interface elements selectable to perform other operations as described with reference to method 1300. In FIG. 12G, user interface element 1228 is displayed as half expanded. In some embodiments, user interface element 1228 is displayed as fully expanded. For example, in FIG. 12G, the electronic device 500 detects swipe gesture (e.g., with contact 1202) directed to user interface element 1228. In response, the electronic device 500 updates user interface element 1228, as shown in FIG. 12H, to display user interface element 1228 is fully expanded. In FIG. 12H, user interface element 1228 includes the same content and user interface elements included in FIG. 12G, as well as user interface element 1241d that is selectable to initiate an operation to subscribe and receive notifications related to the media content, as described in more detail with reference to method 1300.

In some embodiments, the map user interface of the map application includes user interface objects or elements selectable to display a user interface of a respective media content application related to the media content. For example, in FIG. 12I, media content user interface 1242 of media content application (e.g., streaming service application) is displayed in response to the electronic device 500 detecting selection (e.g., with contact 1202) of user interface element 1235a in FIG. 12H. In some embodiments, the electronic device displays media content user interface 1242 in response to the electronic device detecting selection of other user interface objects or elements, such as user interface media content objects 1220d in FIG. 12D or user interface element 1220g that is selectable to perform an operation to playback a corresponding respective media content (e.g., play a movie, song, music video, or podcast, open an electronic book, or navigate to a website) in media content user interface 1242 or sixth media content user interface object 1229d in FIG. 12F.

In some embodiments, the electronic device 500 displays the media content user interface including detailed information about the respective media content and selectable user interface elements to interact with the respective media content. In some embodiments, the media content user interface includes more information about the respective media content than the user interfaces of the map application. For example, media content user interface 1242 includes content 1244a comprising a title and a short description of the media content, content 1244b comprising a storyline description of the media content, and user interface element 1246 comprising an image related to the media content and selectable to display more information and/or initiate playback of a commercial advertisement or short preview related to the media content in a section under content header 1245. In FIG. 12I, media content user interface 1242 also includes a close button or icon selectable to close or cease displaying media content user interface 1242, media content user interface object 1243 selectable to initiate playback of the media content and media content user interface object 1248 in a section under content header 1247, the media content user interface object 1248 is selectable to view the supplemental map 1226 associated with the media content shown in FIG. 12G. In some embodiments, media content user interface 1242 includes other content and/or user interface objects or elements selectable to perform other operations as described with reference to method 1300.

In some embodiments, the electronic device 500 suggests media content based on user queries. For example, the electronic device optionally suggests media content that is similar or related to a recently viewed geographic area or other user queries as described with reference to method 1300. For example, if the user recently performed a search for “San Francisco” or recently viewed San Francisco in the map application as illustrated in FIG. 12A, the electronic device 500 is optionally configured to suggest media content about San Francisco in an application other than the map application, such as media content applications described with reference to FIG. 12J and FIG. 12K. In 12J, the electronic device 500 displays media content user interface 1249 of a streaming service application in response to detecting selection (e.g., with contact 1202) of the user interface element 1244c selectable to close media content user interface 1242 as shown in FIG. 12I. The media content user interface 1249 displayed in FIG. 12J includes content 1250d identifying the media content type (“Movies and TV Shows”) and a first set of media content user interface objects 1251a in a section under content header 1250a. In FIG. 12J, the first set of media content user interface objects 1251a corresponds to movies and television the user has already started to watch or is planning to watch. The media content user interface 1249 also includes a second set of media content user interface objects 1252b in a section under content header 1250b. In FIG. 12J, the second set of media content user interface objects 1252b corresponds to movies and television shows related to San Francisco. In some embodiments, if the user recently viewed or searched for a geographic area different from San Francisco, such as Los Angeles, the media content user interface 1249 additionally or alternatively includes a set of media content user interface objects related to Los Angeles. In FIG. 12J, the media content user interface 1249 also includes a third set of media content user interface objects 1252c in a section under content header 1250c, the third set of media content user interface objects 1252c corresponds to recently released movies and television shows that may or may not be related to San Francisco. In some embodiments, the plurality of media content user interface objects of the first, second, and third sets are selectable to view more information related to the respective movie or television show and/or initiate playback of the respective movie or television show.

In some embodiments, other types of media content is suggested by the electronic device 500, different from movies and television shows. For example, in FIG. 12K the electronic device 500 displays a media content user interface 1252 of a digital audio file streaming application (e.g., a Podcast application) that is different from a user interface of the streaming service application and a user interface of the map application described above. Similarly to FIG. 12K, the media content user interface 1252 displayed in FIG. 12K includes content 1253d identifying the media content type (“Podcasts”) and a first set of media content user interface objects 1254a in a section under content header 1253a. In FIG. 12K, the first set of media content user interface objects 1254a corresponds to podcasts the user has already started to listening to or is planning to listen to. The media content user interface 1252 also includes a second set of media content user interface objects 1254b in a section under content header 1253b. In FIG. 12K, the second set of media content user interface objects 1254b corresponds to podcasts related to San Francisco. In some embodiments, the media content user interface 1252 includes this section of podcasts related to San Francisco because the user recently searched for or recently viewed San Francisco in the map application. In FIG. 12K, the media content user interface 1252 also includes a third set of media content user interface objects 1254c in a section under content header 1253c, the third set of media content user interface objects 1252c corresponds to recently released podcasts that may or may not be related to San Francisco. In some embodiments, the plurality of media content user interface objects of the first, second, and third sets are selectable to view more information related to the respective podcast show and/or initiate playback of the respective podcast episode. Other types of media content may be suggested by electronic device 500 as described in method 1300.

The figures that follow relate to the map application. In some embodiments, while navigating along a route on a user interface of the map application or exploring a three-dimensional map of the map application, the electronic device 500 presents representations of media content related to a geographic area along the route and/or related to a geographic area in the three-dimensional map. For example, in FIG. 12L, electronic device 500 displays map user interface 1276 of the map application. In FIG. 12L, the map user interface 1276 of the map application includes a current navigation position within the map and content 1255 comprising an upcoming maneuver along the route. The current navigation position is associated with a geographic area 1257 that is related to media content. In response to the determination that the current navigation position is associated with geographic area 1257 that is related to media content, the electronic device displays the map user interface 1276 including media content representation 1256 of the media content. In some embodiments, the media content representations include one or more of the characteristics of the media content representations described with reference to FIG. 12G. For example, the media content representations are selectable to display more information related to the respective media content and/or cause playback of the respective media content. In FIG. 12L, the electronic device 500 also displays map user interface 1276 including media content notification 1258a. The media content notification 1258a includes user interface element 1258b that is selectable to initiate an operation to subscribe and receive notifications related to the media content, as described in more detail with reference to method 1300.

In some embodiments, while navigating along the route, the electronic device outputs spatial audio from a direction corresponding to a respective direction associated with a respective media content that is related to the geographic area and/or a visual notification indicating that the respective media content related to the geographic area is available. For example, in FIG. 12M, electronic device 500 displays map user interface 1276 of the map application. In FIG. 12M, the map user interface 1276 of the map application includes a current navigation position within the map and content 1260 comprising an upcoming maneuver along the route. The current navigation position is associated with a geographic area 1262 that is related to media content. In response to the determination that the current navigation position is associated with geographic area 1262 that is related to media content, the electronic device displays the map user interface 1276 including media content representation 1261 of the media content. In some embodiments, the media content representation 1261 includes one or more of the characteristics of the media content representations described with reference to FIG. 12G. For example, the media content representation 1261 is selectable to display more information related to the respective media content and/or cause playback of the respective media content. In FIG. 12M, the electronic device 500 also displays map user interface 1276 including media content notification 1263. The media content notification 1263 includes user interface element 1264 that is selectable to display information related to the respective media content, such as shown in FIG. 12I and/or initiate playback of the respective media content as described with reference to methods 1300 and/or 1500. In FIG. 12M, in addition or alternatively to displaying media content notification 1263, the electronic device 500 presents spatial audio as represented by graphic 1266 from the direction corresponding to the respective direction associated with the respective media content as if emanating from a location corresponding to the respective media content. In some embodiments, as the location of the electronic device 500 relative to the location corresponding to the respective media content changes, the electronic device 500 changes the direction of spatial audio that is output such that the spatial audio continues to be output as if emanating from the location corresponding to the respective media content. In some embodiments, the volume of the spatial audio that is output changes as the distance of the electronic device 500 from the location corresponding to the respective media content changes (e.g., as the distance decreases, the volume increases or as the distance increases, the volume decreases). In some embodiments, the electronic device 500 outputs other spatial audio characteristics as described with reference to methods 1300 and/or 1500.

In some embodiments, while exploring a three-dimensional map of the map application, the electronic device 500 presents representations of media content related to a geographic area and/or landmark or point of interest in the three-dimensional map. For example, in FIG. 12N, electronic device 500 displays three-dimensional map user interface 1267 including landmark 1268 rendered for display in three-dimensions. In FIG. 12N, electronic device 500 displays representations of media content related to landmark 1268, such as first media content representation 1269a, second media content representation 1269c, and third media content representation 1269b. Each of first media content representation 1269a, second media content representation 1269c, and third media content representation 1269b are located in respective areas of landmark 1268 corresponding to the related media content. In some embodiments, each of first media content representation 1269a, second media content representation 1269c, and third media content representation 1269b are selectable to display information related to the media content as will be described with reference to FIG. 12P and/or selectable to initiate playback of the media content.

In some embodiments, as the user explores the three-dimensional map by panning and/or zooming within the three-dimensional map, the electronic device 500 changes the three-dimensional map user interface to display more or less representations of media content related to the geographic area. For example, from FIG. 12N to FIG. 12O, in response to user input to zoom out of the three-dimensional map, the electronic device 500 changes the three-dimensional map user interface 1267 to display representations of media content related to the zoomed out geographic area. In FIG. 12O, the electronic device 500 displays the three-dimensional map user interface 126 including geographic area 1277 differently from the geographic area associated with landmark 1268 in FIG. 12N. The geographic area 1277 includes representations of media content such as fourth representation of media content 1271a, fifth representation of media content 1271b, and sixth representation of media content 1271c associated with respective media content related to geographic area 1277 that was not previously displayed in FIG. 12N. In some embodiments, the representations of media content include one or more of the characteristics of the media content representations described with reference to FIG. 12G. For example, the representations of media content are selectable to display more information related to the respective media content and/or cause playback of the respective media content. In some embodiments, a representation of media content displayed in user interface 1267 is selectable to display information related to the respective media content. For example, in FIG. 12O, the electronic device 500 detects selection (e.g., with contact 1202) of the fourth representation of media content 1271a. In response, the electronic device 500 changes the three-dimensional map user interface 1267 as shown in FIG. 12P to display user interface element 1279 including information associated with the fourth media content. In FIG. 12P, user interface element 1279 includes content 1273 comprising a title of the media content and a brief description of the media content and user interface media content object 1274. In FIG. 12P, user interface media content object 1274 includes an image associated with the media content and user interface element 1275a that is selectable to initiate an operation to open the media content in the respective media content application (e.g., electronic device 500 ceases to display the three-dimensional map user interface 1267 of the map application and displays a user interface of the media content application, such as described with respect to FIG. 12I). The user interface media content object 1274 of FIG. 12P also includes user interface element 1275b that is selectable to initiate an operation to save the media content to a supplemental map and user interface element 1275c that is selectable to initiate an operation to share the media content to an electronic device, different from electronic device 500, and/or share information about and/or a link to the media content. In some embodiments, user interface element 1279 includes other user interface elements selectable to perform other operations as described with reference to method 1300.

FIG. 13 is a flow diagram illustrating a method 1300 for displaying media content in a map application. The method 1300 is optionally performed at an electronic device such as device 100, device 300, device 500 as described above with reference to FIGS. 1A-1B, 2-3, 4A-4B and 5A-5H. Some operations in method 1300 are, optionally combined and/or the order of some operations is, optionally, changed.

In some embodiments, method 1300 is performed at an electronic device (e.g., 500) in communication with a display generation component (e.g., 504) and one or more input devices. In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 1300 is performed at or by an automobile (e.g., at an infotainment system of an automobile having or in communication with one or more display generation components and/or input devices).

In some embodiments, while displaying (1302a), via the display generation component, a user interface of a map application, wherein the user interface is associated with a respective geographic area in a map within a map user interface of a map application, such as user interface 1276 in FIG. 12A, and in accordance with a determination that the respective geographic area is a first geographic area and that the first geographic area satisfies one or more first criteria (e.g., the first geographic area includes one or more POIs associated with media content), the electronic device displays (1302b), in the user interface, a first representation of a first media content that is related to the first geographic area, such as first media content user interface object 1207a in FIG. 12B. In some embodiments, the user interface is a map user interface of a map application, such as the map user interface of the map application as described with reference to methods 700, 900, 1100, 1300, 1500, and/or 1700. In some embodiments, the respective geographic area is an area that is centered on a location of the electronic device. In some embodiments, the respective geographic area is an area that is selected by a user of the electronic device (e.g., by panning or scrolling through the map user interface of the map application). In some embodiments, the map within the map user interface has one or more of the characteristics of the primary map described with reference to method 700, 900, 1100, 1300, 1500, and/or 1700. In some embodiments, the user interface of the map application is a supplemental map having one or more of the characteristics of the supplemental maps described with reference to methods 700, 900, 1100, 1300, 1500, and/or 1700. In some embodiments, the user interface of the map application is a details user interface for one or more points of interest (POIs) (e.g., landmark, public park, structure, business, or other entity that is of interest to the user). For example, the details user interface includes details about POIs and/or locations within the respective geographic area, such as POIs in the first geographic area, photos and/or videos of POIs and/or locations in the first geographic area, links to guides of activities to do in the first geographic area, and/or any information associated with the first geographic area such as described with reference to methods 700, 900, 1100, 1300, 1500, and/or 1700.

In some embodiments, the first geographic area includes first map data such as a first set of streets, highways, and/or one or more first points of interest. In some embodiments, the electronic device utilizes the first map data about the first geographic area for use in one or more applications, different from the map application (e.g., a content media application as media content metadata) as described with reference to method 1300. In some embodiments, the first representation of the first media content related to the first geographic area includes icons, photos, text, links, user interface elements, and/or selectable user interface objects of the first media content such as a music album, song, movie, tv show, audio book, digital publication, podcast, or video. In some embodiments, the first representation of the first media content related to the first geographic area is displayed within the map user interface of the map application. More details with regards to the first representation of the first media content is described with reference to method 1300. In some embodiments, when the first geographic area does not satisfy the one or more first criteria, the electronic device does not display, in the user interface, the first representation of the first media content that is related to the first geographic area. In some embodiments, if the first geographic area is within a threshold distance (e.g., e.g., 1, 5, 10, 50, 100, 200, 500, 1000, 10000 or 100000 meters) of another geographic area, different from the first geographic area, and the other geographic area does satisfy the one or more first criteria, the electronic device displays, within the first geographic area in the map user interface of the map application, an indicator (e.g., an arrow, icon, or user interface element) indicating to the user to pan or scroll through the map user interface to view/display the other geographic area and/or respective media content related to the other geographic area. In some embodiments, when the respective geographic area does not correspond to the first geographic area (e.g., the respective geographic area does not include one or more first points of interest or other entity that is of interest of the user), the electronic device does not display, in the user interface, the first representation of the first media content that is related to the first geographic area.

In some embodiments, while displaying (1302d) the user interface of a map application, and in accordance with a determination that the respective geographic area is a second geographic area, different from the first geographic area, such as geographic area associated with representation 1227e in FIG. 12F and that the second geographic area satisfies one or more second criteria (e.g., the second geographic area includes one or more POIs associated with media content), the electronic device displays (1302e), in the user interface, a second representation of a second media content, different from the first media content, that is related to the second geographic area, such a media content user interface object 1229e. In some embodiments, the one or more first criteria is the same as the one or more second criteria. In some embodiments, the second geographic area is smaller or bigger than the first geographic area. In some embodiments, the second geographic area includes a greater amount or lesser amount of second map data than the first map data such as a second set of streets, highways, and/or one or more second points of interest different from the first set of streets, highways, and/or the one or more first points of interest. In some embodiments, the second representation of the second media content includes characteristics similar to that of the first representation of the first media content as will be described with reference to method 1300. In some embodiments, the second media content is different from the first media content. For example, the second media content is optionally a music album and the first media content optionally refers to digital content other than a music album, such as an audio book, a podcast, a video, a movie, or a tv show. In another example, the second media content and the first media content are optionally both music albums, but associated with different musicians.

In some embodiments, while displaying (1302f) the user interface of the map application, the electronic device receives, via the one or more input devices, a first input that corresponds to a selection of the first representation of the first media content, such as contact 1202 in FIG. 12F. In some embodiments, the first input includes a user input directed to the first representation of the first media content, such as an gaze-based input, an activation-based input such as a tap input, or a click input, (e.g., via a mouse, trackpad, or another computer system in communication with the electronic device).

In some embodiments, in response to receiving the first input, the electronic device displays (1302g), via the display generation component, a user interface that includes information about the first media content, such as user interface 1228 in FIG. 12G. In some embodiments, information about the first media content includes metadata, photos, text, links, user interface elements, and/or selectable user interface objects. In some embodiments, information about the first media content is displayed within the map user interface of the map application. More details with regards to information about the first media content is described with reference to method 1300. In some embodiments, in response to receiving the first input, the electronic device initiates an operation associated with the first media content such as playing the first media content and/or displaying the first media content. In some embodiments, the electronic device performs the operation associated with the first media content in a user interface separate from the user interface that includes the first representation of the first media content. In some embodiments, the electronic device performs the operation associated with the first media content in the same user interface that includes the first representation of the first media content.

In some embodiments, the first input includes a sequence of inputs corresponding to a request to select the first representation of the first media content and the second representation of the second media content, and in response to the sequence of inputs, the electronic device displays the user interface including information about the first media content and concurrently displays information about the second media content, such information optionally analogous and/or the same as the information about the first media content. In some embodiments, the electronic device receives a second input corresponding to a selection of the second representation of the second media content. In some embodiments, in response to receiving the second input corresponding to the selection of the second representation of the second media content, the electronic device displays the second user interface that includes the information about the second media content. Displaying the first representation of the first media content that is related to the first geographic area within the same user interface as the map user interface enables a user to view both map-related information and the first representation of the first media content at the same time, without having to leave the map application, thereby reducing the need for subsequent inputs to display the first representation of the first media content. Providing the first representation of the first media content in the map application and providing the ability to interact with the first representation of the first media content to cause the user interface to display information about the first media content provides quick and efficient access to related content without the need for additional inputs for searching for related content and avoids erroneous inputs related to searching for such content.

In some embodiments, the first media content includes music, video, literature, spoken-word, or map content, such as shown in FIG. 12D with representations 1220a-1220f and 1223a-1223f. The first media content and/or the second media content optionally includes a variety of media content types, including music, spoken-word (e.g., audio books, podcasts, lectures), video (e.g., television, movies), and/or digital content (e.g., electronic books, magazines, maps, guides, animated images). It is understood that although some descriptions refer to movies or television, it should be understood as also applicable to other media content types. For example, an episode of a television series optionally corresponds to a music track, a podcast episode, a chapter of an electronic book or audio book, a scene of a movie, or a geographic area in a map. An “actor” starring in the television series can correspond to a performer of a music album, audio book, or podcast or a travel guide/explorer of a map. Presenting a variety of media content simplifies the interaction between the user and the electronic device by reducing the number of inputs needed to search for different types of related content in respective media content applications and avoids erroneous inputs related to searching for such content, which reduces power usage and improves battery life of the electronic device.

In some embodiments, the first media content is related to the first geographic area based on one or more first metadata attributes of the first media content, such as shown by user interface media content container element 1222 based on geographic area representation 1218 in FIG. 12D. For example, when the first media content is a television show, the one or more first metadata attributes associated with the first media content optionally identifies actors, writers, directors of the television show; locations (e.g., geographic areas) where the television is set and/or filmed; POIs featured in the television show; and/or events occurring in the television show. In some embodiments, the first geographic area associated with the first media content is determined based on the one or more first metadata attributes associated with the first media content. For example, when the first media content is the television show, the first geographic area associated with the first media content optionally represents a geographic area where the television show was set, a geographic area where the POI featured in the television show is located, a geographic area where the director of the television show was born, and/or a geographic area where the event featured in the television show occurred. It is understood that although the embodiments described herein are directed to the first media content, such functions and/or characteristics, optionally apply to other media content including the second media content. Utilizing existing metadata to search for related media content is a quick and convenient method to locate related media content without the need for additional inputs for searching for related content and avoids erroneous inputs related to searching for such content, thereby saving time and computing resources.

In some embodiments, while displaying, via the display generation component, the user interface that includes information about the first media content, such as user interface 1228 in FIG. 12H, the electronic device receives, via the one or more input devices, a second input that corresponds to a request to receive future alerts about media that is related to the first geographic area, such as an input directed to representation 1241 in FIG. 12H. For example, a second input directed to a selectable user interface object that is optionally associated with the first geographic area. In some embodiments, the selectable user interface object is included within the map user interface. In some embodiments, the selectable user interface object is included within a second user interface, different from the map user interface. In some embodiments, the second user interface is a user interface of a settings application or a notifications scheduling application. The settings application or the notifications scheduling application is optionally configured to schedule the future alerts about media that is related to the first geographic area at a specific time of day. In some embodiments, the future alerts about media that is related to the first geographic area are notifications from the respective media content application. For example, if a future alert is about media corresponding to music, the future alert is from the music player application. In another example, if the future alert is about media corresponding to a movie, the future alert is from a video streaming application. In some embodiments, the future alerts about media that is related to the first geographic area are notifications from the map application. In some embodiments, the request to receive future alerts about media that is related to the first geographic area includes user input directed to a selectable user interface element displayed on the maps user interface (e.g., location details user interface of the map application for the first geographic area as described herein). For example, the selectable user interface element is selectable to initiate the process to request to receive future alerts about media that is related to the first geographic area. In some embodiments, the selectable user interface element is displayed in a user interface other than the maps user interface, such as a user interface of the media application.

In some embodiments, in response to receiving the second input, the electronic device initiates a process to receive future alerts about media that is related to the first geographic area, such as, for example, an alert similar to or corresponding to notification 1263 in FIG. 12M. In some embodiments, initiating the process to receive future alerts about media that is related to the first geographic area includes displaying, via the display generation component, notifications (audio and/or visual) that indicate that media related to the first geographic area is available when media related to the first geographic area is available. In some embodiments, initiating the process to receive future alerts about media that is related to the first geographic area includes displaying, via the display generation component, a user interface of an application associated with receiving the future alerts about media that is related to the first geographic area.

In some embodiments, the notifications are displayed subsequent to displaying a user interface of an application associated with the media. For example, if the future alert is about media corresponding to music, the future alert is optionally displayed upon displaying a user interface of the music player application. In some embodiments, the notifications are displayed subsequent to displaying a supplemental map associated with the first geographic area, such as described with reference to methods 700, 900, 1100, 1300, 1500, and/or 1700. For example, if the future alert is about media corresponding to music, the future alert is optionally displayed upon displaying the supplemental map associated with the first geographic area of the map application. In some embodiments, if media related to the first geographic area is not available, the electronic device does not display notifications that indicate that media related to the first geographic area is available. In some embodiments, the future alert is displayed in a user interface of the maps application. In some embodiments, the future alert is displayed outside the user interface of the maps application. For example, the future alert is optionally presented above (or bottom or sides of and/or overlaid) the user interface of the maps application. In some embodiments, the future alert is selectable to cause playback of the media and/or display information related to the media. Providing an option to request to receive future alerts about media that is related to the first geographic area simplifies interaction between the user and the electronic device and enhances operability of the electronic device by providing a way to receive future alerts about media related to the first geographic area without navigating away from the user interface that includes the first geographic area, such as by streamlining the process of receiving future alerts for media related to the first geographic area for which the first geographic area had recently been presented by the electronic device.

In some embodiments, after initiating the process to receive future alerts about media that is related to the first geographic area, the electronic device receives, via the one or more input devices, a second input that corresponds to a request to change the future alerts about media that is related to the first geographic area, such as, for example, input directed to user interface element 1258b in FIG. 12L, and thereafter, unsubscribing to the future alerts as described herein. In some embodiments, the change to the future alerts about media related to the first geographic area includes subscription to one or more first metadata attributes and/or cancelling subscription to one or more second metadata attributes, different from the one or more first metadata attributes. For example, the change optionally includes In some embodiments, the change to the future alerts about media related to the first geographic area includes subscription to a first type of media content (e.g., music) and/or cancelling subscription to a second type of media content (e.g., movies and television shows), different from the first type of media content. In some embodiments, the change to the future alerts about media related to the first geographic area includes unsubscribing from the future alerts (e.g., all future alerts). In some embodiments, the change to the future alerts about media related to the first geographic area includes changing from the first geographic to a second geographic area, different from the first geographic area.

In some embodiments, in response to receiving the second input, the electronic device initiates a process to change the future alerts about media that is related to the first geographic area, such as changing the type of media content (e.g., user interface media content container elements 1219 and 1222 in FIG. 12D) that is displayed to the user of the electronic device as described herein. In some embodiments, initiating the process to change the future alerts about media that is related to the first geographic area includes displaying, via the display generation component, a confirmation of the change. In some embodiments, initiating the process to change the future alerts about media that is related to the first geographic area includes ceasing to display, via the display generation component, the notifications that indicate that media related to the first geographic area is available when the change includes cancelling a subscription as described herein. Providing an option to change future alerts about media that is related to the first geographic area avoids unwanted transmission of future alerts, and thereby reduces computing resource usage and improves battery life of the electronic device.

In some embodiments, the user interface of the map application is a location details user interface of the map application for the respective geographic area, such as user interface 1200 in FIG. 12B. For example, the location details user interface optionally includes the first representation of the first media content that is related to the first geographic area and/or the second representation of the second media content that is related to the second geographic area. In some embodiments, the location details user interface includes details about locations within the respective geographic area as described with reference to method 700. In some embodiments, the location details user interface is accessible in a supplemental map associated with the respective geographic area. Displaying the first representation of the first media content that is related to the first geographic area within the location details user interface of the map application enables a user to view both map-related information such as details about locations within the respective geographic area and the first representation of the first media content at the same time, without having to leave the map application, thereby reducing the need for subsequent inputs to display the first representation of the first media content.

In some embodiments, the user interface of the map application includes a first plurality of media content representations related to the first geographic area including the first representation of the first media content and a third representation of a third media content, such as the plurality of representations 1220a-1220f and 1223a-1223f in FIG. 12D. In some embodiments, the third representation of the third media content is different from the first representation of the first media content. For example, the third representation of the third media content optionally corresponds to a movie filmed in a location within the first geographic area and the first representation of the first media content optionally corresponds to a song about a same or different location within the first geographic area. In some embodiments, the first media content and the third media content are the same type of media content. For example, the third representation of the third media content and the first representation of the first media content optionally correspond to musical artists from the first geographic area.

In some embodiments, the first plurality of media content representations related to the first geographic area are displayed in a first layout, such as shown user interface 1200 in FIG. 12D. In some embodiments, the first layout includes displaying the first representation of the first media content as a first element in the user interface, such as user interface media content object 1220a in FIG. 12D, and the third representation of the third media content as a second element, outside of the first element, in the user interface, such as user interface media content object 1223a in FIG. 12D. For example, the first layout optionally includes the first representation of the first media content and the third representation of the third media content grouped by media type, such as music, tv shows, movies, books, podcasts, or map content. In some embodiments, metadata associated with the media content indicate the respective type of media. In some embodiments, the respective media content application from which to play or engage with the media content indicates the respective type of media. In some embodiments, the first layout includes presenting the first plurality of media content representations related to the first geographic area including the first representation of the first media content and the third representation of the third media content from most recent to least recent. In some embodiments, the first layout includes displaying the first representation of the first media content and the third representation of the third media content, also referred to as the first element and the second element, respectively separated by a visible or an invisible border. Displaying the third representation of the third media content outside of the first representation of the first media content provides a more efficient use of display space and enables the user to easily locate media content, which reduces power usage and improves battery life of the electronic device by enabling the user to use the electronic device more quickly and efficiently.

In some embodiments, the user interface of the map application includes a selectable option that is selectable to filter display of the respective plurality of media content representations according to first filter criteria, and a selectable option that is selectable to filter display of the respective plurality of media content representations according to second filter criteria, different from the first filter criteria, such as shown by user interface element 1228 including a filtered plurality of media content related to “Movies and TV Shows” in FIG. 12F. In some embodiments, the electronic device filters display of the respective plurality of media content representations by various filter criteria. In some embodiments, the electronic device increases the emphasis of media content representations meeting the filter criteria relative to media content representations not meeting the filter criteria. For example, the first filter criteria is optionally based on a first type of media content (e.g., show only media content that includes music, or do not show media content that includes music) and the second filter criteria is optionally based on a second type of media content (e.g., show only media content that includes movies, or do not show media content that includes movies). In some embodiments, the first and/or second filter criteria is optionally based on age of the media content (e.g., show only media content released within a predefined time period). In some embodiments, the first and/or second filter criteria is optionally based on metadata associated with the media content (e.g., show only media content that includes musical artist “Grateful Dead”). In some embodiments, the selectable option includes a toggle user interface object to toggle from the first filter criteria to the second filter criteria. In some embodiments, the selectable option is any selectable user interface object other than a toggle user interface object. Displaying selectable options to filter media content reduces the cognitive burden on a user when filtering media content and provides a more tailored user interface that is less cluttered and includes more of the desired media content, which additionally reduces power usage and improves battery life of the electronic device by enabling the user to use the electronic device more quickly and efficiently.

In some embodiments, the user interface of the map application includes a first selectable option that is selectable to initiate a process to access the first media content without navigating away from the user interface, such a user interface element 1221a in FIG. 12D. In some embodiments, the process to access the first media content without navigating away from the user interface includes initiating playback of the first media content in the user interface of the map application (e.g., without displaying a user interface of a media browsing and/or playback application on the electronic device). In some embodiments, the electronic device continues playback of the first media content when the electronic device detects user interaction directed away from the first media content. For example, if the electronic device detects user interaction with the second representation of the second media content, the electronic device optionally continues to playback the first media content and optionally displays the representation of the second media content. In some embodiments, the first media content is played in the background and displayed concurrently with the representation of the second media content albeit to the side and/or overlaid on the user interface of the map application. In some embodiments, the process to access the first media content without navigating away from the user interface includes initiating playback of the first media content on a second electronic device, different from the electronic device, while displaying the user interface of the map application on the electronic device. For example, the electronic device optionally hands off playback of the first media content to the second electronic device without navigating away from the user interface of the map application on the electronic device such that the electronic device controls playback of the first media content on the second electronic device. In some embodiments, the process to access the first media content without navigating away from the user interface includes downloading and/or purchasing the first media content. In some embodiments, initiating the process to access the first media content without navigating away from the user interface include causing playback of the first media content without displaying a user interface of an application associated with the first media content (e.g., a media content details user interface of a respective media application). In some embodiments, causing playback of the first media content includes playback in an application other than the map application, such as the application associated with the first media content (e.g., music application, tv application, podcast application, or electronic book application). In some embodiments, causing playback of the first media content includes playback in the map application. Displaying a selectable option to playback, download, and/or purchase media content simplifies the interaction between the user and the electronic device by reducing the number of inputs needed to navigate to respective user interface for performing the action of playing, downloading, and/or purchasing media content when immediate action to playback, download, and/or purchase media content is desired, which additionally reduces power usage and improves battery life of the electronic device by enabling the user to use the electronic device more quickly and efficiently.

In some embodiments, while displaying, via the display generation component, the user interface of the map application, the electronic device receives, via the one or more input devices, a second input that corresponds to selection of the first representation of the first media content, such as contact 1202 directed to media content user interface object 1225g in FIG. 12E. For example, a second input directed to a selectable user interface object different from the first input that corresponds to the selection of the first representation of the first media content described in method 1300.

In some embodiments, in response to receiving the second input, the electronic device displays a second user interface of a media application, different from the map application, wherein the second interface includes a plurality of selectable options that are selectable to perform different operations with respect to the first media content, such as user interface 1242 and media content user interface object 1248 in FIG. 12I. In some embodiments, the second user interface includes second information about the first media content that is different from information about the first media content displayed on the user interface that includes information about the first media content described in method 1300. For example, when the first media content corresponds to a television show, the second information optionally includes second information such as listing of all episodes, cast and crew information, a more detailed description of what the television show is about, and/or one or more selectable user interface objects to perform different operations with respect to the first media content, such as playing, saving, and/or downloading episodes or television show trailers; browsing related videos and/or content; and/or sharing the television show to a second electronic device. In contrast, the user interface that includes information about the first media content described in method 1300 optionally includes a brief description of what the television is about and/or one or more selectable user interface objects for playing the television show trailer and/or a portion of the television show. Displaying a user interface of a media application that includes a plurality of selectable options to perform different operations with respect to the first media content enables a user to view details and perform more operations with respect to the first media content, without the need for additional inputs for opening the media application and searching for the first media content, thereby streamlining the process of interacting with first media content details within the media application for which the first representation of the first media content had recently been presented by the electronic device.

In some embodiments, the user interface of the map application includes a first selectable option that is selectable to add the first media content to a supplemental map associated with the first geographic area, such as user interface element 1235b in FIG. 12G, and/or a second selectable option that is selectable to facilitate access to the first media content in a first application, different from the map application, such as user interface element 1235a in FIG. 12G. In some embodiments, the supplemental map includes one or more of the characteristics of the supplemental maps described with reference to methods 700, 900, 1100, 1300, 1500, and/or 1700. In some embodiments, adding the first media content to the supplemental map includes adding a selectable user interface object representing the first media content for display on the supplemental map. The user interface object is optionally selectable to display the user interface that includes information about the first media content as described with reference to method 1300. In some embodiments, adding the first media content to the supplemental map associated with the first geographic area does not including adding the first media content to the primary map. Characteristics of the primary map are described with reference to methods 700, 900, 1100, 1300, 1500, and/or 1700. In some embodiments, adding the first media content to the supplemental map associated with the first geographic area does include adding the first media content to the primary map. In some embodiments, facilitating access to the first media content in the first application includes adding the first media content as a favorite or preferred media content in the first application.

In some embodiments, the first application is a media application associated with the first media content (e.g., an application in which the first media content can be played). In some embodiments, the first application is an application other than a media application or a map application, such as a notes application, calendar application, reminders application, and/or messaging application. In some embodiments, after adding the first media content as a favorite media content, the electronic device displays the first media content in the first application with an indication that the first media content is a favorite (e.g., displays a list of favorite media content to include the first media content and/or displays the first media content as emphasized relative to media content that are not favorited or selected to facilitate access). Displaying selectable options to i.) add the first media content to the supplemental map; and/or ii.) facilitate access to the first media content enables a user to identify the first media content as being reserved or otherwise set apart (collected) for easy access later in the supplemental map and/or the application associated with the first media content, thereby reducing the number of inputs needed to locate the first media content when immediate access to the first media content is desired, which additionally reduces power usage and improves battery life of the electronic device by enabling the user to use the electronic device more quickly and efficiently.

In some embodiments, the user interface that includes information about the first media content is displayed within a user interface of a first application, different from the map application, such as user interface 1242 in FIG. 12I. In some embodiments, the user interface of the first application is based on the first media content. For example, if the first media content corresponds to an electronic book, the user interface of the first application is optionally a user interface of an electronic book reading application. In some embodiments, the user interface of the first application that is based on the first media content is a first media content details user interface that includes a detailed description of what the first media content is about, and/or one or more selectable user interface objects to perform different operations with respect to the first media content as described with reference to method 1300. In some embodiments, the electronic device is further configured to, in response to receiving the first input (as described with reference to method 1300), cease to display the map user interface of the map application and display the user interface of the first application that includes information about the first media content. In some embodiments, the electronic device is configured to display the user interface of the first application that includes information about the first media content as overlaid over the map user interface of the map application. For example, the user interface of the first application that includes information about the first media content is optionally concurrently displayed with the map user interface of the map application. Displaying a user interface of an application, different from the map application that includes information about the first media content enables a user to view details and perform more operations with respect to the first media content within the respective application, without the need for additional inputs for opening the application and searching for the first media content, thereby streamlining the process of interacting with the first media content within the respective application for which the first representation of the first media content had recently been presented in the map application by the electronic device.

In some embodiments, the user interface that includes information about the first media content includes a first selectable option that is selectable to display a representation of the first geographic area that is related to the first media content, such as media content user interface object 1248 in FIG. 211 in FIG. 12I, as will be described in more detail with reference to method 1500. In some embodiments, in response to receiving user input directed to the first selectable option, the electronic device displays the representation of the first geographic area that is related to the first media content in the map application. Displaying a selectable option to display the representation of the first geographic area that is related to the first media content simplifies the interaction between the user and the electronic device by reducing the number of inputs needed to navigate to the representation of the first geographic area that is related to the first media content when immediate action to return to map-related information is desired, which additionally reduces power usage and improves battery life of the electronic device by enabling the user to use the electronic device more quickly and efficiently.

In some embodiments, the user interface of the map application includes a representation of a map including the respective geographic area, and the first representation of the first media content or the second representation of the second media content is displayed concurrently with the respective geographic area in the representation of the map, such as representation 1227a in FIG. 12F. In some embodiments, the representation of the map includes one or more representations of POIs including the first representation of the first media content or the second representation of the second media content. In some embodiments, the first representation of the first media content or the second representation of the second media content is displayed concurrently with and/or overlaid upon the respective geographic area in the representation of the map. In some embodiments, the electronic device displays the first representation of the first media content or the second representation of the second media content concurrently with other representations of POIs that are not associated with media content. For example, the respective geographic area in the representation of the map optionally includes the first representation of the first media content, the second representation of the second media content, and landmarks, restaurants, buildings, or parks. In some embodiments, the other representations of POIs that are not associated with media content, first representation of the first media content and/or the second representation of the second media content are displayed at locations in the map corresponding to their respective POIs. In some embodiments, the first representation of the first media content and the second representation of the second media content are selectable to cause playback of the respective media content and/or display information related to the respective media content.

In some embodiments, the electronic device is configured to change a zoom level of the representation of the map including the respective geographic area. In some embodiments, the electronic device is configured to display different levels of detail of the first representation of the first media content or the second representation of the second media content based on the zoom level. For example, at a first zoom level, the representation of the map includes a movie poster of the first media content, and at a second zoom level, closer than the first zoom level, the representation of the map includes an image of a scene of the movie including content identifying the movie of the first media content associated with the respective geographic area. Concurrently displaying the representation of the media content with the respective geographic area in the representation of the map quickly and efficiently provides the user with both map information and media content information as the user interacts with the representation of the map (e.g., by automatically surfacing relevant media content as the user interacts with the representation of the map), which simplifies the interaction between the user and the electronic device and enhances the operability of the electronic device and makes the user-device interface more efficient.

In some embodiments, the user interface of the map application includes a selectable option that is selectable to filter display of a plurality of media content representations according to first filter criteria, and a selectable option that is selectable to filter display of the plurality of media content representations according to second filter criteria, different from the first filter criteria, wherein the plurality of media content representations includes the first representation of the first media content or the second representation of the second media content, such as shown by user interface 1276 where representations 1227a-1227f are associated with “Movies and TV Shows” in FIG. 12F. In some embodiments, filtering the display of the plurality of media content representations according to the first filter criteria and/or the second filter criteria is consistent but not limited to filtering the display of the plurality of media content representations according to the first filter criteria and/or the second filter criteria described in method 1300. In some embodiments, filtering the display of the plurality of media content representations according to the first filter criteria and/or the second filter criteria includes filtering the display of the plurality of media content representations according to the first filter criteria and/or the second filter criteria on the respective geographic area in the representation of the map described in method 1300. For example, when the first filter criteria is optionally based on a first type of media content (e.g., show only media content that includes movies and/or television shows), the electronic device displays the first representation of the first media content corresponding to a movie concurrently with and/or overlaid upon the respective geographic area in the representation of the map and ceases to display the second representation of the second media content corresponding to an electronic book such that the second representation of the second media content is not displayed concurrently with and/or overlaid upon the respective geographic area in the representation of the map. In some embodiments, the map includes other representations of POIs that are not associated with media content as described herein. For example, the electronic device is configured to filter the display of the other representations of POIs that are not associated with media content as described herein. Displaying selectable options to filter media content and displaying the results of the filtering on the respective geographic area in the representation of the map quickly and efficiently provides the user with both map information and media content information and reduces the cognitive burden on the user when filtering media content and provides a more tailored user interface that is less cluttered and includes more of the desired media content, which additionally reduces power usage and improves battery life of the electronic device by enabling the user to use the electronic device more quickly and efficiently.

In some embodiments, after displaying the user interface of the map application, the electronic device receives, via the one or more input devices, a second input that corresponds to a request to display a user interface of a first application, different from the map application, such as user interface 1252 in FIG. 12 For example, the first application is a media content application (e.g., music player application, television shows and film player application, electronic reader application, and/or podcasting application). In some embodiments, the first application is a time management and scheduling application, content editing application, and/or a messaging application. In some embodiments, the second input corresponding to the request to display the user interface of the first application is directed to a selectable user interface object that is associated with the first application. In some embodiments, the selectable user interface object is included within a user interface of the map user interface. In some embodiments, the selectable user interface object is included within a user interface of a different application from the map application. In some embodiments, the first application corresponds to any one of the applications described herein.

In some embodiments, in response to receiving the second input, the electronic device displays the user interface of the first application, including in accordance with a determination that the user interface of the first application satisfies one or more third criteria, the electronic device displays, in the user interface of the first application, a third representation of the first media content that is related to the first geographic area, such as representations in FIG. 12K displayed beneath content header 1253b. In some embodiments, the one or more third criteria include a criterion that is satisfied when the first application is configured to render, generate, or otherwise create the third representation of the first media content. In some embodiments, the electronic device operating the first application receives and/or retrieves one or more metadata attributes of the respective geographic area to generate the third representation of the first media content. In some embodiments, the third representation of the first media content includes one or more characteristics of the second information of the second user interface of the media application described in method 1300. In some embodiments, the third representation of the first media content includes one or more characteristics of the media content of the user interface of the media application described in more detail with reference to method 1500. In some embodiments, when the first application is an application other than a media application or a map application, the third representation of the first media content includes preview content (e.g., image and/or text) of the first media content that is optionally selectable to display the first media content within the associated application. In some embodiments, in accordance with a determination that the user interface of the first application does not satisfy the one or more third criteria, the electronic device does not display the third representation of the first media content that is related to the first geographic area.

In some embodiments, in response to receiving the second input, the electronic device displays the user interface of the first application, including in accordance with a determination that the user interface of the first application satisfies one or more fourth criteria, different from the one or more third criteria, the electronic device displays, in the user interface of the first application, a fourth representation of the second media content that is related to the second geographic area, such as representations in FIG. 12J displayed beneath content header 1250b. In some embodiments, the one or more fourth criteria include a criterion that is satisfied when the first application is associated with the first media content. In some embodiments, the fourth representation of the second media content related to the second geographic area includes one or more characteristics of the second information of the second user interface of the media application described in method 1300. In some embodiments, the fourth representation of the second media content includes one or more characteristics of the media content of the user interface of the media application described in more detail with reference to method 1500. In some embodiments, the electronic device operating the first application receives and/or retrieves one or more metadata attributes to generate the fourth representation of the second media content. In some embodiments, the electronic device displays representations of suggested media content, different from the third representation of the first media content and the fourth representation of the second media content, based on the one or more metadata attributes of the respective geographic area. In some embodiments, the electronic device suggests media content based on user queries. For example, the electronic device optionally suggests media content that is similar or related to the user queries. In some embodiments, the electronic device identifies media content to suggest based on matches to keywords in a user query. For example, if the user recently performed a search for “San Francisco” in the map application, the electronic device is optionally configured to suggest media content about San Francisco in the respective media content application (e.g., movies set in San Francisco, artists from San Francisco, and/or podcasts and/or electronic books based on San Francisco). In another example, if the user recently searched for “Italian food” in the map application, the electronic device is optionally configured to suggest media content related to Italy or food (e.g., cooking shows, travel guides about Italy, and/or Italian music). In some embodiments, the suggested media content is displayed in the respective media content application with other media content. In some embodiments, the other media content is not related to a geographic area and/or not related to prior interaction with the maps application (e.g., is included as a suggestion for reasons different or other than those reasons the geographic area-related content items are suggested). In some embodiments, the other media content includes media content the user has recently watched, read, and/or listed to; or media content the user has purchased or added; media content recently released; or media content featured by the respective media application. In some embodiments, the electronic device optionally determines that the respective geographic area is the first geographic area and that the first geographic area satisfies the one or more first criteria described in method 1300, and in response, the electronic device displays in the user interface of the first application a fifth representation of a third media content, different from the first media content, and related to the first geographic area. It is understood that although the embodiments described herein are directed to the first geographic area, such functions and/or characteristics, optionally apply to other geographic areas including the second geographic area. In some embodiments, the fourth representation of the second media content that is related to the second geographic area is selectable to initiate playback of the second media content and/or display information related to the second media content Displaying representations of media content related to a respective geographic area within a user interface of an application, different from the map application enables a user to view and access the media content in an application other than a media application or a map application and perform more operations with respect to the media content within the respective application, without the need for additional inputs for opening the application and searching for the first media content, thereby proactively populating the application with media content information which enables the user to use the electronic device more quickly and efficiently.

In some embodiments, the one or more first criteria and the one or more second criteria are satisfied based on a current location of the electronic device, such as location of the electronic device shown and described in FIG. 12M. As discussed with respect to method 1300, the one or more first criteria and the one or more second criteria are satisfied when the respective geographic area includes one or more POIs associated with media content. In some embodiments, the one or more first criteria are satisfied when the current location of the electronic device is within the first geographic area, and the one or more second criteria are satisfied when the current location of the electronic device is within the second geographic area. In some embodiments, the one or more first criteria and the one or more second criteria are satisfied based on a predefined starting location in the respective geographic area, independent of the current location of the electronic device. Displaying representations of media content related to a respective geographic area where the electronic device is currently located enables a user to view both map-related information and representations of media content at the same time and based on their current location, without having to leave the map application, thereby reducing the need for subsequent inputs to search for related media content at the current location of the electronic device which simplifies the interaction between the user and the electronic device and enhances the operability of the electronic device and makes the user-device interface more efficient.

In some embodiments, the one or more first criteria include criterion that is satisfied when one or more points of interest associated with first media content are within a threshold distance of the current location of the electronic device. In some embodiments, the one or more second criteria include criterion that is satisfied when one or more points of interest associated with the second media content are within the threshold distance of the current location of the electronic device, such as location of the electronic device shown and described in FIG. 12L. For example, detecting that the current location of the electronic device is optionally within a threshold distance, such as 1, 5, 10, 50, 100, 200, 500, 1000, 10000 or 100000 meters, of the one or more points of interest associated with first media content or the one or more points of interest associated with second media content. As described with reference to method 1300 the one or more points of interest include landmarks, public parks, structures, businesses, or other entities that are of interest to the user. In some embodiments, the one or more points of interest are associated with the first media content and/or the second media content based on one or more metadata attributes of the first media content or the second media and/or one or more metadata attributes of the one or more points of interest. For example, a first point of interest corresponding to a house is related to the first media content (e.g., television show “Full House”) because the first point of interest is the house where the family starring in the television show lived. In another example, a second point of interest corresponding to a music venue is related to the second media content (e.g., musical band “The Grateful Dead”) because the second point of interest is the music venue where the band first performed. Displaying representations of media content related to a point of interest within a respective geographic area where the electronic device is currently located enables a user to view both map-related information including the point of interest and representations of media content at the same time and based on their current location, without having to leave the map application, thereby reducing the need for subsequent inputs to search for related media content at the current location of the electronic device which simplifies the interaction between the user and the electronic device and enhances the operability of the electronic device and makes the user-device interface more efficient.

In some embodiments, the one or more first criteria and the one or more second criteria are satisfied based on a destination of current navigation instructions provided by the electronic device, such as destination “San Francisco” shown and described with reference to FIG. 12A. In some embodiments, the current navigation instructions correspond to a set of navigation directions from a first location to the destination. As discussed with respect to method 1300, the one or more first criteria and the one or more second criteria are satisfied when the respective geographic area includes one or more POIs associated with media content. In some embodiments, the one or more first criteria are satisfied when the destination (e.g., final destination or intermediate destination in a multi-stop route) is within the first geographic area, and the one or more second criteria are satisfied when the destination is within the second geographic area. Displaying representations of media content based on the destination of current navigation instructions enables a user to view both map-related information and representations of media content at the same time and based on the destination of the current navigation instructions, without having to leave the map application, thereby reducing the need for subsequent inputs to search for related media content at the destination of the current navigation instructions which simplifies the interaction between the user and the electronic device and enhances the operability of the electronic device and makes the user-device interface more efficient.

In some embodiments, while displaying the user interface of the map application and while providing the current navigation directions, such as content 1255 in FIG. 12L, in accordance with a determination that the one or more first criteria are satisfied, including a criterion that is satisfied when the destination of the current navigation directions is reached (e.g., within a threshold distance (e.g., e.g., 0.1, 0.3, 0.5, 1, 5, 10, 30, 50, 100, 200, 500, 1000, 10000 or 100000 meters) and the destination is associated with the first media content, the electronic device displays, in the user interface, the first representation of the first media content, such as notification 1258a in FIG. 12L. For example, the electronic device is optionally navigating along a route from a first location to the destination using the current navigation instructions displayed on the user interface of the map application. In some embodiments, when the electronic device detects arrival to the destination and the destination is associated with the first media content, the electronic device displays, in the user interface of the map application, an alert notification including the first representation of the first media content. In some embodiments, the electronic device displays the first representation of the first media content in the user interface of the map application absent the alert notification of the first representation of the first media content. In some embodiments, in accordance with a determination that the destination of the current navigation direction is not reached independent of the destination being associated with the first media content, the electronic device does not display the first representation of the first media content. In some embodiments, in accordance with a determination that the destination is not associated with the first media content independent of whether the destination is reached, the electronic device does not display the first representation of the first media content.

In some embodiments, while displaying the user interface of the map application and while providing the current navigation directions, in accordance with a determination that the one or more second criteria are satisfied, including a criterion that is satisfied when the destination of the current navigation directions is reached and the destination is associated with the second media content, the electronic device displays, in the user interface, the second representation of the second media content, such as notification 1263 in FIG. 12M. It is understood that although the embodiments described herein are directed to the first media content, such functions and/or characteristics, optionally apply to other media content including the second media content. In some embodiments, the second representation of the second media content is selectable to initiate playback of the second media content and/or display information associated with the second media content. Displaying representations of media content when the destination of current navigation directions is reached enables a user to view both map-related information and representations of media content at the same time and based on reaching the destination of the current navigation directions, without having to leave the map application, thereby reducing the need for subsequent inputs to search for related media content when the destination of the current navigation directions is reached which simplifies the interaction between the user and the electronic device and enhances the operability of the electronic device and makes the user-device interface more efficient.

In some embodiments, while displaying the user interface of the map application and while providing the current navigation directions, in accordance with a determination that the one or more first criteria are satisfied, including a criterion that is satisfied when the electronic device is a predetermined distance (e.g., 0.5, 1, 3, 5, 7, 10, 13, 15, 20, 50, 100, 200, 500, 1000, or 5000 meters) from the destination of the current navigation directions and the destination is associated with the first media content, the electronic device displays, in the user interface, the first representation of the first media content, such as representation 1256 in FIG. 12L.

In some embodiments, while displaying the user interface of the map application and while providing the current navigation directions, in accordance with a determination that the one or more second criteria are satisfied, including a criterion that is satisfied when the electronic device is a predetermined distance (e.g., 0.5, 1, 3, 5, 7, 10, 13, 15, 20, 50, 100, 200, 500, 1000, or 5000 meters) from the destination of the current navigation directions and the destination is associated with the second media content, displaying, in the user interface, the second representation of the second media content, such as representation 1261 in FIG. 12M. In some embodiments, in accordance with a determination that the electronic device is not the predetermined distance from the destination of the current navigation directions independent of the destination being associated with the second media content, the electronic device does not display the second representation of the second media content. In some embodiments, in accordance with a determination that the destination is not associated with the second media content independent of whether the electronic device is the predetermined distance from the destination of the current navigation directions, the electronic device does not display the second representation of the second media content. In some embodiments, the second representation of the second media content is selectable to initiate playback of the second media content and/or display information associated with the second media content. It is understood that although the embodiments described herein are directed to the second media content, such functions and/or characteristics, optionally apply to other media content including the first media content. Displaying representations of media content when the electronic device is a predetermined distance from the destination of the current navigation directions enables a user to view both map-related information and representations of media content at the same time and based on the electronic device being a predetermined distance from the destination of the current navigation directions, without having to leave the map application, thereby reducing the need for subsequent inputs to search for related media content when the electronic device is a predetermined distance from the destination of the current navigation directions which simplifies the interaction between the user and the electronic device and enhances the operability of the electronic device and makes the user-device interface more efficient.

In some embodiments, while displaying the user interface of the map application, receiving, via the one or more input devices, a sequence of inputs corresponding to a request to display information about the respective geographic area as part of initiating navigation directions including the respective geographic area, such as shown and described with reference to FIG. 12A. In some embodiments, in response to receiving the sequence of inputs, in accordance with a determination that the one or more first criteria are satisfied, including a criterion that is satisfied when the respective geographic area of the navigation directions is associated with the first media content, the electronic device displays, in the user interface, the first representation of the first media content, such as user interface container element 1215b in FIG. 12C. In some embodiments, the sequence of inputs corresponding to the request to display information about the respective geographic area as part of initiating navigation directions including the respective geographic area includes interactions to pan, navigate, or scroll through the respective geographic area. In some embodiments, the sequence of inputs is received before beginning to navigate along a route from a starting location for the route to a destination or during navigation. In some embodiments, the one or more first criteria are satisfied when the navigation instructions includes a destination (e.g., final destination or intermediate destination in a multi-stop route) or starting location that is within the respective geographic area associated with the first media content. In some embodiments, the one or more first criteria are satisfied when the navigation instructions includes a route that is within the respective geographic area associated with the first media content. In some embodiments, when the electronic device determines that the respective geographic area of the navigation directions is associated with the first media content, the electronic device displays, in the user interface of the map application, an alert notification including the first representation of the first media content. In some embodiments, the electronic device displays the first representation of the first media content in the user interface of the map application absent the alert notification of the first representation of the first media content. In some embodiments, in accordance with a determination that the respective geographic area of the navigation directions is not associated with the first media content, the electronic device does not display the first representation of the first media content. In some embodiments, the first representation of the first media content is selectable to initiate playback of the first media content and/or display information associated with the first media content.

In some embodiments, in response to receiving the sequence of inputs, in accordance with a determination that the one or more second criteria are satisfied, including a criterion that is satisfied when the respective geographic area of the navigation directions is associated with the second media content, the electronic device displays, in the user interface, the second representation of the second media content, such as fourth media content user interface object 1207d in FIG. 12B. It is understood that although the embodiments described herein are directed to the first media content, such functions and/or characteristics, optionally apply to other media content including the second media content. Displaying representations of media content as part of initiating navigation directions to a respective geographic enables a user to view both map-related information and representations of media content at the same time, without having to leave the map application, thereby reducing the need for subsequent inputs to search for related media content within the respective geographic area which simplifies the interaction between the user and the electronic device and enhances the operability of the electronic device and makes the user-device interface more efficient.

In some embodiments, a current physical location of the electronic device corresponds to the respective geographic area, such as the current location of the electronic device indicated and described with reference to FIGS. 12L and 12M. As used herein, the current physical location of the electronic device optionally refers to a location where the user is in physical form. In some embodiments, the current physical location of the electronic device is an actual physical location remote from the user. In some embodiments, the one or more first criteria are satisfied when the current physical location of the electronic device is within the respective geographic area, and the one or more second criteria are satisfied when the current physical location of the electronic device is within the respective geographic area. Displaying representations of media content related to a respective geographic area where a user of the electronic device is physically located enables a user to view both map-related information and representations of media content at the same time and based on their current physical location, without having to leave the map application, thereby reducing the need for subsequent inputs to search for related media content at their current physical location which simplifies the interaction between the user and the electronic device and enhances the operability of the electronic device and makes the user-device interface more efficient.

In some embodiments, a current physical location of the electronic device does not correspond to the respective geographic area, such as a location in FIG. 12O that is optionally remote from the user of the electronic device. For example, a physical location remote from the user optionally corresponds to the respective geographic area. In some embodiments, the one or more first criteria are satisfied when a location that the user has navigated to in the maps application (e.g., via user input to zoom and/or pan, optionally without or independent of the physical location of the electronic device being in the respective geographic area) is within the respective geographic area, and the one or more second criteria are satisfied when the location that the user has navigated to is within the respective geographic area. Displaying representations of media content related to a respective geographic area where a user of the electronic device is remote from a physical location within the respective geographic area enables a user to view both map-related information and representations of media content at the same time, without having to leave the map application and be physically at the location within the respective geographic area, thereby reducing the need for subsequent inputs to search for related media content at the location within the respective geographic area which simplifies the interaction between the user and the electronic device and enhances the operability of the electronic device and makes the user-device interface more efficient.

In some embodiments, wherein providing the current navigation directions to the destination includes presenting spatial audio from a direction corresponding to a respective direction associated with a respective media content that is related to the destination (as if a source of the spatial audio is optionally located at the destination), wherein one or more characteristics of the spatial audio change in response to detecting that the spatial arrangement of the electronic device relative to the destination changes, such as represented by graphic 1266 in FIG. 12M. In some embodiments, the one or more characteristics of the spatial audio relate to pitch, loudness, and/or different tones to provide directional information. In some embodiments, as the electronic device moves with respect to the destination causing a distance and/or direction between the electronic device and the destination to change, the one or more characteristics of the spatial audio gradually changes accordingly. For example, a tone sequence or sound associated with the respective media content is optionally presented by the electronic device with increasing volume and/or frequency as the electronic device moves closer and in the direction of the destination. In some embodiments, presenting spatial audio includes a haptic or tactile output. In some embodiments, presenting spatial audio from the direction corresponding to the respective direction associated with the respective media content includes generating the spatial audio as if emanating from a location (e.g., relative to the physical location of the electronic device) corresponding to the respective media content. Presenting a spatial audio indication of the direction of the respective media content related to the destination enhances user interactions with the electronic device by providing improved feedback to the user to start or during navigation, such as assisting visually-impaired users with traveling to the destination associated with the respective media content.

In some embodiments, wherein displaying the user interface of the map application includes, in accordance with a determination that the respective geographic area is a landmark, displaying, concurrently with the first or second representations, a three-dimensional map of the landmark, such as landmark 1268 in FIG. 12N. In some embodiments, the three-dimensional map of the landmark has more detail or is a higher quality rendering (e.g., three-dimensional vs. two-dimensional) of the landmark. In some embodiments, the first representation of the first media content or the second representation of the second media content is displayed concurrently with and/or overlaid upon the three-dimensional map of the landmark. In some embodiments, the electronic device receives user input corresponding to a request to pan and/or zoom within the three-dimensional map of the landmark, and in response to the user input, the electronic device pans and/or zooms within the three-dimensional map in accordance with the user input. In some embodiments, the three-dimensional map includes one or characteristics and/or features described with reference to method 700. Displaying a three-dimensional map experience including representations of media content related to the landmark allows the user to view details about such physical landmarks without being present in person at those physical geographic areas.

In some embodiments, displaying the three-dimensional map of the landmark includes displaying a first location of the landmark including a third representation of a third media content that is related to the first location of the landmark, such as representations 1220a-1220f and 1223a-1223f in FIG. 12D. In some embodiments, while displaying the user interface of the map application including the three-dimensional map of the landmark, the electronic device receives, via the one or more input devices, a second input that corresponds to a request to change the display of the three-dimensional map of the landmark to display a portion of the three-dimensional map that corresponds to a second location of the landmark, different from the first location of the landmark, such as contact 1202 in FIG. 12D. For example, the request to change the display of the three-dimensional map of the landmark to display the portion of the three-dimensional map that corresponds to the second location of the landmark, different from the first location of the landmark optionally indicates that the user is no longer viewing or interacting with the first location of the landmark. As will be described herein, the electronic device optionally determines if the second location is associated with media content. In some embodiments, the request to change the display of the three-dimensional map of the landmark includes user input to pan, zoom, and/or rotate the three-dimensional map.

In some embodiments, in response to the second input, in accordance with a determination that one or more third criteria are satisfied, including a criterion that is satisfied when the second location of the landmark is associated with a fourth media content, the electronic device ceases to display, in the user interface, the third representation of the third media content, such as shown by user interface element 1228 in FIG. 12F where the electronic device ceases to display representations associated with “Music”. In some embodiments, the electronic device displays, concurrently with the portion of the three-dimensional map of the landmark that corresponds to the second location, a fourth representation of the fourth media content, such as representations 1227a-1227f corresponding to representations 1229a-1229f associated with “Movies and TV Shows” in FIG. 12F. In some embodiments, the change from displaying the first location of the landmark to displaying the second location of the landmark causes the electronic device to transition from displaying the third representation of the third media content to displaying the fourth representation of the fourth media content concurrently with and/or overlaid upon the three-dimensional map of the landmark. In some embodiments, when the electronic device detects that the second location of the landmark is not associated with the fourth media content, the electronic device continues to display the third representation of the third media content and does not display the fourth representation of the fourth media content. In some embodiments, the fourth representation of the fourth media content is selectable to initiate playback of the fourth media content and/or display information associated with the fourth media content. Automatically displaying the fourth representation of the fourth media content in response to the change from displaying the first location of the landmark to displaying the second location of the landmark avoids additional interaction between the user and the electronic device associated with searching for related media content at the second location of the landmark when seamless transition between locations of the landmark is desired, thereby reducing errors in the interaction between the user and the electronic device and reducing inputs needed to correct such errors.

In some embodiments, while displaying the user interface of the map application, in accordance with a determination that a current context of the electronic device satisfies one or more third criteria, the electronic device displays, in the user interface, a third representation of a third media content that is related to the respective geographic area and the current context of the electronic device that satisfies the one or more third criteria, such as user interface element 1279 related to the geographic area displayed in user interface 1267 in FIG. 12P. In some embodiments, the one or more third criteria includes a criterion that is satisfied when the current context indicates a start of an activity associated with the respective geographic area and that the respective geographic area is associated with the third media content. For example, the current context of the electronic device optionally corresponds to the electronic device arriving at a specified destination (e.g., Oracle Park) that is associated with the third media content (e.g., video about the history of Oracle Park), and the current context of the electronic device that is displayed indicates arrival at Oracle park. In some embodiments, the third representation of the third media content is selectable to initiate playback of the third media content and/or display information associated with the third media content.

In some embodiments, while displaying the third representation of the third media content that is related to the respective geographic area and the current context of the electronic device that satisfies the one or more third criteria, the electronic device detects, via the one or more input devices, a change to the current context of the electronic device, such as, for example, navigating to a geographic area that is away from the geographic area displayed in user interface 1267 in FIG. 12P. In some embodiments, the change in contextual information indicates a change in location of the electronic device, a change in motion of the electronic device, and/or a change in user engagement with the electronic device.

In some embodiments, in response to detecting the change in the current context of the electronic device, in accordance with a determination that the changed current context of the electronic device satisfies one or more fourth criteria, the electronic device ceases to display, in the user interface, the third representation of the third media content that is related to the respective geographic area and the current context of the electronic device that satisfies the one or more third criteria, such as for example, ceasing to display user interface element 1279 in FIG. 12P. For example, the one or more fourth criteria include a criterion that is satisfied when the changed current context of the electronic device indicates a change from a first geographic area to a second geographic area, different from the first geographic area; a change in movement from a first speed of the electronic device to a second speed greater or less than the first speed; a change in user interaction with the electronic device from a first degree of engagement to a second degree of engagement greater or less than the first degree of engagement.

In some embodiments, in response to detecting the change in the current context of the electronic device, in accordance with a determination that the changed current context of the electronic device satisfies one or more fourth criteria, the electronic device displays, in the user interface, a fourth representation of a fourth media content that is related to the respective geographic area and the changed current context of the electronic device that satisfies the one or more fourth criteria, such as for example, content 1231 associated with the geographic area displayed in user interface 1276 in FIG. 12G. In some embodiments, the change from displaying the third media content that is related to the respective geographic area and the current context of the electronic device causes the electronic device to transition from displaying the third media content that is related to the respective geographic area and the current context of the electronic device to displaying the fourth media content that is related to the respective geographic area and the changed current context of the electronic device concurrently with and/or overlaid upon the user interface of the map application. In some embodiments, when the electronic device detects that the changed current context of the electronic device does not satisfy the one or more fourth criteria, the electronic device continues to display the third representation of the third media content that is related to the respective geographic area and the current context of the electronic device. In some embodiments, the fourth representation of the fourth media content is selectable to initiate playback of the fourth media content and/or display information associated with the fourth media content. Automatically displaying the fourth representation of the fourth media content in response to the changed current context of the electronic device avoids additional interaction between the user and the electronic device associated with searching for related media content in response to the changed current context of the electronic device when seamless transition between presenting media content is desired, thereby reducing errors in the interaction between the user and the electronic device and reducing inputs needed to correct such errors.

It should be understood that the particular order in which the operations in method 1300 and/or FIG. 13 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 13 are, optionally, implemented by components depicted in FIGS. 1A-1B. For example, displaying operations 1302a, 1302c, and 1302e, and receiving operation 1302f, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

User Interfaces for Displaying Supplemental Map Information in a Media Content Application

Users interact with electronic devices in many different manners. In some embodiments, an electronic device presents media content within a media content user interface of a media content application. In some embodiments, while presenting the media content, the electronic device detects that the media content is associated with map information. The embodiments described below provide ways in which an electronic device presents map-related information to the media content within a same user interface as the media content user interface. Presenting both map-related information and media content at the same time, without having to navigate away from the media content application reduces the need for subsequent inputs to display related map-related information, thus enhancing the user's interaction with the device. Enhancing interactions with a device reduces the amount of time needed by a user to perform operations, and thus reduces the power usage of the device and increases battery life for battery-powered devices. Presenting map-related information in the media content application and providing the ability to interact with the map-related information to cause the user interface to display map information about the media content provides quick and efficient access to related map information without the need for additional inputs for searching for related map information and avoids erroneous inputs related to searching for map information. It is understood that people use devices. When a person uses a device, that person is optionally referred to as a user of the device.

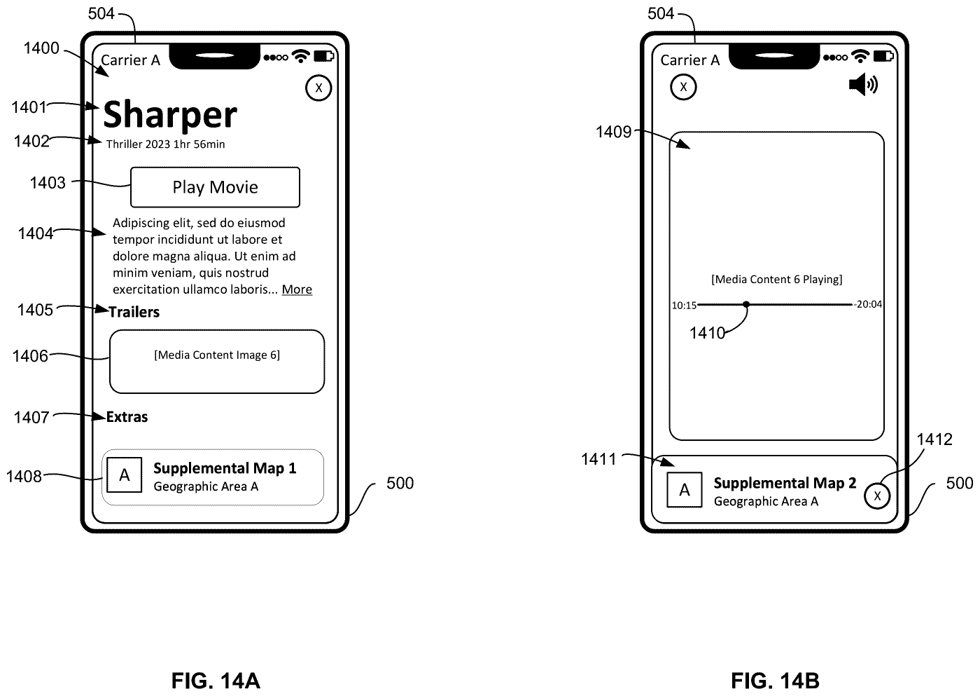

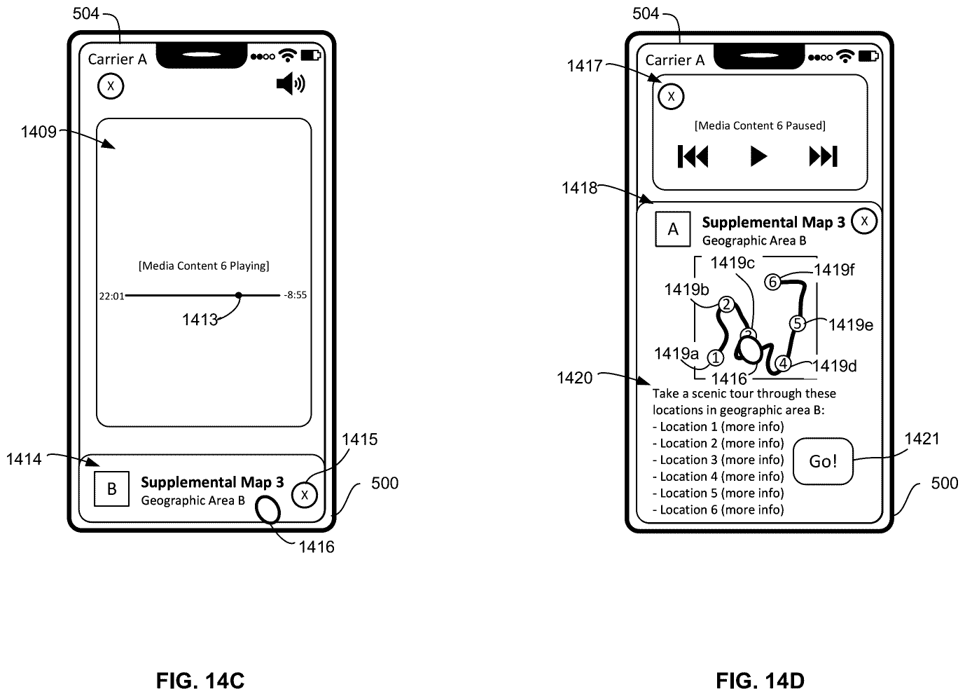

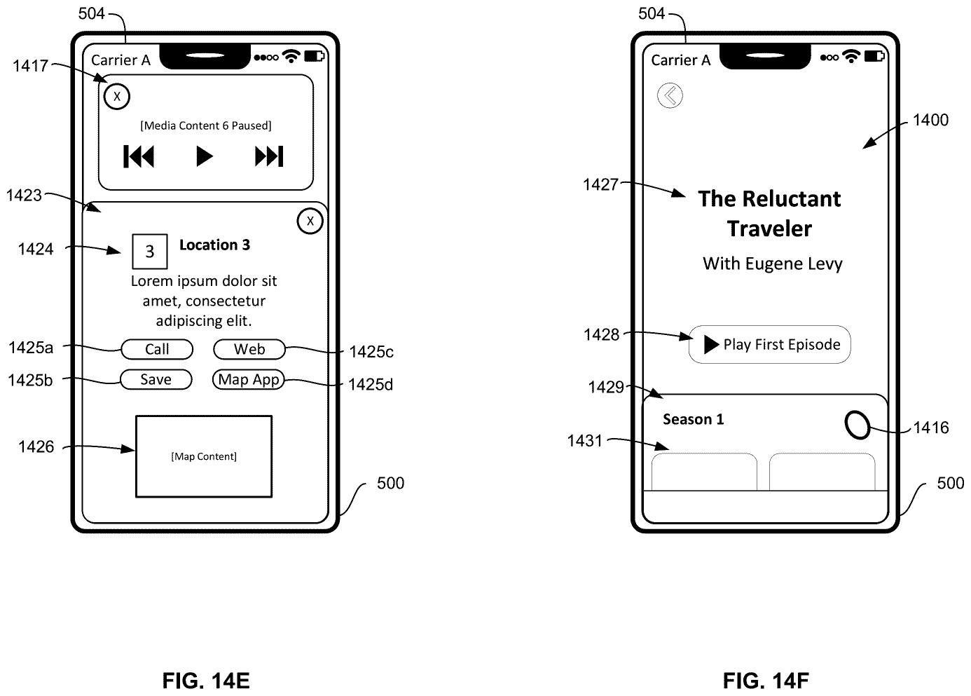

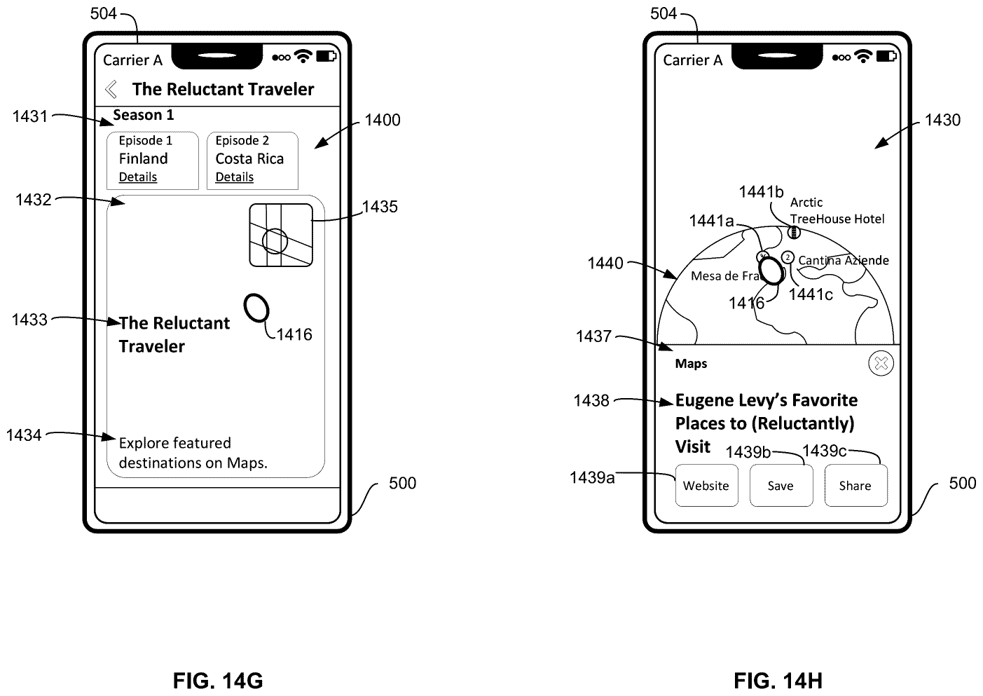

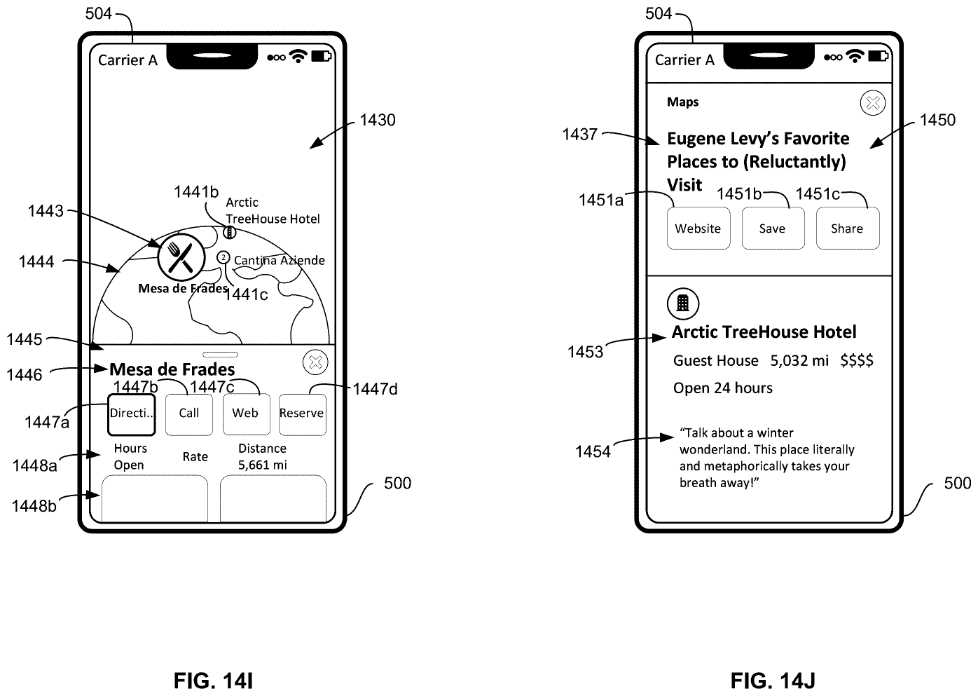

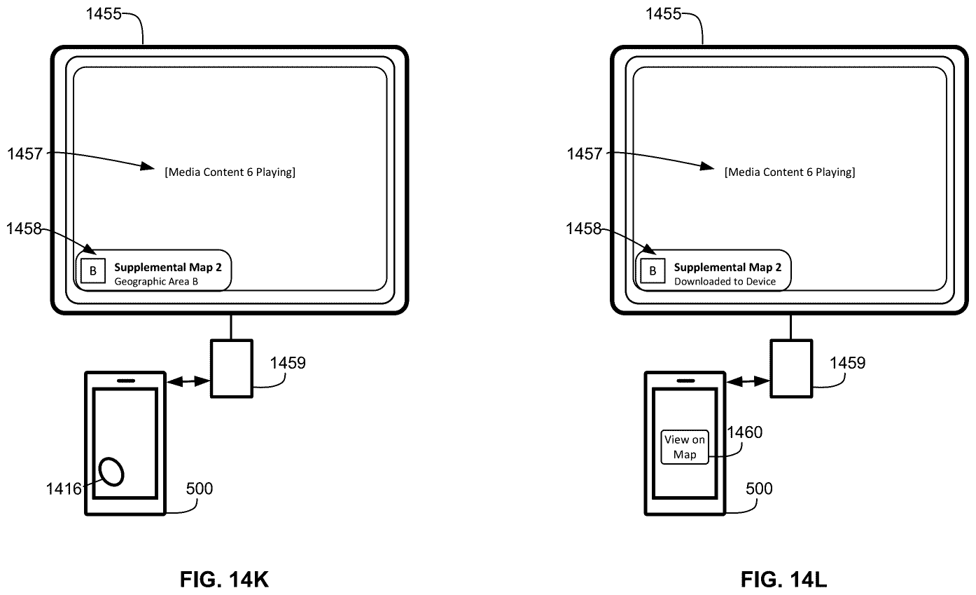

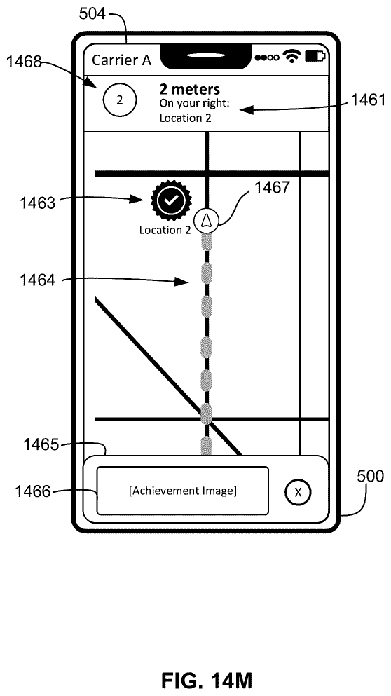

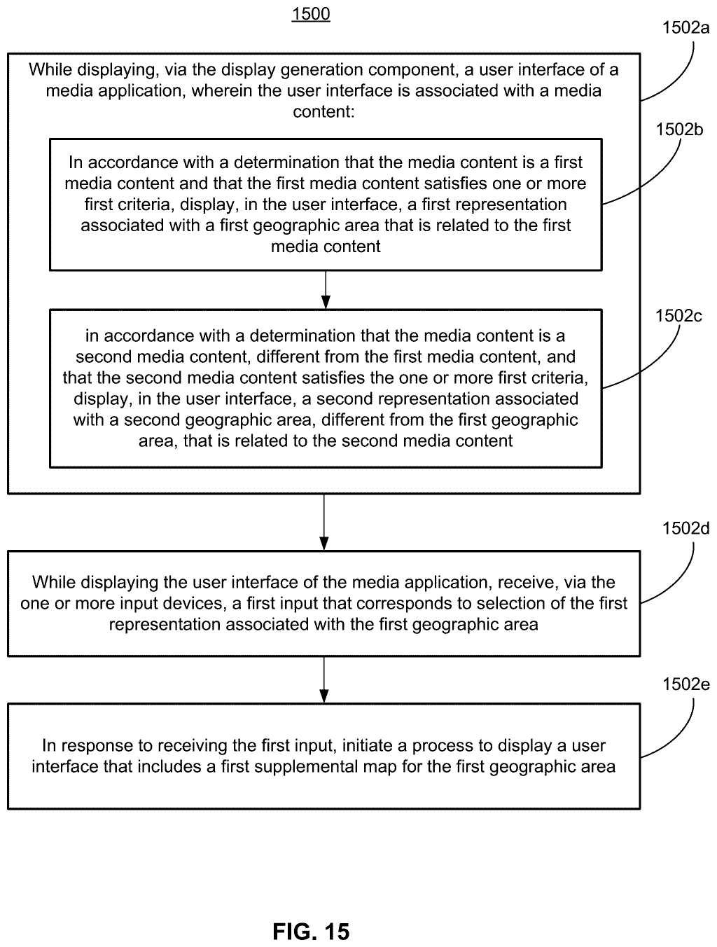

FIGS. 14A-14M illustrate exemplary ways in which an electronic device displays map information in a media content application. The embodiments in these figures are used to illustrate the processes described below, including the processes described with reference to FIG. 15. Although FIGS. 14A-14M illustrate various examples of ways an electronic device is able to perform the processes described below with respect to FIG. 15, it should be understood that these examples are not meant to be limiting, and the electronic device is able to perform one or more processes described below with reference to FIG. 15 in ways not expressly described with reference to FIGS. 14A-14M.

FIG. 14A illustrates electronic device 500 displaying a user interface. In some embodiments, the user interface is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

As shown in FIG. 14A, the electronic device 500 presents media content user interface 1400 of a media content application (e.g., a streaming service application). In some embodiments, the media content user interface 1400 includes information about the respective media content and selectable user interface elements, that when selected, causes the electronic device 500 to initiate operations associated with the respective media content (e.g., cause playback, initiate a purchase, or another action) as described with reference to methods 1300 and/or 1500. In FIG. 14A, media content user interface 1400 includes media content information comprising a title of the media content (e.g., representation 1401), a short description of the media content (e.g., representation 1402), a storyline description of the media content (e.g., representation 1404), media content user interface object (e.g., representation 1403) that, when selected causes the electronic device 500 to initiate playback of the media content, and media content user interface element comprising an image related to the media content (e.g., representation 1406) that, when selected, causes the electronic device 500 to display more information and/or initiate playback of a commercial advertisement or short preview of media content related to the media content. In FIG. 14A, representation 1406 is located under a media content header (e.g., representation 1405). Media content user interface 1400 also includes a supplemental map user interface object comprising a description of and/or icon of the supplemental map (e.g., representation 1408) that, when selected, causes the electronic device to initiate a process to display a supplemental map as described herein and with reference to methods 1300, 1500, and/or 1700. In some embodiments, media content user interface 1400 includes other media content information and/or user interface elements selectable to perform other operations as described with reference to methods 1300 and/or 1500. In some embodiments, the electronic device 500 detects user input (e.g., a contact on a touch-sensitive surface, actuation of a physical input device of the electronic device 500 or in communication with the electronic device 500, and/or a voice input from the user) corresponding to selection of the supplemental map user interface object (e.g., representation 1408), and in response, the electronic device 500 displays a supplemental map associated with the media content in a user interface of map application as described with reference to method 1300 or a supplemental map within the media content user interface 1400 as illustrated in the subsequent figures and with reference to method 1500.

In some embodiments, and as will be described in FIG. 14B, the electronic device surfaces one or more supplemental maps in response to (or while) media content is playing. For example, in FIG. 14A, the electronic device 500 detects user input (e.g., a contact on a touch-sensitive surface, actuation of a physical input device of the electronic device 500 or in communication with the electronic device 500, and/or a voice input from the user) corresponding to selection of the media content user interface object (e.g., representation 1403), and in response, the electronic device 500 initiates playback of the media content as shown in FIG. 14B. In some embodiments, the electronic device 500 surfaces map information during playback of the media content at electronic device 500 as described with reference to method 1500. For example, in FIG. 14B, while the media content is playing (e.g., representation 1409), the electronic device 500 determines that playback of the media content has reached a predetermined point of time (e.g., representation 1410), and in response, the electronic device 500 displays a notification of a supplemental map associated with the media content (e.g., representation 1411). In FIG. 14B, the notification includes a description of and/or icon of the supplemental map and a user interface object 1412, that, when selected, causes the electronic device 500 to close the notification. In some embodiments, the supplemental map associated with the notification displayed in FIG. 14B (e.g., representation 1411) is the same as the supplemental map associated with the media content user interface 1400 displayed in FIG. 14a.

In some embodiments, a variety of supplemental maps are presented in response to playback of the media content reaching different predetermined points of time. For example, in FIG. 14C, while the electronic device 500 continues playing the media content (e.g., representation 1409), the electronic device determines that playback of the media content has reached a second predetermined point of time (e.g., representation 1413), different from the predetermined point of time in FIG. 14B (e.g., representation 1410), and in response, the electronic device 500 displays a notification of a supplemental map associated with the media content (e.g., representation 1414) comprising a description of and/or icon of the supplemental map and a user interface object 1415, that, when selected, causes the electronic device 500 to close the notification. In some embodiments, the supplemental map associated with the notification displayed in FIG. 14C (e.g., representation 1414) is different from the supplemental map associated with the notification displayed in FIG. 14B. For example, in some embodiments, the electronic device 500 displays said notifications when playback of the media content has reached a respective point of time in which an event in the media content stream is related to the respective supplemental map as described with reference to methods 1300 and/or 1500.

In some embodiments, displaying said notifications of respective supplemental maps associated with the media content does not stop playback of the media content. In some embodiments, the electronic device 500 temporarily displays said notifications for a predetermined period of time (e.g., 0.5 seconds, 1 minute, 2 minutes, 3 minutes, 4 minutes, or 5 minutes) before removing said notifications. In some embodiments, the respective supplemental maps of the respective notifications are displayed in the media content user interface 1400 as the supplemental map user interface object (e.g., representation 1408) in FIG. 14A.

In some embodiments, supplemental map information is displayed in the media content user interface. For example, in FIG. 14C, the electronic device 500 detects user input (e.g., contact 1416) directed to the notification of the supplemental map associated with the media content (e.g., representation 1414), and in response, the electronic device displays a supplemental map user interface element (e.g., representation 1418 in FIG. 14D) without navigating away from the media content user interface and/or displaying a map user interface of a map application. In some embodiments, in response to detecting the user input directed to the notification of the supplemental map associated with the media content (e.g., representation 1414), the electronic device pauses playback of the media content (e.g., representation 1417). In some embodiments, the electronic device does not pause playback of the media content. In FIG. 14D, the supplemental map user interface element includes map information, such as a description of and/or icon of the supplemental map, user interface location objects in the supplemental map (e.g., representations 1419a-f) that, when selected causes the electronic device 500 to display location information associated with the user interface location object. In FIG. 14D, the supplemental map user interface element further includes information about each of the locations in the supplemental map (e.g., representation 1420) and a user interface object (e.g., 1421) that, when selected, causes the electronic device 500 to initiate navigation directions along a route that includes the locations in the supplemental map.

In some embodiments, location information associated with the supplemental map is displayed in the media content user interface. In some embodiments, the location is a business, a landmark, public park, structure, or other entity featured in the supplemental map. In FIG. 14D, the electronic device 500 detects user input (e.g., contact 1416) directed at user interface location object (e.g., representation 1419c), and in response, the electronic device displays a location user interface element (e.g., representation 1423 of FIG. 14E) without navigating away from the media content user interface and/or displaying a map user interface of a map application. In FIG. 14E, the location user interface element includes location information, such as a description of and/or icon of the location, user interface location objects (e.g., representations 1425a-d) that, when selected causes the electronic device 500 to initiate communication with the location (e.g., representation 1425a), save the location (e.g., representation 1425b) to a favorites container of the media content user interface or other user interface, such as a map user interface described with reference to methods 1300 and/or 1700, open a webpage corresponding to the location (e.g., representation 1425c), or open the map user interface including the supplemental map representing an area associated with the location as described with reference to methods 1300 and/or 1700. FIG. 14E further displays the location user interface element including a location image or other content related to the location (e.g., representation 1426).

FIGS. 14F-14J illustrate another example of presenting map information in a media content user interface. As shown in FIG. 14F, the electronic device 500 presents media content user interface 1400 of a media content application (e.g., a streaming service application). In some embodiments, the media content user interface 1400 includes information about the respective media content and selectable user interface elements, that when selected, causes the electronic device 500 to initiate operations associated with the respective media content (e.g., cause playback or another action) as described with reference to methods 1300 and/or 1500. In FIG. 14F, media content user interface 1400 includes media content information comprising a title of the media content (e.g., representation 1427), media content user interface object (e.g., representation 1428) that, when selected causes the electronic device 500 to initiate playback of the media content, and media content user interface element (e.g., representation 1429) comprising media content user interface objects (e.g., representation 1431) that, when selected, causes the electronic device 500 to display a particular episode of the media content. In FIG. 14F, media content user interface element (e.g., representation 1429) is displayed as half expanded. In some embodiments, media content user interface element (e.g., representation 1429) is displayed as fully expanded as shown in FIG. 14G. For example, in FIG. 14F, the electronic device 500 detects user input 1416 (e.g., a contact on a touch-sensitive surface, actuation of a physical input device of the electronic device 500 or in communication with the electronic device 500, and/or a voice input from the user) corresponding to selection of the media content user interface element (e.g., representation 1429), and in response, the electronic device 500 displays media content user interface 1400 including a fully expanded media content user interface element (e.g., representation 1429). In FIG. 14F, the fully expanded media content user interface element (e.g., representation 1429) includes a full view of media content user interface objects (e.g., representation 1431) compared to a partial view of media content user interface objects (e.g., representation 1431) in FIG. 14F. In FIG. 14G, the fully expanded media content user interface element (e.g., representation 1429) also includes map user interface element 1432 that, when selected causes the electronic device 500 to display a map user interface of the map application as will be described with reference to FIG. 14H. In FIG. 14G, the map user interface element 1432 includes an icon 1435 representing the map application, the title of the media content (e.g., representation 1433), and content (representation 1434) describing that, the map user interface element 1432 provides an interface to explore featured destinations/locations of the media content on a map user interface of the mapping application. For example, in FIG. 14G, the electronic device 500 detects user input (e.g., contact 1416) directed to the map user interface element 1432, and in response, the electronic device 500 displays a map user interface 1430 of the map application as shown in FIG. 14H without user input to navigate away from the media content user interface to the particular supplemental map associated with the media content displayed on the map user interface of the map application. In this case, the electronic device 500 automatically navigates from the media content user interface 1400 of the media content application as shown in FIG. 14G to the map user interface 1430 of the map application as shown in FIG. 14H in response to the user input (e.g., contact 1416) directed to the map user interface element 1432. In some embodiments, automatically navigating from the media content user interface 1400 of the media content application to the map user interface 1430 of the map application includes ceasing display of the media content user interface 1400 of the media content application and/or displaying the map user interface 1430 of the map application as overlaid over the media content user interface 1400 of the media content application.

In FIG. 14H, the map user interface 1430 includes a user interface map object corresponding to a globe 1440 and a user interface map element 1437. The map user interface map element 1437 includes a description (e.g., representation 1438) of the supplemental map including a reference to the media content and map user interface objects (e.g., representations 1439a-1439c) that, when selected cause the electronic device 500 to open a webpage corresponding to the location (e.g., representation 1439a), save the supplemental map (e.g., representation 1439b) to a favorites container of the map user interface or other user interface, such as a media content user interface described with reference to methods 1300 and/or 1500, or share the supplemental map to a second electronic device, different from the electronic device 500, or an application other than the map application, such as an email application, a notepad application, journal application, or other application configured to access the supplemental map. In FIG. 14H, the user interface map object corresponding to the globe 1440 includes one or more locations (e.g., representations 1441a-1441c) featured in the media content that, when selected cause the electronic device 500 to display information about the particular location. For example, in FIG. 14H, the electronic device 500 detects user input (e.g., contact 1416) directed to representation 1441a, and in response, the electronic device 500 displays map user interface element 1445 and the electronic device 500 optionally rotates the globe 1440 to center on the selected location (e.g., representation 1443). In FIG. 14H, the electronic device 500 displays representation 1443 visual emphasized (e.g., larger, bolder, and/or highlighted) compared to the other representations.

In FIG. 14I, the map user interface element 1445 includes information about the location corresponding to representation 1443. Map user interface element 1445 is displayed as half expanded and includes information about a business “Mesa de Frades”, such as hours of operation, business rating, and distance from the electronic device 500 (e.g., representation 1448). The map user interface element also includes one or more images or media content associated with the business (e.g., representation 1448b). In FIG. 14I, the map user interface element 1445 also includes user interface map objects (e.g., representations 1447a-1447d) that, when selected cause the electronic device to initiate navigation directions to the business (e.g., representation 1447a), initiate communication with the business (e.g., representation 1447b), open a webpage corresponding to the business (e.g., representation 1425c), or initiate a process to make a reservation at the business (e.g., 1447d).

In some embodiments, the electronic device displays a listing of the locations associated with representations 1447a-1447d in FIG. 14I. For example, the electronic device 500 displays map user interface 1451 in FIG. 14J that is scrollable to view all the locations associated with representations 1447a-1447d in FIG. 14I. In some embodiments, the electronic device 500 navigates to map user interface 1450 in response to detecting user input directed to user interface map element 1437 in FIG. 14H. In FIG. 14H, the user interface map element 1437 is displayed as half expanded, and in FIG. 14J, the user interface map element 1437 is displayed as fully expanded to include information about the locations featured in the media content represented by the user interface element map element 1437. For example, in FIG. 14J, the map user interface 1450 includes location 1453 corresponding to representation 1441b in FIG. 14I. In FIG. 14J, the location 1453 includes content describing the location (e.g., representation 1454).

In some embodiments, the electronic device 500 surfaces map information during playback of the media content at a second electronic device, different from the electronic device 500 as described with reference to method 1500. For example, FIG. 14K illustrates electronic device 500 in communication with second electronic device 1459. In some embodiments, the second electronic device 1459 is a set-top box connected to television display 1455. In FIG. 14K, the second electronic device 1459 displays, on display 1455, media content 1457. In some embodiments, while the media content 1457 is playing, a notification (e.g., representation 1458) of a supplemental map that is associated with the media content 1457 is displayed on display 1455. In some embodiments, representation 1458 has one or more characteristics similar to or corresponding to representation 1411 in FIG. 14B. In some embodiments, in response to the electronic device 500 detecting user input (e.g., contact 1416) corresponding to a request to display the supplemental map of the notification (e.g., representation 1458), the electronic device 500 displays, via the television display 1455 the supplemental map, such as the supplemental map displayed in FIG. 14H or a supplemental map as described with reference to method(s) 1300, 1500, and/or 1700.

Additionally or alternatively, in response to detecting the user input (e.g., contact 1416) corresponding to a request to display the supplemental map of the notification (e.g., representation 1458), the electronic device 500 initiates an operation to download the supplemental map to the electronic device as indicated by representation 1458 in FIG. 14L. In FIG. 14L, the electronic device 500 displays a notification (e.g., representation 1460) that the supplemental map is downloaded and available to be viewed on the electronic device 500.

In some embodiments, the electronic device 500 displays representations of achievements when the electronic device 500 is at a location featured in the media content. For example, in FIG. 14M, the electronic device 500 displays a navigation user interface 1468 including navigation directions to a location (representation 1463) associated with the media content. In some embodiments, displaying the navigation directions includes displaying a representation of the route line 1464, a current location of the electronic device 500 (e.g., representation 1467), and information related to an upcoming maneuver (e.g., representation 1461). In FIG. 14M, when the electronic device 500 determines that the electronic device 500 is at the representation 1463, the electronic device 500 displays a notification (e.g., representation 1465) including an image of the achievement (e.g., representation 1466). The achievement is described in more detail with reference to method 1500.

FIG. 15 is a flow diagram illustrating a method for displaying map information in a media content application. The method 1500 is optionally performed at an electronic device such as device 100, device 300, device 500 as described above with reference to FIGS. 1A-1B, 2-3, 4A-4B and 5A-5H. Some operations in method 1500 are, optionally combined and/or the order of some operations is, optionally, changed.

In some embodiments, method 1500 is performed at an electronic device (e.g., 500) in communication with a display generation component (e.g., 504) and one or more input devices. In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 1500 is performed at or by an automobile (e.g., at an infotainment system of an automobile having or in communication with one or more display generation components and/or input devices).

In some embodiments, while displaying (1502a), via the display generation component, a user interface of a media application, wherein the user interface is associated with a media content, such as media content user interface 1400 in FIG. 14A. In some embodiments, the media application is a music, video, podcast, electronic publication, or audiobook application. In some embodiments, media content such as an audio book, a podcast, a video, a movie, or a tv show is played using a media application. In some embodiments, the user interface is a media content overview user interface for one or more media contents. For example, when the media application is a video streaming application, the media content overview user interface includes a plurality of representations associated with a plurality of tv shows and/or movies. In some embodiments, the media content overview user interface includes the plurality of representations organized by genre, popularity, and/or geographic area as will be described in detail with reference to method 1500. In some embodiments, the user interface is a media content details user interface for one or more media contents. For example, when the media application is a music application, the media content details user interface includes details about a music album, artist, or playlist, such as a list of songs, music videos, related albums, and/or any information associated with the media content.

In some embodiments, in accordance with a determination that the media content is a first media content and that the first media content satisfies one or more first criteria (e.g., the first media content is associated with a geographic area as described herein and with reference to method 1300), the electronic device displays (1502b), in the user interface, a first representation associated with a first geographic area that is related to the first media content, such as representation 1408 in FIG. 14A. In some embodiments, the first media content includes metadata, such as titles, artist names, set location, songs, historical events, points of interest, and/or other information related to the first geographic area. In some embodiments, the metadata is timed into the first media content (e.g., timed metadata associated with a video track). For example, metadata is optionally available at a point in the playback of the video track. In some embodiments, the one or more first criteria include a criterion that is satisfied when playback has reached a point of time in which an event in the video track or media stream is related to the first media content. For example, an event is optionally defined by when a point of interest is included in a scene of a media stream or when a location is mentioned in a song or podcast.

In some embodiments, the one or more first criteria being satisfied is independent from playing the first media content to the point in time at which the event occurred. In some embodiments, the electronic device utilizes the metadata about the first media content for use in one or more applications, different from the media application (e.g., a map application as described with reference to methods 700, 900, 1100, 1300, 1500, and/or 1700). In some embodiments, the first representation of the first geographic area related to the first media content includes first map data such as a first set of streets, highways, and/or one or more first points of interest (e.g., landmark, public park, structure, business, or other entity that is of interest to the user). In some embodiments, the first representation of the first geographic area related to the first media content is displayed within the user interface of the media application. More details with regards to the first representation of the first geographic area are described with reference to method 1500. In some embodiments, when the first media content does not satisfy the one or more first criteria, the electronic device does not display, in the user interface, the first representation of the first geographic area that is related to the first media content. In some embodiments, the first representation associated with the first geographic area that is related to the first media content includes, is and/or has one or more characteristics of a supplemental map associated with the first geographic area, such as described with reference to methods 700, 900, 1100, 1300, 1500, and/or 1700.

In some embodiments, in accordance with a determination that the media content is a second media content, different from the first media content, and that the second media content satisfies the one or more first criteria, the electronic device displays (1502c), in the user interface, a second representation associated with a second geographic area, different from the first geographic area, that is related to the second media content, such as representation 1411 in FIG. 4B. In some embodiments, the second representation associated with the second geographic area that is related to the second media content includes, is and/or has one or more characteristics of a supplemental map associated with the second geographic area that is different or the same as the supplemental map associated with the first representation. Characteristics of supplemental maps are described with reference to methods 700, 900, 1100, 1300, 1500, and/or 1700. In some embodiments, the second media content and the first media content are associated with an episodic series of media content. For example, the second media content is associated with a second episode in the series that is after or before the first episode associated with the first media content. In some embodiments, the second representation associated with the second geographic area includes a greater amount or lesser amount of second map data than the first map data such as a second set of streets, highways, and/or one or more second points of interest different from the first set of streets, highways, and/or the one or more first points of interest. In some embodiments, the second representation associated with the second geographic area includes characteristics similar to that of the first representation of the first geographic area as will be described with reference to method 1500. In some embodiments, the second media content is different from the first media content. For example, the second media content is optionally a first episode of a TV series, and the first media content optionally refers to a second episode of the same tv series. In another example, the second media content and the first media content are optionally associated with different tv series, electronic publications, music, movies, podcasts, or audiobooks.

In some embodiments, while displaying the user interface of the media application, the electronic device receives (1502d), via the one or more input devices, a first input that corresponds to selection of the first representation associated with the first geographic area, such as contact 1416 directed the map user interface element 1432 in FIG. 14G. In some embodiments, the first input includes a user input directed to the first representation associated with the first geographic area, such as a gaze-based input, an activation-based input such as a tap input, or a click input (e.g., via a mouse, trackpad, or another computer system in communication with the electronic device).

In some embodiments, in response to receiving the first input, the electronic device initiates (1502e) a process to display (optionally via the display generation component) a user interface that includes a first supplemental map for the first geographic area, such as map user interface 1430 in FIG. 14H. In some embodiments, the first supplemental map for the first geographic area has one or more of the characteristics of the supplemental maps described with reference to methods 700, 900, 1100, 1300, 1500, and/or 1700. In some embodiments, the first supplemental map for the first geographic area is displayed within the user interface of the media application. In some embodiments, the first supplemental map (and/or the second supplemental map) for the first geographic area (and/or the second geographic area) is displayed within a user interface of an application other than the media application (e.g., map application). More details with regards to information about the first supplemental map for the first geographic area is described with reference to methods 700, 900, 1100, 1300, 1500, and/or 1700. In some embodiments, in response to receiving the first input, the electronic device initiates an operation associated with the first representation associated with the first geographic area such as displaying the first supplemental map. In some embodiments, the electronic device performs the operation associated with the first representation associated with the first geographic area in a user interface separate from the user interface that includes the first representation associated with the first geographic area. In some embodiments, the electronic device performs the operation associated with the first representation associated with the first geographic area in the same user interface that includes the first representation associated with the first geographic area. In some embodiments, the first input includes a sequence of inputs corresponding to a request to select the first representation associated with the first geographic area and the second representation associated with the second geographic area, and in response to the sequence of inputs, the electronic device displays the user interface including the first supplemental map for the first geographic area and the second geographic area. In some embodiments, the user interface includes the first supplemental map for the first geographic area and a second supplemental map for the second geographic area. In some embodiments, the electronic device receives a second input corresponding to a selection of the second representation associated with the second geographic area. In some embodiments, in response to receiving the second input corresponding to the selection of the second representation of the second geographic area, the electronic device displays a second user interface that includes a second supplemental map for the second geographic area. Displaying the first representation associated with the first geographic area within the same user interface of the media application enables a user to view both media content and map-related information at the same time, without having to leave the media application, thereby reducing the need for subsequent inputs to display the first representation associated with the first geographic area. Providing the first representation associated with the first geographic area in the media application and providing the ability to interact with the first representation associated with the first geographic area to cause the user interface to display the first supplemental map for the first geographic area provides quick and efficient access to related map information without the need for additional inputs for searching for related map information and avoids erroneous inputs related to searching for such map information.

In some embodiments, the first supplemental map for the first geographic area includes one or more locations related to the first media content, such as representations 1441a-1441c in FIG. 14H. In some embodiments, the one or more locations related to the first media content have one or more of the characteristics of the POIs associated with media content described with reference to method 1300. For example, the user interface of the first media content optionally includes a first selectable option that is selectable to display the first supplemental map for the first geographic area that includes the one or more locations related to the first media content. In some embodiments, the first supplemental map includes one or more representations corresponding to the one or more locations related to the first media content. For example, the one or more representations corresponding to the one or more locations related to the first media content are optionally displayed at locations of the first supplemental map that correspond to the one or more locations related to the first media content. In some embodiments, the one or more representations corresponding to the one or more locations related to the first media content are selectable to display a user interface that includes information about the first media content as described with reference to method 1300. Displaying one or more locations related to the first media content in the first supplemental map for the first geographic area provides quick and efficient identification of the one or more locations related to the first media content without the need for additional inputs for searching for locations in the geographic area related to the first media content and avoids erroneous inputs related to searching for such locations.

In some embodiments, initiating the process to display the user interface that includes the first supplemental map for the first geographic area includes concurrently displaying the first supplemental map for the first geographic area and the first media content via the display generation component, such as shown in FIG. 14D with representations 1417 and 1418. In some embodiments, the first supplemental map for the first geographic area is displayed within the user interface of the media application. For example, the first supplemental map for the first geographic area is optionally displayed in a same region of the user interface of the media application as the first media content. In another example, the supplemental map for the first geographic area and the first media content are optionally displayed in the user interface of the media application separated by a visible or an invisible border. In some embodiments, the first supplemental map for the first geographic area is displayed during playback of the first media content at the electronic device. For example, displaying the first supplemental map for the first geographic area optionally does not disrupt playback of the first media content at the electronic device. Displaying the first supplemental map for the first geographic area concurrently with the first media content within the same user interface of the media application enables a user to view both media content and map-related information at the same time, without having to leave the media application, thereby reducing the need for subsequent inputs to display the first supplemental map.

In some embodiments, initiating the process to display the user interface that includes the first supplemental map for the first geographic area includes initiating display of the first supplemental map for the first geographic area via a second electronic device, different from the electronic device, such as shown in FIGS. 14K and 14L with devices 500 and 1455. In some embodiments, the second electronic device has one or more of the characteristics of the electronic device of method 700. In some embodiments, the process to initiate display of the first supplemental map for the first geographic area via the second electronic device, different from the electronic device includes displaying the first supplemental map on the second electronic device while displaying the first media content on the electronic device. In some embodiments, the electronic device continues playback of the first media content on the electronic device. Displaying the first supplemental map for the first geographic area via the second device enables handoff of displaying the supplemental map to the second device without navigating away from the user interface of the media application on the electronic device such that the electronic device continues to interact with the first media content on the electronic device, thereby offering efficient use of display space when used in conjunction with a second electronic device.

In some embodiments, displaying, via the display generation component, the user interface that includes the first supplemental map for the first geographic area includes displaying an indicator of the first media content at a location in the first supplemental map corresponding to the first media content, such as representation 1463 in FIG. 14M. For example, the location in the first supplemental map is featured in the first media content (e.g., the first media content includes a movie scene filmed at the Golden Gate Bridge in San Francisco; the first media content includes a song about the city Los Angeles; or the first media content includes a podcast episode about a building located in Paris). For example, the indicator of the first media content at the location in the first supplemental map corresponding to the first media content optionally includes an icon or user interface element indicating to the user of the first media content at the location in the first supplemental map. In some embodiments, the electronic device is configured to change the display of the indicator of the first media content at the location in the first supplemental based on a zoom level of the first supplemental map including the first geographic area. In some embodiments, the indicator optionally includes different information for display in the first supplemental map based on the zoom level. For example, at a first zoom level, the indicator includes an icon indicating the first media content (e.g., music note icon, movie reel icon, book icon, and/or another icon corresponding to the first media content), and at a second zoom level, closer than the first zoom level, the representation of the map includes text and/or an image larger than the icon identifying the first media content (e.g., music album cover, music artist photo, movie poster, book cover, and/or another image identifying the first media content). In some embodiments, the indicator of the first media content is selectable to playback the first media content and/or display information about the first media content. Providing an indicator of the first media content at the location in the first supplemental map corresponding to the first media content provides the user with both map information and media content information as the user interacts with the first supplemental map (e.g., by automatically surfacing relevant media content as the user interacts with the first supplemental map), which simplifies the interaction between the user and the electronic device and enhances the operability of the electronic device and makes the user-device interface more efficient.

In some embodiments, displaying, via the display generation component, the user interface that includes the first supplemental map for the first geographic area includes displaying one or more indications of a relationship between the first media content and the first supplemental map, such as representation 1420 in FIG. 14D. In some embodiments, the one or more indications of the relationship between the first media content and the first supplemental map include a description of why the first media content is included in the first supplemental map. The relationship is optionally known either through the user (e.g., this is my favorite movie set in San Francisco, I saw my favorite band at this music venue in San Francisco, and/or my favorite book mentions this neighborhood in San Francisco), and/or one or more metadata attributes as described with reference to method 1300. For example, the electronic device optionally derives from the one or more metadata attributes that the first media content was created or recorded within the first geographic area; and/or the first media content is accessible within the first geographic area (e.g., movie about San Francisco is showing in a theater in the first geographic area). Displaying one or more indications of the relationship between the first media content and the first supplemental map enables a user to view more information about why the first media content is included in the first supplemental map without having to leave the first supplemental map which simplifies the interaction between the user and the electronic device and enhances the operability of the electronic device and makes the user-device interface more efficient.

In some embodiments, while displaying, via the display generation component, the user interface that includes the first supplemental map for the first geographic area, in accordance with a determination that a current location corresponds to a first portion of the first geographic area and that the first portion satisfies one or more second criteria, displaying, concurrently with the first supplemental map, a representation of the first media content that is related to the first portion of the first geographic area, such as representation 1463 in FIG. 14M. In some embodiments, the current location corresponds to a current location of the electronic device within the first portion of the first geographic area. In some embodiments, the current location that corresponds to the first portion of the first geographic area is remote from the user. In some embodiments, the current location is in response to user input (e.g., panning and/or zooming) navigating within the first supplemental map. As discussed with respect to method 1300, the one or more second criteria are satisfied when the first portion of the first geographic area includes one or more POIs associated with the first media content as described with reference to method 1300. In some embodiments, the representation of the first media content that is related to the first portion of the first geographic area has one or more of the characteristics of the first representation of the first media content that is related to the first geographic area described with reference to method 1300. In some embodiments, the representation of the first media content that is related to the first portion of the first geographic area is selectable to cause playback of the first media content and/or display information about the first media content.

In some embodiments, in accordance with a determination that the current location corresponds to a second portion of the first geographic area, forgoing displaying the representation of the first media content, such as foregoing displaying representation 1463 in FIG. 14M. For example, the electronic device optionally does not display the representation of the first media content concurrently with the first supplemental map. In some embodiments, the electronic device displays the second portion of the first geographic area concurrently with the first supplemental map as described with reference to method with reference to methods 700, 900, 1100, 1300, 1500, and/or 1700. In some embodiments, the second portion of the first geographic area does not satisfy the one or more second criteria, and in response, the electronic device foregoes displaying the representation of the first media content. Displaying the representation of the first media content in the supplemental map enables a user to view both map-related information and the first representation of the first media content at the same time and reduces the number of inputs needed to locate the first media content when immediate access to the first media content is desired, without having to leave the map application, thereby reducing the need for subsequent inputs to display the first representation of the first media content.

In some embodiments, displaying the first representation associated with the first geographic area that is related to the first media content includes displaying a first alert about the first media content that is related to the first geographic area, such as for example, an alert similar to representation 1458 in FIG. 14K. For example, the first alert about the first media content that is related to the first geographic area is optionally displayed concurrently with and/or overlaid upon the user interface associated with the first media content. In some embodiments, the first alert includes a first representation of the first media content that is related to the first geographic area described with reference to method 1300. In some embodiments, the first alert includes a third representation of the first media content, different from the first representation of the first media content, that is related to the first geographic area. For example, the third representation of the first media content optionally includes a newly available episode of a television series while the first representation of the first media content optionally includes a first episode of the television series. In some embodiments, the respective representation associated with the first media content is selectable to cause playback of the respective episode of the television series and/or cause display of information related to the respective episode of the television series.

In some embodiments, displaying the second representation associated with the second geographic area that is related to the second media content includes displaying a second alert about the second media content that is related to the second geographic area, such as for example, an alert similar to representation 1465 in FIG. 14M. For example, the second alert about the second media content is optionally selectable to cause playback of the second media content and/or cause display of information related to the second media content. It is understood that although the embodiments described herein are directed to the first media content, such functions and/or characteristics, optionally apply to other media content including the second media content. Displaying alerts about media that is related to the respective geographic area simplifies interaction between the user and the electronic device and enhances operability of the electronic device by providing a way to receive alerts about media related to the respective geographic area without navigating away from the user interface that includes the respective geographic area, such as by streamlining the process of receiving alerts for media related to the respective geographic area for which the respective geographic area had recently been presented by the electronic device.

In some embodiments, the first alert and/or the second alert are displayed during playback of the media content at the electronic device, such as shown in FIG. 14B with representations 1409 and 1411. In some embodiments, the first alert and/or the second alert are associated with respective metadata attributes that determine a time (e.g., in the playback of the media content) at which the first alert and/or the second alert are displayed during playback of the media content at the electronic device. For example, the electronic device displays the first and/or second media content at a predetermined point in time during playback of the media content. In some embodiments, pausing playback of the media content at the predetermined point in time causes the electronic device to display the first alert and/or the second alert. Displaying the first and/or second alert at an appropriate time during playback of the media content enables a user to view both the media content and map-related information during playback of the media content which reduces power usage and improves battery life of the electronic device by enabling the user to use the electronic device more quickly and efficiently without the need for additional inputs for searching for related map information and avoids erroneous inputs related to searching for such map information.

In some embodiments, the first alert and/or the second alert are displayed when the electronic device has completed the playback of the media content, such as for example, an alert similar to representation 1414 when playback of the media content is complete in FIG. 14C. In some embodiments, when and/or until the electronic device has not completed the playback of the media content, the electronic device does not display the first and/or second alert. Displaying the first and/or second alert at an appropriate time once playback of the media content is completed enables a user to immediately view map-related information after playback of the media content is complete which reduces power usage and improves battery life of the electronic device by enabling the user to use the electronic device more quickly and efficiently without the need for additional inputs for searching for related map information and avoids erroneous inputs related to searching for such map information.

In some embodiments, the first alert about the first media content that is related to the first geographic area includes a first user interface object indicative of viewing the first supplemental map for the first geographic area at a second electronic device, different from the electronic device, such as for example, representation 1458 in FIG. 14L. For example, the first user interface object is optionally a notification (audio and/or visual) indicating to the user to view the first supplemental map for the first geographic area at the second electronic device. In some embodiments, the first user interface object includes a selectable option to dismiss the notification. For example, selecting the option to dismiss the notification causes the electronic device to initiate display of the first supplemental map for the first geographic area at the electronic device. In some embodiments, the notification includes a selectable option to initiate display of the first supplemental map for the first geographic area via the second electronic device while displaying the first media content on the electronic device.

In some embodiments, the second alert about the second media content that is related to the second geographic area includes a second user interface object indicative of viewing a second supplemental map for the second geographic area at the second electronic device, different from the electronic device, such as for example, a second alert similar to representation 1458 in FIG. 14L. It is understood that although the embodiments described herein are directed to the first media content, such functions and/or characteristics, optionally apply to other media content including the second media content. Displaying a user interface object indicative of viewing a supplemental map for the respective geographic area at the second electronic device enables notifying to the user that handoff of displaying the supplemental map to the second device without navigating away from the user interface of the media application on the electronic device is an option. In this way, the electronic device continues to interact with the first media content on the electronic device while the supplemental map is optionally viewed on the second electronic device, thereby offering efficient use of display space when used in conjunction with the second electronic device.

In some embodiments, the first alert indicates that the first geographic area is available for viewing in the first supplemental map for a predetermined period of time (e.g., 30 minutes, 60 minutes, 2 hours, 6 hours, 12 hours, 24 hours, 1 week, or 1 month) and the second alert indicates that the second geographic area is available for viewing in the second supplemental map for the predetermined period of time, such as for example representation 1460 in FIG. 14L. For example, after the predetermined period of time has elapsed, the first geographic area and/or the second geographic area is optionally not available for viewing in the respective supplemental map. In some embodiments, the electronic device provides one or more selectable options to save, download, and/or provide access to the first geographic area and/or the second geographic area via the respective supplemental map. In this case, in response to selection to save, download, and/or provide access to the first geographic area and/or the second geographic area, the first geographic area and/or the second geographic area is optionally available for viewing in the respective supplemental map after the predetermined period of time has elapsed. Displaying alerts indicating that the first geographic area and/or the second geographic area is available for viewing in the respective supplemental map enables the user to view map-related information for a predetermined period of time without requiring the electronic device to download the first geographic area and/or the second geographic area to the respective supplemental map. which reduces power usage and improves battery life of the electronic device by enabling the user to use the electronic device more quickly and efficiently without the need for additional inputs for downloading the related map information, and avoids erroneous inputs related to downloading such map information.

In some embodiments, while playback of the media content is on-going in the user interface of the media application, such as shown by representation 1409 in FIG. 14B. In accordance with a determination that a first playback position of the media content corresponds to the first geographic area and that a current playback position of the media content corresponds to the first playback position, the electronic device displays, in the user interface, a first alert associated with the first supplemental map of the first geographic area, such as representation 1411 in FIG. 14B. For example, the first geographic area is optionally defined by when the first geographic area is included in the first playback position of the media content (e.g., a particular scene of a movie or television show includes the first geographic area; or the first geographic area is mentioned in a particular part of a song, podcast, or electronic book). In some embodiments, the first alert associated with the first supplemental map of the first geographic area includes, is and/or has one or more characteristics of the first representation associated with the first geographic area that is related to the first media content and/or the first alert that indicates that the first geographic area is available for viewing in the first supplemental map for a predetermined period of time, such as described with reference to method 1500. In some embodiments, in accordance with a determination that the first playback position of the first media content does not correspond to the first geographic area and that the current playback position of the media content corresponds to the first playback position, the electronic device does not display, in the user interface, the first alert. In some embodiments, in accordance with a determination that the first playback position of the first media content corresponds to the first geographic area and that the current playback position of the media content does not correspond to the first playback position, the electronic device does not display, in the user interface, the first alert.

In some embodiments, in accordance with a determination that a second playback position of the media content corresponds to the second geographic area and that the current playback position corresponds to the second playback position, the electronic device displays, in the user interface, a second alert associated with a second supplemental map of the second geographic area, such as representation 1414 in FIG. 14C. In some embodiments, the second playback position is different from the first playback position of the same media content. In some embodiments, the second alert is different from the first alert. In some embodiments, the second supplemental map is different from the first supplemental map. In some embodiments, the second supplemental map is the same as the first supplemental map. In some embodiments, the first and second supplemental map include the first geographic area and the second geographic area. It is understood that although the embodiments described herein are directed to the first geographic area and the first alert, such functions and/or characteristics, optionally apply to other geographic areas/alerts including the second geographic area and the second alert. Displaying alerts about supplemental maps at an appropriate time during playback of the media content enables a user to view both the media content and map-related information during playback of the media content which reduces power usage and improves battery life of the electronic device by enabling the user to use the electronic device more quickly and efficiently without the need for additional inputs for searching for related map information and avoids erroneous inputs related to searching for such map information.

In some embodiments, in accordance with a determination that a location of the electronic device has corresponded to the first geographic area, the electronic device displays, via the display generation component, a representation of a first achievement that is related to the first geographic area, such as representation 1465 in 14M. For example, the electronic device optionally displays the first achievement or reward in a form of a badge or other visual representation awarded to the user in response to satisfying a predetermined criterion such as visiting a location corresponding to the first geographic area and/or visiting the location corresponding to the first geographic area over a predetermined number of times (e.g., location of the electronic device has corresponded to the first geographic area over 5 times). In some embodiments, the representation of the first achievement that is related to the first geographic area include media content rewards, such as music, videos, electronic books, images, promotions and/or ringtones related to the first geographic area (e.g., 3D images of Golden Gate Bridge or promotion for free music subscription). In some embodiments, representation of the first achievement that is related to the first geographic area include a time and/or date the achievement was achieved and/or a percentage of progress for an achievement that is in progress, though not yet completed (e.g., location of the electronic device has corresponded to the first geographic area 3 times). In some embodiments, in accordance with a determination that a location of the electronic device has not corresponded to the first geographic area, the electronic device does not display, via the display generation component, a representation of a first achievement that is related to the first geographic area. In some embodiments, the electronic device saves the representation of the first achievement to a record of achievements. Displaying achievements when the location of the electronic device corresponds to the first geographic area reduces the cognitive burden on a user when monitoring the location of the electronic device, thereby creating a more efficient human-machine interface without the need for additional inputs for tracking the location of the electronic.

In some embodiments, the user interface of the media application is a details user interface for the first media content, such as user interface 1400 in FIG. 14A. The details user interface for the first media content is described with reference to method 1500. In some embodiments, the details user interface for the first media content is accessible in a supplemental map associated with the respective geographic area related to the first media content. Displaying the respective geographic area within the details user interface for the first media content of the media application enables a user to view both map-related information and details about the first media content at the same time, without having to leave the media application, thereby reducing the need for subsequent inputs to display the map-related information.

In some embodiments, the first supplemental map for the first geographic area includes one or more representations of first points of interest associated with respective media content including the first media content and the one or more representations of the first points of interest are displayed in locations in the first supplemental map corresponding to the respective media content, such as representations 1419a-1419f in FIG. 14D. In some embodiments, the one or more representations of first points of interest associated with the respective media content including the first media content include, are and/or have one or more characteristics of the representations (e.g., icons, photos, or the like) of the points of interest on a supplemental map, such as described with reference to methods 900 and/or 1700. For example, the representations of the first points of interest are displayed in locations in the first supplemental map corresponding to locations of the points of interest and/or locations of the respective media content. In some embodiments, the points of interest are locations where the respective media content was created and/or recorded as described herein with reference to method 1500. In some embodiments, the electronic device displays, within the first supplemental map, an indicator (e.g., an arrow, icon, or user interface element) indicating to the user to pan or scroll through the first supplemental map to view/display the locations in the first supplemental map corresponding to the respective media content. In some embodiments, the one or more representations of the first points of interest are selectable to display more information about the first points of interest. In some embodiments, the information about the first points of interest include information about the respective media content. In some embodiments, the one or more representations of the first points of interest are selectable to cause playback of the respective media content.

In some embodiments, the second supplemental map for the second geographic area includes one or more representations of second points of interest associated with respective media content including the second media content and the one or more representations of the second points of interest are displayed in locations in the second supplemental map corresponding to the respective media content, such as location 1453 in 14J. It is understood that although the embodiments described herein are directed to the first geographic area and representations of first points of interest, such functions and/or characteristics, optionally apply to other geographic areas/representations of points of interest including the second geographic area and the representations of second points of interest. Displaying representations of points of interest associated with respective media content in locations in the supplemental map corresponding to the respective media content enables a user to view/discover points of interest related to the respective media content which reduces power usage and improves battery life of the electronic device by enabling the user to use the electronic device more quickly and efficiently without the need for additional inputs for searching for points of interest related to the respective media content and avoids erroneous inputs related to searching for such map information.

In some embodiments, while displaying, via the display generation component, the user interface that includes the first supplemental map for the first geographic area, the electronic device displays, outside of the first supplemental map, a description of the first supplemental map that includes a reference to the first media content, such as representation 1418 in FIG. 14D. In some embodiments, the description of the first supplemental map includes a description of what the first supplemental map is about, associated with and/or includes (e.g., references to the first media content), and/or one or more selectable user interface objects to perform different operations with respect to the first supplemental map (e.g., share the first supplemental map) as described in more detail with reference to methods 700 and/or 1700. In some embodiments, the electronic device is configured to display the description of the first supplemental map that includes a reference to the first media content as overlaid over and/or concurrently with the supplemental map. In some embodiments, the reference to the first media content is selectable to cause playback of the first media content and/or cause display of information about the first media content. In some embodiments, the description of the first supplemental map includes actors, performers, artists, content creators associated with the first media content, other media content related to the first media content, information related to consuming the first media content (e.g., viewing and/or purchasing information), contributors of the first supplemental map (e.g., users with access to the first supplemental map as described with reference to method 1700). Displaying a description of the supplemental map enables a user to view details about the supplemental map, without the need for additional inputs for navigating within the supplemental map and searching for the first media content with the supplemental map, thereby improving battery life of the electronic device by enabling the user to view supplemental map information quickly and efficiently without the need for additional inputs for navigating with the supplemental map to view references to the first media content.

It should be understood that the particular order in which the operations in method 1500 and/or FIG. 15 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 15 are, optionally, implemented by components depicted in FIGS. 1A-1B. For example, displaying operations 1502a, 1502b, and 1502c, and receiving operation 1502d, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces for Sharing Supplemental Map Information

Users interact with electronic devices in many different manners, including interacting with maps and maps applications for viewing information about various locations. In some embodiments, an electronic device provides supplemental map information and shares the supplemental map information to a second electronic device, different from the electronic device, thus enhancing the user's interaction with the device. The embodiments described below provide ways to incorporate user annotations to supplemental maps and allow supplemental maps to be shared which increases collaboration such that annotations provided by users of different electronic devices appear in a same supplemental map, thereby improving the interaction between the user and the electronic device and ensuring consistency of information displayed across different devices. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

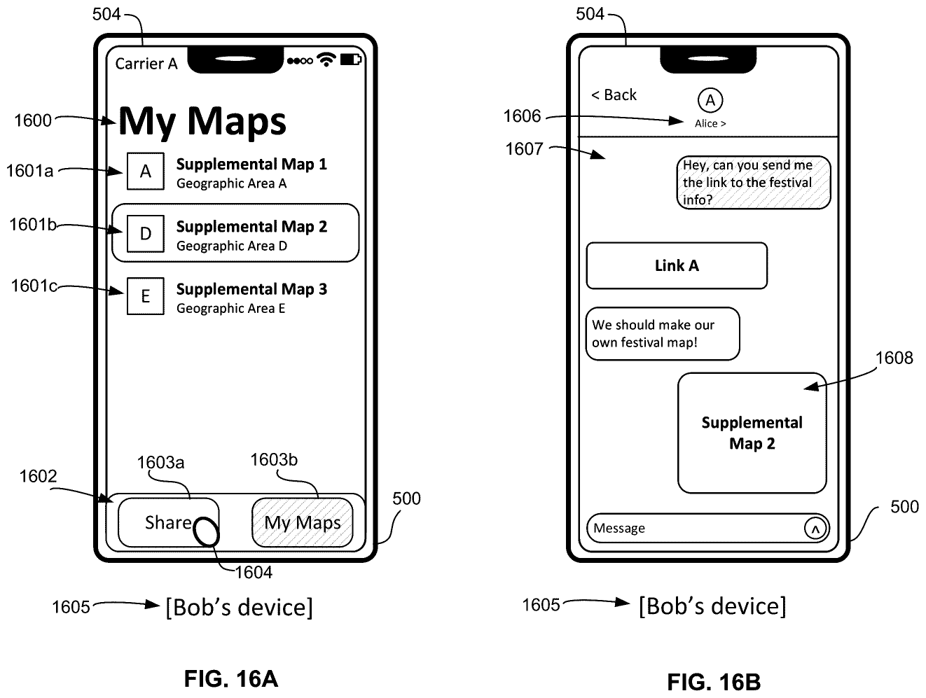

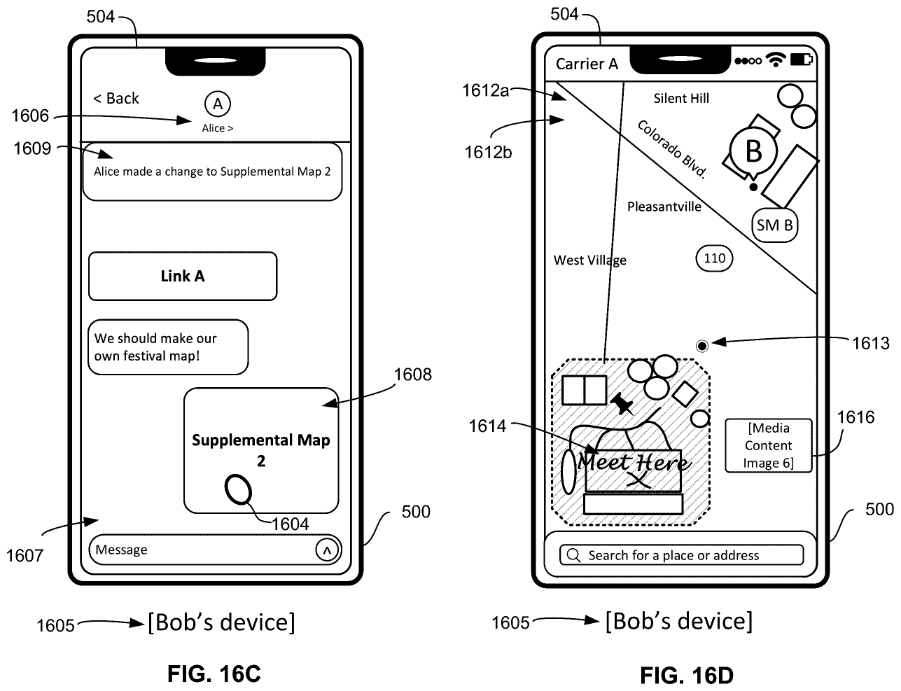

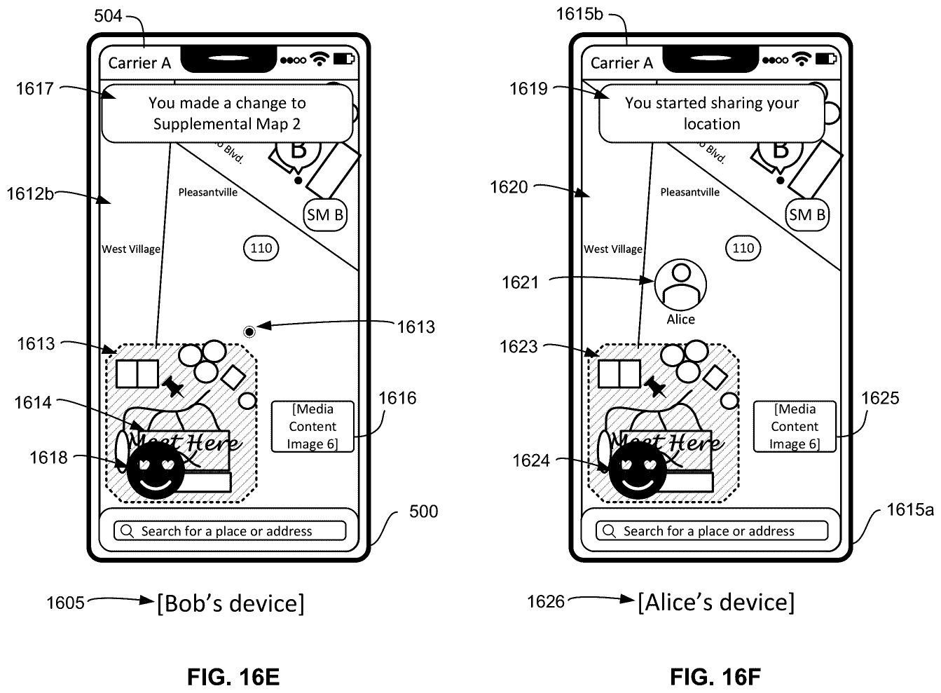

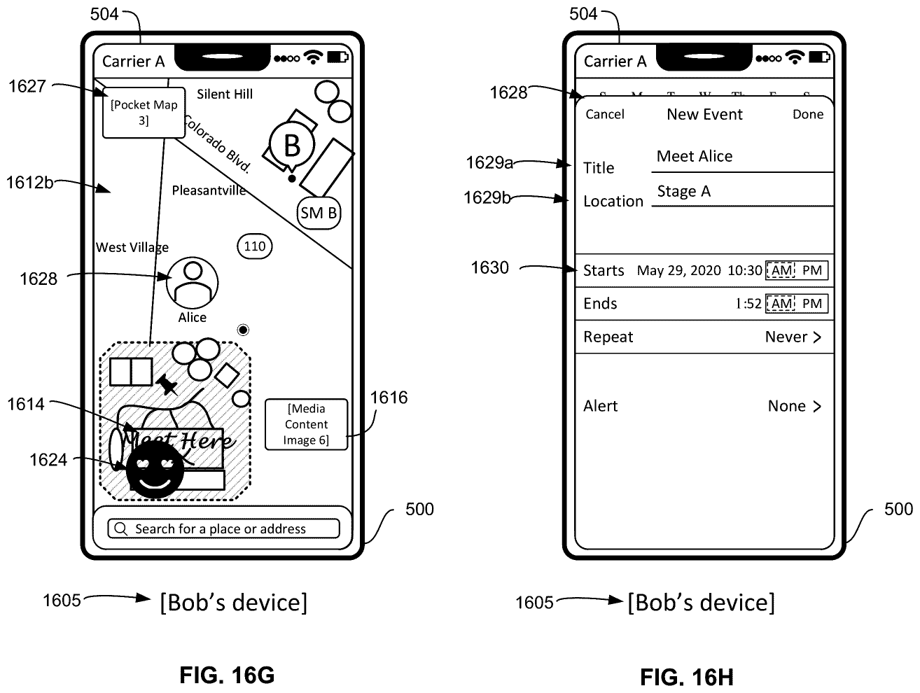

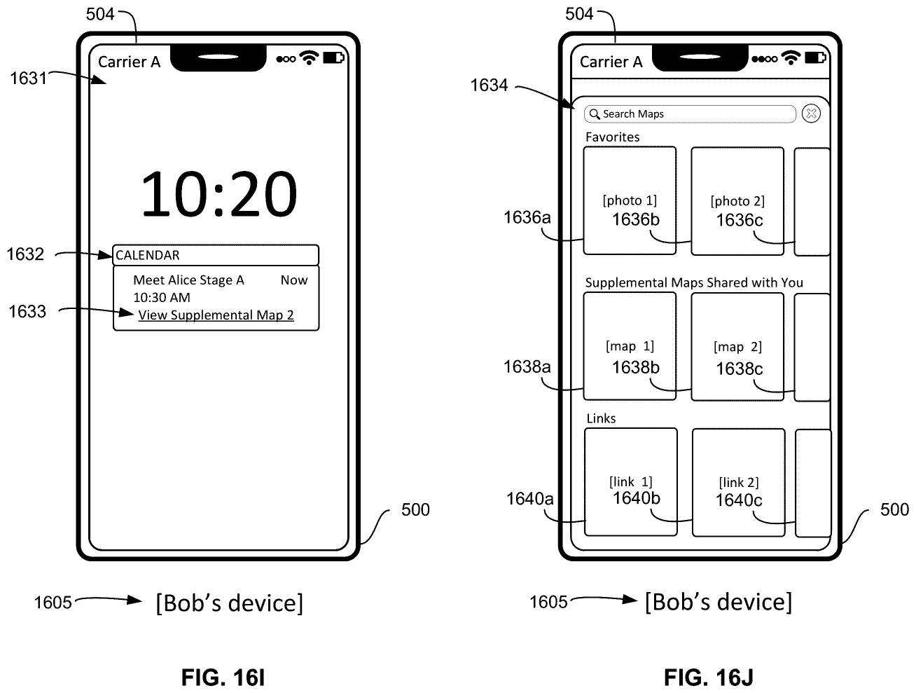

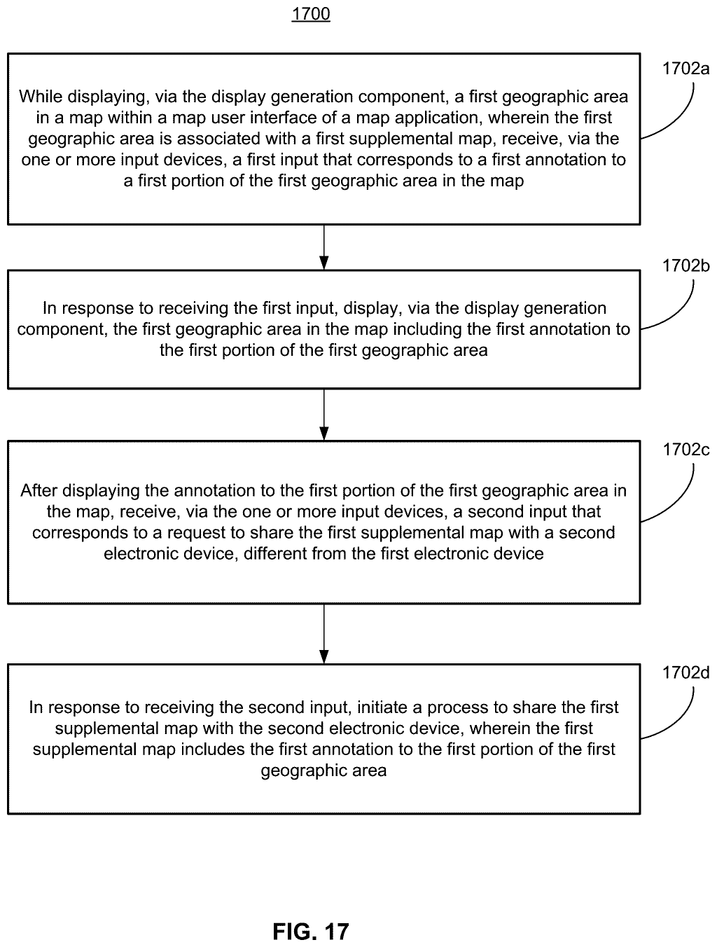

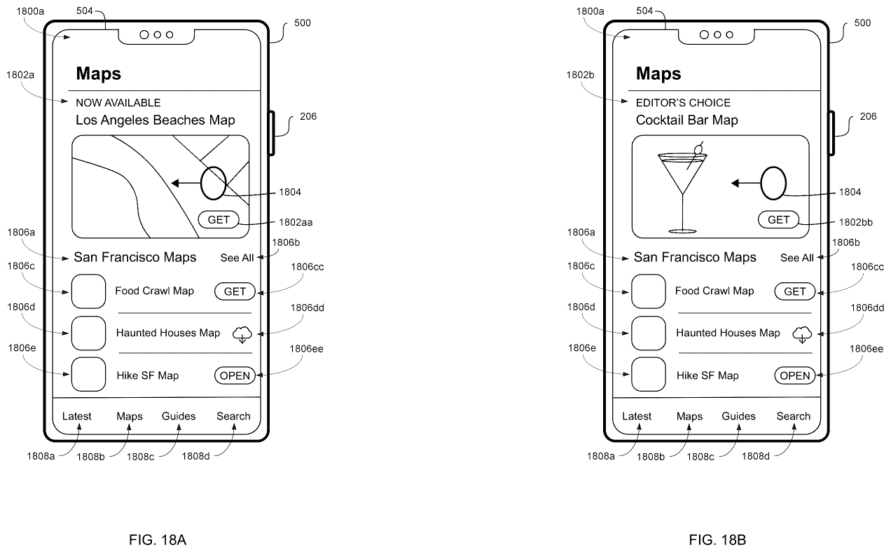

FIGS. 16A-16J illustrate exemplary ways in which an electronic device adds annotations to maps which are shared to a second electronic device, different from the electronic device. The embodiments in these figures are used to illustrate the processes described below, including the processes described with reference to FIG. 17. Although FIGS. 16A-16J illustrate various examples of ways an electronic device is able to perform the processes described below with respect to FIG. 17, it should be understood that these examples are not meant to be limiting, and the electronic device is able to perform one or more processes described below with reference to FIG. 17 in ways not expressly described with reference to FIGS. 16A-16J.

FIG. 16A illustrates a first electronic device 500 of user Bob as indicated by identifier 1605 (“Bob's device”). The first electronic device 500 displays a user interface. In some embodiments, the user interface is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

As shown in FIG. 16A, the first electronic device 500 presents primary map application. For example, the primary map application can present maps, routes, location metadata, and/or imagery (e.g., captured photos) associated with various geographical locations, points of interest, etc. The primary map application can obtain map data that includes data defining maps, map objects, routes, points of interest, imagery, etc., from a server. For example, the map data can be received as map tiles that include map data for geographical areas corresponding to the respective map tiles. The map data can include, among other things, data defining roads and/or road segments, metadata for points of interest and other locations, three-dimensional models of the buildings, infrastructure, and other objects found at the various locations, and/or images captured at the various locations. The primary map application can request, from the server through a network (e.g., local area network, cellular data network, wireless network, the Internet, wide area network, etc.), map data (e.g., map tiles) associated with locations that the electronic device frequently visits. The primary map application can store the map data in a map database. The primary map application can use the map data stored in map database and/or other map data received from the server to provide the maps application features described herein (e.g., navigation routes, maps, navigation route previews, etc.). In some embodiments, the server can be a computing device, or multiple computing devices, configured to store, generate, and/or provide map data to various user devices (e.g. first electronic device 500), as described herein. For example, the functionality described herein with reference to the server can be performed by a single computing device or can be distributed amongst multiple computing devices.

As shown in FIG. 16A, the first electronic device 500 presents a map user interface 1600 (e.g., of a primary map application installed on first electronic device 500) on display generation component 504. In FIG. 16A, the map user interface 1600 is currently presenting a list of supplemental map user interface objects (e.g., representations 1601a, 1601b, and 1601c) described with reference to methods 700, 900, 1100, 1300, 1500, and/or 1700. In some embodiments, a supplemental map user interface object (e.g., representations 1601a, 1601b, and 1601c) include a description of and/or icon of the supplemental map that, when selected, causes the first electronic device 500 to initiate a process to display a supplemental map as described with reference to methods 1300, 1500, and/or 1700. In some embodiments, the first electronic device 500 detects user input (e.g., a contact on a touch-sensitive surface, actuation of a physical input device of the first electronic device 500 or in communication with the first electronic device 500, and/or a voice input from the user) corresponding to selection of the supplemental map user interface object (e.g., representation 1601b), and in response, the first electronic device 500 displays user interface element 1602. User interface element 1602 includes selectable user interface element 1603b, that when selected, causes the first electronic device 500 to display a full listing of all supplemental maps including representations 1601a, 1601b, and 1601c associated with the user (“Bob”) of the first electronic device 500. User interface element 1602 also includes selectable user interface element 1603a that is selectable to share the selected supplemental map (e.g., representation 1601b) with a second electronic device, different from the first electronic device 500. For example, in response to detecting selection of the user interface element 1603a (e.g., with contact 1604 in FIG. 16A), the first electronic device 500 displays options to share via a messaging application, an email application, and/or a wireless ad hoc service, or other application as described with reference to methods 1300, 1500, and/or 1700.

As shown in FIG. 16B, the user of the first electronic device 500 elected to share the supplemental map via a messaging application as shown by messaging user interface 1607. Messaging user interface 1607 includes a message 1608 corresponding to the supplemental map selected in FIG. 16A transmitted to a second electronic device belonging to user “Alice” (e.g., representation 1606). In some embodiments, the message 1608 includes a description of and/or icon of the respective supplemental map that, when selected, causes the first electronic device 500 (and the second electronic device belonging to user “Alice”) to initiate a process to display the respective supplemental map as described with reference to methods 1300, 1500, and/or 1700.

In some embodiments, the first electronic device 500 displays notifications that the supplemental map has been updated with content from the user of the first electronic device 500 or a second user of a second electronic device other than the first electronic device. For example, in FIG. 16C, the first electronic device 500 displays messaging user interface 1607 including a notification (e.g., representation 1609) that user “Alice” has made a change to the supplemental map. In some embodiments, the notification(e.g., representation 1609) is selectable to cause the first electronic device 500 to initiate a process to display the updated supplemental map as described with reference to methods 1300, 1500, and/or 1700. Additionally and as shown in FIG. 16C, the first electronic device 500 displays the updated supplemental map in response to a detection user input directed to message 1608. For example, the first electronic device 500 detects user input (e.g., a contact on a touch-sensitive surface, actuation of a physical input device of the first electronic device 500 or in communication with the first electronic device 500, and/or a voice input from the user) corresponding to selection of the message 1608 corresponding to the supplemental map, and in response, the first electronic device 500 displays a map user interface 1612a (e.g., of a primary map application installed on first electronic device 500) on display generation component 504, as shown in FIG. 16D. In FIG. 16D, the map user interface 1612a includes a supplemental map 1612b associated with a geographic area. In some embodiments, supplemental map 1612b includes one or more of the characteristics of the supplemental maps described with reference to methods 700, 900, 1100, 1300, 1500, and/or 1700. In FIG. 16D, supplemental map 1612b includes annotation 1614 (e.g., handwritten note “Meet Here” with an “X”) provided by user “Alice” via the second electronic device. Supplemental map 1612b also includes current location indicator 1613 that indicates the current location of the electronic device 500 in the area and representation 1616 of media content associated with the are depicted in the supplemental map 1612b. In some embodiments, representation 1616 of media content includes one or more of the characteristics of representations of media content described with reference to methods 1300, 1500, and/or 1700.

In some embodiments, electronic device 500 is configured to receive input from a user (e.g., “Bob”) of the electronic device 500 requesting to annotate the supplemental map 1612b. For example, in FIG. 6E, device 500 has detected input via touch screen of display generation component 504 to annotate the supplemental map 1612b with an emoji in a location of the supplemental map 1612b corresponding to the annotation 1614 made by the second electronic device. In response to the input to annotate the supplemental map 1612b, the electronic device 500 saves the annotation 1618 to the supplemental map 1612b and displays a notification (e.g., representation 1617) that the user of the electronic device 500 made a change to the supplemental map 1612b (e.g., by adding annotation 1618). In some embodiments, the supplemental map information including annotation 1614 is displayed at other devices, different from the electronic device, such as the second electronic device 1615a corresponding to user “Alice” as shown in FIG. 16F. In some embodiments, the electronic device 500 is configured to receive input from a user of the electronic device 500 requesting to share the current location of the electronic device 500 in the geographic area of the supplemental map 1612b. For example, in FIG. 6F, electronic device 1615a associated with user 1626 (“Alice”) has detected input via touch screen 1615b to annotate the supplemental map 1612b with an indicator 1621 that indicates the current location of the electronic device 1615a. In response to the input to share the current location of the electronic device 1615a, the electronic device 1615a saves the indicator 1621 to the supplemental map 1612b and displays a notification (e.g., representation 1619) that the user (“Alice”) of the electronic device 1615a made a change to the supplemental map 1612b (e.g., by adding indicator 1621). In some embodiments, the supplemental map information including indicator 1621 is displayed at other devices, different from the electronic device, such as the electronic device 500 corresponding to user “Bob” as shown in FIG. 16G.

In some embodiments, the electronic device 500 is configured to provide input to share supplemental maps (along with annotations) via the maps application. For example, and as shown in FIG. 16G, the supplemental map 1612b includes representation 1627 of a second supplemental map, different from supplemental map 1612b. In some embodiments, representation 1627 of the second supplemental map is displayed in response to a request from a second electronic device, different from electronic device 500, to share the second supplemental map associated with representation 1627. In some embodiments, when user (“Alice”) of the electronic device 1615a elected to share their current location with electronic device 500 as discussed with reference to FIG. 16F, the electronic device 1615a also shared one or more supplemental maps created by user (“Alice”) of the electronic device 1615a. In some embodiments, the electronic device 1615a does not share the one or more supplemental maps created by user (“Alice”) of the electronic device 1615a without receiving a request to share the one or more supplemental maps by user (“Alice”) of the electronic device 1615a.

In some embodiments, the electronic device 500 determines that the supplemental map is associated with an event and in response to determining that the supplemental map is associated with an event, the electronic device 500 creates a calendar event for the event. For example in FIG. 16H, the electronic device 500 determines an event associated with supplemental map 1612b. The event is optionally associated with annotation 1614 (e.g., handwritten note “Meet Here” with an “X”) in FIG. 16G that was provided by user “Alice” of the electronic device 1615a. In response to determining the event associated with annotation 1614, the electronic device 500 creates a calendar event 1628 as shown in FIG. 16H. The electronic device 500 optionally populates one or more data fields of calendar event 1628 with metadata captured by annotation 1614 and/or the supplemental map 1612b. For example, in FIG. 16H, calendar event 1628 includes a title 1629a and a location 1629 corresponding to content (e.g. “Meet Alice”) and location data (e.g., “Stage A”) of annotation 1614 and/or the supplemental map 1612b. Other data fields may be automatically populated by the electronic device 500, such as the event start time, end time, occurrence, and alert information (e.g., representation 1630). In some embodiments, the electronic device 500 receives input from a user of the electronic device 500 to provide data for one or more of the data fields of calendar event 1628. In some embodiments, after creating the calendar event 1628 in FIG. 16H, the electronic device 500 determines that a current time is within a time threshold of the calendar event 1628 as described with reference to methods 1300, 1500, and/or 1700. In some embodiments, in response to determining that the current time is within the time threshold of the calendar event 1628, the electronic device 500 displays a notification (e.g., representation 1632) of the calendar event 1628 as shown in FIG. 16I. The notification (e.g., representation 1632) includes information about the calendar event (e.g., title, description, and/or start time) and a selectable option (e.g., representation 1633) to navigate to (or open) the supplemental map 1612b associated with the calendar event 1628.

In some embodiments, the electronic device 500 displays supplemental map information in user interfaces other than user interfaces of the maps application, such as a home page user interface or a lock screen user interface, as shown in FIG. 16I. Other user interfaces and/or applications in which the electronic device 500 displays representations of supplemental maps is described with reference to methods 1300, 1500, and/or 1700. For example, in FIG. 16J, the electronic device 500 displays user interface 1634. User interface 1634 includes a collection of media content saved by the user of the electronic device 500, such as favorite photos (e.g., representations 1636a, 1636b, and 1636c), supplemental maps shared with the user (e.g., representations 1638a, 1638b, and 1638c), and links saved and/or shared with the user (e.g., representations 1640a, 1640b, and 1640c). In some embodiments, the representations of media content are selectable to display respective media content. For example representation, in FIG. 16J, the user interface 1634 includes representation 1638, that when selected, causes the electronic device 500 to display a respective supplemental map, such as supplemental map 1612b in FIG. 16G.

FIG. 17 is a flow diagram illustrating a method for adding annotations to maps which are shared to a second electronic device, different from an electronic device. The method 1700 is optionally performed at an electronic device such as device 100, device 300, device 500 as described above with reference to FIGS. 1A-1B, 2-3, 4A-4B and 5A-5H. Some operations in method 1700 are, optionally combined and/or the order of some operations is, optionally, changed.

In some embodiments, method 1700 is performed at an electronic device (e.g., 500) in communication with a display generation component (e.g., 504) and one or more input devices. In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 1700 is performed at or by an automobile (e.g., at an infotainment system of an automobile having or in communication with one or more display generation components and/or input devices).

In some embodiments, while displaying, via the display generation component, a first geographic area in a map within a map user interface of a map application, wherein the first geographic area is associated with a first supplemental map, the electronic device receives (1702a), via the one or more input devices, a first input that corresponds to a first annotation to a first portion of the first geographic area in the map, such as annotation 1614 in FIG. 16D. In some embodiments, the map user interface of the map application has one or more of the characteristics as described with reference to methods 700, 900, 1100, 1300, 1500, and/or 1700. In some embodiments, the first geographic area has one or more of the characteristics as described with reference to methods 700, 900, 1100, 1300, 1500, and/or 1700. In some embodiments, the map within the map user interface has one or more of the characteristics of the primary map described with reference to methods 700, 900, 1100, 1300, 1500, and/or 1700. In some embodiments, the first supplemental map has one or more of the characteristics of the supplemental map described with reference to methods 700, 900, 1100, 1300, 1500, and/or 1700. In some embodiments, the displayed first geographic area includes content from the first supplemental map that is displayed in and/or overlaid on the first geographic area, such as described with reference to methods 700, 900 and/or 1100. In some embodiments, the first input that corresponds to the first annotation to the first portion of the first geographic area in the map has one or more of the characteristics of the annotation to the first portion of the first geographic area in the primary map described with reference to methods 700 and/or 1700. In some embodiments, the first input includes user input directed to a markup affordance or markup user interface element interactable to allow the user to markup the first portion of the first geographic are in the map. In some embodiments, the markup user interface element is included within the map application. In some embodiments, the markup user interface element is included within an application other than the map application (e.g., a digital whiteboarding application) that is accessible via the map user interface of the map application.

In some embodiments, in response to receiving the first input, the electronic device displays (1702b), via the display generation component, the first geographic area in the map including the first annotation to the first portion of the first geographic area (e.g., at the location(s) to which the annotation was directed), such as annotation 1618 in FIG. 16E. In some embodiments, the first annotation to the first portion of the first geographic area includes text, images, graphics, handwritten input, references (e.g., links to information), or other information about the first portion of the first geographic area. In some embodiments, the first annotation is provided for display proximate to and/or overlaid on the first portion of the first geographic area.

In some embodiments, after (and/or while) displaying the annotation to the first portion of the first geographic area in the map, the electronic device receives (1702c), via the one or more input devices, a second input that corresponds to a request to share the first supplemental map with a second electronic device, different from the first electronic device, such as the request to share via the messaging user interface 1607 in FIG. 16B. In some embodiments, the first supplemental map is shared with other electronic devices, for example, using a messaging application, an email application, and/or a wireless ad hoc service. In some embodiments, sharing with the other devices is similar to the process of transmitting the first supplemental map to a second electronic device described with reference to method 700. In some embodiments, the second input includes user input directed to a share affordance or share user interface element interactable to share the first supplemental map with the second electronic device.

In some embodiments, in response to receiving the second input, the electronic device initiates (1702d) a process to share the first supplemental map with the second electronic device, wherein the first supplemental map includes the first annotation to the first portion of the first geographic area, such as illustrated by message 1608 in FIG. 16B. For example, annotations made to the first supplemental map are optionally added to the first supplemental map such that when the annotated first supplemental map is shared with and subsequently displayed at the second electronic device, the annotations made to the first supplemental map at the first electronic device are displayed in the first geographic area by the second electronic device (e.g., in a map within a map user interface of a map application on the second electronic device). In some embodiments, the first supplemental map includes a second portion of the first geographic area. In some embodiments, in accordance with a determination that the first supplemental map includes a second annotation to the second portion of the first geographic area, the first supplemental map shared with the second electronic device includes the second annotation to the second portion of the first geographic area. In some embodiments, in accordance with a determination that the first supplemental map does not include a second annotation to the second portion of the first geographic area, the first supplemental map shared with the second electronic device does not include the second annotation to the second portion of the first geographic area. In some embodiments, initiating the process to share the first supplemental map with the second electronic device includes a request from the first electronic device to the second electronic device to enter a shared annotation communication session (e.g., live conversation) between the first electronic device and the second electronic device during which annotations made to the supplemental map and/or map are shared and/or displayed by the two devices in real-time (or near real-time or dynamically).

In some embodiments, the first geographic area is also associated with a second supplemental map (e.g., as described with reference to methods 700, 900 and/or 1100). In some embodiments, the second supplemental map include the first portion of the first geographic area. The first portion of the first geographic area optionally includes the first annotation, but that annotation is optionally associated with the first supplemental map and not the second supplemental map. In some embodiments, initiating a process to share the second supplemental map with the second electronic device does not include the first annotation to the first portion of the first geographic area. For example, the annotations made to the first portion of the first geographic area are not displayed in the first geographic area by the second electronic device. Incorporating user annotations to supplemental maps and allowing supplemental maps to be shared increases collaboration such that annotations provided by users of different electronic devices appear in a same supplemental map, thereby improving the interaction between the user and the electronic device and ensuring consistency of information displayed across different devices.

In some embodiments, displaying the first annotation on the first portion of the first geographic area includes overlaying the first annotation as a first layer on one or more layers of a representation of the first geographic area from the first supplemental map, such as annotation 1614 overlaid over the geographic are in FIG. 16D. For example, the first annotation as the first layer is optionally on top (or in front of) a base map layer described in method 700. In some embodiments, the first layer is one of a plurality of layers of different respective content. For example, the first layer optionally includes annotations provided by the first electronic device including the first annotation, whereas annotations provided by the second electronic device are optionally included in a second layer, different from the first layer. In some embodiments, the one or more layers including the first layer and the second layer are overlaid or superimposed on one another to give an appearance of a single layer containing all the annotations and map information. In some embodiments, the first annotation as the first layer is optionally displayed in a semi-translucent or semi-transparent manner on the base map layer. For example, a semi-translucent or semi-transparent layer is optionally overlaid on the base map layer, and the first annotation is displayed in the semi-translucent or semi-transparent layer. Thus, the first annotation is optionally displayed such that the first annotation does not obscure the entire base map layer. In some embodiments, the first annotation as the first layer is optionally not displayed in a semi-translucent or semi-transparent manner on the base map layer. By overlaying the first annotation as the first layer on the one or more layers of the representation of the first geographic are from the first supplemental map, the first annotation is displayed adjacent to or near the first portion of the first geographic area that the first annotation is associated with, and reduces errors in interacting with annotations and map information concurrently, thereby improving the interaction between the user and the electronic device.

In some embodiments, the map user interface of the map application includes an editing user interface element provided to annotate the first geographic area in the map, and wherein the first input includes selection of the editing user interface element, such as, for example, map user interface 1612a in FIG. 16B configured to provide annotations. In some embodiments, the editing user interface element includes markup tools (e.g., marker or highlighter tool, a pen tool, a pencil tool, an eraser tool, a ruler tool, a tool for converting handwritten input into font-based text, a tool for adding emoji characters, images, videos, animations or media content) to add annotations to the first geographic area in the map. In some embodiments, the editing user interface element corresponds to one of the markup tools listed herein. In some embodiments, selection of the editing user interface element includes a gesture on or directed to the editing user interface element. For example, the gesture optionally corresponds to contact (e.g., via a finger or stylus) with the display generation component or clicking a physical mouse or trackpad. In some embodiments, when the first electronic device does not detect user interactions with the editing user interface element, the electronic device does not display the editing user interface element. Providing an option to annotate the first geographic area in the map simplifies interaction between the user and the electronic device and enhances operability of the electronic device by providing a way to add annotations without navigating away from the user interface that includes the first geographic area.

In some embodiments, the map user interface of the map application includes an editing user interface element provided to associate media content with the first geographic area, such as representation 1616 of media content in FIG. 16E. For example, the editing user interface element optionally corresponds to a tool for adding media content to the first geographic area. In some embodiments, the media content has one or more of the characteristics of the media content described with reference to method 1300. In some embodiments, to associate the media content with the first geographic area includes saving or storing a representation of the media content and/or a link to the media content with the first geographic area from the first supplemental map. In some embodiments, the first electronic device detects a sequence of user inputs corresponding to selection of the editing user interface element and the media content. In response to the detection of the sequence of user inputs corresponding to selection of the editing user interface element and the media content, the first electronic device generates an annotation associated with the media content for display on the first geographic area of the first supplemental map. Providing an option to associate media content with the first geographic area in the map simplifies interaction between the user and the electronic device and enhances operability of the electronic device by providing a way to add media content without navigating away from the user interface that includes the first geographic area.

In some embodiments, after initiating the process to share the first supplemental map with the second electronic device, the electronic device receives an indication of a second annotation to the first supplemental map provided by the second electronic device, such as representation 1609 in FIG. 16C. For example, a user of the second electronic device optionally created the second annotation on the second electronic device. In some embodiments, the second electronic device transmits the second annotation to the first electronic device in response to detecting user input corresponding to sharing the second annotation to the first electronic device.

In some embodiments, in response to receiving the indication of the second annotation to the first supplemental map provided by the second electronic device, the electronic device displays, via the display generation component, a visual indication of the second annotation, such as, for example a visual indication similar to representation 1617 in FIG. 16E. In some embodiments, the visual indication comprises a textual description. For example, the textual description describes that the second annotation was provided by the second electronic device (e.g., created by a user of the second electronic device) and/or describes the annotation (e.g., user of the second electronic device added a heart emoji to location ABC of the first supplemental map). In some embodiments, the visual indication is displayed at or near the top (or bottom) of the display generation component. In some embodiments, the visual indication is displayed overlaid over the map user interface and/or a user interface that is different from the map user interface (e.g., a home screen user interface or a wake or lock screen user interface of the first electronic device).

In some embodiments, the visual indication is responsive to user input corresponding to a request to display the second annotation to the first supplemental map. For example, if the first electronic device detects a gesture on or directed to the visual indication (e.g., finger tap or mouse click), the first electronic device, in response to the detected gesture, displays the second annotation to the first supplemental map. In some embodiments, the visual indication is displayed for a predetermined amount of time (e.g., 1, 3, 5, 7, 10, 20, 30, 40, 50, or 60 seconds) before the first electronic device automatically removes the visual indication. In some embodiments, the first electronic device removes the visual indication (before the predetermined time has elapsed) in response to user input corresponding to a request to remove the visual indication. Displaying a visual indication of the second annotation to the first supplemental map provided by the second electronic device enables a user to view both map-related information and annotations at the same time, without having to leave the map application, thereby reducing the need for subsequent inputs to view the visual indication of the second annotation while viewing map-related information which simplifies the interaction between the user and the electronic device and enhances the operability of the electronic device and makes the user-device interface more efficient.

In some embodiments, displaying, via the display generation component, the first geographic area in the map including the first annotation to the first portion of the first geographic area includes, in accordance with a determination that the first annotation to the first portion of the first geographic area included in the first supplemental map is a first type of annotation, the electronic device removes the first annotation to the first portion of the first geographic area included in the first supplemental map after a predetermined period of time, such as annotation 1614 in FIG. 16D being removed. In some embodiments, the first type of annotation is an ephemeral annotation (e.g., the annotation is included in the first portion of the first geographic area for a predetermined amount of time (e.g., 1 minute, 5 minutes, 10 minutes, 20 minutes, 30 minutes, 60 minutes, 8 hours, 24 hours, or 48 hours) before being removed)). In some embodiments, the predetermined period of time is set by the user. In some embodiments, the annotation is included in the first portion of the first geographic area for a communication session between the first electronic device and the second electronic device. For example, once the communication session between the first electronic device and the second electronic device ends, the annotation is optionally removed from the first portion of the first geographic area. In some embodiments, the first electronic device removes the first annotation to the first geographic area included in the first supplemental map without receiving user input corresponding to or requesting the removal of the first annotation.

In some embodiments, in accordance with a determination that the first annotation to the first portion of the first geographic area included in the first supplemental map is a second type of annotation, different from the first type of annotation, the electronic device foregoes removing the first annotation to the first portion of the first geographic area included in the first supplemental map after the predetermined period of time, such as representation 1616 in FIG. 16E. In some embodiments, the second type of annotation is a permanent annotation (e.g., the annotation is permanently included in the first portion of the first geographic area and is accessible for later viewing via the first supplemental map). In some embodiments, the first electronic device maintains the first annotation to the first portion of the first geographic area included in the first supplemental map until the first electronic device receives user input corresponding to or requesting the removal of the first annotation. In some embodiments, even if the communication session between the first electronic device and the second electronic device ends, the annotation is available and included in the first portion of the first geographic area because the annotation is permanently saved to the first supplemental map. In some embodiments, the first electronic device changes the first annotation from the first type of annotation to the second type of annotation or vice versa in response to user input. Providing different types of annotations that are removed after a predetermined amount of time reduces the number of annotations that are saved to the first supplemental map which saves memory space and increases performance.

In some embodiments, while displaying, via the display generation component, the first geographic area in the map within the map user interface of the map application, wherein the first geographic area is associated with the first supplemental map, the electronic device receives, via the one or more input devices, a third input that corresponds to a request to locate the second electronic device, such as device 1615a belonging to user 1626 in FIG. 16F. For example, the third input optionally includes a sequence of user inputs to interact with a searching user interface element (e.g., entering and/or selecting from a list the name of the user associated with the second electronic device).

In some embodiments, in response to receiving the third input, the electronic device displays, via the display generation component, a respective representation associated with the second electronic device at a location of the second electronic device in the map within the map user interface of the map application, such as event 1628 in FIG. 16G. In some embodiments, the respective representation associated with the second electronic device at a location of the second electronic device in the map includes graphics, icons, and/or texts representing a user of the second electronic device. In some embodiments, the location of the second electronic device is the current location of the second electronic device. In some embodiments, the respective representation associated with the second electronic device is displayed as a first layer on one or more layers of a representation of the first geographic area from the first supplemental map as described herein. In some embodiments, the respective representation associated with the second electronic device is selectable to send a communication to the second electronic device or view annotations provided by the second electronic device. In some embodiments, as the location of the second electronic device changes, the location of the respective representation associated with the second electronic device in the map within the map user interface of the map application changes. In some embodiments, the first electronic device ceases to display the respective representation associated with the second electronic device at the location in response to receiving a response from the second electronic device denying the request to locate the second electronic device. Displaying the respective representation associated with the second electronic device at the location of the second electronic device in the map within the map user interface of the map application enables a user to view both map-related information and the location of the second electronic device at the same time, without having to leave the map application, thereby reducing the need for subsequent inputs to locate the second electronic device which simplifies the interaction between the user and the electronic device and enhances the operability of the electronic device and makes the user-device interface more efficient.

In some embodiments, the electronic device receives, via the one or more input devices, a first indication that the second electronic device has arrived at a location associated with the first supplemental map and in response to receiving the first indication, the electronic device displays, via the display generation component, a second indication, different from the first indication, that the second electronic device has arrived at the location associated with the first supplemental map, such as for example, and indication similar to representation 1619 in FIG. 16F. In some embodiments, the second electronic device is configured to trigger transmission of the first indication that the second electronic device has arrived at the location to the first electronic device in response to a determination, by the second electronic device, that the second electronic device has arrived at the location by monitoring the second electronic device's GPS coordinates. In some embodiments, the second indication that the second electronic device has arrived at the location associated with the first supplemental map is a visual indication comprising a textual description, graphics and/or icons indicating that the second electronic device has arrived at the location associated with the first supplemental map. In some embodiments, the second indication that the second electronic device has arrived at the location associated with the first supplemental map is displayed at or near the top (or bottom) of the display generation component. In some embodiments, the second indication that the second electronic device has arrived at the location associated with the first supplemental map is displayed overlaid over the map user interface and/or a user interface different from the map user interface, such as a home screen user interface or a wake or lock screen user interface of the first electronic device. Displaying an indication that the second electronic device has arrived at the location associated with the first supplemental map notifies the user of the second electronic device's arrival to the location associated with the first supplemental map, thereby reducing the need for subsequent inputs to monitor the second electronic device's location with respect to the location associated with the first supplemental map which simplifies the interaction between the user and the electronic device and enhances the operability of the electronic device and makes the user-device interface more efficient.

In some embodiments, the first supplemental map is associated with a respective event (e.g., vacation, festival, dining, adventure, or social gathering), In some embodiments, the respective event corresponds to and/or is defined by a calendar event of a calendar application on the first electronic device and/or the second electronic device. In some embodiments, the respective event includes metadata (optionally created by a user of the first electronic device and/or the second electronic device) that associates the respective event to the first supplemental map, such as event 1628 in FIG. 16H. For example, the user of the first electronic device optionally creates the first supplemental map for a music festival event. In some embodiments, the electronic device receives, via the one or more input devices, a third input that corresponds to creation of content at the first electronic device, such as, for example, content similar to representation 1633 in FIG. 16I. For example, creation of content at the first electronic device optionally includes capturing digital images, videos, audio, and/or generating annotations or notes. In some embodiments, creation of content at the first electronic device is performed in a user interface other than the map user interface (e.g., while the map user interface is not displayed), such as a camera user interface of a camera application, a drawing user interface of a drawing application, or a notetaking user interface of a notetaking application.

In some embodiments, in response to receiving the third input, in accordance with a determination that the third input was received at a time (and/or location) associated with the respective event, the electronic device associates the content with the first portion of the first geographic area in the map, such as described with reference to representation 1633 in FIG. 16I. In some embodiments, in accordance with a determination that the third input was not received at a time (and/or location) associated with the respective event, foregoing associating the content with the first portion of the first geographic area in the map. For example, the first electronic device optionally determines that while at the respective event (e.g., the location of the first electronic device corresponds to the location of the respective event) and/or at a time during the duration of the respective event or within a threshold of time (e.g., 30 seconds, 40 seconds, 60 seconds, 5 minutes, 10 minutes, 30 minutes, or 1 hour) before or after the duration of the event, the first electronic device received the third input corresponding to creation of content (e.g., the first electronic device is operating to create content as described herein while at the respective event).

In some embodiments, associating the content with the first portion of the first geographic area in the map includes saving or storing the content (or a representation of the content) and/or a link to the content with the first geographic area in the map. In some embodiments, associating the content with the first portion of the first geographic area in the map includes displaying a visual representation of the content in the first portion of the first geographic area in the map. In some embodiments, the first electronic device groups the content as a collection of content (e.g., memory of the respective event) for association with the first portion of the first geographic are in the map. In some embodiments, content that is not associated with the respective event (e.g., content created at a time that does not correspond to the time associated with the respective event) is not associated with the first portion of the first geographic area in the map. For example, said content is optionally not included in the collection of content. Associating the content with the first portion of the first geographic area in accordance with a determination that the third input corresponding to creation of content at the first electronic device was received at a time associated with the respective event simplifies interaction between the user and the electronic device and enhances operability of the electronic device by reducing the need for subsequent inputs to locate content associated with the respective event.

In some embodiments, initiating the process to share the first supplemental map with the second electronic device includes, in accordance with a determination that the first supplemental map is associated with a respective event (e.g., such as described with reference to method 1700), the electronic device initiates a process to create a calendar event for the respective event, such as event 1628 in FIG. 16H, and in accordance with a determination that the first supplemental map is not associated with the respective event, the electronic device forgoes initiating the process create the calendar event for the respective event. In some embodiments, the respective event corresponds to and/or is defined by a calendar event of a calendar application on the first electronic device and/or the second electronic device. In some embodiments, the respective event includes metadata (optionally created by a user of the first electronic device and/or the second electronic device) that associates the respective event to the first supplemental map. For example, the user of the first electronic device optionally creates the first supplemental map for a music festival event, a vacation, a dining 192 experience, an adventure, or a social gathering. In some embodiments, and as described with reference to method 700, the first supplemental map is a map for a discrete and/or temporary event, like a trade show, a music festival or a city fair that has a start date and/or time, and an end date and/or time. In some embodiments, initiating a process to create a calendar event for the respective event includes creating the calendar event for the respective event for storage to a respective calendar application on the first electronic device and/or the second electronic device.

In some embodiments, initiating a process to create a calendar event for the respective event includes creating the calendar event for the respective event with data values from the first supplemental map. For example, said calendar event optionally populates the attendees of the calendar event with users associated with the first supplemental map. In some embodiments, the users associated with the first supplemental map includes users with access to the first supplemental map. In another example, said calendar event is optionally populated with a description of the respective event, location of the respective event, and/or timeframe of the respective event (e.g., start date and/or time, and/or an end date and/or time). In some embodiments, said calendar event data is derived from metadata associated with the calendar event and/or created by the user of the first electronic device. In some embodiments, initiating a process to create a calendar event for the respective event includes displaying the calendar event with the data values from the first supplemental map as described herein. In some embodiments, initiating a process to create a calendar event for the respective event includes providing a link to the first supplemental. In some embodiments, initiating a process to create a calendar event for the respective event is in response to receiving or creating a respective supplemental map. Creating a calendar event for the respective event in accordance with a determination that the first supplemental map is associated with the respective event simplifies interaction between the user and the electronic device and enhances operability of the electronic device by reducing the need for subsequent inputs to create a calendar event and populate the event with data associated with the respective event.

In some embodiments, the first supplemental map is associated with the respective event, and the respective event is associated with a start time (and/or an end time). In some embodiments, after initiating the process to create the calendar event for the respective event, in accordance with a determination that a current time at the first electronic device is within a time threshold (e.g., 30 seconds, 40 seconds, 60 seconds, 5 minutes, 10 minutes, 30 minutes, or 1 hour) of the start time of the respective event, the electronic device displays, via the display generation component, a first indication of the first supplemental map associated with the respective event, such as representation 1632 in FIG. 16I. In some embodiments, the first indication of the first supplemental map associated with the respective event is a visual indication comprising a textual description, graphics and/or icons indicating the respective event and the supplemental map associated with the respective event is available. In some embodiments, the visual indication is selectable to display the supplemental map in the map user interface of the map application. In some embodiments, the visual indication is displayed in a user interface other than the map user interface of the map application, such as a home screen user interface or a wake or lock screen user interface of the first electronic device. In some embodiments, the visual indication is selectable to display the calendar event in the calendar application as described herein. In some embodiments, in accordance with a determination that the current time at the first electronic device is not within the time threshold, the first electronic device forgoes displaying, via the display generation component, the first indication of the first supplemental map associated with the respective event.

In some embodiments, in accordance with a determination that the first electronic device is within a threshold distance (e.g., 0.1, 0.5, 1, 5, 10, 100, 1000, 10000 or 100000 meters) of a location associated with the respective event, the electronic device displays, via the display generation component, the first indication of the first supplemental map associated with the respective event, such as for example, an indication similar to representation 1632 in FIG. 16I. In some embodiments, the location associated with the respective event is determined by the first electronic device from metadata associated with the respective event and/or the corresponding calendar event. In some embodiments, in accordance with a determination that the first electronic device is not within the threshold distance of the location associated with the respective event, the first electronic device forgoes displaying, via the display generation component, the first indication of the first supplemental map associated with the respective event. Displaying the first indication of the first supplemental map associated with the respective event when the current time is within a time threshold of the start time of the respective event or when the first electronic device is within a threshold distance of a location associated with the respective event reduces the need for subsequent inputs to monitor, keep track of the respective event which simplifies the interaction between the user and the electronic device and enhances the operability of the electronic device and makes the user-device interface more efficient.

In some embodiments, the second input that corresponds to the request to share the first supplemental map with the second electronic device includes sharing the first supplemental map with the second electronic device via a messaging user interface, such as messaging user interface 1607 in FIG. 16C. For example, the messaging user interface optionally corresponds to a messaging conversation in a messaging application via which the first electronic device is able to transmit to and/or receive messages from and/or display messages in the messaging conversation from the second electronic device as described with reference to methods 700 and/or 900. Sharing the supplemental map via a messaging user interface facilitates sharing of supplemental maps amongst different users, thereby improving interaction between the user and the electronic device.

In some embodiments, after initiating the process to share the first supplemental map with the second electronic device via the messaging user interface, the electronic device receives an indication of a change to the first supplemental map, such as representation 1609 in FIG. 16C. For example, the change to the supplemental map is optionally provided by an input by a user of the second electronic device and/or the first electronic device. In some embodiments, the change to the supplemental map includes adding, removing, or editing one or more annotations or data elements of the first supplemental map. For example, the data elements optionally includes a description of the first supplemental map, a list of electronic devices having access to the first supplemental map, content including media content associated with the first supplemental map, and/or calendar events associated with the first supplemental map.

In some embodiments, in response to receiving the indication of the change to the first supplemental map, the electronic device displays, via the messaging user interface, the indication of the change to the first supplemental map, such as representation 1609 in FIG. 16C. In some embodiments, the indication of the change to the first supplemental map is a visual indication comprising a textual description, graphics and/or icons indicative of the change to the first supplemental map. In some embodiments, the visual indication is selectable to display the supplemental map in the map user interface of the map application including the change to the first supplemental map. In some embodiments, the visual indication is displayed in a user interface other than the messaging user interface, such as a home screen user interface or a wake or lock screen user interface of the first electronic device. Displaying the indication of the change to the first supplemental map reduces the need for subsequent inputs to monitor, keep track of changes made to the first supplemental map which simplifies the interaction between the user and the electronic device and enhances the operability of the electronic device and makes the user-device interface more efficient.

In some embodiments, while displaying the map user interface of the map application, the electronic device receives, via the one or more input devices, a sequence of one or more inputs corresponding to a request to navigate within the map, such as for example, if in FIG. 16D, the electronic device receives an input to pan or scroll the map user interface 1612a. In some embodiments, the sequence of one or more inputs is received before beginning to navigate along a route or during navigation along the route. For example, the first electronic device enables a user of the electronic device to optionally view an area of the map and/or configure the route from a beginning location to a first destination on the map. In some embodiments, the sequence of one or more inputs corresponding to a request to navigate within the map include requests to pan or scroll through the map.

In some embodiments, in response to the sequence of one or more inputs corresponding to the request to navigate within the map, the electronic device updates the display of the map user interface of the map application to correspond with a current navigation position within the map, such as for example, if in FIG. 16D, the electronic device updates the map user interface 1612a to pan or zoom the map. For example, the first electronic device displays an area of the map corresponding to the current navigation position with the map. In some embodiments, updating the display of the map user interface of the map application to correspond with the current navigation position within the map includes displaying an area of the map centered on a location corresponding to the current navigation position within the map. In some embodiments, the current navigation position within the map is selected by a user of the first electronic device (e.g., by panning or scrolling through the map). In some embodiments, the current navigation position within the map corresponds to the current location of the first electronic device.

In some embodiments, in accordance with a determination that the current navigation position within the map is associated with a first respective geographic area and that the first respective geographic area satisfies one or more first criteria, including a first criterion that is satisfied when the first respective geographic area is associated with a second supplemental map, different from the first supplemental map, previously shared by the second electronic device, the electronic device displays, in the map user interface, an indication of the second supplemental map, such as, for example, an indication similar to representation 1633 in FIG. 16I. In some embodiments, the indication of the second supplemental map has one or more of the characteristics of the first indication of the first supplemental map described herein.

In some embodiments, in accordance with a determination that the current navigation position within the map is associated with the first respective geographic area and that the first respective geographic area satisfies one or more second criteria, including a second criterion that is satisfied when the first respective geographic area is associated with a third supplemental map, different from the second supplemental map, previously shared by the second electronic device, the electronic device displays, in the map user interface, an indication of the third supplemental map, such as, for example, an indication similar to message 1608 in FIG. 16B. In some embodiments, the indication of the third supplemental map has one or more of the characteristics of the first indication of the first supplemental map described herein. For example the third supplemental map is optionally associated with a first event and the second supplemental map is optionally associated with a second event, different from the first event. In some embodiments, the third supplemental map optionally includes a first set of annotations and the second supplemental map optionally includes a second set of annotations, different from the first set of annotations. It is understood that although the embodiments described herein are directed to the second and/or third supplemental map, such functions and/or characteristics, optionally apply to other supplemental maps including the first supplemental map. For example, the indication of the respective supplemental map optionally includes a graphical indication that is displayed at a respective location in the map that the respective supplemental map corresponds to. In some embodiments, the graphical indication is selectable to display the respective supplemental map. In some embodiments, the indication of the respective supplemental map includes a representation of the users who shared the respective supplemental map. Displaying supplemental maps previously shared by other electronic devices while navigating within a map enables a user to view both map-related information and available supplemental maps at the same time, without having to leave the map application, thereby reducing the need for subsequent inputs to locate supplemental maps which simplifies the interaction between the user and the electronic device and enhances the operability of the electronic device and makes the user-device interface more efficient.

In some embodiments, while displaying the map user interface of the map application, the electronic device receives, via the one or more input devices, a third input that corresponds to a request to view a plurality of map content that has been shared with the first electronic device by other electronic devices. For example the plurality of map content optionally includes supplemental maps and/or locations shared with the first electronic device by other electronic devices.

In some embodiments, in response to receiving the second input, the electronic device displays, via the display generation component, a user interface that includes the plurality of map content, such as user interface 1634 in FIG. 16J. In some embodiments, the user interface that includes the plurality of map content corresponds to a user interface of the map application. In some embodiments, the user interface that includes the plurality of map content corresponds to a user interface other than a user interface of the map application, such as a messaging application or a media content application as described with reference to methods 1300 and/or 1500.

In some embodiments, in accordance with a determination that a second supplemental map, different from the first supplemental map, was previously shared by another electronic device with the first electronic device, the electronic device displays the plurality of map content including a visual indication of the second supplemental map, such as representation 1638a in FIG. 16J. In some embodiments, the visual indication of the second supplemental map has one or more of the characteristics of the first indication of the first supplemental map described herein. For example, the visual indication of the second supplemental map is optionally selectable to display the second supplemental map in the map user interface of the map application. In some embodiments, the visual indication of the second supplemental map includes a representation of the users who shared the second supplemental map.

In some embodiments, in accordance with a determination that a location was previously shared by another electronic device with the first electronic device, the electronic device displays the plurality of map content including a visual indication of the location, such as representation 1638b in FIG. 16J. In some embodiments, the visual indication of the location includes a textual description, graphics and/or icons associated with the location. In some embodiments, the visual indication is selectable to display the location in the map user interface of the map application. Displaying map content including supplemental maps previously shared by other electronic devices in a user interface that includes the plurality of map content enables a user to view all map content previously shared by other electronic devices in a single user interface, thereby reducing the need for subsequent inputs to locate map content shared by other electronic devices which simplifies the interaction between the user and the electronic device and enhances the operability of the electronic device and makes the user-device interface more efficient.

In some embodiments, the first annotation to the first portion of the first geographic area includes an emoji (e.g., image or icon used to express an emotion), such as annotation 1618 in FIG. 16E. In some embodiments, the emoji is animated. In some embodiments, the emoji is placed in a variety of locations within the first portion of the first geographic area in accordance with user input directing placement of the emoji. Providing different types of annotations such as emojis simplifies the interaction between the user and the electronic device by reducing the number of inputs needed to include text where an emoji would be appropriate, which reduces clutter in the supplemental map, power usage and improves battery life of the electronic device.

In some embodiments, the emoji includes an animated emoji (e.g., animation used to express an emotion), such as, for example, an animated emoji similar to annotation 1618 in FIG. 16E. In some embodiments, the emoji corresponds to audio and/or video. For example, the first electronic device optionally records audio and/or video which is used to generate a corresponding animated emoji. Providing different types of annotations such as animated emojis simplifies the interaction between the user and the electronic device by reducing the number of inputs include text where an animated emoji is appropriate, which reduces clutter in the supplemental map, power usage and improves battery life of the electronic device.

In some embodiments, the first supplemental map is associated with a vendor (e.g., business and/or creator of the supplemental map). In some embodiments, while displaying the map user interface of the map application, the electronic device receives an indication of content provided by the vendor. In some embodiments, the content provided by the vendor includes promotions, offers, and/or “non-fungible tokens” for goods or services redeemable by the vendor.

In some embodiments, in response to receiving the indication of the content provided by the vendor, the electronic device displays, via the display generation component, a representation of the content provided by the vendor on the first supplemental map, such as, for example, content similar to representation 1616 in FIG. 16E. For example, the representation of the content provided by the vendor on the first supplemental map includes a textual description, graphics and/or icons associated with the content provided by the vendor. In some embodiments, the representation of the content is selectable to display a website of the vendor. In some embodiments, the representation of the content provided by the vendor is displayed at or near the top (or bottom) of the first supplemental map and/or at a location in the map associated with the vendor. In some embodiments, the first electronic device receives an indication of a change of content or new content provided by the vendor, and in response to receiving the indication of the change of content or new content provided by the vendor, the first electronic device displays a representation of the change of content or the new content provided by the vendor. In some embodiments, the representation of the change of content or the new content provided by the vendor replaces a previously displayed representation of content provided by the vendor (e.g., the first electronic device ceases to display the previously displayed representation of content provided by the vendor). Displaying representations of content provided by vendors on supplemental maps enables a user to view both map-related information and content provided by vendors at the same time, without having to leave the map application, thereby reducing the need for subsequent inputs to research and find vendor content which simplifies the interaction between the user and the electronic device and enhances the operability of the electronic device and makes the user-device interface more efficient.

In some embodiments, initiating the process to share the first supplemental map with the second electronic device includes, in accordance with a determination that the second input that corresponds to the request to share the first supplemental map with the second electronic device indicates a first access option for the first supplemental map, the electronic device initiates the process to share the first supplemental map with one or more first electronic devices, including the second electronic device, according to the first access option, such as for example sharing via messaging user interface 1607 in FIG. 16C. In some embodiments, the second access option sets the first supplemental map open to access by the general public (e.g., all electronic devices that have the map application). For example, the one or more first electronic devices are part of the general population and were not pre-selected by the first electronic device. In some embodiments, the one or more first electronic devices including the second electronic device are permitted to share the first supplemental map to other electronic devices without restriction (e.g., without permission from the creator and/or users of the first supplemental map to share the first supplemental map to the other electronic devices).

In some embodiments, in accordance with a determination that the second input that corresponds to the request to share the first supplemental map with the second electronic device indicates a second access option for the first supplemental map, different from the first access option, the electronic device initiates the process to share the first supplemental map with one or more second electronic devices, including the second electronic device, according to the second access option, such as for example, as shown in FIG. 16B where the electronic device 500 is sharing a supplemental map via message 1608. In some embodiments, the second access option is limited to a pre-selected group: the one or more second electronic devices including the second electronic device. In some embodiments, initiating the process to share the first supplemental map with one or more second electronic devices, including the second electronic device, includes one or more of the characteristics of initiating the process to share the first supplemental map with the second electronic device as described herein. In some embodiments, after initiating the process to share the first supplemental map with one or more second electronic devices, including the second electronic device, the one or more second electronic devices, including the second electronic device, are not permitted to share the first supplemental map with other electronic devices. In this case, the first supplemental is accessible to only the first electronic device, the second electronic device, and the one or more second electronic devices. Providing the option to share supplemental maps to pre-selected electronic devices or all electronic devices (e.g., general public) preserves user privacy.

In some embodiments, the first annotation to the first portion of the first geographic area includes a location indicator that indicates a location on the first supplemental map, such as location indicator 1613 in FIG. 16D. In some embodiments, the location corresponds to a location selected by the first electronic device. For example, a user of the first electronic device optionally provides user input corresponding to the selection of the location as a meeting location or the location as a favorite location. In some embodiments, the location corresponds to the current location of the first electronic device. In some embodiments, the current location of the first electronic device is different from the location selected, via user input, by the user of the first electronic device. In some embodiments, the location indicator that indicates the location on the first supplemental map is a graphic, icon, image, or emoji representing the location on the first supplemental map. Providing the option to share a location indicator on the first supplemental maps simplifies the interaction between the user and the electronic device by providing quick location identification and reducing the number of inputs needed to display guiding or other map-related information to identify the location and avoids erroneous inputs related to sharing the location, which reduces power usage and improves battery life of the electronic device.

It should be understood that the particular order in which the operations in method 1700 and/or FIG. 17 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 17 are, optionally, implemented by components depicted in FIGS. 1A-1B. For example, displaying operation 1702a, and receiving operation 1702c, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces for Obtaining Access to Supplemental Map Information

Users interact with electronic devices in many different manners, including interacting with maps and maps applications for viewing information about various locations. In some embodiments, an electronic device facilitates a way to obtain access to supplemental maps via a map store user interface thus enhancing the user's interaction with the device. The embodiments described below provide ways to download supplemental maps directly from the map store user interface and/or view information about supplemental maps, thereby simplifying the presentation of information to the user and interactions with the user, which enhances the operability of the device and makes the user-device interface more efficient. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

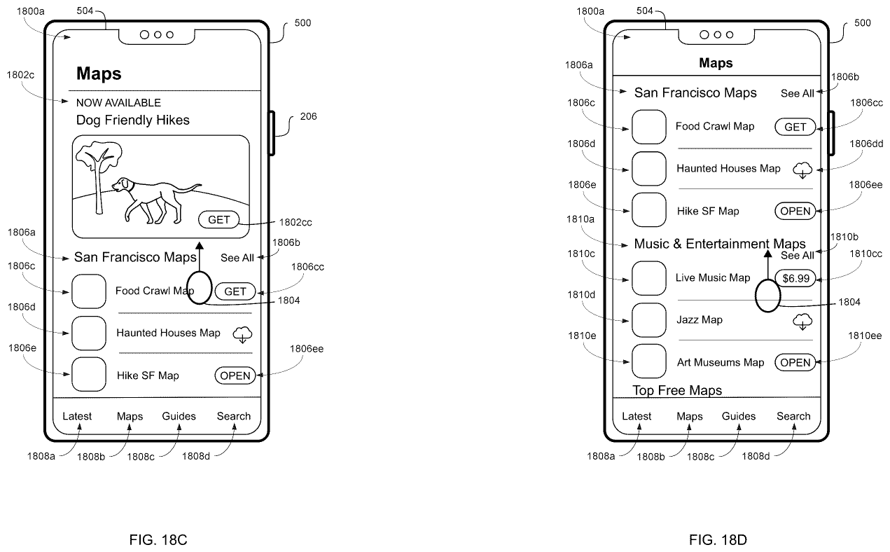

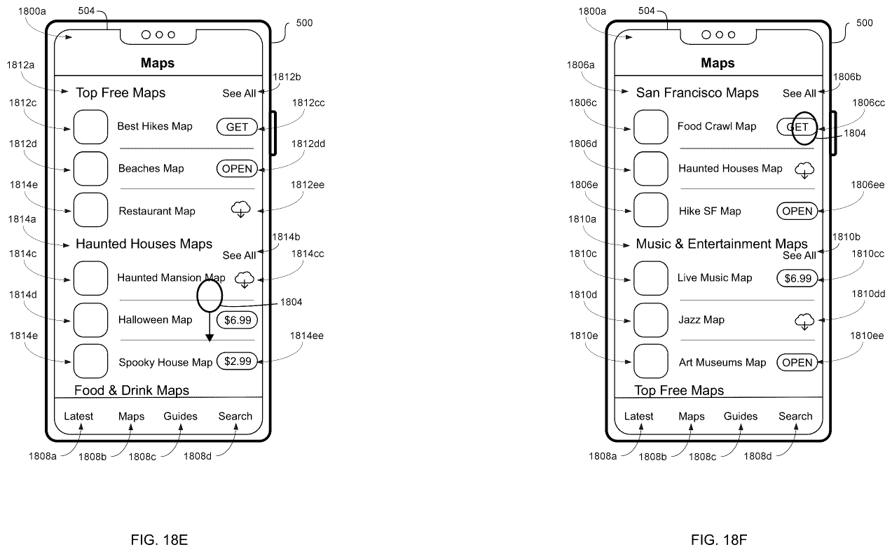

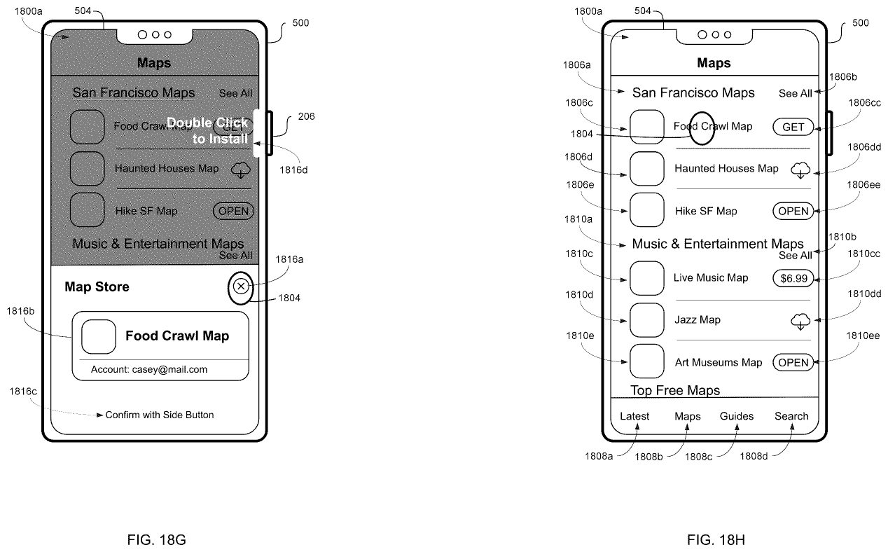

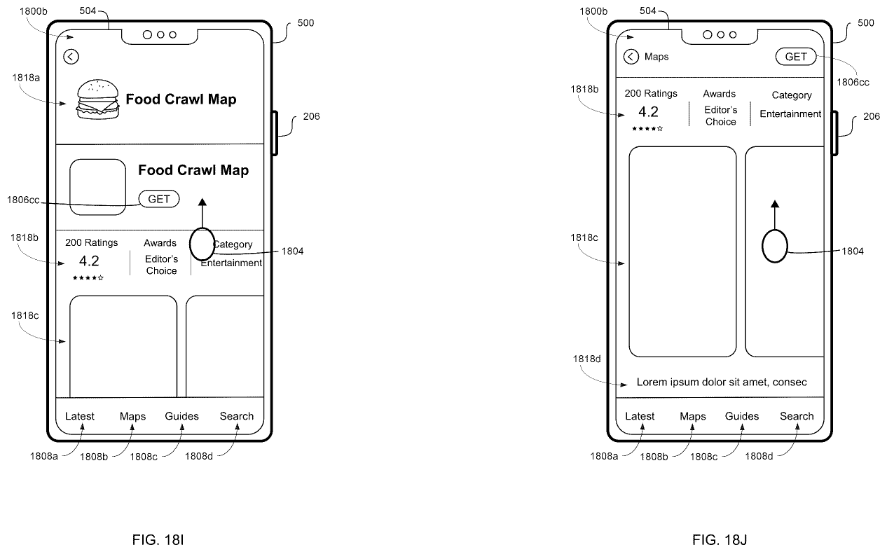

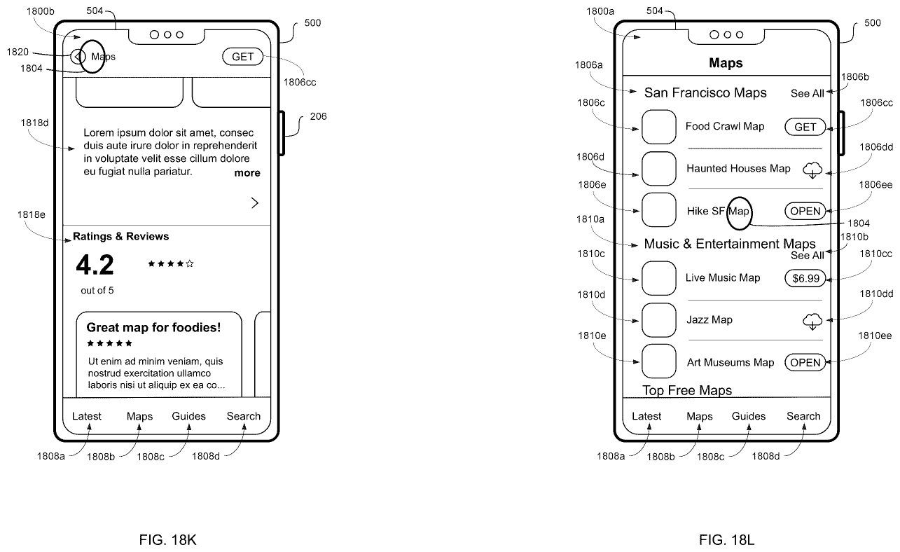

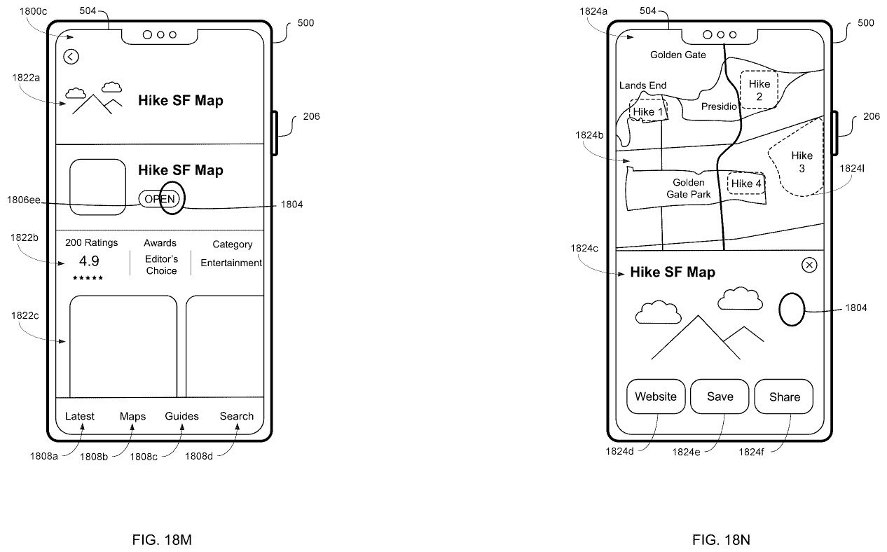

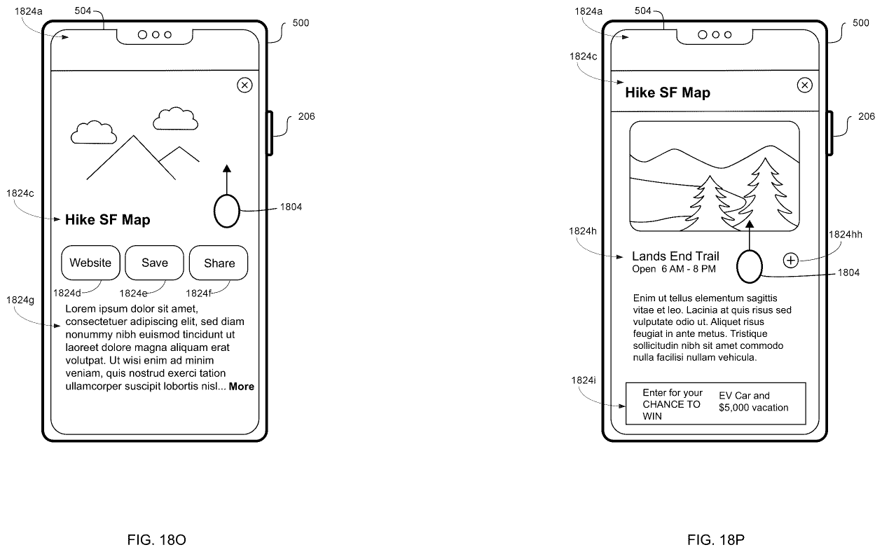

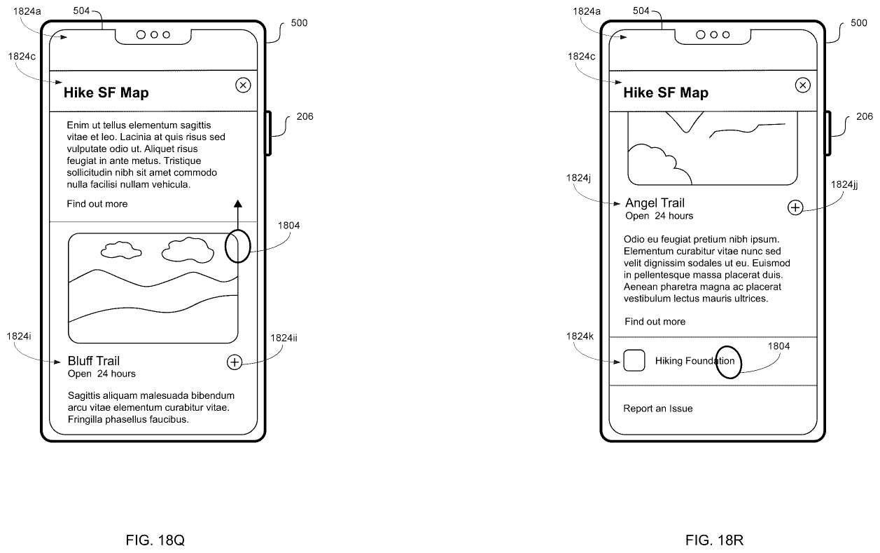

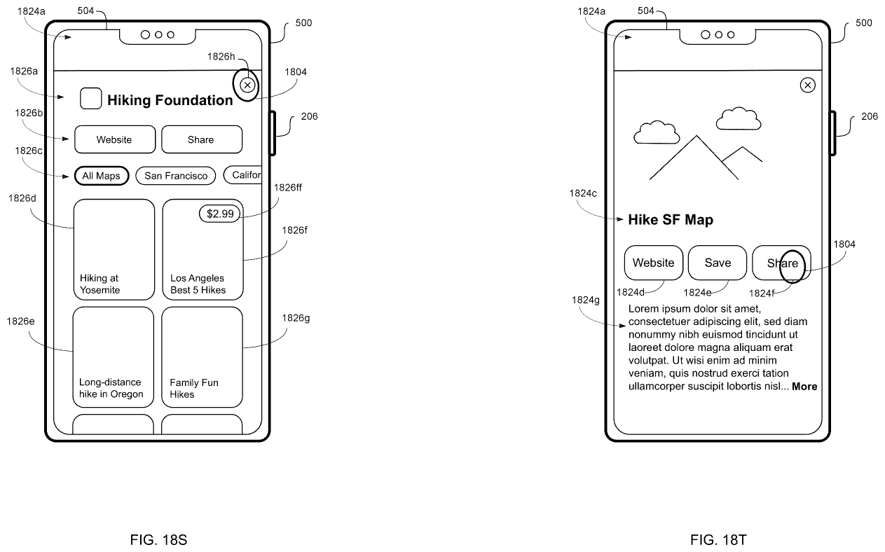

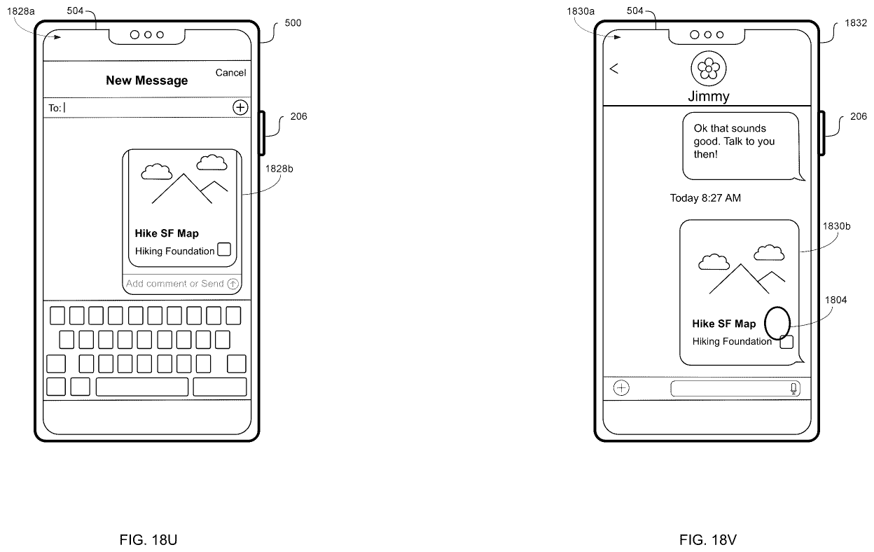

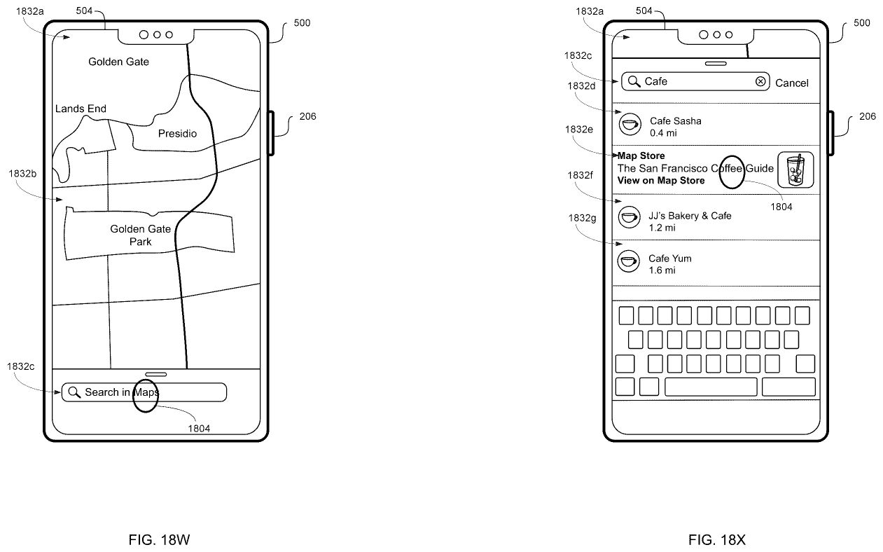

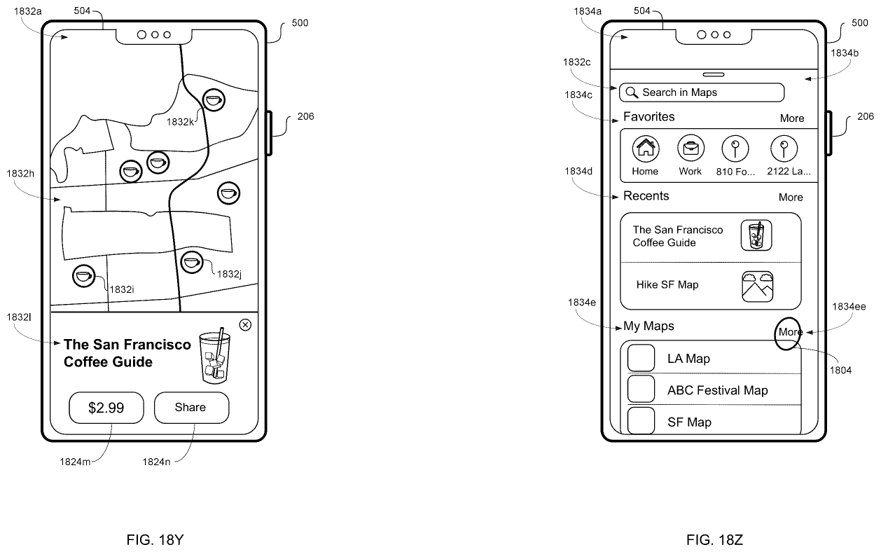

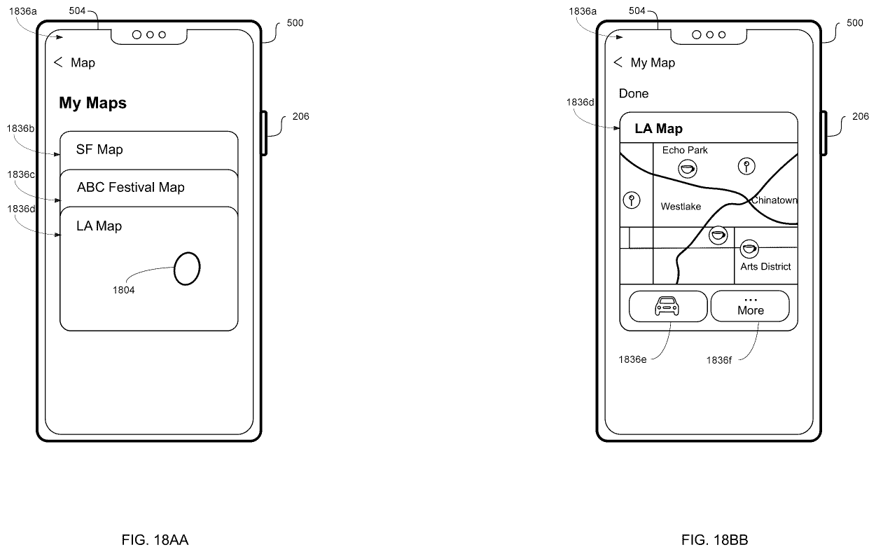

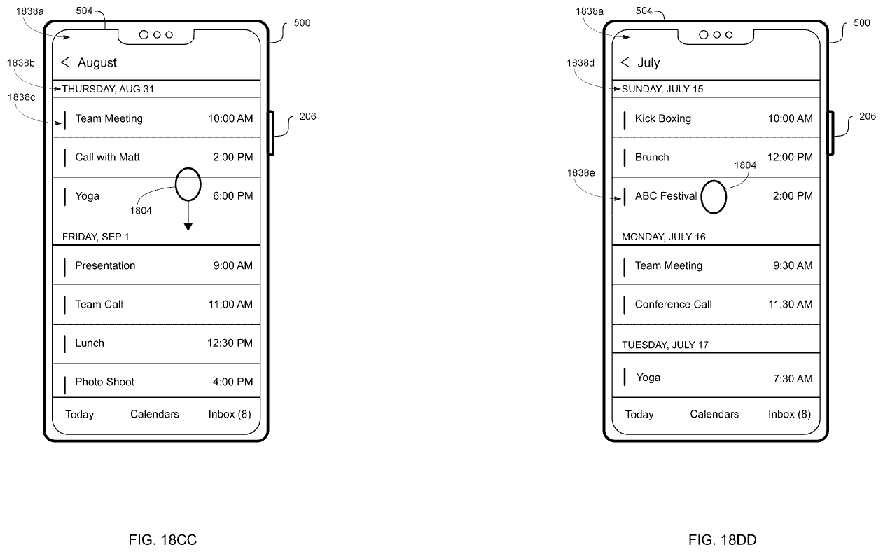

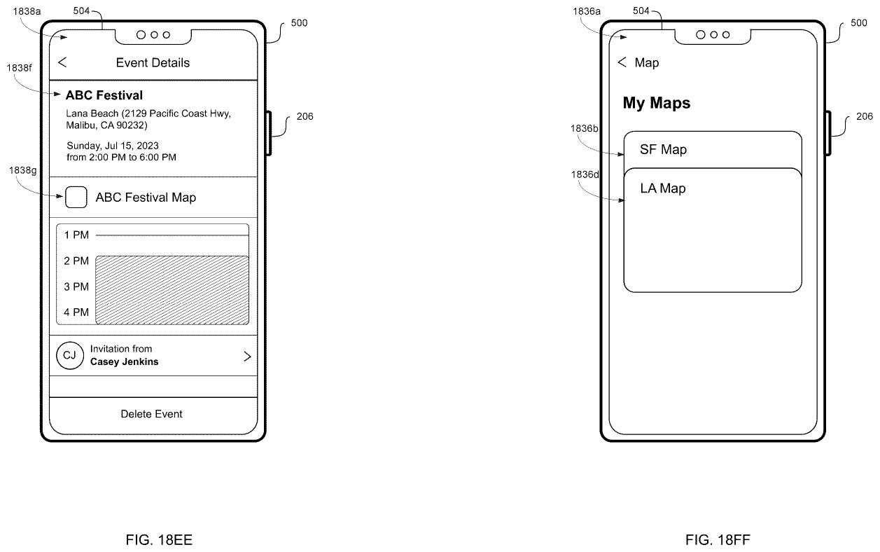

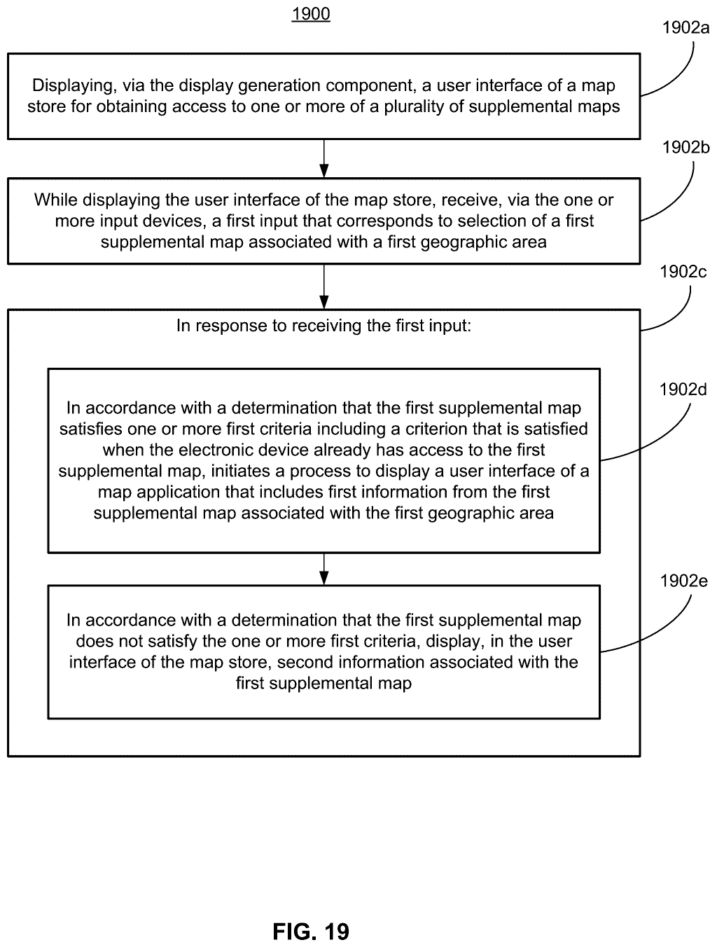

FIGS. 18A-18FF illustrate exemplary ways in which an electronic device facilitates a way to obtain access to supplemental maps via a map store user interface. The embodiments in these figures are used to illustrate the processes described below, including the processes described with reference to FIG. 19. Although FIGS. 18A-18FF illustrate various examples of ways an electronic device is able to perform the processes described below with respect to FIG. 19, it should be understood that these examples are not meant to be limiting, and the electronic device is able to perform one or more processes described below with reference to FIG. 19 in ways not expressly described with reference to FIGS. 18A-18FF.

FIG. 18A illustrates an electronic device 500 displaying a user interface 1800a. In some embodiments, the user interface 1800a is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

As shown in FIG. 18A, the electronic device 500 presents a map store application. For example, the map store application can present maps (e.g., primary maps and/or supplemental maps), routes, location metadata, and/or imagery (e.g., captured photos) associated with various geographical locations, points of interest, etc. The map store application can obtain map data that includes primary maps, supplemental maps, data defining maps, map objects, routes, points of interest, imagery, etc., from a server. For example, the map data can be received as map tiles that include map data for geographical areas corresponding to the respective map tiles. The map data can include, among other things, data defining roads and/or road segments, metadata for points of interest and other locations, three-dimensional models of the buildings, infrastructure, and other objects found at the various locations, and/or images captured at the various locations. The map store application can request, from the server through a network (e.g., local area network, cellular data network, wireless network, the Internet, wide area network, etc.), map data (e.g., map tiles) associated with locations that the electronic device frequently visits. The map store application can store the map data in a map database. The map store application can use the map data stored in map database and/or other map data received from the server to provide map store application features described herein (e.g., maps, navigation route previews, points of interest previews, etc.). In some embodiments, the server can be a computing device, or multiple computing devices, configured to store, generate, and/or provide map data to various user devices (e.g. first electronic device 500), as described herein. For example, the functionality described herein with reference to the server can be performed by a single computing device or can be distributed amongst multiple computing devices.

As shown in FIG. 18A, the first electronic device 500 presents a user interface 1800a (e.g., of a map store application installed on electronic device 500) on display generation component 504. In FIG. 18A, the user interface 1800a is currently presenting a first plurality of supplemental map user interface objects (e.g., representations 1802a, 1806a, 1806c, 1806d, and 1806e) described with reference to methods 700, 900, 1100, 1300, 1500, 1700, 1900, 2100, and 2300. In some embodiments, a supplemental map user interface object (e.g., representations 1802a, 1806a, 1806c, 1806d, and 1806e) include a description of and/or icon of the supplemental map that, when selected, causes the electronic device 500 to initiate a process to display information associated with the supplemental map as described with reference to methods 1300, 1500, 1700, 1900, and 2100. In some embodiments, the supplemental map user interface objects are organized in a layout as shown in user interface 1800a. For example, user interface 1800a includes representation 1802a of a first supplemental map contained within carousel user interface element that, when selected, causes the electronic device to navigate through the representations of the respective plurality of supplemental maps as will be described below with reference to at least FIGS. 18B and 18C. In some embodiments, representation 1802a of the first supplemental map is visually emphasized (e.g., larger and/or includes more content) relative to other representations of supplemental maps (e.g., representations 1806a, 1806c, 1806d, and 1806e) because representation 1802a of the first supplemental map is a featured map or a supplemental map promoted by the map store application. In FIG. 18A, the layout of representations of supplemental maps includes a first grouping of supplemental maps (e.g., representations 1806a, 1806c, 1806d, and 1806e). In some embodiments, the first grouping of supplemental maps is based on a shared criteria as described with reference to method 1900. In FIG. 18A, the first grouping of supplemental maps share a same geographic location (e.g., “San Francisco Maps”). In FIG. 18A, the user interface 1800a includes for each grouping of supplemental maps an option (e.g., representation 1806b) that, when selected causes the electronic device 500 to display all supplemental maps of the respective grouping instead a subset of supplemental maps as shown by the first grouping of supplemental maps (e.g., representations 1806a, 1806c, 1806d, and 1806e). Other groups of supplemental maps based on respective shared criteria, different from the shared criteria associated with the first grouping of supplemental maps will be described with reference to at least FIGS. 18D and 18E.

In some embodiments, a supplemental map user interface object (e.g., representations 1802a, 1806a, 1806c, 1806d, and 1806e) includes an option (e.g., representations 1802aa, 1806cc, 1806ds, and 1806ee) that, when selected, causes the electronic device 500 to initiate a process to obtain access to the supplemental map as described with reference to method 1900 and illustrated in at least FIGS. 18F and 18M.

In FIG. 18A, user interface 1800a includes option 1808a that, when selected, causes the electronic device to filter the plurality of supplemental maps by displaying, in user interface 1800a, the latest or most recent supplemental maps available via the map store application. User interface 1800a also includes option 1808d that, when selected, causes the electronic device to display the first plurality of supplemental map user interface objects (e.g., representations 1802a, 1806a, 1806c, 1806d, and 1806e) as shown by user interface 1802a in FIG. 18A. User interface 1800a also includes option 1808c that, when selected, causes the electronic device to display a second plurality of supplemental map user interface objects, different from the first plurality of supplemental map user interface objects. In some embodiments, the second plurality of supplemental map user interface objects include editorial content as described with reference to methods 1900 and/or 2100.

In some embodiments, the electronic device 500 detects user input 1804 (e.g., a swipe contact on a touch-sensitive surface and/or a voice input from the user) corresponding to a request to navigate (e.g., swipe) through the plurality of supplemental maps contained within the carousel user interface element, and in response, the electronic device 500 displays representation 1802b of a second supplemental map in FIG. 18B, different from the first supplemental map displayed in user interface 1800a, via the carousel user interface element, in FIG. 18A. For example, representation 1802b of the second supplemental map is based on editorial content while representation 1802a of the first supplemental map is based a current location of the electronic device 500.

In FIG. 18B, the electronic device 500 detects user input 1804 (e.g., a swipe contact on a touch-sensitive surface and/or a voice input from the user) corresponding to a request to navigate (e.g., swipe) through the plurality of supplemental maps contained within the carousel user interface element, and in response, the electronic device 500 displays representation 1802c of a third supplemental map in FIG. 18C, different from the first supplemental map and the second supplemental map displayed in user interface 1800a, via the carousel user interface element, in FIGS. 18A and 18B, respectively. For example, representation 1802c of the second supplemental map is based on user-generated content and does not include editorial content.

As described earlier, supplemental maps are optionally grouped based on a shared criteria. For example, in FIG. 18C, the electronic device 500 detects user input 1804 (e.g., a swipe contact on a touch-sensitive surface and/or a voice input from the user) corresponding to a request to navigate (e.g., scroll) through the plurality of supplemental maps in user interface 1800a, and in response, the electronic device 500 displays a second grouping of supplemental maps (e.g., representations 1810a, 1810c, 1810d, and 1810e) in FIG. 18D. In some embodiments, the second grouping of supplemental maps is based on a shared criteria, different from the shared criteria associated with the first grouping of supplemental maps (e.g., representations 1806a, 1806c, 1806d, and 1806e). In FIG. 18A, the second grouping of supplemental maps share a same subject matter and/or activity type (e.g., “Music and Entertainment Maps”). The user interface 1800a includes other groups of supplemental maps based on respective shared criteria. For example, in FIG. 18D, the electronic device 500 detects user input 1804 (e.g., a swipe contact on a touch-sensitive surface and/or a voice input from the user) corresponding to a request to navigate (e.g., scroll) through the plurality of supplemental maps in user interface 1800a, and in response, the electronic device 500 displays a third grouping of supplemental maps (e.g., representations 1812a, 1812c, 1812d, and 1812e) and a fourth grouping of supplemental maps (e.g., representations 1814a, 1814c, 1814d, and 1814e) in FIG. 18E. In some embodiments, the third grouping of supplemental maps is based on a shared criteria, different from the shared criteria associated with the fourth grouping of supplemental maps. In FIG. 18E, the third grouping of supplemental maps share a same business model, that is, the supplemental maps are accessible to the electronic device without payment (e.g., “Top Free Maps”) while the fourth grouping of supplemental maps share a same business type of offering haunted house experiences (e.g., “Haunted Houses Maps”). In some embodiments, the supplemental maps and their respective representations include one or more of the characteristics of the supplemental maps described with reference to methods 700, 900, 1100, 1300, 1500, 1700, 1900, 2100, and 2300.

After the electronic device 500 enables the user to browse through the plurality of maps, in FIG. 18E, the electronic device 500 detects user input 1804 (e.g., a swipe contact on a touch-sensitive surface and/or a voice input from the user) corresponding to a request to navigate (e.g., scroll) back to the first grouping of supplemental maps plurality of supplemental maps in user interface 1800a, and in response, the electronic device 500 displays a first grouping of supplemental maps (e.g., representations 1806a, 1806c, 1806d, and 1806e) and the second grouping of supplemental maps (e.g., representations 1810a, 1810c, 1810d, and 1810e) as shown in FIG. 18F.

In FIG. 18F, the electronic device detects user input 1804 (e.g., a contact on a touch-sensitive surface, actuation of a physical input device of the electronic device 500 or in communication with the electronic device 500, and/or a voice input from the user) corresponding to selection of an option (e.g., representation 1806cc) to access (e.g., save and/or download the supplemental map to the electronic device and/or purchase the supplemental map for download by the electronic device and/or a user account associated with the electronic device) the supplemental map (e.g., representation 1806c), and in response, the electronic device 500 displays user interface element 1816b in FIG. 18G. User interface element 1816b is displayed as overlaid over user interface 1800a and includes content 1816c instructing the user of the electronic device 500 the action required to access the supplemental map. In response to the user input corresponding to selection of the option to access the supplemental map (e.g., representation 1806cc), the electronic device 500 displays content instructing the user of the user input (e.g., double click of push button 206) required to access the supplemental map (e.g., representation 1816d). User interface element 1816b also includes an option (e.g., representation 1816a), that when selected causes the electronic device to cancel the process to access the supplemental map. In some embodiments, the user interface element 1816b configured to confirm user access of the supplemental map by the electronic device includes one or more of the characteristics of the supplemental maps described with reference to methods 700, 900, 1100, 1300, 1500, 1700, 1900, 2100, and 2300.

In FIG. 18G, the electronic device detects user input 1804 (e.g., a contact on a touch-sensitive surface, actuation of a physical input device of the electronic device 500 or in communication with the electronic device 500, and/or a voice input from the user) corresponding to selection of the option (e.g., representation 1816a) to cancel the process to access the supplemental map, and in response, the electronic device 500 cancels the process to access the supplemental map and ceases to display user interface element 1816b as shown in FIG. 18H.

In FIG. 18H, the electronic device detects user input 1804 (e.g., a contact on a touch-sensitive surface, actuation of a physical input device of the electronic device 500 or in communication with the electronic device 500, and/or a voice input from the user) corresponding to selection of the representation 1806c of the supplemental map, and in response the electronic device 500 displays user interface 1800b in FIG. 18I. User interface 1800b includes detailed information about the supplemental map, such as a title and/or icon representative of the supplemental map (e.g., representation 1818a); summarized information (e.g., representation 1818b) about the supplemental map, such as an overall rating, awards, and/or category of the supplemental map; and/or one or more graphics and/or preview images (e.g., representation 1818c) of the supplemental map. In some embodiments, the user interface 1800b includes additional information associated with the supplemental map. For example, the electronic device 500 detects user input 1804 (e.g., a swipe contact on a touch-sensitive surface and/or a voice input from the user) corresponding to a request to navigate (e.g., scroll) user interface 1800b to view the additional information associated with the supplemental map in FIG. 18I, and in response, the electronic device 500 displays the one or more graphics and/or preview images (e.g., representation 1818c) of the supplemental map in their entirety in FIG. 18J instead of partially displaying the one or more graphics and/or preview images as previously shown in FIG. 18I. In FIG. 18J, the user interface 1800b also includes a portion of a detailed description of the supplemental map (e.g., 1818d).

In FIG. 18J, the electronic device 500 detects user input 1804 (e.g., a swipe contact on a touch-sensitive surface and/or a voice input from the user) corresponding to a request to navigate (e.g., scroll) user interface 1800b to view more of the additional information associated with the supplemental map, and in response, the electronic device 500 displays the entire detailed description of the supplemental map (e.g., 1818d) in FIG. 18K instead of a portion of the detailed description of the supplemental map (e.g., 1818d) as previously shown in FIG. 18J. In FIG. 18K, the user interface 1800b also information related to ratings and reviews of the supplemental map (e.g., 1818e). In some embodiments, the user interface element 1800b including information about the supplemental map includes one or more of the characteristics of the supplemental maps described with reference to methods 700, 900, 1100, 1300, 1500, 1700, 1900, 2100, and 2300.

In some embodiments, the electronic device 500 initiates an operation to display the supplemental map (e.g., display a user interface of a map application that includes information from the supplemental map) if the supplemental map has already been downloaded to the electronic device 500 and/or the user account associated with the electronic device 500 has access to the supplemental map. For example, after scrolling user interface 1800b to display the information associated with the supplemental illustrated in FIG. 18K, the electronic device 500 detects user input 1804 (e.g., a contact on a touch-sensitive surface, actuation of a physical input device of the electronic device 500 or in communication with the electronic device 500, and/or a voice input from the user) corresponding to selection of the option (e.g., representation 1820) to navigate back to the plurality of supplemental maps, and in response the electronic device 500 displays user interface 1800a in FIG. 18L. User interface 1800a includes the same user interface elements, representations of supplemental maps, options, and content as previously described with reference to at least FIG. 18A.

In FIG. 18L, the electronic device detects user input 1804 (e.g., a contact on a touch-sensitive surface, actuation of a physical input device of the electronic device 500 or in communication with the electronic device 500, and/or a voice input from the user) corresponding to selection of the representation 1806e of the supplemental map, and in response the electronic device 500 displays user interface 1800c in FIG. 18M. User interface 1800c includes one or more similar user interface elements, information, and options as previously described with reference to user interface 1800b in FIG. 18L. In FIG. 18M, the supplemental map is already accessible by the electronic device as indicated by the option (e.g., representation 1806ee) that, when selected, causes the electronic device to display user interface 1824a in FIG. 18N of a map application that includes information from the supplemental map. In some embodiments, the information includes additional map details about points of interests within a particular geographic area, such as businesses, parks, performance stages, restaurants, trails, and/or the like that are not included in a primary map as described with reference to methods 700, 900, 1100, 1300, 1500, 1700, 1900, 2100, and 2300.

In FIG. 18N, user interface 1824a includes the information from the supplemental map (e.g., representation 18241) as overlaid on the primary map (e.g., representation 1824b), overlaid on the information from the primary map, and/or replacing information from the primary map. For example, in FIG. 18N, the electronic device 500 displays the user interface 1824a of the map application including supplemental map information, such as hiking areas in San Francisco (e.g., representation 18241) as overlaid on the primary map (e.g., representation 1824b). In this example, the supplemental map information includes information about hiking trails, elevation gain, trail attractions (e.g., views, waterfalls, and/or the like), terrain (e.g., paved or not paved), restrooms, water stations, and/or the like that are relevant to the hiking areas in San Francisco, and such supplemental map information is optionally not included in the primary map.

In some embodiments, the electronic device 500 visually distinguishes portions of the primary map that include supplemental map information from portions of the primary map that do not include the supplemental map information. For example, in FIG. 18N, electronic device 500 displays representation 18241 with a dashed outline, different color and/or shading than other portions of the primary map areas. In some embodiments, the electronic device 500 displays additional supplemental map information, different from the supplemental map information overlaid on the primary map, such as text, photos, links, and/or selectable user interface elements objects configured to perform one or more operations related to the supplemental map. For example, in FIG. 18N, the electronic device 500 displays user interface element 1824c as half expanded. In some embodiments, when the user interface element 1824c is half expanded, the additional supplemental map information includes a title and photo of the supplemental map; a first option (e.g., representation 1824d) that, when selected, causes the electronic device 500 to display a webpage corresponding to the supplemental map; a second option (e.g., representation 1824e) that, when selected, causes the electronic device 500 to save the supplemental map to another application other than the map application; and a third option (e.g., representation 1824f) that, when selected, causes the electronic device 500 to share the supplemental to a second electronic device as will be described with reference to FIGS. 18T and 18U.

As shown in FIG. 18N, the user interface element 1824c is displayed as half expanded, but in some embodiments, the user interface element 1824c is displayed as fully expanded. For example, in FIG. 18N, the electronic device detects user input 1804 (e.g., a contact on a touch-sensitive surface, actuation of a physical input device of the electronic device 500 or in communication with the electronic device 500, and/or a voice input from the user) corresponding to selection of the user interface element 1824c, and in response the electronic device 500 displays user interface element 1824c as fully expanded as shown in FIG. 18O. In FIG. 18O, the user interface 1824c includes an overview (e.g., representation 1824g) describing the supplemental map. In some embodiments, the user interface element 1824c includes information about the plurality of points of interest included in the supplemental map. For example, in FIG. 18O, the electronic device 500 detects user input 1804 (e.g., a swipe contact on a touch-sensitive surface and/or a voice input from the user) corresponding to a request to navigate (e.g., scroll) user interface 1824c to view information about the plurality of points of interest included in the supplemental map, and in response, the electronic device 500 displays a representation 1824h of a first point of interest as shown in FIG. 18P. The representation 1824h of the first point of interest (e.g., “Lands End Trail”) includes a title, description, an image, and an option (e.g., representation 1824hh) that, when selected, causes the electronic device 500 to add the first point of interest to a map guide and/or a different supplemental map. In some embodiments, the representation of the point of interest and/or the point of interest of the supplemental map includes one or more of the characteristics of the points of interest and/or destinations of the supplemental maps described with reference to methods 700, 900, 1100, 1300, 1500, 1700, 1900, 2100, and 2300.

In some embodiments, the supplemental map includes advertisement content as described with reference to method 1900. For example, in FIG. 18P, the electronic device displays representation 1824i of advertisement content that, when selected, causes the electronic device 500 to display information related to an electronic vehicle sweepstakes. In some embodiments, the user elects to view more of the plurality of points of interest included in the supplemental map. For example, in FIG. 18P, the electronic device 500 detects user input 1804 (e.g., a swipe contact on a touch-sensitive surface and/or a voice input from the user) corresponding to a request to navigate (e.g., scroll) user interface 1824c to view information a second point of interest included in the supplemental map, and in response, the electronic device 500 scrolls through user interface 1824c and displays a representation 1824i of a second point of interest as shown in FIG. 18Q. The representation 1824i of the second point of interest (e.g., “Bluff Trail”) includes information similar to the first point of interest 1824h as described with reference to FIG. 18P.

In FIG. 18Q, the electronic device 500 device detects user input 1804 (e.g., a swipe contact on a touch-sensitive surface and/or a voice input from the user) corresponding to a request to navigate (e.g., scroll) user interface 1824c to the end of the list of the plurality of the points of interest included in the supplemental map, and in response, the electronic device 500 scrolls through user interface 1824c and displays a representation 1824j of the last listed point of interest as shown in FIG. 18R. The representation 1824j of the last listed point of interest (e.g., “Angel Trail”) includes information similar to the first point of interest 1824h as described with reference to FIG. 18P.

In some embodiments, the electronic device 500 identifies the source and/or creator of the supplemental map. For example, in FIG. 18R, the user interface element 1824c includes a representation 1824k of the creator of the supplemental map that, when selected, (e.g., as shown by user input 1804, such as a contact on a touch-sensitive surface, actuation of a physical input device of the electronic device 500 or in communication with the electronic device 500, and/or a voice input from the user corresponding to selection of the representation 1824k), causes the electronic device 500 to display user interface element 1826a in FIG. 18S. User interface element 1826a includes a title and/or icon representing the creator of the supplemental map and one or more options (e.g., representation 1826b) that, when selected, causes the electronic device 500 to display a webpage corresponding to the creator of the supplemental map and share the representation 1824k of the creator of the supplemental map and/or a user interface element similar to the user interface element 1826a to a second electronic device, respectively. User interface element 1826a further includes options (e.g., representation 1826) to filter the plurality of supplemental maps offered by the creator. For example, in FIG. 18S, the user interface element includes all supplemental maps offered by the creator as indicated by representation 1826 filter option “All Maps”. In FIG. 18S, the user interface element 1826a displays the results of the filter option “All Maps” as show by the representations 1826d, 1826e, 182f, and 1826g of supplemental maps. In some embodiments, the user interface element 1826a includes the supplemental maps downloaded to the electronic device 500 and/or accessible by a user account associated with the electronic device 500 (e.g., representations 1826d, 1826e, and 1826g). In some embodiments, the user interface element 1826a includes supplemental maps and/or information from supplemental maps (e.g., bonus, additional content) that are purchasable by the electronic device as indicated by representation 1826ff of costs associated with obtaining access to such bonus, additional content (e.g., representation 1826f) for download to the electronic device 500. For example, if the electronic device 500 detects user input corresponding to selection of representation 1826ff, the electronic device 500 initiates an operation to purchase the bonus, additional content. In some embodiments, initiating the operation to purchase the bonus, additional content includes the electronic device 500 displaying a user interface element similar to the user interface element 1816b as shown in FIG. 18G.

In some embodiments, the electronic device 500 detects user input 1804 (e.g., a contact on a touch-sensitive surface, actuation of a physical input device of the electronic device 500 or in communication with the electronic device 500, and/or a voice input from the user) corresponding to selection of an option (e.g., representation 1826h) to close or cease displaying user interface element 1826a, and in response the electronic device 500 displays user interface element 1824a as shown in FIG. 18T. The user interface element 1824a includes one or more same user interface elements, information about the supplemental map, options, and content as previously described with reference to at least FIG. 18O.

In FIG. 18T, the electronic device 500 detects user input 1804 (e.g., a contact on a touch-sensitive surface, actuation of a physical input device of the electronic device 500 or in communication with the electronic device 500, and/or a voice input from the user) corresponding to selection of an option (e.g., representation 1824f) to share the supplemental map via a messaging user interface, and in response the electronic device 500 displays messaging user interface element 1828a as shown in FIG. 18U. As shown in FIG. 18U, the messaging user interface includes a message 1828b that includes a representation of the supplemental map. In some embodiments, the electronic device transmits message 1828b including the representation of the supplemental map to a second electronic device 1832 as shown in FIG. 18V.

FIG. 18V illustrates the second electronic device 1832 (e.g., such as described with reference to electronic device 500). In FIG. 18V, the second electronic device is associated with a user account (e.g., “Jimmy”), different from the user account (e.g., “Casey”) associated with electronic device 500. In FIG. 18V, a messaging user interface 1830a is displayed via a display generation component 504 (e.g., such as described with reference to display generation component 504 of electronic device 500). The messaging user interface 1830a includes a message 1830b received from the electronic device 500 that includes the representation of the supplemental map. In FIG. 18V, the second electronic device 1832 detects user input 1804 (e.g., a contact on a touch-sensitive surface, actuation of a physical input device of the electronic device 500 or in communication with the electronic device 500, and/or a voice input from the user) corresponding to selection of message 1830b, and in response the second electronic device 1832 determines whether the second electronic device 1832 already has access to the supplemental map as described with reference to method 1900. In some embodiments, if the second electronic device 1832 determines that the second electronic device 1832 already has access to the supplemental map, the second electronic device 1832 displays a user interface of the map application that includes information from the supplemental similarly to the user interface 1824a in FIG. 18N. In some embodiments, if the second electronic device 1832 determines that the second electronic device 1832 does not have access to the supplemental map, the second electronic device 1832 displays a user interface of the map store application that includes information associated with the supplemental similarly to the user interface 1800b in FIG. 18I. The respective information associated with the supplemental map displayed based on whether the second electronic device 1832 and/or the electronic device 500 has access to the supplemental map is described with reference to method 1900.

In some embodiments, and as will be described with reference to FIGS. 18W-18Y, the electronic device 500 provides a search function for discovering supplemental maps via a user interface other than a user interface of the map store, such as for example a user interface of the map application. For example, in FIG. 18W, the electronic device 500 displays user interface 1832a that includes a primary map (e.g., representation 1832b) of a geographic area of San Francisco. User interface 1832a includes a search field or search user interface element 1832c configured to search for points of interest and/or supplemental maps that satisfy a search parameter. For example, the electronic device detects a sequence of user inputs starting with user input 1804 (e.g., a contact on a touch-sensitive surface, actuation of a physical input device of the electronic device 500 or in communication with the electronic device 500, and/or a voice input from the user) corresponding to selection of the search user interface element 1832c and one or more user inputs for inputting a search parameter, and in response the electronic device 500 displays the user interface 1832a in FIG. 18X including one or more representations of map results (e.g., representations 1832d, 1832e, 1832f, and 1832g) that satisfy the search parameter (e.g., “Café”) included inputted in search user interface element 1832c

In FIG. 18X, the one or more representations of map results include representations of points of interest (e.g., representations 1832d, 1832f, and 1832g) that, when selected, causes the electronic device to initiate navigation directions to the respective point of interest. The representations of map results also include a representation 1832e of a supplemental map. In some embodiments, the representation 1832e of the supplemental map includes a title, description, icon, and an option that, when selected, causes the electronic device 500 to display a user interface of the map store application that include detailed information about the supplemental map similar to the user interface 1800c in FIG. 18M.

In some embodiments, the electronic device 500 detects user input 1804 (e.g., a contact on a touch-sensitive surface, actuation of a physical input device of the electronic device 500 or in communication with the electronic device 500, and/or a voice input from the user) corresponding to selection of representation 1832e of the supplemental map that satisfies the search parameter, and in response the electronic device 500 determines that the electronic device 500 does not have access to the supplemental map, and in response to the determination that the electronic device 500 does not have access to the supplemental map, the electronic device 500 displays in FIG. 18Y the free supplemental map information (e.g., representations 1832i and 1832j) overlaid the primary map 1832h and user interface element 18321 that includes a first option (e.g., representation 1824m) that, when selected causes the electronic device 500 to initiate a process to purchase the supplemental map; and a second option (e.g., representation 1824n) that, when selected causes the electronic device 500 to initiate a process to share the supplemental map to a second electronic device. In some embodiments, if the second electronic device 1832 determines that the second electronic device 1832 does already have access to the supplemental map, the electronic device 500 displays in FIG. 18Y the free supplemental map information (e.g., representations 1832i and 1832j) including bonus, additional search results or supplemental map information overlaid the primary map 1832h.

In some embodiments, the electronic device 500 displays one or more maps accessible to the electronic device 500 in one or more different layouts. For example, in FIG. 18Z, the electronic device 500 displays user interface 1834a of a map application. The user interface 1834a includes the search user interface element 1832c, one or more representations 1834c of favorite points of interest, one or more representations 1834d of recently viewed supplemental maps and a representation 1834 of the plurality of supplemental maps downloaded to the electronic device 500. In FIG. 18Z, the representation 1834 presents the supplemental maps as a list. In FIG. 18Z, representation 1834 includes an option (e.g., representation 1834ee) that, when selected, (e.g., user input 1804 directed to representation 1834ee) causes the electronic device 500 to display the plurality of maps in a layout as shown in FIG. 18AA, different from the list as illustrated by representation 1834e. For example, in FIG. 18AA, the plurality of supplemental maps (e.g., representations 1836b, 1836c, 1836d) are displayed as a stack of representations of supplemental maps. As shown in FIG. 18AA, the stack overlaps on top of each other such that a top representation 1836d is presented in its entirety while representations of supplemental maps (e.g., representations 1836b and 1836c) behind and/or below are partially presented.

In some embodiments, the electronic device 500 detects user input 1804 (e.g., a contact on a touch-sensitive surface, actuation of a physical input device of the electronic device 500 or in communication with the electronic device 500, and/or a voice input from the user) corresponding to selection of representation 1836d of a supplemental map (e.g., “LA Map”), and in response the electronic device 500 displays in user interface 1836a information about the supplemental map (e.g., representation 1836d). In some embodiments, representation 1836d includes an image associated with the supplemental map and a first option (e.g., representation 1836e) that, when selected, causes the electronic device 500 to initiate navigation directions along a route associated with the supplemental map; and a second option (e.g., representation 1836f) that, when selected, causes the electronic device to display a list of the points of interest included in the supplemental map similar to the list of points of interest included in user interface 1824a of FIG. 18O.

In some embodiments, the electronic device 500 automatically deletes one or more supplemental maps if the supplemental map satisfies one or more criteria as described with reference to method 1900. For example, in FIG. 18CC, the electronic device displays a user interface 1838a of a calendar application. The user interface 1838 includes a date (e.g., representation 1838b) and a first set of calendar entries (e.g., representation 1838c) for that date.

In FIG. 18CC, the electronic device 500 device detects user input 1804 (e.g., a swipe contact on a touch-sensitive surface and/or a voice input from the user) corresponding to a request to navigate (e.g., scroll) user interface 1838a to a date in the past, and in response, the electronic device 500 scrolls through user interface 1838a and displays calendar entries for event that occurred in the past (e.g., representation 1838e) as indicated by the date (e.g., representation 1838d). In some embodiments, the user of the electronic elects to view more information about a particular calendar entry (e.g., representation 1838e). For example, the electronic device 500 detects user input 1804 (e.g., a contact on a touch-sensitive surface, actuation of a physical input device of the electronic device 500 or in communication with the electronic device 500, and/or a voice input from the user) corresponding to selection of representation 1838e of a calendar entry (e.g., “ABC Festival”), and in response the electronic device 500 displays in user interface 1838a of FIG. 18EE, information about the calendar entry (e.g., “ABC Festival”). In FIG. 18EE, the user interface 1838a includes calendar event information such as event name, location, and time (e.g., representation 1838f) and a representation 1838g of a supplemental map associated with the calendar event. In this example the supplemental map is a festival map of ABC Festival. In some embodiments, if the electronic device 500 detects user input corresponding to selection of representation 1838g, in response, the electronic device 500 displays a user interface of a map application that includes the supplemental similar to user interface 1800c in FIG. 18M because the supplemental map is expired because the event has ended. In some embodiments, the electronic device 500 automatically deletes the supplemental map from storage of the electronic device because the event has ended as represented by the absence of the representation of the supplemental corresponding to the ABC Festival as shown in user interface 1836a in FIG. 18FF.

FIG. 19 is a flow diagram illustrating a method for facilitating a way to obtain access to supplemental maps via a map store user interface. The method 1700 is optionally performed at an electronic device such as device 100, device 300, device 500 as described above with reference to FIGS. 1A-1B, 2-3, 4A-4B and 5A-5H. Some operations in method 1900 are, optionally combined and/or the order of some operations is, optionally, changed.

In some embodiments, method 1900 is performed at an electronic device in communication with a display generation component (e.g., 504) and one or more input devices. In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 1900 is performed at or by an automobile (e.g., at an infotainment system of an automobile having or in communication with one or more display generation components and/or input devices).

In some embodiments, the electronic device displays (1902a), via the display generation component, a user interface of a map store for obtaining access to one or more of a plurality of supplemental maps, such as user interface 1800a in FIG. 18A. In some embodiments, the user interface is a map store user interface of a map store application, such as the map store application described herein and with reference to method 1900. For example, the map store application is optionally a maps marketplace or digital maps distribution platform that includes a map store user interface that enables a user of the electronic device to view and download supplemental maps as will be described herein and with reference to method 1900. In some embodiments, the map store user interface is a user interface of the map application as described with reference to methods 700, 900, 1100, 1300, 1500, 1700, 1900, 2100, and/or 2300. In some embodiments, the supplemental map includes one or more of the characteristics of the supplemental maps described with reference to methods 700, 900, 1100, 1300, 1500, 1700, 1900, 2100, and/or 2300. In some embodiments, the electronic device has previously downloaded, purchased access to and/or otherwise obtained access to a supplemental map. In some embodiments, the electronic device does not have access to the supplemental map and thus, obtains access to, downloads, and/or purchases access to the supplemental map via the user interface of the map store as described herein and with reference to method 1900. In some embodiments, the user interface of the map store includes a variety of supplemental maps from a variety of sources as will be described with reference to method 1900. In some embodiments, and as will be described in more detail with reference to method 1900, the electronic device provides one or more options for monetizing supplemental maps. In some embodiments, the user interface of the map store is a user interface of the primary map application as described with reference to methods 700, 900, 1100, 1300, 1500, and 1700.

In some embodiments, while displaying the user interface of the map store, the electronic device receives (1902b), via the one or more input devices, a first input that corresponds to selection of a first supplemental map associated with a first geographic area, such as representation 1806ee. In some embodiments, the first input includes a user input directed to a user interface element corresponding to, and/or a representation of, a first supplemental map associated with a first geographic area, such as a gaze-based input, an activation-based input such as a contact on a touch-sensitive surface, a tap input, or a click input, (e.g., via a mouse, trackpad, or another computer system in communication with the electronic device), actuation of a physical input device, a predefined gesture (e.g., pinch gesture or air tap gesture) and/or a voice input from the user) corresponding to (optionally selection of) the supplemental map associated with a first geographic area. In some embodiments, in response to detecting the user input directed to the user interface element, the electronic device performs an operation described herein. In some embodiments, the first supplemental map associated with a first geographic area (or the representation of the first supplemental map associated with a first geographic area) includes text, affordances, virtual objects, that when selected, causes the electronic device to display respective supplemental map information as described herein.

In some embodiments, in response to receiving the first input (1902c), such as input 1804 in FIG. 18M, in accordance with a determination that the first supplemental map satisfies one or more first criteria including a criterion that is satisfied when the electronic device already has access to the first supplemental map (e.g., the first supplemental map is already saved, downloaded, and/or purchased by the electronic device and/or a user account associated with the electronic device), the electronic device initiates (1902d) a process to display a user interface of a map application that includes first information from the first supplemental map associated with the first geographic area, such as user interface 1824a in FIG. 18N. For example, the electronic device optionally navigates to a user interface of the map application. In some embodiments, navigating to the user interface of the map application includes ceasing to display the user interface of the map store. In some embodiments, the electronic device displays the user interface of the map application above (or the bottom or sides of and/or overlaid) the user interface of the map store. In some embodiments, the first information from the first supplemental map associated with the first geographic area includes supplemental map information as described with reference to methods 700, 900, 1100, 1300, 1500, 1700, 1900, 2100, and/or 2300. For example, the first information from the first supplemental map associated with the first geographic area is optionally displayed concurrently with and/or overlaid upon a primary map of the first geographic area, which optionally includes information about the locations from the primary map as described with reference to methods 700, 900, 1100, 1300, 1500, 1700, 1900, 2100, and/or 2300. In some embodiments, the first information optionally includes information associated with an event, such as a music festival, theme park, or trade show. The first information optionally includes information associated with the first geographic area, such as a curated guide to explore points of interest of the first geographic area.

In some embodiments, in accordance with a determination that the first supplemental map does not satisfy the one or more first criteria (e.g., the first supplemental map is not accessible by the electronic device, because the first supplemental map is not already saved, downloaded, and/or purchased by the electronic device and/or a user account associated with the electronic device), the electronic device displays (1902e), in the user interface of the map store, second information associated with the first supplemental map (e.g., without displaying the first information from the first supplemental map associated with the first geographic area), such as user interface 1800b in FIG. 18I. In some embodiments, the second information is different from the first information. In some embodiments, the second information includes information associated with downloading and/or saving the first supplemental map to the electronic device and/or otherwise obtaining access to the first supplemental map. In some embodiments, the second information includes a subset of the map information associated with the first information (e.g., if the first information has map information for twenty points of interest for the first geographic area, the second information optionally includes map information for only three of the those twenty points of interest). In another example, if the first information optionally has map information for a first portion of the first geographic area, the second information optionally includes map information for a second portion of the first geographic area that is less than the first portion of the first geographic area. In some embodiments, the second information associated with the first supplemental map is free content that is viewable by the user of the electronic device without having access to the first supplemental map (e.g., without purchasing and/or downloading the first supplemental map to the electronic device). Displaying information associated with a first supplemental map and/or facilitating a way to view and/or download the first supplemental map via a map store user interface enables a user to, from the map store user interface, either download the first supplemental map directly from the map store user interface and/or view information about the first supplemental map, thereby simplifying the presentation of information to the user and interactions with the user, which enhances the operability of the device and makes the user-device interface more efficient (e.g., by helping the user to provide proper inputs and reducing user mistakes when operating/interacting with the device), which, additionally, reduces power usage and improves battery life of the device by enabling the user to use the device more quickly and efficiently.

In some embodiments, while displaying the user interface of the map store, the electronic device receives, via the one or more input devices, a second input comprising a search parameter, such as user interface element 1832c in FIG. 18W. In some embodiments, the electronic device provides a search function for discovering supplemental maps and/or primary maps via the user interface of the map store. For example, the user interface optionally includes a selectable option (e.g., user interface element) that, when selected, causes the electronic device to display a search field or a search user interface including a search field. In some embodiments, the search user interface further includes a plurality of categorized supplemental maps, such as suggested supplemental maps, new supplemental maps, most downloaded supplemental maps and/or supplemental maps associated with one or more categories as described in more detail below with reference to method 1900. In some embodiments, the search user interface further includes a list of popular search parameters (e.g., keywords and/or phrases). In some embodiments, the second input includes one or more characteristics of the first input that corresponds to selection of the first supplemental map described with reference to method 1900. For example, the electronic device optionally receives the second input of a search parameter in the search field. In some embodiments, the user provides the second input comprising the search parameter using a system user interface of the electronic device (e.g., voice assistant).

In some embodiments, in response to receiving the second input, the electronic device displays, in the user interface of the map store, one or more representations of supplemental maps that satisfy the search parameter, such as for example, representation 1832e. For example, the electronic device optionally updates the user interface of the map store to display the one or more representations of the supplemental maps that satisfy the search parameter. (e.g., the electronic device ceases to display the plurality of categorized supplemental maps and/or the list of popular search parameters as described herein and displays the one or more representations of the supplemental maps that satisfy the search parameter). In some embodiments, the one or more representations of supplemental maps includes text, affordances, virtual objects, that when selected, causes the electronic device to display respective supplemental map information as described herein. In some embodiments, the one or more representations include one or more characteristics of the second information associated with the first supplemental map as described with reference to method 1900. In some embodiments, the one or more representations include third information, different from the second information associated with the first supplemental map as described with reference to method 1900. For example, the third information optionally includes more content associated with the respective supplemental map than the second information. In some embodiments, the third information includes less content associated with the respective supplemental map than the second information. In some embodiments, in accordance with a determination that at least one supplemental map does not satisfy the search parameter, the electronic device provides an indication to the user that no supplemental maps satisfy the search parameter. In some embodiments, the electronic device provides a suggested search parameter. For example, the electronic device optionally determines that the search parameter that is input in the search field is optionally misspelled and/or mistyped. In this case, the electronic device optionally provides a correct version of the misspelled search parameter. It is understood that although the embodiments described herein are directed to supplemental maps, such functions and/or characteristics, optionally apply to other maps including primary maps. Displaying one or more representations of supplemental maps that satisfy a search parameter enables a user to quickly locate, view and/or obtain access to desired supplemental map information, thereby reducing the need for subsequent inputs to locate desired supplemental map information in a potentially large and difficult to search data repository of supplemental maps which reduces power usage and improves battery life of the electronic device by enabling the user to use the electronic device more quickly and efficiently (e.g., the user does not need to scroll through pages and pages of supplemental maps in the map store and can instead simply provide a search parameter is scale down the supplemental maps so that desired supplemental maps are located), which additionally, simplifies the interaction between the user and the electronic device and enhances the operability of the electronic device and makes the user-device interface more efficient.

In some embodiments, while displaying the user interface of the map store, the electronic device displays a representation of a second supplemental map to which the electronic device does not have access, such as representation 1806c in FIG. 18H. For example, the electronic device does not have access to the second supplemental map because the second supplemental map is not already saved, downloaded, and/or purchased by the electronic device and/or a user account associated with the electronic device. In some embodiments, the electronic device facilitates the download and/or purchase of the second supplemental map. In some embodiments, the electronic device obtains access to and/or downloads the second supplemental map without required payment for the purchase of the second supplemental map (e.g., payment is not required to download the second supplemental map to the electronic device and/or save to the user account associated with the electronic device). In some embodiments, the user account associated with the electronic device has access to the second supplemental map, but the electronic device has not downloaded the second supplemental map. In some embodiments, if the electronic device determines that the user account associated with the electronic device has access to the second supplemental, the electronic device initiates a process to download the second supplemental map as will be discussed herein (e.g., repurchasing the second supplemental map for download to the electronic device is now required because the user account associated with the electronic device has access to and/or already purchased the second supplemental). In some embodiments, and as will be described in more detail with reference to method 1900, payment is required to obtain access to and/or download the second supplemental map. In some embodiments, the representation of the second supplemental map includes an indication that payment is not required to obtain access to and/or download the second supplemental map. In some embodiments, the representation of the second supplemental map includes an indication that the user account associated with the electronic device has access to the second supplemental and that the second supplemental map is downloadable to the electronic device. In some embodiments, the representation of the second supplemental map includes one or more characteristics of the one or more representations of supplemental maps as described with reference to method 1900. In some embodiments, the representation of the second supplemental map includes one or more characteristics of the second information associated with the first supplemental map as described with reference to method 1900. In some embodiments, the representation of the second supplemental map includes third information, different from the second information associated with the first supplemental map as described with reference to method 1900. For example, the third information optionally includes more content associated with the second supplemental map than the second information. In some embodiments, the third information includes less content associated with the second supplemental map than the second information.

In some embodiments, while displaying the representation of the second supplemental map, the electronic device receives, via the one or more input devices, a second input corresponding to a request to access the second supplemental map, such as for example, input 1804 in FIG. 18H. For example, the second input includes one or more characteristics of the first input that corresponds to selection of the first supplemental map described with reference to method 1900. In some embodiments, the second input corresponds to selection of the representation of the second supplemental map.

In some embodiments, in response to receiving the second input, the electronic device initiates a process to access the second supplemental map without purchasing the second supplemental map, such as for example, as shown in user interface element 1816b in FIG. 18G. In some embodiments, initiating the process to access the second supplemental map without purchasing the second supplemental map includes downloading the second supplemental map to the electronic device. In some embodiments, initiating the process to access the second supplemental map without purchasing the second supplemental map includes the electronic device displaying a confirmation user interface element concurrently with or overlaid upon the user interface of the map store. In some embodiments, the electronic device displays the confirmation user interface element to confirm the download of the second supplemental map to the electronic device. In some embodiments, the electronic device downloads the second supplemental map in response to receiving user input that corresponds to confirming the request to access (download) the second supplemental map. In some embodiments, the user input that corresponds to confirming the request to access the second supplemental map includes one or more characteristics of the first input that corresponds to selection of the first supplemental map described with reference to method 1900. In some embodiments, if the electronic device does not receive the user input that corresponds to confirming the request to access the second supplemental map, the electronic device does not download the second supplemental map. In some embodiments, if the electronic device determines that the user account associated with the electronic device has access to the second supplemental, the electronic device foregoes displaying the confirmation user interface element and automatically downloads the second supplemental map. In some embodiments, the electronic device pauses and/or cancels the downloading of the second supplemental map in response to the electronic device receiving user input that corresponds to pausing and/or canceling the downloading of the second supplemental map. It is understood that although the embodiments described herein are directed to supplemental maps, such functions and/or characteristics, optionally apply to other maps including primary maps. Initiating a process to access the second supplemental map without purchasing the second supplemental map enables a user to quickly obtain access to the supplemental map, thereby reducing the need for subsequent inputs needed to access the supplemental map when payment is not required and immediate access is desired, which reduces power usage and improves battery life of the electronic device by enabling the user to use the electronic device more quickly and efficiently.

In some embodiments, while displaying the user interface of the map store, the electronic device displays a representation of a second supplemental map to which the electronic device does not have access (e.g., such as described with reference to method 1900), such as for example representation 1810c in FIG. 18H In some embodiments, and as mentioned with reference to method 1900, payment is required to obtain access to and/or download the second supplemental map. In some embodiments, the representation of the second supplemental map includes an indication that payment is required to obtain access to and/or download the second supplemental map. In some embodiments, and as described in more detail with reference to method 1900, the representation of the second supplemental map includes information about additional content, information, and/or features of the supplemental map that require payment to access the additional content.

In some embodiments, while displaying the representation of the second supplemental map, the electronic device receives, via the one or more input devices, a second input corresponding to a request to access the second supplemental map (e.g., such as described with reference to method 1900), such as input 1804 in FIG. 18H. In some embodiments, in response to receiving the second input, the electronic device initiates a process to purchase the second supplemental map, such as for example, user interface element 1816b including purchase information from representation 1810c in FIG. 18H. In some embodiments, initiating the process to purchase the second supplemental map includes the electronic device displaying a confirmation user interface element concurrently with or overlaid upon the user interface of the map store. In some embodiments, the electronic device displays the confirmation user interface element to confirm the purchase and download of the second supplemental map to the electronic device. In some embodiments, the electronic device downloads the second supplemental map in response to receiving user input that corresponds to confirming and/or providing payment authorization to purchase the second supplemental map. In some embodiments, the user input that corresponds to confirming and/or providing payment authorization to purchase the second supplemental map includes one or more characteristics of the first input that corresponds to selection of the first supplemental map described with reference to method 1900. In some embodiments, the electronic device requests successful authentication of the user to provide payment authorization and download the second supplemental map. In some embodiments, if the electronic device does not receive the user input that corresponds to confirming and/or providing payment authorization to purchase the second supplemental map, the electronic device does not download the second supplemental map. In some embodiments, the electronic device cancels the purchase of the second supplemental map in response to the electronic device receiving user input that corresponds to canceling the purchase of the second supplemental map. It is understood that although the embodiments described herein are directed to supplemental maps, such functions and/or characteristics, optionally apply to other maps including primary maps. Initiating a process to purchase the second supplemental map enables a user to quickly purchase and obtain access to the supplemental map, thereby reducing the need for subsequent inputs needed to purchase and access the supplemental map when immediate access is desired, which reduces power usage and improves battery life of the electronic device by enabling the user to use the electronic device more quickly and efficiently.

In some embodiments, the user interface of the map store includes representations of the plurality of supplemental maps and representations of a second plurality of supplemental maps, such as shown in user interface 1800a in FIG. 18D. In some embodiments, the electronic device facilitates the organization of supplemental maps into different groups or collections based on one or more shared criteria as will be described herein and with reference to method 1900. In some embodiments, the representations of the plurality of supplemental maps and the representations of the second plurality of supplemental maps include one or more characteristics of the one or more representations of supplemental maps as described with reference to method 1900. In some embodiments, the plurality of supplemental maps are different from the second plurality of supplemental maps as described with reference to method 1900. For example, the plurality of supplemental maps share one or more first criteria or characteristic and represent a first group while the second plurality of supplemental maps share one or more second criteria, different from the first criteria and represent a second group, different from the first group. In some embodiments, the shared criteria or groupings are based on map store categories (e.g., free maps or paid maps), the subject matter of the supplemental maps (e.g., “Food and Drink”, “Things to Do”, “Nightlife”, “Travel”, and/or the like), functions of the supplemental maps (e.g., electronic vehicle charging locator, public transit navigator, bicycle lane locator, and/or the like), and/or other shared criteria as described with reference to method 1900.

In some embodiments, the representations of the plurality of supplemental maps and the representations of the second plurality of supplemental maps are displayed in a first layout, such as shown in the user interface 1800a in FIG. 18E. In some embodiments, the first layout is one of a plurality of predefined layouts in which the representations of the plurality of supplemental maps and the representations of the second plurality of supplemental maps are displayed at different positions, groupings, and/or presentations styles in the user interface of the map store.

In some embodiments, the first layout includes displaying the representations of the plurality of supplemental maps in a first portion in the user interface of the map store according to a first shared criteria between the plurality of supplemental maps, and the representations of the second plurality of supplemental maps in a second portion in the user interface of the map store according to a second shared criteria between the second plurality of supplemental maps, such as shown with representations 1812a, 1812c, 1812d, and 1812e in a first portion in user interface 1800a in FIG. 18E and representations 1814a, 1814c, 1814d, and 1814e in a second portion in the user interface 1800a in FIG. 18E. For example, the first criteria optionally shared between the plurality of supplemental maps is met when the plurality of supplemental maps are associated with “Music and Entertainment Maps.” In another example, the second criteria optionally shared between the second plurality of supplemental maps is met when the second plurality of supplemental maps are associated with “Featured Maps,” different from the first criteria—“Music and Entertainment Maps”. In some embodiments, the first portion in the user interface of the map store is different from the second portion in the user interface of the map store. For example, displaying the representations of the plurality of supplemental maps in the first portion in the user interface of the map store according to the first shared criteria between the plurality of supplemental maps optionally includes displaying the representations of the plurality of supplemental maps as a list of the representations of the plurality of supplemental maps. In some embodiments, the list of the representations of the plurality of supplemental maps is limited to a predetermined number of supplemental maps (e.g., 1, 3, 5, or 10). In some embodiments, when displaying the plurality of supplemental maps as a list of a limited number of representations of the plurality of supplemental maps, the user interface further includes an option that, when selected, causes the electronic device to display all the plurality of supplemental maps as a list (e.g., the list is not limited to the first five supplemental maps). In another example, displaying the representations of the plurality of second supplemental maps in the second portion in the user interface of the map store according to the second shared criteria between the plurality of supplemental maps optionally includes displaying the representations of the second plurality of supplemental maps as a second list of the representations of the second plurality of supplemental maps. In some embodiments, the second of the representations of the second plurality of supplemental maps include one or more characteristics of the list of the representations of the plurality of supplemental maps as described herein. In some embodiments, the second list of the representations of the second plurality of supplemental maps is displayed above, below, to the left, or to the right of the list of the representations of the plurality of supplemental maps. In some embodiments, the representations of the respective plurality of supplemental maps are displayed as a stack or carousel that, when selected, causes the electronic device to switch or navigate through the representations of the respective plurality of supplemental maps as described in more detail with reference to method 1900. It is understood that although the embodiments described herein are directed to supplemental maps, such functions and/or characteristics, optionally apply to other maps including primary maps. Displaying the representations of the respective plurality of supplemental maps in a first layout wherein the representations of the respective plurality of supplemental maps are included in respective portions in the user interface of the map store according to a respective shared criteria between the respective plurality of supplemental maps provides a more organized user interface that is less cluttered and enables a user to quickly locate desired supplemental maps, which reduces power usage and improves battery life of the electronic device by enabling the user to use the electronic device more quickly and efficiently.

In some embodiments, the first shared criteria is that the plurality of supplemental maps are associated with the first geographic area (e.g., such as described with reference to method 1900), such as the geographic area associated with representation 1802a in FIG. 18A.

In some embodiments, the second shared criteria is that the second plurality of supplemental maps are associated with a second geographic area, different from the first geographic area, such as the geographic area associated with the representations 1806a, 1806c, 1806d, and 1806e in FIG. 18A. In some embodiments, the second geographic area includes one or more of the characteristics of the geographic area described with reference to methods 700, 900, 1100, 1300, 1500, 1700, 1900, 2100, and/or 2300. For example, a size of the second geographic area is optionally larger or smaller than a size of the first geographic area. In some embodiments, the second geographic area is partially contained within the first geographic area. In some embodiments, the second geographic area is partially outside the first geographic area. In some embodiments, the second geographic area covers a plurality of points of interest that are the same, less than, or greater than the first geographic area. In some embodiments, the electronic device is currently located in the first geographic area and/or the second geographic area. In some embodiments, the first geographic area and/or the second geographic area is defined by the user of the electronic device via, for example, a user input corresponding to a request to search for supplemental maps associated with a particular geographic area as similarly described with reference to the second input comprising a search parameter in method 1900. In some embodiments, the first geographic area and/or the second geographic area is defined by an application other than the map store. For example, the first geographic area and/or the second geographic area is optionally based on a location of a calendar event of a calendar application. In another example, the first geographic area and/or the second geographic area is optionally based on a location of a navigation route of a map application as described with reference to method 2100. In some embodiments, the first geographic area and/or the second geographic area is defined by one or more artificial intelligence models as described with reference to method 2300. It is understood that although the embodiments described herein are directed to supplemental maps, such functions and/or characteristics, optionally apply to other maps including primary maps. Displaying the representations of the respective plurality of supplemental maps according to a shared criteria associated with a geographic area provides a more organized user interface that is less cluttered and enables a user to quickly locate desired supplemental maps, which reduces power usage and improves battery life of the electronic device by enabling the user to use the electronic device more quickly and efficiently.

In some embodiments, the first shared criteria is that the plurality of supplemental maps are associated with a first activity (of the user of the electronic device), such as representation 1814a in FIG. 18E. In some embodiments, the first activity is a source of entertainment that the user of the electronic device performs at the respective geographic area associated with the plurality of supplemental maps. For example, the first activity optionally includes things to do at the respective geographic area (e.g., surfing, hiking, shopping, food and/or beverage tours, performances, exhibits, shows, and/or attractions), points of interests to travel to at the respective geographic area (e.g., landmarks, businesses, places to stay, and/or the like), and/or places to eat and/or drink (e.g., restaurants, bars, cafes, and/or the like).

In some embodiments, the second shared criteria is that the second plurality of supplemental maps are associated with a second activity, different from the first activity, such as representation 1802c in FIG. 18C. In some embodiments, the second activity is another source of entertainment that is different from the first activity. For example, the user interface of the map store optionally includes a first activity that includes surfing in Los Angeles and a second activity related to dog friendly hikes in Los Angeles. In some embodiments, the plurality of respective supplemental maps are conceptually related to the respective activity. For example, a supplemental map that includes restaurants, bars, or cafes is optionally relevant or conceptually related to the activity of eating and drinking. It is understood that although the embodiments described herein are directed to supplemental maps, such functions and/or characteristics, optionally apply to other maps including primary maps. Displaying the representations of the respective plurality of supplemental maps according to a shared criteria associated with an activity provides a more organized user interface that is less cluttered and enables a user to quickly locate desired supplemental maps, which reduces power usage and improves battery life of the electronic device by enabling the user to use the electronic device more quickly and efficiently.

In some embodiments, the first shared criteria is that the plurality of supplemental maps are associated with a first media content type, such as representation 1810c in FIG. 18D. For example, the user interface of the map store includes media content that the user is optionally interested in. In some embodiments, the first media content type includes movies, music, audiobooks, podcasts, videos, and/or television shows. For example, if the first media content type is television shows, the plurality of supplemental maps optionally includes television shows set and/or filmed in Los Angeles. In some embodiments, the first media content type and/or the second media content type described herein includes one or more of the characteristics of the media content types described with reference to methods 1300, 1500, 1700, 1900, 2100, and/or 2300.

In some embodiments, the second shared criteria is that the second plurality of supplemental maps are associated with a second media content type, different from the first media content type, such as representation 1810d in FIG. 18D. In another example, if the first media content type is television shows as the example described herein, the second media content type optionally relates to media content of a type other than television shows, such as, for example, music. In this example, the second plurality of supplemental maps associated with music optionally includes a listing of songs and/or music videos of musical artists from Los Angeles. In some embodiments, the plurality of respective supplemental maps are conceptually related to the respective media content type. For example, a supplemental map that includes record stores or music venues is optionally relevant or conceptually related to the media content type of music. In another example, the plurality of supplemental maps are associated with a first media content (e.g., movie A) and the plurality of second supplemental maps are associated with a second media content (e.g., movie B), different from the first media content despite the first media content and the second media content are a same media content type (e.g., movies). It is understood that although the embodiments described herein are directed to supplemental maps, such functions and/or characteristics, optionally apply to other maps including primary maps. Displaying the representations of the respective plurality of supplemental maps according to a shared criteria associated with a media content type provides a more organized user interface that is less cluttered and enables a user to quickly locate desired supplemental maps, which reduces power usage and improves battery life of the electronic device by enabling the user to use the electronic device more quickly and efficiently.

In some embodiments, the first shared criteria is that the plurality of supplemental maps are associated with a first business type (e.g., businesses providing a particular service), such as representation 1802b in FIG. 18B. In some embodiments, the first business type includes cafes, restaurants, bars, shops, pharmacies, grocery stores, dog care services, and/or the like. For example, if the first business type is providing dog care service, the plurality of supplemental maps optionally includes dog stores, dog trainers, dog grooming, dog boarding, and/or the like. In some embodiments, the first business type and/or the second business type described herein includes one or more of the characteristics of the businesses and/or vendors described with reference to methods 1700, 1900, 2100, and/or 2300.

In some embodiments, the second shared criteria is that the second plurality of supplemental maps are associated with a second business type, different from the first business type, such as representation 1806d in FIG. 18B. In another example, if the second business type is providing dog care service as the example described herein, the second business type optionally relates to businesses of a type other than providing dog care service, such as, for example, retail shopping. In this example, the second plurality of supplemental maps associated with retail shopping optionally includes a listing of shopping stores, malls, and/or markets in Los Angeles. In some embodiments, the plurality of respective supplemental maps are conceptually related to the respective business type. For example, a supplemental map that includes toy stores, playgrounds, and/or kids museums is optionally relevant or conceptually related to the business type of kids activities. In another example, the plurality of supplemental maps are associated with a first business (e.g., brewery A) and the plurality of second supplemental maps are associated with a second business (e.g., brewery B), different from the first business despite the first business and the second business are a same business type (e.g., beer bar). It is understood that although the embodiments described herein are directed to supplemental maps, such functions and/or characteristics, optionally apply to other maps including primary maps. Displaying the representations of the respective plurality of supplemental maps according to a shared criteria associated with a business type provides a more organized user interface that is less cluttered and enables a user to quickly locate desired supplemental maps, which reduces power usage and improves battery life of the electronic device by enabling the user to use the electronic device more quickly and efficiently.

In some embodiments, the first shared criteria is that the plurality of supplemental maps include editorial content, such as representation 1802b in FIG. 18B. For example, the plurality of supplemental maps that include editorial content are provided by an editorial database (e.g., maintained by the electronic device from an application operating on the electronic device (Map Store and/or Map Application) and/or by a third-party in communication with the electronic device). In some embodiments, the editorial content includes supplemental maps appropriate for the respective geographic area, such as “Best Trails for Dogs in SF”, “Places to Volunteer in SF”, “Best museums in SF” and/or the like. In some embodiments, the editorial content includes supplemental maps that are selected by algorithms of one or more artificial intelligence models as described with reference to method 2300.

In some embodiments, the second shared criteria is that the second plurality of supplemental maps include user-generated content (e.g., do not include editorial content), such as representation 1802c in FIG. 18C. For example, the user-generated content included in the second plurality of supplemental maps include user notes, highlighting, annotations, and/or other supplemental content provided by users. In some embodiments, the second plurality of supplemental maps that include user-generated content includes one or more of the characteristics of the annotated supplemental maps described with reference to methods 1700, 1900, 2100, and/or 2300. It is understood that although the embodiments described herein are directed to supplemental maps, such functions and/or characteristics, optionally apply to other maps including primary maps. Displaying the representations of the respective plurality of supplemental maps according to a shared criteria associated with editorial content and/or user-generated content provides a more organized user interface that is less cluttered and enables a user to quickly locate desired supplemental maps, which reduces power usage and improves battery life of the electronic device by enabling the user to use the electronic device more quickly and efficiently.

In some embodiments, after displaying the user interface of the map application that includes first information from the first supplemental map associated with the first geographic area (e.g., such as described with reference to method 1900), in accordance with a determination that the first supplemental map is a first type of supplemental map, the electronic device removes the first supplemental map from storage on the electronic device in accordance with a determination that one or more criteria are satisfied, such as shown in user interface 1836a in FIG. 18FF with the removal of representation 1826c. In some embodiments, the first type of supplemental map is a limited supplemental map, such that the supplemental map is set to expire after a predetermined period of time (e.g., 5 hours, 12 hours, 24, hours, 1 week, 1 month, or 1 year) relative to an event. For example a supplemental map including festival information is a first type of supplemental map set to expire after the end date of the corresponding festival event. In some embodiments, the one or more criteria include criterion that is satisfied when the date and/or time at the electronic device is after the expiration date associated with the supplemental map. In some embodiments, the one or more criteria include criterion that is satisfied when the electronic device detects a shortage of storage space for supplemental maps. In some embodiments, the one or more criteria include criterion that is satisfied when the electronic device determines low to zero usage (e.g., user interaction or engagement) of the first supplemental map. In some embodiments, the one or more criteria include a criterion that is satisfied after a predetermined amount of time (e.g., 6 months, 12 months, 3 years, or 5 years) after downloading the first supplemental map. In some embodiments, the one or more criteria include criterion that is satisfied when the electronic device detects user input that corresponds to removing the first supplemental map from storage on the electronic device. In some embodiments, the user input that corresponds to removing the first supplemental map from storage on the electronic device includes one or more characteristics of the first input that corresponds to selection of the first supplemental map described with reference to method 1900. In some embodiments, in accordance with a determination that the first supplemental map is the first type of supplemental map, the electronic device removes or hides displaying a respective representation of the first supplemental map via the user interface of the map application instead of (or in addition to) removing (e.g., permanently deleting) the first supplemental map from storage on the electronic device. In some embodiments, removing the first supplemental map includes the electronic device automatically deleting the first supplemental (e.g., without detecting the user input that corresponds to removing the first supplemental map from storage on the electronic device). In some embodiments, after removing the first supplemental map from storage on the electronic device, the electronic device optionally obtains the first supplemental map for access by the electronic device via the map store as described with reference to method 1900.

In some embodiments, in accordance with a determination that the first supplemental map is a second type of supplemental map, different from the first type of supplemental map, the electronic device maintains the first supplemental map on the storage on the electronic device in accordance with the determination that the one or more criteria are satisfied, such as for example representation 1826b in FIG. 18FF. In some embodiments, the second type of supplemental map is a boundless supplemental map, such that the supplemental map is not associated with an expiration date and/or time. For example a supplemental map including electronic vehicle charging stations information is a second type of supplemental map considered relevant and does not expire after the predetermined time described above such that the electronic device maintains the first supplemental map on the storage on the electronic device. In some embodiments, maintaining the first supplemental map on the storage on the electronic device includes foregoing the removal of the first supplemental map from storage on the electronic device. In some embodiments, maintaining the first supplemental map on the storage on the electronic device includes initiating a process to receive updates and/or future alerts about content that is related to the first supplemental map. For example, updates related to new electronic vehicle charging stations and/or removal of electronic vehicle charging stations. In some embodiments, maintaining the first supplemental map on the storage on the electronic device includes the electronic device automatically subscribing to receive the updates and/or future alerts about content that is related to the first supplemental map (e.g., without detecting user input that corresponds to subscribing to receive the updates and/or future alerts about content that is related to the first supplemental map). In some embodiments, if the electronic device determines that the one or more criteria include criterion that is satisfied when the electronic device detects the shortage of storage space for supplemental maps, the electronic device maintains the first supplemental map that is a second type of supplemental map and removes from storage another supplemental map that is a first type of supplemental map as described herein and with reference to method 1900. It is understood that although the embodiments described herein are directed to supplemental maps, such functions and/or characteristics, optionally apply to other maps including primary maps. Removing supplemental maps from storage on the electronic based on the type of supplemental map and whether the one or more criteria are satisfied provides an efficient use of valuable storage space on the electronic device and limits the number of supplemental maps that are maintained in storage, which minimizes waste of storage space given that some supplemental maps are significant in size.

In some embodiments, the electronic device receives, via the one or more input devices, a second input that corresponds to a request to display a second plurality of supplemental maps that are accessible by the electronic device, such as input 1804 directed to representation 1834ee in FIG. 18Z. In some embodiments, the second input that corresponds to a request to display a second plurality of supplemental maps that are accessible by the electronic device includes one or more characteristics of the first input that corresponds to selection of the first supplemental map described with reference to method 1900. In some embodiments, the second plurality of supplemental maps include one or more characteristics of the plurality of supplemental maps as described with reference to method 1900. In some embodiments, the second plurality of supplemental maps include one or more characteristics of the first supplemental map to which the electronic device already has access to as described with reference to method 1900. In some embodiments, the electronic device displays representations of supplemental maps in an overlapping arrangement (e.g., as a stack of representations of supplemental maps), different from the list of the representations of the plurality of supplemental maps described with reference to method 1900.

In some embodiments, in response to receiving the second input, the electronic device displays, via the display generation component, a second user interface including representations of the second plurality of supplemental maps presented as a stack of representations of supplemental maps, such as for example representations 1836b, 1836c, and 1836d in FIG. 18AA. For example, the second user interface is optionally a user interface of the map store, a user interface of the map application, a user interface of a digital wallet application, a user interface of a calendar application, a user interface of a media content application, or a user interface of an application configured to store supplemental maps, or a user interface described with reference to methods 700, 900, 1100, 1300, 1500, 1700, 1900, 2100, and/or 2300. In some embodiments, the user interface includes a selectable option (e.g., user interface element) that, when selected, causes the electronic device to display the second user interface including representations of the second plurality of supplemental maps presented as a stack of representations of supplemental maps. In some embodiments, the stack of representations of supplemental maps is arranged to provide a visual appearance of representations of supplemental maps stacked on top of each other or an overlapping deck of cards or a fan or other stack arrangement. In some embodiments, when presented as a stack of representations of supplemental maps, a portion of the representation of the supplemental map is displayed without displaying an entire portion of the representation of the supplemental map. In some embodiments, when presented as a stack of representations of supplemental maps, a first presentation of a respective supplemental map that is positioned on top of the stack is displayed in its entirety while the other presentations of respective supplemental maps in the stack (e.g., below the first representation) are partially displayed (e.g., the first representation of the respective supplemental map positioned on top of the stack obscures one or more portions of the other representations of the respective supplemental maps positioned behind the first representation of the respective supplemental map). In some embodiments, each of the representations of the respective supplemental maps are selectable to display the first information, the second information, or other information associated with the respective supplemental map as described with reference to method 1900. In some embodiments, displaying the first information, the second information, or other information associated with the respective supplemental map in response to user input selecting a representation of a supplemental map includes navigating to a user interface, different from the user interface that includes the representations of the second plurality of supplemental maps presented as the stack of representations of supplemental maps. In some embodiments, the second user interface includes representations of other digital content, such as documents, credit cards, coupons, passes, transportation (e.g., airline, train, and/or the like) tickets, public transit cards, and/or event tickets. In some embodiments, the representations of the other digital content are presented as a stack, separate from the stack of representations of supplemental maps. In some embodiments, the representations of other digital content and the representations of supplemental maps are presented in a same stack. It is understood that although the embodiments described herein are directed to supplemental maps, such functions and/or characteristics, optionally apply to other maps including primary maps. Displaying the representations of the respective plurality of supplemental maps as a stack provides a more organized presentation of supplemental maps that is less cluttered and enables a user to quickly locate desired supplemental maps, which reduces power usage and improves battery life of the electronic device by enabling the user to use the electronic device more quickly and efficiently.

In some embodiments, initiating the process to display the user interface of the map application that includes first information from the first supplemental map associated with the first geographic (e.g., such as described with reference to method 1900) area includes in accordance with a determination that one or more first criteria are satisfied, the electronic device downloads the first supplemental map to storage on the electronic device, such as for example as indicated with representation 1806dd in FIG. 18A. In some embodiments, the one or more first criteria include a criterion that is satisfied when the electronic device determines that a location of the electronic device is associated with the first geographic area of the first supplemental map. For example, if the first geographic area of the first supplemental map includes Los Angeles, the electronic device optionally downloads the first supplemental map to storage on the electronic device in response to a determination that the location of the electronic device corresponds to Los Angeles. In some embodiments, the one or more first criteria include a criterion that is satisfied when the electronic device determines that a time at the electronic device is associated with a time of an event associated with the first supplemental map. For example, if an event associated with the first electronic device includes a flight from San Francisco International Airport to Burbank Airport, the electronic device optionally downloads the first supplemental map to storage on the electronic device in response to a determination that a time at the electronic device corresponds to a predetermined amount of time (e.g., 24 hours, 12 hours, 6 hours, 1 hour, or 30 minutes) prior to the boarding time of the flight. In some embodiments, downloading the first supplemental map to storage on the electronic device includes the electronic device automatically downloading the first supplemental (e.g., without detecting user input that corresponds to downloading the first supplemental map to storage on the electronic device).

In some embodiments, in accordance with a determination that the one or more first criteria are not satisfied, the electronic device delays downloading of the first supplemental map to the storage on the electronic device until the one or more first criteria are satisfied, such as for example when a current location of the electronic device corresponds to the location shown in representation 1828f in FIG. 18EE. For example, the electronic device optionally determines that the location of the electronic device is not associated with the first geographic area of the first supplemental map. In another example, the electronic device delays downloading of the first supplemental map to the storage on the electronic device in response to a determination that a time at the electronic device is not within the predetermined amount of time of a time of an event associated with the first supplemental map. In some embodiments, the electronic device delays downloading the first supplemental map to storage on the electronic device until the electronic device determines that the one or more first criteria include a criterion that is satisfied when the electronic device detects user input that corresponds to downloading the first supplemental map to storage on the electronic device. It is understood that although the embodiments described herein are directed to supplemental maps, such functions and/or characteristics, optionally apply to other maps including primary maps. Downloading supplemental maps to storage on the electronic based on whether the one or more criteria are satisfied provides an efficient use of valuable storage space on the electronic device and limits the number of supplemental maps that are maintained in storage (e.g., the supplemental map is not initially downloaded and is downloaded at a later time, preferably before the user of the electronic device actually needs, wants, or utilizes the supplemental map), which minimizes waste of storage space given that some supplemental maps are significant in size.

In some embodiments, while displaying a respective user interface of the map application (e.g., such as described with reference to methods 700, 900, 1100, 1300, 1500, 1700, 1900, 2100, and/or 2300), the electronic device receives, via the one or more input devices, a second input comprising a search parameter, such as representation 1832c in FIG. 18W. In some embodiments, the respective user interface is the user interface of the map application that includes the first information from the first supplemental map associated with the first geographic area as described with reference to method 1900. In some embodiments, the respective user interface is a user interface of the map application other than the user interface of the map application that includes the first information from the first supplemental map associated with the first geographic area as described with reference to method 1900. In some embodiments, the respective user interface is the user interface of the map store that includes the second information from the first supplemental map associated with the first geographic area as described with reference to method 1900. In some embodiments, the respective user interface is a user interface of the map store other than the user interface of the map store that includes the second information from the first supplemental map associated with the first geographic area as described with reference to method 1900. For example, the respective user interface of the map application optionally includes primary map information as described with reference to methods 700, 900, 1100, 1300, 1500, 1700, 1900, 2100, and/or 2300. In another example, the respective user interface is optionally a user interface of an application other than the map application, such as a user interface of the map store as described with reference to method 1900. In some embodiments, the respective user interface is a user interface of a digital wallet application, a calendar application, a media content application, or an application configured to store primary and/or supplemental maps. In some embodiments, the second input comprising the search parameter includes one or more characteristics of the second input comprising the search parameter of the user interface of the map store as described with reference to method 1900. For example, the respective user interface optionally includes a search field (e.g., user interface element) or a search user interface including a search field that, in response to receiving a search parameter (e.g., such as described with reference to method 1900) in the search field, displays one or more representations of map application search results as described herein. In some embodiments, the user provides the second input comprising the search parameter using a system user interface of the electronic device (e.g., voice assistant).

In some embodiments, in response to receiving the second input, the electronic device displays, in the user interface of the map application (e.g., such as described with reference to method 1900) one or more representations of map application search results, wherein the map application search results include one or more points of interest and one or more search results from one or more respective supplemental maps, such as representations 1832d, 1832e, 1832f, and 1832g in FIG. 18X. In some embodiments, the one or more search results from the one or more respective supplemental maps includes one or more characteristics of the one or more representations of supplemental maps that satisfy the search parameter as described with reference to method 1900. In some embodiments, the one or more search results from the one or more respective supplemental maps includes one or more points of interest that satisfy the search parameter. In some embodiments, the one or more points of interest are not associated with the one or more respective supplemental maps. In some embodiments, the one or more points of interest are associated with the one or more respective supplemental maps. For example, a supplemental map optionally includes the one or more points of interest. In some embodiments, the one or more points of interest are associated with a respective primary map and/or a respective geographic area. In some embodiments, in accordance with a determination that the electronic device already has access to the one or more respective supplemental maps included in the search results, the one or more representations of map application search results includes third information from the one or more respective supplemental maps. For example, the third information optionally includes content and/or images of the one or more respective supplemental maps. In some embodiments, the third information optionally includes one or more characteristics of the first information from the first supplemental map as described with reference to method 1900. In some embodiments, the third information includes more or less information than the first information from the first supplemental map as described with reference to method 1900. In some embodiments, the third information includes an indication that the user account associated with the electronic device or the electronic device already has access to the one or more respective supplemental maps included in the search results. In some embodiments, when the electronic device detects user input corresponding to selection of the one or more search results from the one or more respective supplemental maps, the electronic device displays fourth information from the one or more respective supplemental maps. In some embodiments, the fourth information includes one or more characteristics of the first information from the first supplemental map as described with reference to method 1900. For example, in response to detecting the user input corresponding to selection of the one or more search results from the one or more respective supplemental maps, the electronic device optionally determines if the electronic device has access to the one or more respective supplemental maps included in the search results. In this case, in accordance with a determination that the electronic device has access to the one or more respective supplemental maps included in the search results, the electronic device optionally initiates a process to display a user interface of a map application that includes the fourth information from the respective supplemental map similarly to initiating a process to display a user interface of a map application that includes first information from the first supplemental map described with reference to method 1900. In some embodiments, in accordance with a determination that the electronic device does not have access to the one or more respective supplemental maps included in the search results, the one or more representations of map application search results includes fifth information from the one or more respective supplemental maps, different from the third information described herein. For example, the fifth information optionally includes more or less information than the third information. In some embodiments, the third information includes an indication that the user account associated with the electronic device or the electronic device already does not have access to the one or more respective supplemental maps included in the search results. In some embodiments, when the electronic device detects user input corresponding to selection of the one or more search results from the one or more respective supplemental maps to which the electronic device does not have access, the electronic device displays sixth information from the one or more respective supplemental maps. In some embodiments, the sixth information includes one or more characteristics of the second information associated with the first supplemental map as described with reference to method 1900. For example, in response to detecting that the electronic device does not have access to the one or more respective supplemental maps included in the search results, the electronic device optionally initiates a process to display a user interface of a map store that includes the sixth information from the respective supplemental map similarly to initiating a process to display a user interface of a map store that includes second information associated with the first supplemental map described with reference to method 1900. It is understood that although the embodiments described herein are directed to supplemental maps, such functions and/or characteristics, optionally apply to other maps including primary maps. Displaying map application search results, via a respective user interface of a map application, that include both one or more points of interest and one or more search results from one or more respective supplemental maps enables a user to quickly locate, view and/or obtain access to desired supplemental map information without navigating away from the respective user interface of the map application, thereby enabling the user to use the electronic device more quickly and efficiently (e.g., the user does not need to navigate away from the respective user interface to a user interface of the map store and can instead simply provide a search parameter to discover a supplemental map that satisfies the user's search parameter), which additionally, simplifies the interaction between the user and the electronic device and enhances the operability of the electronic device and makes the user-device interface more efficient.

In some embodiments, while displaying, in the user interface of the map store, second information associated with the first supplemental map (e.g., such as described with reference to method 1900), the electronic device receives, via the one or more input devices, a second input that corresponds to a request to share the first supplemental map with a second electronic device, different from the first electronic device, such as input 1804 directed to representation 1824f in FIG. 18T. In some embodiments, the second input that corresponds to a request to share the first supplemental map with a second electronic device includes one or more characteristics of the first input that corresponds to selection of the first supplemental map described with reference to method 1900. In some embodiments, the first supplemental map is shared with other electronic devices, for example, using a messaging application, an email application, and/or a wireless ad hoc service. In some embodiments, sharing with the other devices is similar to the process of transmitting the first supplemental map to a second electronic device described with reference to method 700, 1700, 1900, and 2100.

In some embodiments, in response to receiving the second input, the electronic device initiates a process to share the first supplemental map with the second electronic device, including sharing a representation of the first supplemental map that is selectable at the second electronic device to initiate a process to display information about the first supplemental map in a map store at the second electronic device, such as shown in user interface 1828a with message 1828b in FIG. 18U. For example, the information displayed about the first supplemental map on the map store at the second electronic device optionally includes one or more characteristics of the second information associated with the first supplemental map displayed in the user interface of the map store at the electronic device as described herein with reference to method 1900. In some embodiments, if the second electronic device determines that the second electronic device and/or a user account associated with the second electronic device already has access to the first supplemental map, initiating a process to display information about the first supplemental at the second electronic device includes one or more characteristics of initiating a process to display the user interface of the map application that includes first information from the first supplemental map as described with reference to method 1900. In some embodiments, if the second electronic device determines that the second electronic device and/or a user account associated with the second electronic device already has access to the first supplemental map, initiating a process to display information about the first supplemental at the second electronic device includes initiating a shared annotation communication session as described with reference to method 1700. It is understood that although the embodiments described herein are directed to supplemental maps, such functions and/or characteristics, optionally apply to other maps including primary maps. Allowing supplemental maps to be shared increases collaboration and facilitates sharing of supplemental maps amongst different users, thereby improving the interaction between the user and the electronic device and promoting supplemental map discovery across different devices.

In some embodiments, the first supplemental map includes advertisement content, such as representation 1824i in FIG. 18P. In some embodiments, the electronic device displays advertisement content within the first supplemental map to facilitate monetization. In some embodiments, the advertisement content is provided by an advertiser or a sponsor of the first supplemental map. In some embodiments, if the first supplemental map includes advertisement content, the supplemental map creator receives a payment for displaying the advertisement content. In some embodiments, if the electronic device detects user input corresponding to selection of the advertisement content, the electronic device, in response to detecting the user input corresponding to selection of the advertisement content, initiates a payment process to the supplemental map creator. It is understood that although the embodiments described herein are directed to supplemental maps, such functions and/or characteristics, optionally apply to other maps including primary maps. Monetizing supplemental maps via advertisement content enables supplemental map creators to receive funds for their map information without manually setting up a payment initiative, thereby improving the interaction between the user and the electronic device.

In some embodiments, displaying the first information of the first supplemental map in the user interface of the map application (e.g., such as described with reference to method 1900) includes in accordance with a determination that the electronic device has access to a first portion of the first information from the first supplemental map but not a second portion of the first information from the first supplemental map, the electronic device receives displays the first portion of the first information from the first supplemental map in the user interface of the map application, such as for example a first portion shown as representation 1826d in FIG. 18S and a second portion shows as representation 1826f in FIG. 18S. For example, the first portion of the first information optionally includes unpaid or free content and the second portion of the first information includes paid content. In some embodiments, the paid content includes additional content about the first supplemental map and/or additional features provided by the first supplemental content. For example, if the supplemental map is a map of an amusement park, the first portion of the first information optionally includes a first set of attractions and the second portion of the first information optionally includes a second set of attractions greater than the first set of attractions. In another example, the second portion of the first information optionally includes information related to wait times for each of the attractions. In another example, the second portion of the first information optionally includes a feature to reserve a spot in line to an attraction. In some embodiments, the electronic device displays the first portion of the first information without initiating a process to purchase the first portion of the first information. In some embodiments, an indication that the second portion of the first information is available for purchase is displayed in the user interface of the map application. In some embodiments, initiating a process to purchase the second portion of the first information includes one or more characteristics of initiating a process to purchase a supplemental map as described with reference to method 1900. In some embodiments, initiating a process to purchase the second portion of the first information includes initiating a process to purchase the second portion of the first information within the user interface of the map application (e.g., without navigating to a respective user interface of the map store).

In some embodiments, in accordance with a determination that the electronic device has access to the first portion of the first information from the first supplemental map and the second portion of the first information from the first supplemental map, the electronic device displays the first portion and the second portion of the first information from the first supplemental map in the user interface of the map application, such as for example a resulting user interface including a first portion shown as representation 1826d in FIG. 18S and a second portion shows as representation 1826f in FIG. 18S. For example, after receiving confirmation of successful purchase of the second portion of the first information (e.g., after access to the first portion of the first information of the first supplemental map has been obtained by the electronic device), the electronic device displays the second portion of the first information from the first supplemental map in the user interface of the map application. It is understood that although the embodiments described herein are directed to supplemental maps, such functions and/or characteristics, optionally apply to other maps including primary maps. Providing an option to display (paid) portions of supplemental map information simplifies interaction between the user and the electronic device and enhances operability of the electronic device by providing a way to display the portions of the supplemental map without navigating away from the user interface of the map application that includes the supplemental map, thereby improving the interaction between the user and the electronic device.

It should be understood that the particular order in which the operations in method 1900 and/or FIG. 19 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 19 are, optionally, implemented by components depicted in FIGS. 1A-1B. For example, displaying operation 1902a, and receiving operation 1902b, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces for Displaying One or More Routes Associated with a Supplemental Map

Users interact with electronic devices in many different manners, including interacting with maps and maps applications for viewing information about various locations. In some embodiments, an electronic device displays one or more routes associated with a supplemental map thus enhancing the user's interaction with the device. The embodiments described below provide ways to display a representation of one or more routes associated with a supplemental map in response to the electronic device having access to the supplemental map, thereby simplifying the presentation of information to the user and interactions with the user, which enhances the operability of the device and makes the user-device interface more efficient. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

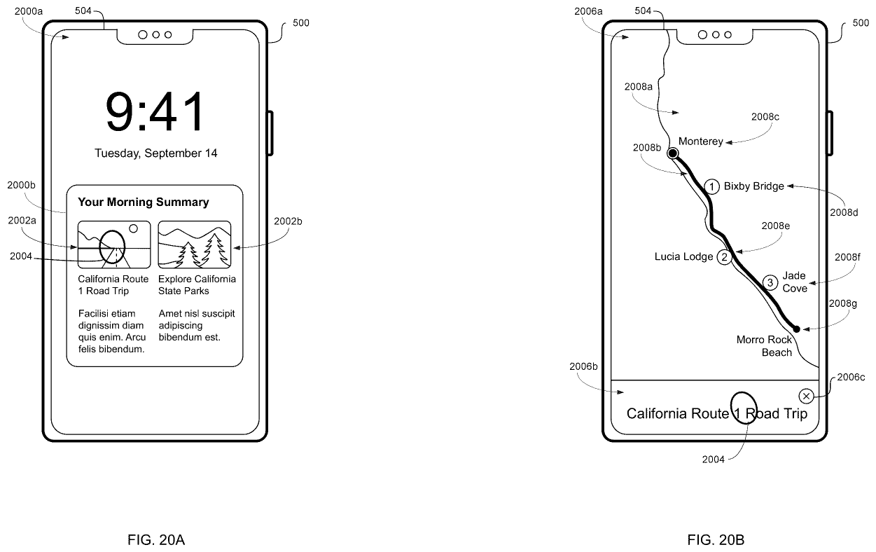

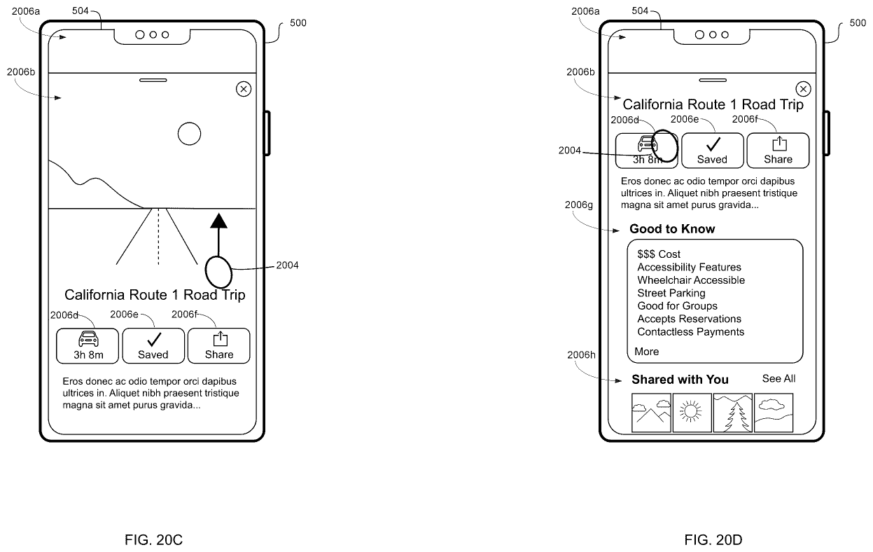

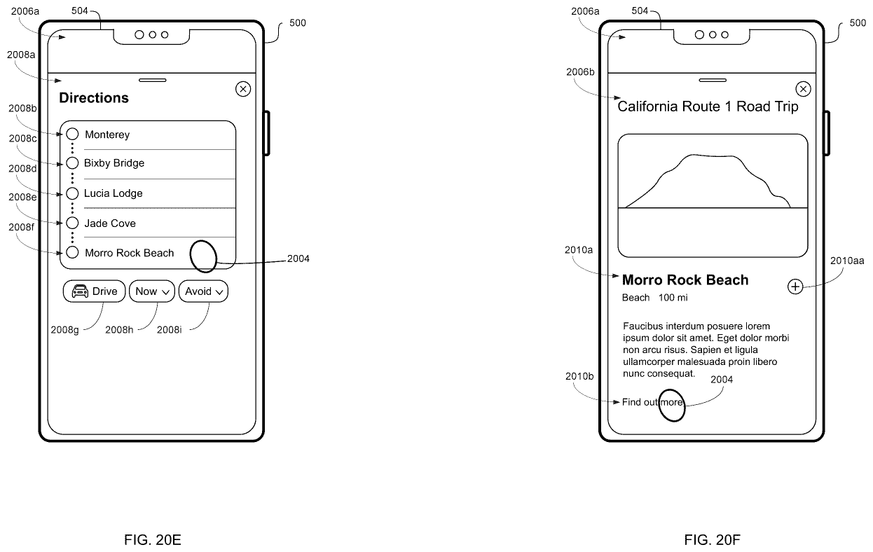

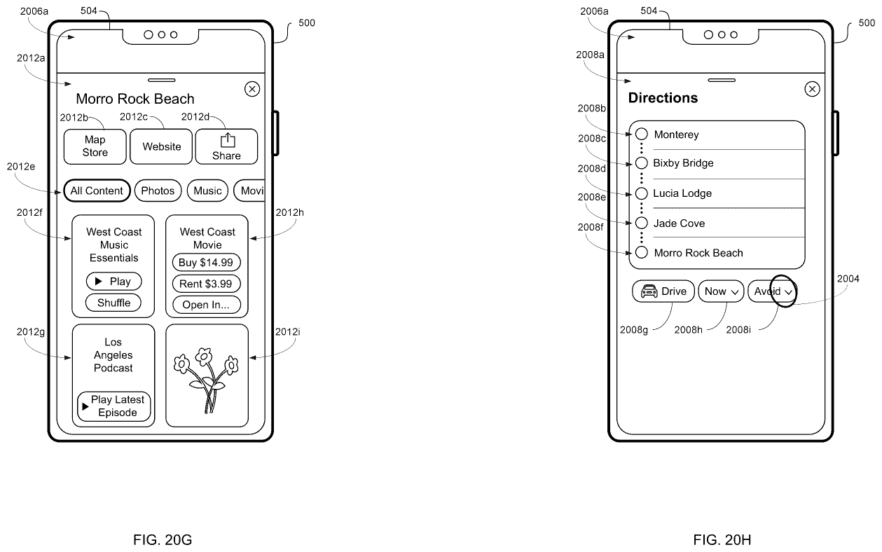

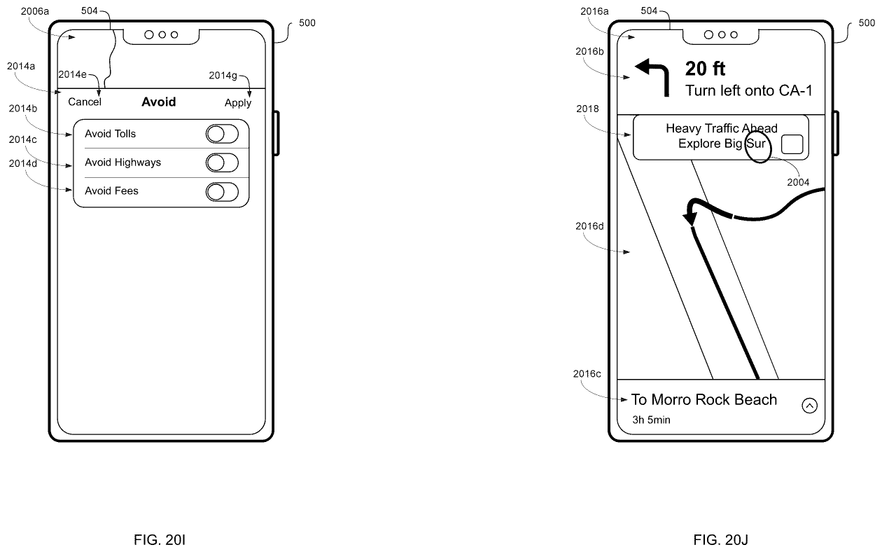

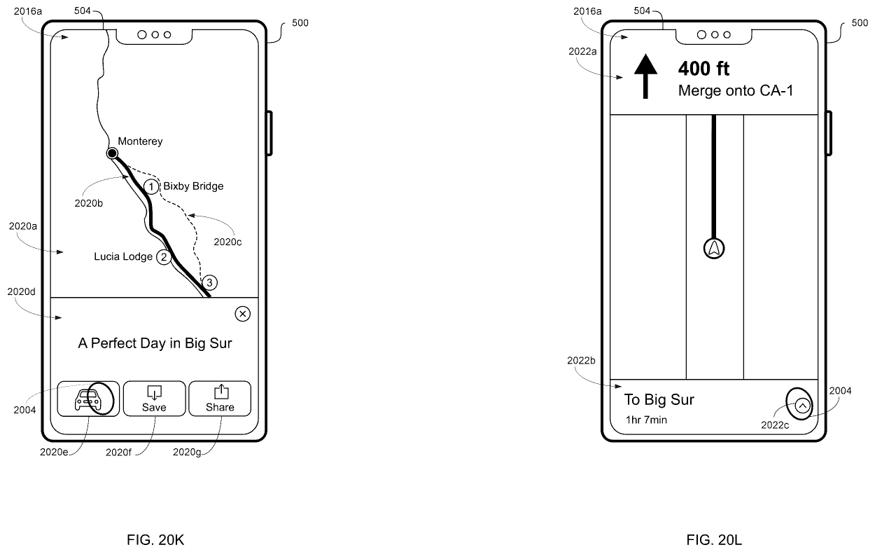

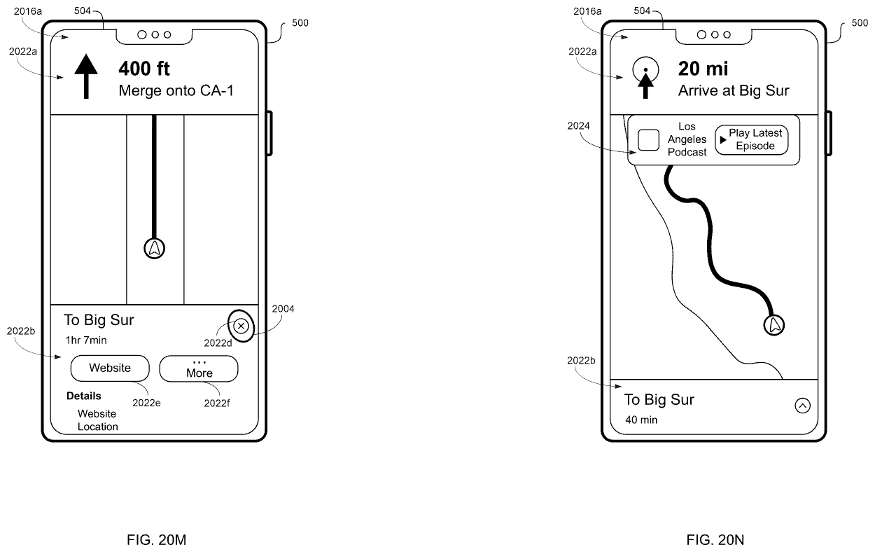

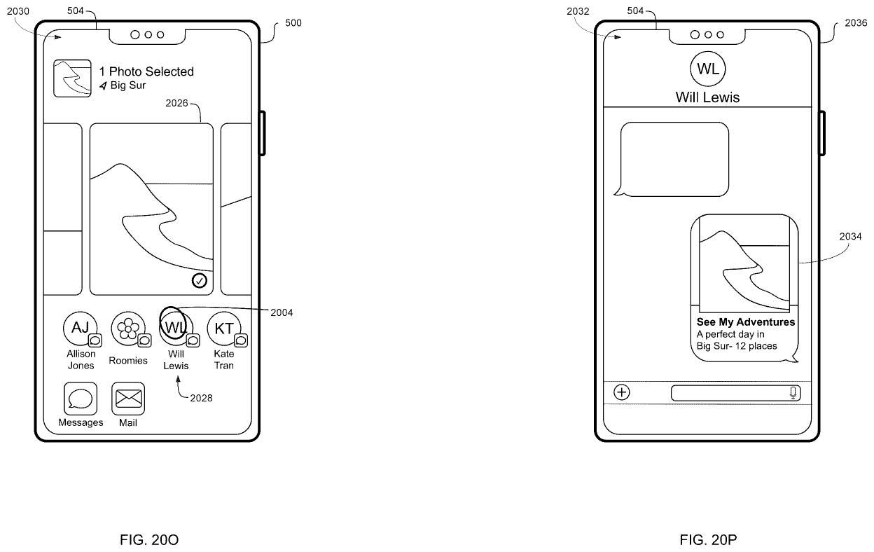

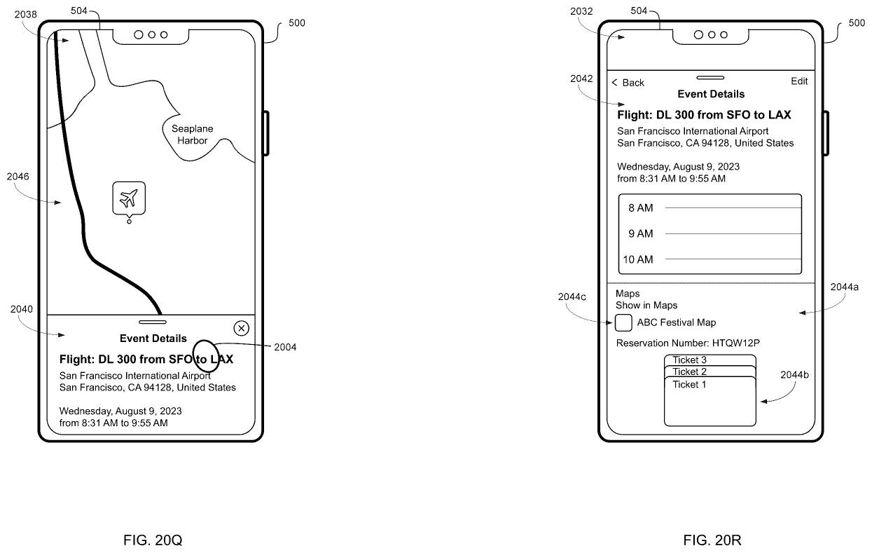

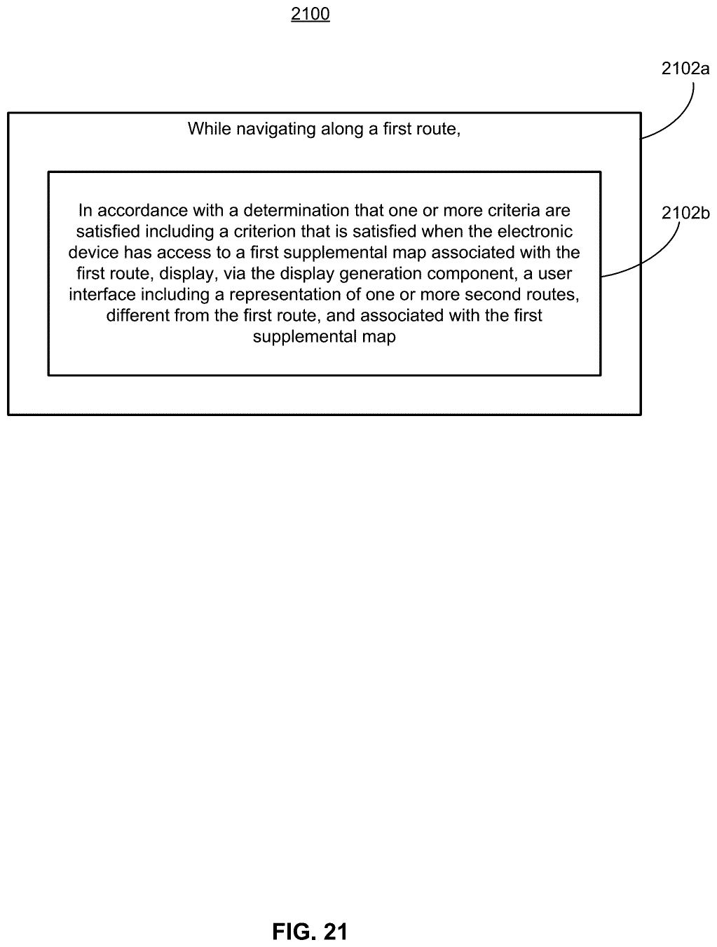

FIGS. 20A-20R illustrate exemplary ways in which an electronic device displays one or more routes associated with a supplemental map. The embodiments in these figures are used to illustrate the processes described below, including the processes described with reference to FIG. 21. Although FIGS. 20A-20R illustrate various examples of ways an electronic device is able to perform the processes described below with respect to FIG. 21, it should be understood that these examples are not meant to be limiting, and the electronic device is able to perform one or more processes described below with reference to FIG. 21 in ways not expressly described with reference to FIGS. 20A-20R.

FIG. 20A illustrates an electronic device 500 displaying a user interface 2000a. In some embodiments, the user interface 2000a is displayed via a display generation component 504. In some embodiments, the display generation component is a hardware component (e.g., including electrical components) capable of receiving display data and displaying a user interface. In some embodiments, examples of a display generation component include a touch screen display, a monitor, a television, a projector, an integrated, discrete, or external display device, or any other suitable display device.

As shown in FIG. 20A, the electronic device 500 presents a user interface 2000a (e.g., home screen user interface or a lock screen user interface) on display generation component 504. In FIG. 20A, the user interface 2000a is currently presenting a representation 2000b of a notification comprising a representation 2002a of a first route associated with a first supplemental map and a representation 2002b of a second supplemental map, different from the first supplemental map. The first supplemental map and the second supplemental map described with reference to methods 700, 900, 1100, 1300, 1500, 1700, 1900, 2100, and 2300. In FIG. 20A, the some embodiments, the representation 2002a of the first route associated with the first supplemental map and the representation 2002b of the second supplemental map include a description of and/or icon of the first route and second supplemental map, respectively.

In FIG. 20A, the electronic device detects user input 2204 (e.g., a contact on a touch-sensitive surface, actuation of a physical input device of the electronic device 500 or in communication with the electronic device 500, and/or a voice input from the user) corresponding to selection of the representation 2002a of the first route associated with the first supplemental map, and in response, the electronic device 500 displays user interface 2006a of a map application in FIG. 20B. User interface 2006a includes the information from the first supplemental map, such as a representation 2008b of a route line of the first route (e.g., overlaid on a representation of a primary map) and one or more representations of physical objects, route characteristics, and/or points of interest (e.g., representations 2008b, 2008c, 2008d, 2008e, and 2008f) in the vicinity of the route line. In FIG. 20B, the electronic device 500 displays the representation 2008b of the route line of the first route and the representations 2008c, 2008d, 2008e, 2008f, and 2008g of the points of interest as overlaid on the primary map (e.g., representation 2048). In this example shown in FIG. 20B, the supplemental map information includes a scenic route (e.g., representation 2008b) and a plurality of points of interest along the route (e.g., representations 2008b, 2008c, 2008d, 2008e, and 2008f), such as views, parks, beaches, waterfalls, coastal restaurants, beachfront lodging, and/or the like, and such scenic route including the plurality of points of interest is optionally not included in the primary map.

In some embodiments, the electronic device 500 visually distinguishes portions of the primary map that include supplemental map information from portions of the primary map that do not include the supplemental map information. For example, in FIG. 20B, electronic device 500 displays representation 2008b of the route line of the first route with a bolded line, different color and/or shading than other routes and/or other portions of the primary map areas. In some embodiments, the electronic device 500 displays additional supplemental map information, different from the supplemental map information overlaid on the primary map, such as text, photos, links, and/or selectable user interface elements objects configured to perform one or more operations related to the supplemental map. For example, in FIG. 20B, the electronic device 500 displays user interface element 2006b as half expanded. In some embodiments, when the user interface element 2006b is half expanded, the additional supplemental map information includes a title and/or photo of the first route associated with the supplemental map; a first option (e.g., representations 2006c) that, when selected, causes the electronic device 500 to close or cease displaying user interface element 2006b.

As shown in FIG. 20B, a portion of the user interface element 2006b is displayed, but in some embodiments, the user interface element 2006b is displayed as fully expanded. For example, in FIG. 20B, the electronic device detects user input 2004 (e.g., a contact on a touch-sensitive surface, actuation of a physical input device of the electronic device 500 or in communication with the electronic device 500, and/or a voice input from the user) corresponding to selection of the user interface element 2006b, and in response the electronic device 500 displays user interface element 2006b as fully expanded as shown in FIG. 20C. In FIG. 20C, the user interface 2006b includes an overview describing the first route associated with the supplemental map; a first option (e.g., representation 2006d) that, when selected, causes the electronic device 500 to initiate navigation along the first route; a second option (e.g., representation 2006e) that, when selected, causes the electronic device 500 to save the first route to another application other than the map application, such as in a digital travel guide application, digital magazine application, or digital journal application; and a third option (e.g., representation 2006f) that, when selected, causes the electronic device 500 to share the first route associated with the supplemental map to a second electronic device as will be described with reference to FIG. 20P.

In some embodiments, the user interface element 2006a includes information about the first route associated with the supplemental map. For example, in FIG. 20C, the electronic device 500 detects user input 2004 (e.g., a swipe contact on a touch-sensitive surface and/or a voice input from the user) corresponding to a request to navigate (e.g., scroll) user interface 2006a to view information about the first route associated with the supplemental map, and in response, the electronic device 500 scrolls user interface 2006a and displays additional content about the first route associated with the supplemental map as shown in FIG. 20D. For example, in FIG. 20D, user interface element 2006b includes information (e.g., representation 2006g), such as costs associated with navigating along the first route, suitability of the first route (e.g., wheelchair accessible/friendly, dog friendly), information about parking, and/or the like. The user interface element 2006b also includes one or more images, documents, media content, and/or the like about the first route. For example, representation 2006h includes photos captured by users and/or the user associated with the electronic device 500 of the first route and/or the points of interests along the first route.

As discussed above, the user interface element 2006b includes a first option (e.g., representation 2006d) that, when selected, causes the electronic device 500 to initiate navigation along the first route. For example, in FIG. 20D, the electronic device detects user input 2004 (e.g., a contact on a touch-sensitive surface, actuation of a physical input device of the electronic device 500 or in communication with the electronic device 500, and/or a voice input from the user) corresponding to selection of the first option (e.g., representation 2006d), and in response the electronic device 500 displays user interface element 2006a as shown in FIG. 20E. User interface 2006a includes the plurality of points of interest (e.g., representations 2008b, 2008c, 2008d, 2008e, and 2008f in a first order set by the supplemental map (e.g., the creator of the supplemental map). In some embodiments, the electronic device 500 detects a sequence of one or more user inputs (e.g., similar to user input 2004) corresponding to a request to modify the order of the plurality of points of interest. For example, the electronic device 500 initiates navigation along a first route where the electronic device 500 provides navigation directions to the point of interest “Jade Cove” (e.g., representation 2008e) after the point interest “Monterey” (e.g., representation 2008b). In another example, the electronic device provides navigation directions along the first route where the point of interest “Lucia Lodge” is removed (e.g., the electronic device does not provide navigation directions to “Lucia Lodge”.

In FIG. 20E, the user interface 2006a further includes a first option (e.g., representation 2008g) that, when selected, causes the electronic device 500 to start navigating along the first route; a second option (e.g., 2008h) that, when selected, causes the electronic device to set a particular departure time and/or arrival time; and a third option (e.g., representation 2008i) that, when selected, causes the electronic device to set one or more route preferences as will be described with reference to FIG. 20I.

In some embodiments, the electronic device 500 displays information about a particular point of interest along the first route associated with the supplemental map. For example, in FIG. 20E, the electronic device detects user input 2004 (e.g., a contact on a touch-sensitive surface, actuation of a physical input device of the electronic device 500 or in communication with the electronic device 500, and/or a voice input from the user) corresponding to selection of the representation 2008f of the point of interest “Morro Rock Beach”, and in response, the electronic device 500 displays user interface element 2006b as shown in FIG. 20F. User interface 2006b includes the name or title of the first route and a representation 2010a of the point of interest (e.g., “Morro Rock Beach”). Representation 2010a includes information (e.g., representation 2010a), such as the name of the point of interest and a description. Representation 2010a also includes a link or option (e.g., representation 2010b) that, when selected, causes the electronic device 500 view additional information about the point of interest. Representation 2010a also includes an option (e.g., representation 2010aa) that, when selected, causes the electronic device 500 to add the point of interest to a map guide, a supplemental map (different from the supplemental associated with the first route), and/or another application other than the map application, such as in a digital travel guide application, digital magazine application, or digital journal application.

In FIG. 20F, the electronic device 500 detects user input 2004 (e.g., a contact on a touch-sensitive surface, actuation of a physical input device of the electronic device 500 or in communication with the electronic device 500, and/or a voice input from the user) corresponding to selection of the link (e.g., representation 2010b), and in response, the electronic device 500 displays user interface element 2012a in FIG. 20G. User interface element 2012a includes addition information about and/or associated with the point of interest “Morro Rock Beach”. For example, in FIG. 20G, the electronic device 500 includes a first option (e.g., representation 2012b) that, when selected, causes the electronic device 500 to display a user interface of a map store application as described with reference to method 1900; a second option (e.g., representation 2012c) that, when selected, causes the electronic device to display a webpage corresponding to the point of interest and/or the associated supplemental map; and a third option (e.g., representation 2012d) that, when selected, causes the electronic device 500 to share the point of interest to a second electronic device as will be described with reference to FIG. 20P.

In some embodiments, the electronic device 500 displays media content related to the point of interest. For example, in FIG. 20G, the electronic device displays a plurality of representations of media content (e.g., representations 2012f, 2012g, 2012h, and 2012i). In some embodiments, the related media content includes music, movies, television shows, podcasts, images, photos, and/or the like. For example, in FIG. 20G, point of interest “Morro Rock Beach” is associated with a representation 2012f of a music playlist that, when selected, causes the electronic device 500 to initiate an operation to play the music playlist. User interface element 2012a also includes a representation 2012g of a podcast that discusses the history of the point of interest. Similarly to representation 2012f, if the electronic device detects user input corresponding to selection of representation 2012g, the electronic device, in response to the detected user input, initiates and operation to play the podcast. Other representations of media content displayed by the electronic device 500 include a representation 2012h of a movie about the geographic area corresponding to the point of interest that includes options that, when selected, cause the electronic device to initiate an operation to purchase the movie, rent the movie, or open the movie in movie streaming application.

In FIG. 20G, the user interface element 2012a further includes options (e.g., representation 2012e) to filter the plurality of media content. For example, in FIG. 20G, the user interface element 2012a includes all media content related to the point of interest as indicated by selection of “All Content”. In another example, if the electronic device 500 detects selection of “Photos”, the electronic device, in response, displays a subset of the plurality of media content to include representation 2012i. In some embodiments, the representation of the point of interest and/or the representations of related media content include one or more of the characteristics of the points of interest and/or related media content of the supplemental maps described with reference to methods 700, 900, 1100, 1300, 1500, 1700, 1900, 2100, and 2300.

As mentioned above, the electronic device 500 provides an option (e.g., representation 2008i in FIG. 20H and FIG. 20E) that, when selected, causes the electronic device to set one or more route preferences. For example, in FIG. 20H, the electronic device 500 detects user input 2004 (e.g., a contact on a touch-sensitive surface, actuation of a physical input device of the electronic device 500 or in communication with the electronic device 500, and/or a voice input from the user) corresponding to selection of representation 2008i, and in response, the electronic device 500 displays user interface element 2014a in FIG. 20I. User interface element 2014a includes filter options, that when selected, cause the electronic device 500 to display a subset of routes that satisfy one or more filter criteria. For example, the electronic device 500 displays a first filter option to avoid tolls (e.g., representation 2014b), avoid highways (e.g., representation 2014c), and avoid fees (e.g., representation 2014d).

In some embodiments, while the electronic device 500 detects the electronic device 500 navigating along a first route, the electronic device 500 recommends one or more second routes, different from the first route, and associated with a supplemental in response to a determination that the electronic device 500 has access to the supplemental map as described with reference to methods 1900 and/or 2100. In FIG. 20J, the electronic device 500 is navigating to a first destination as shown by representation 2016c displayed in a user interface 2016a of a map application. The user interface 2016a includes navigation instructions (e.g., representation 2016b) and a representation 2016d of a primary map. In FIG. 20J, the electronic device 500 determines an upcoming route characteristic satisfies one or more criteria as described with reference to method 2100 and, in response, the electronic device 500 displays a representation 2018 of a second route associated with a supplemental map that the electronic device 500 has access to (e.g., downloaded to storage of the electronic device 500). In some embodiments, the representation 2018 includes information related to the upcoming route characteristic (e.g., “Heavy Traffic”). In some embodiments, the representation 2018 includes the name or title of the second route and an icon or image associated with the second route and/or the supplemental map. In FIG. 20J, the electronic device 500 detects user input 2004 (e.g., a contact on a touch-sensitive surface, actuation of a physical input device of the electronic device 500 or in communication with the electronic device 500, and/or a voice input from the user) corresponding to selection of representation 2018, and in response, the electronic device 500 displays supplemental map information including a representation 2020b of the second route as shown in FIG. 20K.

In FIG. 20K, user interface 2016a includes the second route (e.g., representation 2020b) as overlaid on the primary map (e.g., representation 2020a) and concurrently displayed with the first route (e.g., representation 2020c). User interface 2016a also includes user interface element 2020d that includes information about the second route, such as description and/or the name of the second route; a first option (e.g., representation 2020e) that, when selected, causes the electronic device 500 to start navigating along the second route; a second option (e.g., 2020f) that, when selected, causes the electronic device 500 to save the second route to another application other than the map application, such as in a digital travel guide application, digital magazine application, or digital journal application; and a third option (e.g., representation 2020g) that, when selected, causes the electronic device 500 to share the second route associated with the supplemental map to a second electronic device as will be described with reference to FIG. 20P. In FIG. 20K, the electronic device 500 detects user input 2004 (e.g., a contact on a touch-sensitive surface, actuation of a physical input device of the electronic device 500 or in communication with the electronic device 500, and/or a voice input from the user) corresponding to selection of representation 2020e, and in response, the electronic device 500 ceases navigating along the first route and begins navigating along the second route as shown in FIG. 20L. For example, the electronic device 500 displays user interface element 2022b including a new destination associated with the second route and updated navigation instructions (e.g., representation 2022a). In FIG. 20L user interface element 2022b includes an option (e.g. representation 2022c) that, when selected, causes the electronic device 500 to display information related to the new destination. For example, the electronic device 500 detects user input 2004 (e.g., a contact on a touch-sensitive surface, actuation of a physical input device of the electronic device 500 or in communication with the electronic device 500, and/or a voice input from the user) corresponding to selection of representation 2022c, and in response, the electronic device 500 displays user interface 2022b including information about the new destination, such as an estimated time of arrival to the new destination and options (e.g., representations 2022e, 2022f, and 2022d) that, when selected, causes the electronic device 500 to display a webpage associated with the destination and/or the supplemental map, display a list of points of interest included in the second route similar to the list of points of interest included in user interface element 2008a in FIG. 20H, and close the user interface element 2022b, respectively. For example, the electronic device 500 detects user input 2004 (e.g., a contact on a touch-sensitive surface, actuation of a physical input device of the electronic device 500 or in communication with the electronic device 500, and/or a voice input from the user) corresponding to selection of representation 2022d, and in response, the electronic device 500 ceases to display user interface element 2022b as shown in FIG. 20N.

In some embodiments, while navigating along the second route, the electronic device 500 determines that the electronic device 500 is within a predetermined distance from the destination, and in response the electronic device 500 displays a notification of media content related to the destination (e.g., representation 2024 in FIG. 20N). For example, representation 2024 includes a podcast geographically related to the destination. In some embodiments, when the electronic device 500 detects user input directed to representation 2024, the electronic device 500, in response, initiates playback of the podcast.

In some embodiments, the user of the electronic device 500 elects to share information captured while navigating along the second route, such as one or more photos. For example, in FIG. 20O, the electronic device 500 displays a user interface 2030 of a photos application. The user interface 2030 includes a selected photo 2026 captured at a destination along the second route to be shared to a second user of a second electronic device (e.g., representation 2028), different from the user of the first electronic device 500. In FIG. 20O, the electronic device detects user input 2004 (e.g., a contact on a touch-sensitive surface, actuation of a physical input device of the electronic device 500 or in communication with the electronic device 500, and/or a voice input from the user) corresponding to selection of representation 2028, and in response, the electronic device 500 transmits the photo via a messaging communication as shown in FIG. 20P.

FIG. 20P illustrates the second electronic device 2036 (e.g., such as described with reference to electronic device 500). In FIG. 20P, the second electronic device 2036 displays a messaging user interface 2032 including a message 2034 received from the electronic device 500 that includes the photo captured by the electronic device 500 at a destination along the second route. In some embodiments, and as described with reference to method 2100, the electronic device 2036 displays notifications related to the user of electronic device 500 navigating along the second route, for example location notifications, shared photos and/or videos captured while on the second route, and/or the like.

In some embodiments, the electronic device 500 displays representations of supplemental maps in applications other than the map application. For example, in FIG. 20Q, the electronic device 500 determines based on calendar data and/or a current location of the electronic device that the user of the electronic device 500 is attending an event, and in response, the electronic device displays user interface 2038 that includes user interface element 2040 and a supplemental map (e.g., representation 2046) associated with the event. For example, in FIG. 20Q user interface element 2040 includes event details corresponding to a flight and representation 2046 is a supplemental map of the San Francisco Airport.

In FIG. 20Q, the electronic device 500 detects user input 2004 (e.g., a contact on a touch-sensitive surface, actuation of a physical input device of the electronic device 500 or in communication with the electronic device 500, and/or a voice input from the user) corresponding to selection of user interface element 2040, and in response the electronic device 500 displays user interface 2032 of a calendar application in FIG. 20R. User interface 2032 includes detailed information about the event (e.g., representation 2042) and a representation of a supplemental map associated with the event, different from the supplemental map of the San Francisco Airport. For example, the supplemental map is a festival map being held in San Francisco which is the flight destination. In some embodiments, in response to user input directed to representation 2042, the electronic device 500 displays the supplemental map. User interface 2032 also includes one or more passes and/or tickets (e.g., representation 2044b) associated with the event. In some embodiments, and as discussed with reference to methods 1900 and/or 2100, the electronic device automatically removes from storage of the electronic device 500 the supplemental map and/or the one or more passes in response to a determination an end of the event and/or after an expiration date associated with the supplemental map and/or the one or more passes.

FIG. 21 is a flow diagram illustrating a method for displaying one or more routes associated with a supplemental map. The method 2100 is optionally performed at an electronic device such as device 100, device 300, device 500 as described above with reference to FIGS. 1A-1B, 2-3, 4A-4B and 5A-5H. Some operations in method 2100 are, optionally combined and/or the order of some operations is, optionally, changed.

In some embodiments, method 2100 is performed at an electronic device in communication with a display generation component (e.g., 504) and one or more input devices. In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 2100 is performed at or by an automobile (e.g., at an infotainment system of an automobile having or in communication with one or more display generation components and/or input devices).

In some embodiments, while navigating along a first route (2102a), such as shown in FIG. 20J with user interface 2016a, in accordance with a determination that one or more criteria are satisfied including a criterion that is satisfied when the electronic device has access to a first supplemental map associated with the first route, the electronic device displays (2102b), via the display generation component, a user interface including a representation of one or more second routes, different from the first route, and associated with the first supplemental map, such as representation 2018 in FIG. 20J. In some embodiments, the user interface is a user interface of the map application as described with reference to methods 700, 900, 1100, 1300, 1500, 1700, 1900, 2100, and/or 2300. In some embodiments, the first supplemental map includes one or more of the characteristics of the supplemental maps described with reference to methods 700, 900, 1100, 1300, 1500, 1700, 1900, 2100, and/or 2300. In some embodiments, the electronic device has previously downloaded, purchased access to and/or otherwise obtained access to the first supplemental map as described with reference to method 1900. In some embodiments, the first route is a pathway along which the electronic device is navigating via automobile, train, ship, airplane, bicycle, public transportation, rideshare, or any other mode of transportation. In some embodiments, the electronic device obtains the first route from the map application. For example, the map application has programmed in and/or provides maps (e.g., primary and/or supplemental), navigation routes, navigation directions, location metadata, and/or imagery (e.g., captured photos) associated with various geographical locations, points of interest, and/or media content. In some embodiments, the electronic device is providing navigation directions for the first route while the electronic device is navigating along the first route. In some embodiments, the electronic device presents the navigation directions which include a representation of a route line of the first route (e.g., overlaid on a representation of a map) and one or more representations of physical objects, route characteristics, and/or points of interest in the vicinity of the route line. The first route optionally extends from a first location (e.g., starting location) to a second location (e.g., destination location). In some embodiments, the first supplemental map is geographically associated with the first location, the second location, and/or other geographic region of the first route such that while navigating along the first route, the electronic device automatically presents map information from the first supplemental map (e.g., the one or more second routes). In some embodiments, the first supplemental map is geographically associated with the first location, the second location, and/or other geographic region of the first route in accordance with a determination that the first location, the second location, and/or other geographic region of the first route are at least partially or fully included within the geographic location/region of the first supplemental map. In some embodiments, the electronic device automatically presents for display a representation of one or more second routes, different from the first route, and associated with the first supplemental map (e.g., the one or more second routes are geographically associated with the geographic location/region of the first supplemental map, such as being at least partially or fully included within the geographic location/region of the first supplemental map) in response to the one or more criteria being satisfied. For example, as a result of the electronic device having access to the first supplemental map associated with the first route, the electronic device presents or suggests navigating along one or more of the one or more second routes associated with the first supplemental map. In some embodiments, the one or more second routes extend from the first location to the second location. In some embodiments, the one or more second routes extends from a third location, different from the first location, to the second location. In some embodiments, the one or more second routes extend from the first location to a fourth location, different from the second location. In some embodiments, the one or more second routes extend from the third location to the fourth location. In some embodiments, the one or more second routes include route characteristics that are different from the route characteristics associated with the first route. For example, the route characteristics of the one or more second routes optionally include a greater amount of natural landscapes, scenic qualities, and/or cultural features than the route characteristics of the first route. In some embodiments, the one or more second routes include an estimated time of arrival to the second location later than the first route (e.g., the one or more second routes have a longer duration than the original first route). In some embodiments, the one or more second routes include an estimated time of arrival to the second location sooner than the first route (e.g., the one or more second routes have a shorter duration than the original first route). In some embodiments, if the first route is geographically associated with a second supplemental map (e.g., the first location, the second location, and/or other geographic region of the first route corresponds to a geographic region of the second supplemental map), the electronic device presents one or more third routes, different from the one or more second routes, and associated with the second supplemental map. In some embodiments, the association between the first route and the one or more second routes to the first supplemental map is based on metadata defining maps, map objects, navigation routes, points of interest, imagery, and/or media content. For example, the first location (e.g., San Francisco) of the first route and/or the one or more second routes includes an association with at least two media content tags (e.g., the song “I Left My Heart in San Francisco” and the movie “The Rock”) included in the first supplemental map as described in more detail with reference to methods 1300, 1500, 2100, and/or 2300. In some embodiments, in accordance with a determination that the one or more criteria are not satisfied, the electronic device forgoes displaying the user interface including the representation of the one or more second routes. In some embodiments, the electronic device displays the user interface including the representation of the one or more second routes prior to navigating along the first route when the electronic device determines that the one or more criteria are satisfied. For example, when the electronic device determines a current time and/or day of the electronic device indicates a start of (or initiation of) navigating along the first route (e.g., morning of a flight or day of a road trip) and/or a contextual change of the electronic device indicates a start of navigating along the first route (e.g., boarding a plane or getting in an automobile), the electronic device determines whether the one or more criteria are satisfied including the criterion that is satisfied when the electronic device has access to the first supplemental map associated with the first route. In some embodiments, when the electronic device determines that the one or more criteria are satisfied including the criterion that is satisfied when the electronic device has access to the first supplemental map associated with the first route, the electronic device displays the user interface including the representation of the one or more second routes prior to or a predetermined amount of time (e.g., 1 month, 3 weeks, 1 week, 24 hours, 12 hours, 6 hours, or 1 hour) before navigating along the first route. Automatically displaying a representation of one or more second routes that may be of interest to the user, and associated with a first supplemental map in response to the electronic device having access to the first supplemental map avoids additional interaction between the user and the electronic device associated with inputting a change in route navigation when seamless transition between routes is desired, thereby reducing errors in the interaction between the user and the electronic device and reducing inputs needed to correct such errors.

In some embodiments, the one or more second routes include one or more points of interest that are within a threshold distance of a location associated with an event that is associated with the first supplemental map, such as for example an event as shown by representation 2040 in FIG. 20Q. For example, the one or more points of interest optionally include landmarks, public parks, structures, businesses, or other entities that that are within a threshold distance (e.g., 5, 10, 20, 50, 100, 150, or 250 kilometers) of a location associated with an event that is associated with the first supplemental map. In some embodiments, the location associated with the event is the same as the event location. For example, if the event location is Las Vegas, the one or more points of interest are within the threshold distance of Las Vegas. In some embodiments, the location associated with the event is geographically associated with the event location in accordance with a determination that the location is at least partially or fully included within the geographic location/region of the event location. For example, if the event location is San Francisco, the one or more points of interest are within the threshold distance of Sausalito which is geographically associated with San Francisco. In some embodiments, an event that is associated with the first supplemental map is an event that is featured in the first supplemental map. For example, if the event is ABC Festival, the first supplemental map is a map showing stage locations, restrooms, and food stalls within the location of the ABC Festival. In another example, if the event is ABC Festival, the first supplemental map is a map showing hotels, restaurants, bars, convenience stores, and/or the like within the location of the ABC Festival. Providing one or more points of interest that are within a threshold distance of a location associated with an event that is associated with the first supplemental map enables a user to view/discover points of interest associated with an event of the supplemental map which reduces power usage and improves battery life of the electronic device by enabling the user to use the electronic device more quickly and efficiently without the need for additional inputs for searching for points of interest associated with the event and avoids erroneous inputs related to searching for such map information.

In some embodiments, the one or more second routes associated with the first supplemental map are based on user-generated content (e.g., do not include editorial content) or editorial content included in the first supplemental map, such as for example representation 2006b and representation 2006h in FIG. 20D. In some embodiments, the editorial content includes one or more characteristics of the editorial associated with the first supplemental map as described with reference to method 1900. In some embodiments, the user-generated content includes one or more characteristics of the editorial associated with the first supplemental map as described with reference to methods 1700, 1900, 2100, and/or 2300. In some embodiments, the editorial content and/or the user-generated content includes a particular type of activity and/or focus on one or more environmental factors (e.g., landscapes, sunset and/or sunrise views, foliage of trees, oceans, mountains, wildflowers in a field, and/or other scenery), such as “Scenic Trails for Dogs in SF”, “Best Places to Take Photos in Big Sur”, and/or the like. Displaying the one or more second routes based on editorial content and/or user-generated content enables a user to quickly locate desired supplemental maps, which reduces power usage and improves battery life of the electronic device by enabling the user to use the electronic device more quickly and efficiently and without the need for additional inputs for searching for user-generated and/or editorial content and avoids erroneous inputs related to searching for such content.

In some embodiments, the user interface includes one or more representations of one or more points of interest associated with the one or more second routes (e.g., such as described with reference to method 2100), such as representations 2008c, 2008d, 2008e, 2008f, and 2008g in FIG. 20B.

In some embodiments, while displaying the user interface, the electronic device receives, via the one or more input devices, an input that corresponds to selection of a representation of a point of interest, such as input 2004 directed to representation 2008f in FIG. 20E. In some embodiments, the input includes a user input directed to a user interface element corresponding to, and/or a representation of, a point of interest associated with the one or more second routes, such as a gaze-based input, an activation-based input such as a contact on a touch-sensitive surface, a tap input, or a click input, (e.g., via a mouse, trackpad, or another computer system in communication with the electronic device), actuation of a physical input device, a predefined gesture (e.g., pinch gesture or air tap gesture) and/or a voice input from the user) corresponding to (optionally selection of) the representation of the point of interest. In some embodiments, the representation of the point of interest includes text, affordances, virtual objects, that when selected, causes the electronic device to display media content information as described herein.

In some embodiments, in response to receiving the input, the electronic device displays, via the display generation component, a representation of media content that is related to the point of interest, such as representation 2012f in FIG. 20G. In some embodiments, the representation of media content is included in the user interface of the map application as described with reference to methods 700, 900, 1100, 1300, 1500, 1700, 1900, 2100, and/or 2300. In some embodiments, the representation of media content is included in a user interface other than the user interface that includes the representation of one or more second routes of the map application as described with reference to method 2100. In some embodiments, the representation of media content is included in a user interface of an application different from the map application, such as media content application as described with reference to methods 1300, 1500, 1900, 2100, and/or 2300. In some embodiments, the representation of media content includes one or more characteristics of the representation of media content described with reference to methods 1300 and/or 1500. In some embodiments, the media content includes metadata, such as titles, artist names, set location, songs, historical events, points of interest, and/or other information related to the point of interest. For example, if the point of interest is Golden Gate Bridge, the media content includes a television show and/or movie filmed at Golden Gate Bridge, and/or a song or podcast about Golden Gate Bridge. In some embodiments, the media content includes movies, music, audiobooks, podcasts, videos, and/or television shows. In some embodiments, the media content described herein includes one or more of the characteristics of the media content described with reference to methods 1300, 1500, 1700, 1900, 2100, and/or 2300. In some embodiments, the electronic device detects input that corresponds to selection of the representation of media content. In some embodiments the input that corresponds to selection of the representation of media content includes one or more characteristics of the input that corresponds to selection of the representation of the point of interest as described herein. In some embodiments, in response to the detecting the input that corresponds to selection of the representation of media content, the electronic device displays a details user interface of the media content as described with reference to methods 1300 and/or 1500. Displaying a representation of media content that is related to the point of interest enables a user to view both map-related information and media content, thereby reducing the need for subsequent inputs to locate and display the media content related to the point of interest, which reduces power usage and improves battery life of the electronic device by enabling the user to use the electronic device more quickly and efficiently and without the need for additional inputs for searching for related media content and avoids erroneous inputs related to searching for such content.

In some embodiments, while navigating along the first route (e.g., such as described with reference to method 2100), in accordance with a determination that a destination of the first route is reached, the electronic device displays, via the display generation component, a representation of editorial content associated with the first supplemental map and the destination, such as representation 2024 in FIG. 20N. In some embodiments, the destination is an intermediate destination or a final destination of the first route. In some embodiments, the electronic device determines that the destination of the first route is reached when the electronic device determines that a current location of the electronic device corresponds to the respective location of the destination. In some embodiments, the electronic device determines that the destination of the first route is reached when the electronic device determines that a current location of the electronic device is within a threshold distance (e.g., 5, 10, 20, 50, 100, 150, or 250 kilometers) of the destination. In some embodiments, the representation of editorial content associated with the first supplemental map and the destination is included in the user interface of the map application as described with reference to methods 700, 900, 1100, 1300, 1500, 1700, 1900, 2100, and/or 2300. In some embodiments, the representation of editorial content is included in a user interface other than the user interface that includes the representation of one or more second routes of the map application as described with reference to method 2100. In some embodiments, the editorial content includes one or more characteristics of the editorial associated with the first supplemental map as described with reference to methods 1900 and 2100. In some embodiments, the destination is featured in the first supplemental map and includes editorial content, such as favorite beaches in San Francisco, famous landmarks in San Francisco, most beautiful parks in San Francisco, and/or the like. In some embodiments, displaying the representation of editorial content includes displaying the representation as a notification overlaid a respective user interface. For example, when the respective user interface includes navigation directions as described with reference to method 2100, the electronic device displays the representation of editorial content concurrently with and/or overlaid upon the navigation directions and/or the respective user interface. In some embodiments, the representation of editorial content includes a graphical image and/or text description describing the editorial content. In some embodiments, the representation of editorial content includes a prompt to the user of the electronic device to accept or decline performing an operation associated with the editorial content and continuing to navigate along the first route. For example, if the editorial content includes music, a podcast, a video, or an audiobook, performing an operation associated with the editorial content includes optionally playing the music, the podcast, the video, or the audiobook. In some embodiments, the first electronic device automatically transitions to playing the music, the podcast, the video, or the audiobook after a period of time (e.g., 5, 10, 15, 20, 25, 30, 35, or 40 seconds). In some embodiments, performing an operation associated with the editorial content includes pausing navigating along the first route. In some embodiments, the electronic device detects user input that corresponds to selection of the representation of the editorial content, and in response, the electronic device causes the editorial content to be played. In some embodiments, the user input that corresponds to selection of the representation of the editorial content has one or more characteristics as the input that corresponds to selection of a representation of a point of interest as described with reference to method 2100. Automatically displaying a representation of editorial content associated with the first supplemental map and the destination in response to a determination that a destination of the first route is reached and without receiving user input avoids additional interaction between the user and the electronic device associated with inputting a request to navigate away from navigating along the first route to navigate to the editorial content, thereby reducing errors in the interaction between the user and the electronic device and reducing inputs needed to correct such errors by providing improved feedback to the user.

In some embodiments, while navigating along the first route (e.g., such as described with reference to method 2100), in accordance with a determination that one or more points of interest associated with the first supplemental map are within a threshold distance (e.g., 5, 10, 20, 50, 100, 150, or 250 kilometers) of a current location of the electronic device along the first route (e.g., such as described with reference to method 2100), the electronic device displays, in the user interface, a representation of a first point of interest associated with the first supplemental map that is selectable to display information about the first point of interest, such as representation 2018 in FIG. 20J. In some embodiments, the representation of the first point of interest associated with the first supplemental map includes one or more of the characteristics of the representation of the point of interest described with reference to methods 1300, 1500, 1700, 1900, 2100, and/or 2300. For example, displaying the representation of the first point of interest includes displaying the representation as a notification overlaid a respective user interface. For example, when the respective user interface includes navigation directions as described with reference to method 2100, the electronic device displays the representation of the first point of interest concurrently with and/or overlaid upon the navigation directions and/or the respective user interface. In some embodiments, the representation of the first point of interest includes a graphical image and/or text description describing the point of interest. In some embodiments, the representation of the first point of interest includes a prompt to the user of the electronic device to accept or decline performing an operation associated with the first point of interest and continuing to navigate along the first route. For example, if the first point of interest includes other points of interest, performing an operation associated with the first point of interest includes optionally displaying information about the other points of interest. For example, the information about the other points of interest include graphical images and/or text descriptions describing the other points of interest. In some embodiments, the first electronic device automatically transitions to displaying the information about the other points of interest after a period of time (e.g., 5, 10, 15, 20, 25, 30, 35, or 40 seconds). In some embodiments, performing an operation associated with the first point of interest includes pausing navigating along the first route. In another example, performing an operation associated with the first point of interest includes navigating to the first point of interest. For example, the electronic device optionally pauses navigating along the first route and navigates to the first point of interest. In some embodiments, after navigating to the first point of interest, the electronic device resumes navigating along the first route. In some embodiments, navigating to the first point of interest is based on a condition that the electronic device receives acceptance to cease navigating along the first route and instead, navigate to the first point of interest. In some embodiments, the acceptance is indicated by detection of an appropriate movement of the electronic device along a respective route to the first point of interest (e.g., navigating towards the first point of interest). Automatically displaying a representation of a point of interest associated with the first supplemental map in response to a determination that a current location of the electronic device is within a threshold distance from the point of interest and without receiving user input avoids additional interaction between the user and the electronic device associated with inputting a request to navigate away from navigating along the first route to navigate to the point of interest, thereby reducing errors in the interaction between the user and the electronic device and reducing inputs needed to correct such errors by providing improved feedback to the user.

In some embodiments, while navigating along the first route, and after displaying the user interface including the representation of the one or more second routes, in accordance with a determination that an upcoming route characteristic satisfies one or more first criteria, the electronic device displays, via the display generation component, a representation of one or more third routes, different from the first route and the one or more second routes, and associated with the first supplemental map, such as representation 2018 in FIG. 20J. In some embodiments, the upcoming route characteristic is a segment or point of the first route the electronic device has yet to reach (e.g., the upcoming route characteristic is a threshold distance (e.g., 1, 5, 10, 20, 30, 50, or 100) kilometers) from the current location of the electronic device and/or a threshold time (e.g., 10, 20, 30, 60, or 120 minutes) from the current location of the electronic device). For example, the one or more first criteria include a criterion that is satisfied when the upcoming route characteristic relates to an itinerary change (e.g., flight change), traffic, transit times, road closures, imminent weather, path accessibility, user preferences (e.g., avoid hills, avoid tolls, and/or the like) indicative of ceasing to navigate along the first route and recommend one or more other routes (e.g., the one or more third routes associated with the first supplemental map described herein), different from the first route to avoid the upcoming route characteristic. In some embodiments, the representation of one or more third routes associated with the first supplemental map is included in the user interface of the map application as described with reference to methods 700, 900, 1100, 1300, 1500, 1700, 1900, 2100, and/or 2300. In some embodiments, the representation of one or more third routes is included in a user interface other than the user interface that includes the representation of one or more second routes of the map application as described with reference to method 2100. In some embodiments, the one or more third routes associated with the first supplemental map is geographically associated with the geographic location/region of the first supplemental map, such as being at least partially or fully included within the geographic location/region of the first supplemental map. In some embodiments, the one or more third routes include one or more points of interest not included in the first route. For example, the one or more third routes optionally include more natural landscapes, scenic qualities, and/or cultural features than the first route, In some embodiments, the one or more third routes include the same one or more points of interest as in the first route. In some embodiments, the one or more third routes have one or more of the characteristics of the one or more second routes as described with reference to method 2100. In some embodiments, the representation of the one or more third routes include a prompt to the user of the electronic device to accept or decline performing an operation associated with the one or more third routes. In some embodiments, performing an operation associated with the first point of interest includes pausing navigating along the first route. In another example, performing an operation associated with the first point of interest optionally includes navigating along the one or more third routes (e.g., instead of along the first route). For example, the electronic device optionally pauses navigating along the first route and navigates according to the one or more third routes. In some embodiments, navigating along the one or more third routes is based on a condition that the electronic device receives acceptance to cease navigating along the first route and instead, navigate along the one or more third routes. In some embodiments, the acceptance is indicated by detection of an appropriate movement of the electronic device along the one or more third routes (e.g., ceasing to navigate along the first route and/or navigating using the one or more third routes). Automatically displaying a representation of one or more routes, different from the first route, and associated with the first supplemental map in response to a determination that an upcoming route characteristic satisfies one or more first criteria and without receiving user input avoids additional interaction between the user and the electronic device associated with inputting a request to locate alternative routes and/or navigate away from the upcoming route characteristic, thereby reducing errors in the interaction between the user and the electronic device and reducing inputs needed to correct such errors by providing improved feedback to the user.

In some embodiments, the one or more second routes include navigating according to a first mode of transportation for a first segment of the one or more second routes and navigating according to a second mode of transportation, different from the first mode of transportation, for a second segment of the one or more second routes, such as for example where representation 2008b includes navigating by plane and representation 2008e includes navigating by bicycle in FIG. 20H. For example, the electronic device is optionally navigating along the first route using a motorized vehicle, such as an automobile (e.g., driving directions). In some embodiments, navigating according to the first mode of transportation includes bicycling, walking, using public transit, flying, or transportation other than the motorized vehicle. In some embodiments, the second mode of transportation is the same as the mode of transportation associated with the first route. In some embodiments, the second mode of transportation is different from the mode of transportation associated with the first route. For example, the first segment of the one or more second routes optionally includes navigating along the first segment using a bicycle, and navigating along the second segment by walking. In this example, the electronic device determines that the second segment includes a vista or sight that is accessible using the second mode of transportation (e.g., walking). Providing routes that include a particular mode of transportation provides an efficient way of navigating along a route and enhances interactions with the electronic device (e.g., by reducing the amount of time needed for the user of the electronic device to perform route configuration operations), which reduces power usage and improves battery life of the electronic device by enabling the user to use the electronic device more quickly and efficiently.

In some embodiments, displaying the user interface including the representation of the one or more second routes (e.g., such as described with reference to method 2100) includes in accordance with a determination that the one or more second routes satisfy one or more second criteria, the electronic device displays first information from the first supplemental map, such as representation 2008d in FIG. 20B. For example, the one or more second criteria optionally include a criterion that is satisfied when the one or second routes include a point of interest that is related to media content as described with reference to methods 1300, 1500, 1700, 1900, 2100, and/or 2300. In this case, the first information from the supplemental map includes a representation of media content that is related to the point of interest as described with reference to method 2100. In some embodiments, the one or more second criteria optionally include a criterion that is satisfied when the one or second routes include a point of interest that includes one or more characteristics related to costs, fees, tolls, and/or the like. For example, if the point of interest includes and entrance fee, the first information displayed includes a description of the entrance fee. In some embodiments, the one or more second criteria optionally include a criterion that is satisfied when the one or second routes include a point of interest that was previously visited by the user of the electronic device as indicated via a calendar application, a map application, a photos application that includes a tag corresponding to the point of interest. In this case, the first information includes an indication that the user of the electronic device has previously visited the point of interest and/or has previously traveled along the one or more second routes. In some embodiments, the information includes media content (e.g., photos and/or videos) taken from the previously visited point of interest and/or navigated one or more second routes. In some embodiments, the one or more second criteria optionally include a criterion that is satisfied when the one or second routes and/or a point of interest of the one or more second routes that was previously shared by a friend or user, different from the user of the electronic device as indicated via a messaging application, an email application, or any other collaboration application that includes a tag corresponding to the one or second routes and/or the point of interest. In this case, the first information includes an indication that the friend of the electronic device shared the point of interest and/or the one or more second routes to the user of the electronic device. In some embodiments, the information includes media content (e.g., the message, the email, documents, photos and/or videos) that was shared from the friend that was taken from the shared point of interest and/or one or more second routes.

In some embodiments, in accordance with a determination that the one or more second routes do not satisfy the one or more second criteria, the electronic device displays second information from the first supplemental map without displaying the first information, such as displaying representation 2008c without displaying representation 2008d in FIG. 20B. For example, the second information includes one or more characteristics of the information displayed from the first supplemental maps as described with reference to methods 1300, 1500, 1700, 1900, 2100, and/or 2300. Displaying information from the supplemental map enables a user to view both map-related information and relevant information at the same time, without having to leave the map application, thereby reducing the need for subsequent inputs to view information relevant to the supplemental map which simplifies the interaction between the user and the electronic device and enhances the operability of the electronic device and makes the user-device interface more efficient.

In some embodiments, while displaying the user interface including the representation of the one or more second routes (e.g., such as described with reference to method 2100), the electronic device receives, via the one or more input devices, an input comprising filter criteria, such as representation 2014d in FIG. 20I. In some embodiments, the electronic device provides a filter function for filtering the one or more second routes. For example, the user interface optionally includes a selectable option (e.g., user interface element) that, when selected, causes the electronic device to apply (e.g., turn on) a filter criteria. In some embodiments, the selectable option is an on/off toggle user interface element or a checkbox user interface element. In some embodiments, the filter criteria includes user preferences such as avoiding hills, tolls, and/or fees.

In some embodiments, in response to receiving the input, the electronic device initiates a process to display a subset of the one or more second routes that satisfy the filter criteria, such as a route as indicated by representation 2020b in FIG. 20K. For example, if the electronic device determine that the filter criteria avoiding fees is selected, the electronic device optionally does not present the one or more second that that include fees (e.g., parking fees, entrance fees, tolls, and/or the like). In this example, the subset of the one or more second routes that satisfy the filter criteria include routes without fees. Providing a subset of suggested routes that complies with preferences set by the user enhances interactions with the electronic device (e.g., by reducing the amount of time needed for the user of the electronic device to set their preferences), which reduces power usage and improves battery life of the electronic device by enabling the user to use the electronic device more quickly and efficiently.

In some embodiments, the one or more second routes include navigating from a first destination to a second destination, and from the second destination to a third destination, such as show in user interface 2008a in FIG. 20H. For example, the one or more second routes include navigating in an order of the first destination, the second destination, and the third destination.

In some embodiments, while displaying the user interface, the electronic device receives, via the one or more input devices, an input that corresponds to a request to modify the first destination, the second destination, or the third destination, such as for example one or more inputs similar to input 2004 directed to representation 2008c in FIG. 20H. In some embodiments the input that corresponds to a request to modify the first destination, the second destination, or the third destination includes one or more characteristics of the input that corresponds to selection of the representation of the point of interest as described with reference to method 2100. In some embodiments, the request to modify includes removing the first destination, the second destination, or the third destination. In some embodiments, the request to modify includes reordering the first destination, the second destination, and the third destination. For example, instead of navigating from the first destination to the second destination, and from the second destination to the third destination, the request to modify optionally includes navigating from the first destination to the third destination, and from the third destination to the second destination. In some embodiments, the request to modify includes modifying the respective transportation mode as described with reference to method 2100. It is understood that although the embodiments described herein include removing the first destination and a particular ordering of the destinations, any number of modifications and/or orders are optionally applied and executed by the electronic device.

In some embodiments, in response to receiving the input, the electronic device displays, in the user interface, a representation of a second route that includes navigating along a modified subset of the first destination, the second destination, and the third destination, such as, for example, representation 2008c set after representation 2008d in FIG. 20H. In some embodiments, the representation of the second route that includes navigating along the modified subset of the first destination, the second destination, and the third destination (e.g., such as described herein) includes navigation directions for navigating along the modified subset and/or a representation of a route line of the second route that includes the modified subset (e.g., overlaid on a representation of a map) and one or more representations of physical objects, route characteristics, and/or points of interest in the vicinity of the route line. In some embodiments, the representation of the second route that includes the modified subset includes a selectable option that, when selected, causes the electronic device to initiate navigating along the second route. For example, the electronic device detects user input that corresponds to selection of the selectable option (e.g., that corresponds to a request to initiate navigation along the second route), and in response, the electronic device navigates along the second route. In some embodiments, the user input that corresponds to selection of the selectable option has one or more characteristics as the input that corresponds to selection of a representation of a point of interest as described with reference to method 2100. Providing the ability to directly modify a route associated with a supplemental map enhances interactions with the electronic device, which reduces the need for additional inputs for searching for alternative routes when faster interaction is desired.

In some embodiments, the electronic device receives, via the one or more input devices, an input that corresponds to a request to share information associated with the one or more second routes with a second electronic device, different from the electronic device, such as for example, input 2004 directed to representation 2020g in FIG. 20k. In some embodiments the input that corresponds to a request to share information associated with the one or more second routes with a second electronic device includes one or more characteristics of the input that corresponds to selection of the representation of the point of interest as described with reference to method 2100. In some embodiments the input that corresponds to a request to share information associated with the one or more second routes with a second electronic device includes one or more characteristics of the input that corresponds to a request to share the first supplemental map with a second electronic device as described with reference to method 1900.

In some embodiments, in response to receiving the input, the electronic device initiates a process to share the information associated with the one or more second routes with the second electronic device, such as shown by user interface 2030 in FIG. 20O. For example, the information associated with the one or more second routes includes photos, videos, annotations, and/or the like of and/or about one or more points of interests of the one or more second routes. In some embodiments, the information associated with the one or more second routes includes an indication of the current location of the electronic device along the one or more second routes. In some embodiments, the electronic device automatically sends a notification to the second electronic device when the electronic device reaches one or more points of interest along the one or more second routes. Allowing information associated with the one or more second routes to be shared increases collaboration and facilitates sharing of route information amongst different users, thereby improving the interaction between the user and the electronic device and promoting supplemental map discovery across different devices.

In some embodiments, the electronic device receives, via the one or more input devices, an input that corresponds to a request to display a user interface of a calendar application, such as input 2004 directed to representation 2040 in FIG. 20Q. In some embodiments, the input that corresponds to a request to display a user interface of a calendar application includes one or more characteristics of the input that corresponds to selection of the representation of the point of interest as described with reference to method 2100.

In some embodiments, in response to receiving the input, the electronic device displays, via the display generation component, the user interface of the calendar application including a representation of one or more events, wherein the one or more events include information associated with one or more of a plurality of supplemental maps including the first supplemental map associated with the first route, such as representations 2044c and 2044b displayed with representation 2042 in FIG. 20R. In some embodiments, displaying the user interface of the calendar application includes displaying the user interface of the calendar application concurrently with or overlaid the user interface of the map application as described with reference to method 2100 or another user interface of an application other than the map application, such as system level application or a lock screen. In some embodiments, displaying the user interface of the calendar application includes navigating away from a respective user interface and navigating to the user interface of the calendar application (e.g., ceasing to display the user of the map application and instead, displaying the user interface of the calendar application). In some embodiments, the one or more events are associated with respective locations that are geographically associated with respective geographic locations/regions of one or more of a plurality of supplemental maps. For example, if the electronic device determines that a first location of a first calendar event is included within the geographic location/region of the first supplemental map, the electronic device optionally displays a representation of the first calendar event including a representation of the first supplemental map that, when selected, causes the electronic device to display information associated with the first supplemental as described with reference to methods 1900 and/or 2100. In some embodiments, in accordance with a determination that the first location of the first calendar event is not included within the geographic location/region of the first supplemental map, the electronic device displays the representation of the first calendar event, wherein the first calendar event does not include the representation of the first supplemental map (e.g., the electronic device foregoes displaying the representation of the first supplemental map). In some embodiments, the electronic device displays a representation of a second calendar event, different from the first calendar event. In some embodiments, the representation of the second calendar event includes a representation of a second supplemental map different from the first supplemental map because the location of the second calendar event is different from the first location of the first calendar event and is therefore geographically associated with the second supplemental map and not the first supplemental map. In some embodiments, the information associated with the one or more of the plurality of supplemental maps includes representations of digital content related to the one or more events and/or geographic area of the one or more of the plurality of supplemental maps (e.g., such as airline tickets, event tickets, parking passes, rental car information, hotel reservation codes, and/or the like). In some embodiments, the digital content is not included in the one or more of the plurality of supplemental maps because digital content, such as airline tickets, event passes and/or the like are single-use (e.g., set to expire after use). In some embodiments, the representations of the digital content are presented as a stack as described with reference to method 1900. Displaying information associated with one or more of a plurality of supplemental maps in a calendar user interface enables a user to quickly locate, view and/or obtain access to desired information, thereby reducing the need for subsequent inputs to locate desired information which reduces power usage and improves battery life of the electronic device by enabling the user to use the electronic device more quickly and efficiently.

It should be understood that the particular order in which the operations in method 2100 and/or FIG. 21 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 21 are, optionally, implemented by components depicted in FIGS. 1A-1B. For example, navigating operation 2102a, and displaying operation 2102b, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

Users interact with electronic devices in many different manners, including interacting with supplemental maps that are generated by the electronic device. In some embodiments, the electronic device generates supplemental maps that are customized to the user of the electronic device. For instance, the electronic device customizes a supplemental map by including locations, navigation routes, itineraries, and other information that may be of relevance to the user based on their preferences and interests. Similarly, the electronic device customizes supplemental maps based on other information that may be pertinent to the map such as weather, operating hours of certain attractions, road conditions, and other factors. In some embodiments, the process of generating a supplemental map that is customized to a specific user can be time consuming since any given supplemental map includes a myriad of features (e.g., points of interests, navigation routes, itineraries) and each feature is based on a complex set of factors (e.g., user preferences, weather, and other situational factors). The process of creating a customized supplemental map can require the user to provide copious amounts of information regarding their preferences, thus making the process burdensome on the user. Furthermore, translating user preferences to customized features on a supplemental map can be difficult since user information and preferences can vary widely thus making a deterministic algorithm (such as a decision tree) to customize a supplemental map computationally infeasible.

In some embodiments, the electronic device can incorporate artificial intelligence in the process of generating supplemental maps, to ensure that the generated supplemental map is responsive to the user's preferences in a computationally feasible manner. In some embodiments, the use of artificial intelligence in the process of generating a supplemental map ensures that the electronic device leverages prior generated supplemental maps to “learn” the factors and processes for generating a new supplemental map that is responsive to a user's preferences. The embodiments described below provide ways in which an electronic device utilizes artificial intelligence to generate supplemental maps that are responsive to a user's preferences, while also minimizing the amount of user input needed to generate the supplemental map, thus enhancing the user's interaction with the device. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

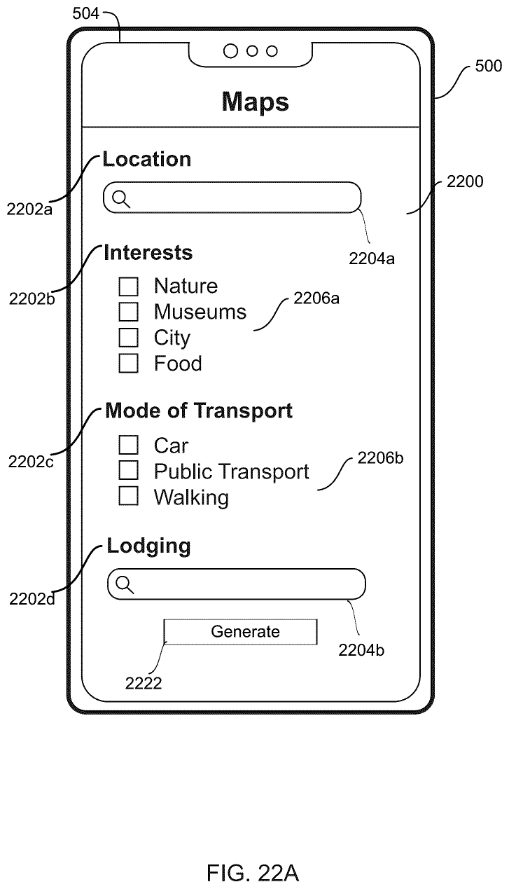

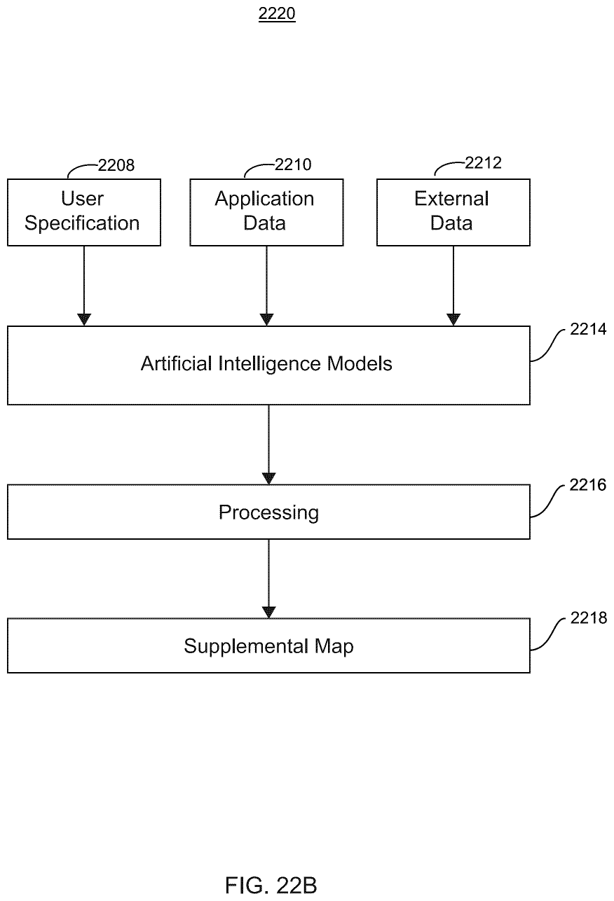

FIGS. 22A-B illustrate an exemplary process for utilizing artificial intelligence to generate a supplemental map. In some embodiments, the process of generating a supplemental map, and specifically using artificial intelligence to generate a supplemental map that is customized to the user's preferences begins with the user providing information regarding the desired supplemental map at a supplemental map creation user interface as illustrated in FIG. 22A. In some embodiments, supplemental map creation user interface 2200 is displayed by electronic device 500 (via display 504) as illustrated in FIG. 22A. In some embodiments, supplemental map creation user interface 2200 is configured to receive one or more inputs from the user regarding preferences that should be incorporated into the supplemental map generated by electronic device 500. For instance, supplemental map creation user interface 2200 includes one more categories of information 2202a-d to be solicited from the user for the purpose of generating the supplemental map.

In some embodiments, the categories of information 2202a-d include a location 2202a, configured to accept input from the user regarding the geographic location that the supplemental map should cover. In some embodiments, location 2202a includes a text entry field 2204a that is configured to accept input from the user (in the form of alpha-numeric characters) specifying the geographic location that the supplemental map is to cover. As an example, the user can enter a country, state, province, city, or any other geographic term that allows the device to understand the geographic area the generated supplemental map is to cover. In some embodiments, the categories of information 2202a-d include interests 2022b. In some embodiments, interests 2202b include one or more selectable options 2206a that are configured to allow the user to share the types of locations that they would want featured in the supplemental map (e.g., nature locales, museums, city locations, food locations). In some embodiments, the categories of information 2202a-d include mode of transport 2202c. Mode of transport 2202c includes one or more selectable options 2206 configured to allow the user to specify the types of transportation they will be utilizing when using the supplemental map. For instance, mode of transport 2202c can include such modes as a car, public transport, or walking. In some embodiments, the categories of information 2202a-d include lodging 2202d. In some embodiments, lodging 2202d include a text entry field 2204b that is configured to receive input from the user regarding their lodging preferences. For instance, at text entry field 2204b, the user can enter the name of the hotel they will be staying at (in the case of a vacation away from home) or specify the type of lodging they would prefer (e.g., camping, hotel, bed and breakfast). It should be understood that the categories of information described are meant as examples only and should not be seen as limiting to the disclosure herein. In some embodiments, the categories of information could include more or less categories than what is illustrated in FIG. 22A. Supplemental map creation user interface 2200 can include any category that would be pertinent to the creation of a supplemental map. In some embodiments, supplemental map creation user interface 2200 includes a selectable generate button 2222, that is selected by the user to initiate the process of generating a supplemental map once the user has inputted their specifications into supplement map creation user interface 2200.

In some embodiments, the information collected from the user of electronic device 500 at supplemental map creation user interface 2200 is utilized and combined with other sources of information to generate one or more supplemental maps according to the data flow diagram illustrated in FIG. 22B. In some embodiments, data flow diagram 2220 illustrates the processing steps that are applied to one or more sources of input data (described in further detail below) to generate a supplemental map using artificial intelligence. In some embodiments, the inputs to the process include user specification 2208. User specification 2208 includes the information that is gathered by electronic device 500 from the user at supplemental map creation user interface 2200 described above with respect to FIG. 22A.

In some embodiments, the inputs to the process illustrated in data flow diagram 2220 include application data 2210. In some embodiments, the application data includes user specific data that is stored by the electronic device and associated with other applications associated with the electronic device (other than the maps applications). For instance, the electronic device accesses data pertaining to the user's interactions with other applications (e.g., a calendar application, a music application, a media content application) and uses the data to glean user preferences and information pertinent to the generation and customization of a supplemental map. In some embodiments, electronic device 500 accesses application data 2210 by scraping data from the applications themselves (e.g., accessing data that the application stores in memory during operation of the application). Additionally or alternatively, electronic device 500 accesses operating system data pertaining to the applications that is also stored in a memory on the device.

In some embodiments, the inputs to the process illustrated in data flow diagram 220 include external data 2212. In some embodiments, the one or more external data sources include data sources that are stored on one or more separate/external electronic devices and are accessible to the electronic device via one or more communications links. For instance, an external source can include a website, a data warehouse, a computing network, or other computing resource external to the electronic device that contains data/information that is relevant to the generation of a supplemental map. For instance, external data 2212 can include one or more websites or web-based databases that include up-to-date information about a location, including opening and closing times, attractions at the location, and other information that could be pertinent to a supplemental map. In some embodiments, electronic device 500 accesses external data 2212 via one or more communications link between the electronic device 500 and the electronic devices that store the external data. In some embodiments, the inputs described above (e.g., user specification 2208, application data 2210, and external data 2212) are meant as examples and should not be seen limiting to the disclosure. In some embodiments the data sources used as inputs can include more or less sources than those illustrated in FIG. 22B.

In some embodiments, each of the inputs 2208, 2210, and 2212 are inputted into one or more artificial intelligence models 2214 (e.g., the artificial intelligence models 2214 are applied to the data sources). In some embodiments, the one or more artificial intelligence models are configured to use the inputs provided to it, to generate an output that is used to ultimately generate a supplemental map. For instance, artificial intelligence models 2214 use inputs 2208, 2210, and 2212 as well as information about previously generated supplemental maps to generate an output that is used to generate a new supplemental map. In this way, artificial intelligence models 2214 “learn” from the generation of prior maps (and the inputs used to generate those supplemental maps) to create new supplemental maps that are response to the inputs 2208, 2210, and 2212). In some embodiments, the artificial intelligence models that are applied to both the one or more first specifications as well as the application data include one or more of: machine learning models, deep learning models, neural network models, and natural language processing models.

In some embodiments, the output of artificial intelligence models 2214 includes data that can be used to generate a supplemental map. For instance, the output of artificial intelligence models 2214 includes parameters, specifications, and/or information that are used to generate a map. In one or more examples, the outputs of artificial intelligence models 2214 can be sent to processing 2216 for further processing to convert the outputs of the artificial intelligence models 2214 to a supplemental map 2218. In some embodiments, processing 2216 can be optional, in the event that the output of the artificial intelligence models produces a supplemental map 2218 directly.]

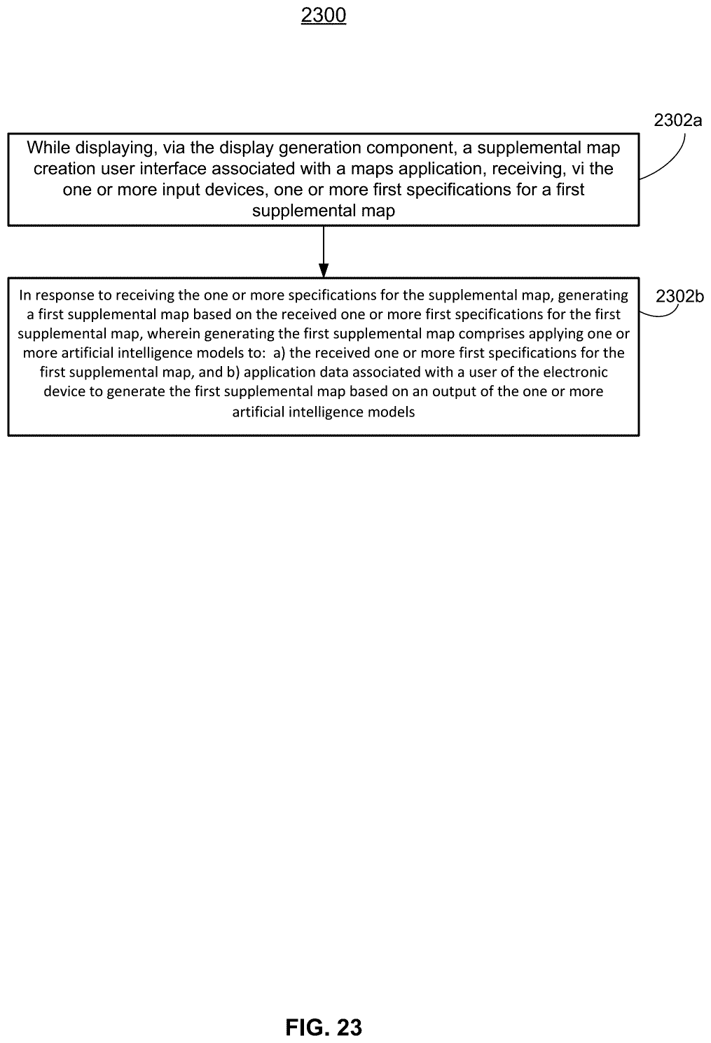

FIG. 23 is a flow diagram illustrating a method for generating supplemental maps using one or more artificial intelligence models in accordance with some embodiments. The method 2300 is optionally performed at an electronic device such as device 100, device 300, or device 500 as described above with reference to FIGS. 1A-1B, 2-3, 4A-4B and 5A-5H. Some operations in method 2300 are, optionally combined and/or order of some operations is, optionally, changed.

As described below, the method 2300 provides ways to facilitate efficient use of artificial intelligence models to generate supplemental maps. The method reduces both the cognitive burden on a user as well as the computing burden on electronic devices when generating supplemental maps, thereby creating a more efficient human-machine interface. For battery-operated electronic devices, increasing the efficiency of the user's interaction with the user interface conserves power and increases the time between battery charges.

In some embodiments, method 2300 is performed at an electronic device in communication with a display generation component and one or more input devices: In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 2300 is performed at or by an automobile (e.g., at an infotainment system of an automobile having or in communication with one or more display generation components and/or input devices).

In some embodiments, while displaying, via the display generation component, a supplemental map creation user interface associated with a maps application such as supplemental map creation user interface 2200 from FIG. 22A, the electronic device receives (2302a), via the one or more input devices, one or more first specifications for a first supplemental map. In some embodiments, the supplemental map creation user interface includes one or more parameters (e.g., inputted by a user) that are used by the electronic device to generate a supplemental map. In some embodiments, the supplemental map generated by the electronic device shares one or more characteristics of the supplemental maps described above with respect to methods 700, 900, 1100, 1300, 1500, 1700, 1900, and 2100. In some embodiments, the parameters (e.g., corresponding to the one or more first specifications) displayed on and/or inputted to the supplemental map creation user interface include any information that is relevant to the creation of a supplemental map including but not limited to: the geographic area or areas to be covered by the map, types of attractions that the user is interested in seeing while they are visiting the geographic area the map is to cover, mode of transportation to be used while vising the geographic area covered by the supplemental map, lodging reservations, dining reservations, and any other parameter that would influence the content of the supplemental map. In some embodiments, the supplemental map creation user interface can be displayed while a user of the electronic device is engaged with a maps application that is configured to provide the user with one or more maps that the user can interact with (e.g., the supplemental map creation user interface is a user interface of the maps application, such as a primary maps application). In some embodiments, the supplemental map creation interface can be displayed while the user of the electronic device is engaged with another application that initiates the creation of a supplemental map (e.g., the supplemental map creation user interface is not a user interface of the maps application). In some embodiments, the supplemental map creation user interface can include a plurality of selectable options that the user can select, and/or include text entry fields that the user can enter text into using the one or more input devices of the electronic device. In some embodiments, the values and entries provided by the user collectively form the one or more first specifications that will be used by the electronic device to generate the first supplemental map.

In some embodiments, in response to receiving the one or more specifications for the supplemental map the electronic device generates (2302b) a first supplemental map based on the received one or more first specifications for the first supplemental map, wherein generating the first supplemental map comprises applying one or more artificial intelligence models (such as artificial intelligence models 2214 in FIG. 22B) as artificial intelligence models to: a) the received one or more first specifications for the first supplemental map (such as user specification 2208 of FIG. 22B), and b) application data associated with a user of the electronic device (such as application data 2210 of FIG. 22B) to generate the first supplemental map based on an output of the one or more artificial intelligence models. In some embodiments, the one or more artificial intelligence models used to generate the first supplemental map use both the one or more first specifications inputted by the user at the supplemental map creation user interface (described above) as well as application data associated with the user of the electronic device, as inputs to generate the first supplemental map. In some embodiments, the application data includes user specific data that is stored by the electronic device and associated with other applications associated with the electronic device (other than the maps applications). In some embodiments, the artificial intelligence models that are applied to both the one or more first specifications as well as the application data include one or more of: machine learning models, deep learning models, neural network models, and natural language processing models. In some embodiments, the one or more artificial intelligence models are generated using supervised and/or unsupervised training processes. In the example of an artificial intelligence model that is generated using a supervised training process, training data includes prior supplemental maps that were generated based on a user's specification. In some embodiments, the prior supplemental maps were created by other users in addition to prior supplemental maps created by the user of the electronic device. In some embodiments, the prior supplemental maps are annotated (thereby providing a supervised training process). The annotations to the prior supplemental maps can include but are not limited to: the one or more specifications provided by the user to create the map, the content of the prior supplemental map including the geographic area of the supplemental map, the routes listed in the supplemental map, and the points of interest highlighted in the supplemental map. In the example of an artificial intelligence model that is generated using an unsupervised training process, training includes prior supplemental maps and the specifications used to generate the prior supplemental maps, all of which are not annotated. In some embodiments, and in the case of artificial intelligence models that are natural language processing modules, the natural language processing modules can include but are not limited to: sentiment analysis modules, named entity recognition modules, summarization modules, topic modeling modules, text classification modules, keyword extraction modules, and lemmatization and stemming modules. In one or more examples, the natural language processing modules can be generalized natural language processing modules that are based on a specific language (e.g., English). Additionally or alternatively, the natural language processing modules can be supplemental map context specific modules that are created using natural language associated with the context of specifying and generating supplemental maps. In some embodiments, the user can use the process described above to create multiple supplemental maps. For instance, in some embodiments, in response to receiving a second one or more specifications from the user, the electronic device generates a second supplemental map, different from the first supplemental map, by applying the one or more artificial intelligence modules described above to the second one or more specifications. In some embodiments, after a supplemental map has been generated using the process described above, the electronic device displays the contents of the supplement map in accordance with the methods described above with respect to methods 700, 900, 1100, 1300, 1500, 1700, 1900, and 2100. In some embodiments, the contents of the supplemental map are displayed automatically once the map has been generated. Additionally or alternatively, the supplemental map is displayed by the electronic device in response to user input indicating a request to display the supplemental map. In some embodiments, one or more of the supplemental maps of methods 700, 900, 1100, 1300, 1500, 1700, 1900, and 2100 are generated in accordance with method 2300. Applying artificial intelligence modules to user provided specifications for supplemental maps as well as application data stored on the electronic device minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, the one or more first specifications for the supplemental map includes at least one of a geographic location, a length of a trip, or a place of interest as illustrated by categories 2202a, 2202b, 2202c, and 2202d in FIG. 22A. In some embodiments, the supplemental map creation user interface includes selectable options and/or input entry fields for receiving user input that specifies parameters that are pertinent to the creation of the first supplemental map. For instance, in some embodiments, the one or more first specifications for the supplemental map includes a geographic location including but not limited to: a city, county, province, state, country, latitude, longitude, common name of locations, geographic features, and other terms that specify (directly or indirectly), a geographic location or locations that first supplemental map should include. In some embodiments, the one or more artificial intelligence modules are applied to the geographic location to determine what geographic locations should be specified in the supplemental map. In some embodiments, the one or more first specification for the supplemental map includes a length of a trip that will be associated with the first supplemental map. In some embodiments, the length of the trip can be specified in second, minutes, hours, days, months, and/or years. In some embodiments, the electronic device applies the one or more artificial modules to the specified length of the trip to determine the content of the map. For instance, in the example of a supervised machine learning model, the machine learning model is applied to the length of the trip by examining prior supplemental maps that have a similar length of trip to determine the amount and/or substance of the supplemental map. In some embodiments, the one or more first specifications includes one or more places of interest. In some embodiments, a place of interest can be specific such as the specific name of a place (e.g., a particular name of a beach, museum, and/or tourist attraction), or can be more generalized to include a type of place such as a beach, castle, art museum. In some embodiments, the specifications provided above are used to generate a supplemental map that includes a navigation route or is associated with a navigation. In some embodiments, the navigation routes of the generated supplemental map share one or more characteristics with the navigation routes described above with respect to method 2100. Applying artificial intelligence modules to user provided specifications of geographic locations, length of trip, and/or places of interests for supplemental maps as well as application data stored on the electronic device minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, the first supplemental map includes one or more points of interests (such as the points of interest described above with respect to method 700), wherein the one or more points of interest is based on the one or more first specifications (e.g., user specification 2208 in FIG. 22B). In some embodiments, the electronic device applies the one or more artificial intelligence models to the one or more first specifications and generates an output that is used to generate or more points interest in the first supplemental map. For instance, the one or more points of interest are based on the geographic location specified by the user in the one or more first specifications, and specifically are based on an output of the one or more artificial intelligence models that have been applied to the geographic location specified by the user in the one or more first specifications. Similarly, other specifications provided in the one or more specifications such as length of trip, and paces of interest can be used by the one or more artificial intelligence models to generate an output that is used by the electronic device to generate one or more points of interest that are included as part of the first supplemental map, and specifically included as part of a navigation route such as the navigation routes described above with respect to method 2100. Generating supplemental maps that include points of interest, wherein the points of interest are based on applying artificial intelligence models to user provided specifications, minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, the first supplemental map includes one or routes (such as representation 860a in FIG. 8E), wherein the one or more routes is based on the one or more first specifications. In some embodiments, the electronic device applies the one or more artificial intelligence models to the one or more first specifications and generates an output that is used to generate or routes in the first supplemental map. In some embodiments, a route refers to a specific path or course through a supplemental route. For instance, if the supplemental map includes one or more roads, then a route can include a specific path within the supplemental using the roads that are part of the supplemental map. In some embodiments, the one or more routes are based on the geographic location specified by the user in the one or more first specifications, and specifically are based on an output of the one or more artificial intelligence models that have been applied to the geographic location specified by the user in the one or more first specifications. Similarly, other specifications provided in the one or more specifications such as length of trip, and paces of interest can be used by the one or more artificial intelligence models to generate an output that is used by the electronic device to generate one or more routes that are included as part of the first supplemental map. In some embodiments, the one or more routes can share one or more characteristics with the navigation routes described above with respect to method 2100. Generating supplemental maps that include one or more routes, wherein the one or more routes are based on applying artificial intelligence models to user provided specifications, minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, the application data associated with the user of the electronic device comprises activity data obtained from one or more applications accessed by the electronic device such as application data 2210 in FIG. 22B, wherein the activity data is associated with one or more activities of the user of the electronic device at the one or more applications. In some embodiments, the activity data includes data pertaining to the user's interactions with various applications on the electronic device. Recording data pertaining to the user's interactions with applications on the electronic device and using that data to generate a supplemental map can work to ensure that the supplemental map is customized to a user's preferences, and leverages prior supplemental maps (e.g., through the one or more artificial intelligence modules) from users and contexts that have similar user preferences (as gleaned through activity data). As an example, in a case where the activity data includes the user's interaction with an alarm clock application, and specifically, the time that the user specified to be woken up in the morning, the electronic device can use the information to generate a supplemental map that includes activities and timings based on the user's normal wake-up time. In another example, the electronic device can access activity data regarding the user's interactions with a health application, and specifically can access information pertaining to the fitness level of the user. In some embodiments, the electronic device applies one or more artificial intelligence models described above to generate supplemental maps that are commensurate with the user's fitness level. In some embodiments, the user can specify which applications on the electronic device can be accessed by the one or more artificial intelligence models to generate supplemental maps and can specify the type of activity data that can be used to generate supplemental maps. In some embodiments, the activity data is accessed from each application directly. Additionally or alternatively, the activity data is accessed from operating system data that is associated with an operating system operating on the electronic device. Applying artificial intelligence modules to activity user data across applications on the electronic device minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, the one or more applications accessed by the electronic device includes at least one of a music application, a maps application, a calendar application, or a media application (such as if application data 2210 was comprised in part from application data acquired from a music application, a maps application, a calendar application, or a media application). In some embodiments, the one or more applications includes a music application that is stored (or accessible) by the electronic device and is configured to facilitate the user playing music content on the electronic device. In the example of a music application, the electronic device applies the one or more artificial intelligence models to data regarding the user's music preferences, including specific genres of music that the user prefers, the artists that the user prefers, and specific albums that the user's prefers. By applying the one or more artificial intelligence modules to the user's music application data, the electronic device can generate supplemental maps that take into account the user's music preferences, for instance, by including points of interests in the generated supplemental map that the user would likely be interested in based on their music preferences. Similarly, with regards to the example of a maps application, the electronic device can leverage application data of the maps application such as prior routes requested by the user and past search data by applying the one or more artificial intelligence models to the map application data to generate supplemental maps. In the example of a calendar application, the electronic device can leverage such data as past appointments created by the user, the user's general time habits (e.g., what time they plan activities) to generate supplemental maps that includes routes, points of interest, and itineraries that align with the preferences gleaned from the user's calendar application activity data. In some embodiments, and in the case of a media application that facilitates interaction between the user and media content (such as videos, podcasts, eBooks), the electronic device can leverage application data of the media application to generate points of interests that are based on the user's media consumption. For instance, if the media application data shows that the user likes a particular move, the supplemental map can contain filming locations of that movie as a point of interest in the supplemental map. Applying artificial intelligence modules to application data of a music application, maps application, calendar application, or a medial application to generate supplemental maps minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, the first supplemental map includes one or more annotations (such as annotation 604d in FIG. 6C), and wherein the one or more annotations are based on the activity data obtained from the one or more applications accessed by the electronic device. In some embodiments, an “annotation” refers to any type of textual or visual information that is included as part of the supplemental map and is designed to provide information to the user regarding one or more features of the map. For instance, annotations can include additional information about places of interests or routes that may be of specific interest to the user (based on their provided one or more specifications, and/or application data of the electronic device). For example, the electronic device using application data associated with a music application, can annotate a supplemental map with points of interest pertaining to a specific concert venue and provide information about past performances at the venue that may be interesting to the user of the electronic device. In another example, the electronic device using application data associated with a media application, can annotate a supplemental map with points of interest about locations where the media content (e.g., move, song, television show) was recorded, distributed, and/or exhibited. In some embodiments, the annotations are generated by applying the one or more artificial intelligence modules to the application data. Generating supplemental maps that include annotations, wherein the annotations are based on applying artificial intelligence models to application data, minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, generating the first supplemental map further comprises applying the one or more artificial intelligence models to one or more contacts accessible by the electronic device such as if artificial intelligence models 2214 were additionally applied to the contacts of the user of the electronic device. In some embodiments, applying the one or more artificial intelligence models to the one or more contacts accessible by the electronic device comprises, for each contact of the one or more contacts, obtaining identification information associated with the contact. In some embodiments, the one or more contacts accessible by the electronic device includes telephone numbers, email addresses, social media handles, and other forms of communication pertaining to an individual that can be employed to contact that individual and is stored on or accessible by the electronic device. In some embodiments, each contact of the one or more contacts includes identification information of the individual or individuals associated with the contact. For instance, the identification can include the name of the contact, social media handles of the contact, nicknames used by the contact, and other information that can be used to identify the contact.

In some embodiments, applying the one or more artificial intelligence models to the one or more contacts accessible by the electronic device comprises, obtaining review information associated with the obtained identification information. In some embodiments, the identification information is used by the electronic device to search for online reviews of various products, services, and establishments left by the individual associated with the identification information. For instance, the obtained identification information of a contact can be used to search for reviews by the individual associated with the contact on a restaurant review aggregation website. In some embodiments, in response to determining that a review is associated with the obtained identification information of a contact, the electronic devices downloads a copy of the review and stores the review in a memory of the electronic device, so that the review can be incorporated into the process of generating a supplemental map.

In some embodiments, applying the one or more artificial intelligence models to the one or more contacts accessible by the electronic device comprises, applying the one or more artificial intelligence models to the obtained review information such as if the review information obtained by the device were part of external data 2212 in FIG. 22B. In some embodiments, the electronic device applies the one or more artificial intelligence models to the stored review information to generate a supplemental map in accordance with the examples provided above. In some embodiments, the generated supplemental map can include one or more features that are based on the obtained review information. For instance, based on the review information, the generated supplemental map can include specific points of interest or locations that were positively reviewed by the contacts of the user of the electronic device. Applying artificial intelligence modules to review information obtained using contact information stored on the electronic device to generate supplemental maps minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, the electronic device obtains external information from one or more external data sources, wherein generating the first supplement map further comprises applying the one or more artificial intelligence models to the obtained external information such as applying intelligence models 2214 to external data 2212 in FIG. 22B. In some embodiments, the one or more external data sources include data sources that are stored on one or more separate/external electronic devices and are accessible to the electronic device via one or more communications links. For instance, an external source can include a website, a data warehouse, a computing network, or other computing resource external to the electronic device that contains data/information that is relevant to the generation of a supplemental map. In some examples, the one or more external data sources includes a database of previously generated supplemental maps (created by the user of the electronic device and/or created by other users). In one or more examples, the electronic device can “scrape” each and every external data source (e.g., download a copy of the information/data that is stored on the external data source and is pertinent to creation of a supplemental map) and then apply the one or more artificial intelligence modules to the scraped data to generate a supplemental map. As an example, in the case where the external data is website information that indicates a museum is holding a special exhibit that the user may find interesting (based on the one or more specifications and their application data), the generated supplemental map can include the museum as a point of interest. In some embodiments, the electronic device scrapes each external data source at a predefined period (e.g., periodically) so that any changes to the information scraped from the external data source are incorporated into the process of generating a supplemental map (described in further detail below). Applying artificial intelligence modules to information scraped from external data sources to generate supplemental maps minimizes the likelihood that a supplemental map generated by the electronic device contains errors or is unresponsive to the specifications provided by the user, thereby minimizing additional user input required to generate, correct or modify the supplemental map, which, conserves computing and power resources that would otherwise be expended due to the additional input.

In some embodiments, after generating the first supplemental map, the electronic device receives auxiliary information, wherein the auxiliary information pertains to one or more features of the generated first supplemental map such as if any one of user specification 2208, application data 2210, or external data 2212 were updated after the supplemental map had been initially generated in FIG. 22B. In one or more examples, auxiliary information can refer to new information that is made available to the electronic device after the first supplemental map has been generated that if it had been taken into account when generating the first supplemental would have caused one or more features of the first supplemental map to be different. For instance, in some embodiments, auxiliary information can take the form of calendar data that exhibits new information about the routine of the user. If the calendar data had been available during generation of the first supplemental map, an itinerary associated with the supplemental map would have been different to take into account the user's routine. In some embodiments, auxiliary information also includes modifications or changes to data that was used during the process of generating the first supplemental map. For instance, using the example of calendar application information, the auxiliary information can take the form of a modification to the user's routine (detected by changes in the calendar application data) that would have an effect on an itinerary provided as part of the first supplemental map. In another example, the auxiliary information includes updated weather information indicating rain/bad weather from a weather application. Using the auxiliary weather information, the electronic device modifies the supplemental map to remove one or more points of interest that are outdoors so that the user can avoid the inclement weather. In some embodiments, the electronic device replaces the outdoor point of interest with an indoor point of interest based on the one or more specifications and the application data as described above. In some embodiments, the electronic device determines the presence of auxiliary information (e.g., new information and/or modified information) based on comparing any new data acquired by the device, or any modifications to data already stored on the electronic device to data types that have historically been used to generate supplemental maps. For instance, in the example where calendar application information has historically been used by the device (or other devices) to generate supplemental maps, any additional calendar application information received by the device, or modifications to existing calendar application data, can be treated as auxiliary information.

In some embodiments, in response to receiving the auxiliary information, the electronic device modifies the first supplemental map in accordance with the received auxiliary information. In some embodiments, the electronic device modifies the first supplemental map by applying the one or more artificial intelligence models to the received auxiliary information, and using the output generated by the one or more artificial intelligence models to modify (e.g., change one or more features) the supplemental map. Additionally or alternatively, the electronic device modifies the first supplemental map based on the received auxiliary information without applying the one or more artificial intelligence models to the auxiliary information. For instance, using the calendar application example described above, the electronic device modifies an itinerary of the supplemental map without requiring the one or more artificial intelligence models to be applied to the new or modified calendar application. Modifying supplemental maps when auxiliary information is acquired by the electronic device minimizes the likelihood that the supplemental map contains errors or is unresponsive to the specifications provided by the user, thereby minimizing additional user input required to generate, correct or modify the supplemental map, which, conserves computing and power resources that would otherwise be expended due to the additional input.

In some embodiments, after generating the first supplemental map, the electronic device receives, via the one or more input devices, a first input corresponding to a request to share the first supplemental map with a respective user (such as if after generating supplemental map 2218, the electronic device transmitted the generated map to an external device in FIG. 22B). In some embodiments, the first input is received at a supplemental map sharing user interface for facilitating sharing of a generated supplemental to one or more external electronic devices. In some embodiments, the first input has one or more characteristics of the inputs described above with respect to methods 700, 900, 1100, 1300, 1500, 1700, 1900, and 2100.

In some embodiments, in response to receiving the first input, the electronic device initiates a process to share the first supplemental map with the respective user. In some embodiments, initiating a process to share the first supplemental map shares one or more characteristics with the processes of sharing supplement maps described above with respect to methods 700, 900, 1100, 1300, 1500, 1700, 1900, and 2100 described above. In some embodiments, the process to share the first supplemental map with the respective user includes transmitting the supplemental map to an electronic device associated with the respective user. In some embodiments, in response to receiving the first input, the device generates a “sharing link” (e.g., a web-based link) that is provided to one or more external users giving them access to the first supplemental map and allowing the user to download the first supplemental map. Optionally, sharing the first supplemental map via the web-based link includes the option to specify whether anyone who accesses the web-based link can have access to the shared first supplemental map. Additionally or alternatively, sharing the first supplemental map via the web-based link includes the option to specify that only the recipients of the web-based link specified by the user of the device can receive the first supplemental map. Allowing supplemental maps to be shared, allows for additional users to collaborate or provide feedback on the supplemental map, thereby minimizing additional user input required to generate, correct or modify the supplemental map, which, conserves computing and power resources that would otherwise be expended due to the additional input.

In some embodiments, after generating the first supplemental map and after initiating the process to share the first supplement map with the respective user, the electronic device receives auxiliary information, wherein the auxiliary information pertains to one or more features of the generated first supplemental map such as if any one of user specification 2208, application data 2210, or external data 2212 were updated after the supplemental map had been initially generated in FIG. 22B. In some embodiments, the auxiliary information is received by the electronic device in accordance with the examples provided above. In some embodiments, the auxiliary information is received when the user changes/modifies the one or more first specifications, for instance by modifying the input they initially had provided at the supplemental map creation user interface when initially generating the supplemental map. Additionally or alternatively, auxiliary information is received at the device, when the device detects changes to the application data that is pertinent to one or more features of the generated first supplemental map as described above.

In some embodiments, in response to receiving the auxiliary information, the electronic device modifies the first supplemental map in accordance with the received auxiliary information; and In some embodiments, modifying the first supplemental map in accordance with the received auxiliary information is in accordance with the examples described above.

In some embodiments, in response to modifying the first supplemental map, the electronic device optionally initiates a process to share the modified first supplemental map with the respective user. In some embodiments, the electronic device after modifying the first supplemental map, determines whether the previous version of the supplemental map (e.g., the supplemental map prior to modification) had been shared to one or more other users as described above. In some embodiments, and in accordance with the determination that the supplemental map had been shared, the electronic device shares the modified first supplemental map in accordance with the process that was used to share the original or previous version of the first supplemental map. In some embodiments, each device that has received a shared supplemental map can each individually update the shared supplemental map based on receiving the same auxiliary information. Optionally, the first device of the one or more devices that have received or transmitted a shared supplemental map based on received auxiliary information, transmits the received auxiliary information to the other devices so that each device can update the shared supplemental map individually. Allowing updates supplemental maps to be shared with users that have previously received earlier versions of the supplemental map, allows for additional users to collaborate or provide feedback on the supplemental map in its latest form, thereby minimizing additional user input required to generate, correct or modify the supplemental map, which, conserves computing and power resources that would otherwise be expended due to the additional input.

In some embodiments, the electronic device receives, at the electronic device a second supplemental map, wherein the second supplemental map is generated by an external electronic device. In some embodiments, the second supplement map is a map that is shared with the user of the electronic device by another user. In some embodiments, the second supplemental map was generated at the electronic device of the other user using a process similar to the process described above in which one or more artificial intelligence models was applied to a user's specifications and their application data to generate the second supplemental map.

In some embodiments, the electronic device applies the one or more artificial intelligence models (such as artificial intelligence models 2214 in FIG. 22B) to the application data associated with the user of the electronic device (such as application data 2210 in FIG. 22B). In some embodiments, and in response to receiving the second supplemental map, the electronic device customizes the received supplemental map according to the application data of the respective user of the electronic device based on the user's application data. In some embodiments, and as an initial step in the process of customizing the received second supplemental map, the electronic device applies the one or more artificial intelligence models to the application data of the respective user.

In some embodiments, the electronic device modifies the received second supplemental map based on an output of applying the one or more artificial intelligence models to the application data associated with the user of the electronic device. In some embodiments, the output of the one or more artificial models that have been applied to the application data of the user for the purpose of customizing the received second supplemental map is used to modify the second supplemental map by changing/modifying one or more features of the second supplemental map in response to the output generated by the one or more artificial intelligence models. As an example, if the calendar application data of the user that has received the second supplemental map is different such that the one or more artificial intelligence models determine that the user has a routine that is different from the user that shared the second supplemental map, then the electronic device modifies an itinerary that is part of the second supplemental map to suit the routine of the user that has received the second supplemental map. As another example, if the media application data that has received the second supplemental map includes content that is different from the user that sent the second supplemental map, then the received second supplemental is updated with additional points of interest that are based on the content that the user of the electronic device has consumed (e.g., movies, television shows, and podcasts). Allowing supplemental maps that have been received from other users to be automatically customized to the receiving user's application data minimizes additional user input required to correct or modify the supplemental map, which, conserves computing and power resources that would otherwise be expended due to the additional input.

In some embodiments, the one or more artificial intelligence models is a machine learning model (such as if artificial intelligence models 2214 in FIG. 22B were implemented as machine learning models). In some embodiments, the machine learning models can include but are not limited to one or more of an artificial neural network, a random forest machine learning model, a supervised model, a semi-supervised model, an unsupervised model, a reinforcement learning model, a naive Bayes classifier, a hierarchical clustering model, a clustering analysis model, or any machine learning model that is configured learn from past supplemental maps and that data used to create the supplemental maps to generate new supplemental maps. Using machine learning models that learn from prior generated supplemental maps to generate new supplemental maps, minimizes additional user input required to correct or modify the supplemental map, which, conserves computing and power resources that would otherwise be expended due to the additional input.

In some embodiments, the one or more artificial intelligence models is a natural language processing model (such as if artificial intelligence models 2214 in FIG. 22B were implemented as natural language processing models). In some embodiments, the one or more natural language processing models can include but are not limited to: sentiment analysis modules, named entity recognition modules, summarization modules, topic modeling modules, text classification modules, keyword extraction modules, and lemmatization and stemming modules. In one or more examples, the natural language processing modules can be generalized natural language processing modules that are based on a specific language (e.g., English). Additionally or alternatively, the natural language processing modules can be supplemental map context specific modules that are created using natural language associated with the context of specifying and generating supplemental maps. Using natural language processing models that use natural language found in a user's specification of a supplemental map and a user's application to generate new supplemental maps, minimizes additional user input required to correct or modify the supplemental map, which, conserves computing and power resources that would otherwise be expended due to the additional input.

It should be understood that the particular order in which the operations in method 2300 and/or FIG. 23 have been described is merely exemplary and is not intended to indicate that the described order is the only order in which the operations could be performed. One of ordinary skill in the art would recognize various ways to reorder the operations described herein.

The operations in the information processing methods described above are, optionally, implemented by running one or more functional modules in an information processing apparatus such as general purpose processors (e.g., as described with respect to FIGS. 1A-1B, 3, 5A-5H) or application specific chips. Further, the operations described above with reference to FIG. 23 are, optionally, implemented by components depicted in FIGS. 1A-1B. For example, receiving operation 2302a, and generating operation 2302b, are optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In some embodiments, aspects/operations of methods 700, 900, 1100, 1300, 1500, 1700, 1900, 2100, and/or 2300, may be interchanged, substituted, and/or added between these methods. For example, the user interfaces of methods 700, 900, 1100, 1300, 1500, 1700, 1900, 2100, and/or 2300, the map and/or media content of methods 700, 900, 1100, 1300, 1500, 1700, 1900, 2100, and/or 2300, the user and device interactions of methods 700, 900, 1100, 1300, 1500, 1700, 1900, 2100, and/or 2300, and/or the supplemental maps of methods 700, 900, 1100, 1300, 1500, 1700, 1900, 2100, and/or 2300, are optionally interchanged, substituted, and/or added between these methods. For brevity, these details are not repeated here.

As described above, one aspect of the present technology potentially involves the gathering and use of data available from specific and legitimate sources to facilitate the display of supplemental map information. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information, usage history, handwriting styles, etc.

The present disclosure recognizes that the use of such personal information data, in the present technology, can be used to the benefit of users. For example, the personal information data can be used to automatically perform operations with respect to displaying supplemental map information. Accordingly, use of such personal information data enables users to enter fewer inputs to perform an action with respect to reporting incidents. Further, other uses for personal information data that benefit the user are also contemplated by the present disclosure. For instance, user location data may be used to identify relevant supplemental map information to display to a user.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the user is able to configure one or more electronic devices to change the discovery or privacy settings of the electronic device. For example, the user can select a setting that only allows an electronic device to access certain of the user's location data when displaying supplemental map information.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, location data can be recognized based on aggregated non-personal information data or a bare minimum amount of personal information, such as the location information being handled only on the user's device, or other non-personal information.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
while displaying, via the display generation component, a first geographic area in a primary map within a map user interface:
in accordance with a determination that the electronic device has access to a first supplemental map for the first geographic area, displaying, in the first geographic area in the primary map, information about one or more locations in the first geographic area from the first supplemental map; and
in accordance with a determination that the electronic device does not have access to the first supplemental map for the first geographic area, displaying, in the first geographic area in the primary map, information about one or more locations in the first geographic area from the primary map without displaying the information about one or more locations in the first geographic area from the first supplemental map.

2. The method of claim 1, further comprising:
while displaying, via the display generation component, the first geographic area in the primary map within the map user interface, in accordance with a determination that the electronic device has access to a second supplemental map for the first geographic area, displaying, in the first geographic area in the primary map, information about one or more locations in the first geographic area from the second supplemental map.

3. The method of claim 1, wherein:
displaying the first geographic area in the primary map includes concurrently displaying the first geographic area and a second geographic area, different from the first geographic area, in the primary map, and
displaying the information about the one or more locations in the first geographic area from the first supplemental map includes concurrently displaying the information from the first supplemental map without displaying any information from any supplemental map in the second geographic area.

4. The method of claim 1, wherein displaying, in the first geographic area in the primary map, the information about the one or more locations in the first geographic area from the first supplemental map includes:
in accordance with a determination that the map user interface is in a first transit mode, displaying the information about the one or more locations in the first geographic area from the first supplemental map, and
in accordance with a determination that the map user interface is in a second transit mode, different from the first transit mode, displaying the information about the one or more locations in the first geographic area from the first supplemental map.

5. The method of claim 1, wherein displaying, in the first geographic area in the primary map, the information about the one or more locations in the first geographic area from the first supplemental map includes overlaying the information about the one or more locations from the first supplemental map on a representation of the first geographic area from the primary map.

6. The method of claim 5, wherein the information about the one or more locations displayed in the first geographic area from the first supplemental map replaces information about the one or more locations from the primary map in the first geographic area.

7. The method of claim 5, wherein the information about the one or more locations displayed in the first geographic area from the first supplemental map is displayed concurrently with information about the one or more locations from the primary map in the first geographic area.

8. The method of claim 5, wherein the information about the one or more locations displayed in the first geographic area from the first supplemental map is displayed at one or more locations in the primary map corresponding to positions of the one or more locations in the primary map.

9. The method of claim 1, wherein a representation of the first supplemental map is displayed within a supplemental map repository user interface of the electronic device.

10. The method of claim 9, wherein the supplemental map repository user interface is a part of a primary map application that is displaying the primary map in the map user interface on the electronic device.

11. The method of claim 9, wherein supplemental map repository user interface is part of an application different from a primary map application that is displaying the primary map in the map user interface on the electronic device.

12. The method of claim 1, wherein a profile of a boundary of the first geographic area is defined by the first supplemental map.

13. The method of claim 12, further comprising:
displaying respective area outside of the boundary of the first geographic area in the primary map based on information from the primary map.

14. The method of claim 12, further comprising:
while displaying, via the display generation component, a second geographic area in the primary map within the map user interface, wherein the second geographic area is different from the first geographic area:
in accordance with a determination that the electronic device has access to a second supplemental map for the second geographic area, different from the first supplemental map, displaying, in the second geographic area in the primary map, information about one or more locations in the second geographic area from the second supplemental map, wherein a profile of a boundary of the second geographic area is different from the profile of the boundary of the first geographic area.

15. The method of claim 14, wherein the first geographic area and the second geographic area overlap in the primary map.

16. The method of claim 1, wherein the information about the one or more locations in the first geographic area includes one or more of:
information about one or more buildings identified in the first supplemental map;
information about one or more areas identified in the first supplemental map;
information about one or more food locations identified in the first supplemental map;
information about one or more landmarks identified in the first supplemental map;
information about one or more restrooms identified in the first supplemental map; or
information about media identified in the first supplemental map.

17. The method of claim 1, further comprising:
while displaying, in the first geographic area in the primary map, the information about the one or more locations in the first geographic area from the first supplemental map, receiving, via the one or more input devices, an input corresponding to a request to cease display of the information from the first supplemental map; and
in response to receiving the input, displaying the first geographic area in the primary map without displaying the information about the one or more locations in the first geographic area from the first supplemental map.

18. The method of claim 1, wherein displaying the information about the one or more locations in the first geographic area from the first supplemental map does not require that the electronic device have an active connection to a device external to the electronic device.

19. The method of claim 1, the method further comprising:
while displaying, in the first geographic area in the primary map, the information about the one or more locations in the first geographic area from the first supplemental map:
receiving, via the one or more input devices, an annotation to a first portion of the first geographic area in the primary map;
in response to receiving the annotation, displaying the annotation as part of the information in the first geographic area in the primary map;
after receiving the annotation to the first portion of the first geographic area, receiving, via the one or more input devices, an input corresponding to a request to share the first supplemental map with a second electronic device, different from the electronic device; and
in response to receiving the input corresponding to the request to share the first supplemental map, initiating a process to transmit the first supplemental map to the second electronic device, wherein the first supplemental map includes the annotation as part of the first geographic area.

20. The method of claim 1, the method further comprising:
while displaying, via the display generation component, a respective geographic area in the primary map within the map user interface:
in accordance with a determination that a respective supplemental map for the respective geographic area is available, displaying, in the respective geographic area in the primary map, a visual indication corresponding to the respective supplemental map.

21. The method of claim 1, the method further comprising:
while displaying the information about the one or more locations in the first geographic area from the first supplemental map:
receiving, via the one or more input devices, a first user input that corresponds to a selection of a respective location of the one or more locations; and
in response to the receiving the first user input, displaying, via the display generation component, additional information associated with the respective location, wherein the additional information is from the first supplemental map.

22. The method of claim 21, the additional information associated with the respective location includes an interior map of a structure associated with the respective location.

23. The method of claim 1, the method further comprising:
while displaying the primary map in the map user interface, receiving, via the one or more input devices, an input directed to an element displayed in the map user interface; and
in response to receiving the input:
in accordance with a determination that the element is included in the information about the one or more locations in the first geographic area from the first supplemental map, performing a first operation associated with the element and in accordance with the input; and
in accordance with a determination that the element is not included in the information about the one or more locations in the first geographic area from the first supplemental map, performing a second operation associated with the element and in accordance with the input.

24. The method claim 1, wherein in accordance with the determination that the electronic device has access to the first supplemental map for the first geographic area, the first geographic area is visually distinguished from a second geographic area in the primary map.

25. The method of claim 1, wherein the information about the one or more locations is not included in the primary map.

26. The method of claim 25, wherein:
in accordance with a determination that the first supplemental map is a first respective supplemental map, the information about the one or more locations is first information; and
in accordance with a determination that the first supplemental map is a second respective supplemental map, different from the first respective supplemental map, the information about the one or more locations is second information, different from the first information.

27. The method of claim 1, the method further comprising:
in accordance with a determination that the first supplemental map is updated, displaying, in the first geographic area in the primary map, updated information about the one or more locations in the first geographic area from the updated first supplemental map.

28. The method of claim 1, the method further comprising:
while displaying, via the display generation component, the first geographic area in the primary map within the map user interface:
in accordance with the determination that the electronic device has access to the first supplemental map for the first geographic area and in accordance with a determination that the electronic device has access to a second supplemental map, different from the first supplemental map, for the first geographic area, displaying, in the first geographic area in the primary map:
the information about the one or more locations in the first geographic area from the first supplemental map; and
second information about one or more second locations in the first geographic area from the second supplemental map.

29. The method of claim 1, the method further comprising:
while displaying, in the first geographic area in the primary map, the information about the one or more locations in the first geographic area from the first supplemental map, receiving, via the one or more input devices, a user input corresponding to a request to perform a first operation corresponding to a feature of the primary map; and
in response to receiving the user input, performing the first operation.

30. The method of claim 1, the method further comprising:
before displaying the information about the one or more locations in the first geographic area from the first supplemental map:
in accordance with a determination that a location of the electronic device relative to the first geographic area satisfies one or more criteria, automatically downloading the first supplemental map to the electronic device; and
in accordance with a determination that the location of the electronic device relative to the first geographic area does not satisfy the one or more criteria, forgoing automatically downloading the first supplemental map to the electronic device.

31. The method of claim 1, wherein the first supplemental map is associated with a respective event that has a start time and an end time, the method further comprising:
in accordance with a determination that the respective event has ended, automatically deleting the first supplemental map from the electronic device.

32. The method of claim 1, the method further comprising:
before displaying the information about the one or more locations in the first geographic area from the first supplemental map:
in accordance with the determination that the location of the electronic device relative to the first geographic area satisfies the one or more criteria, automatically downloading primary map information for one or more geographic areas surrounding the first geographic area; and
in accordance with the determination that the location of the electronic device relative to the first geographic area does not satisfy the one or more criteria, forgoing automatically downloading the primary map information for the one or more geographic areas surrounding the first geographic area.

33. An electronic device that is in communication with a display generation component and one or more input devices, the electronic device comprising:
one or more processors;
memory; and
one or more programs, wherein the one or more programs are stored in the memory and configured to be executed by the one or more processors, the one or more programs including instructions for:
while displaying, via the display generation component, a first geographic area in a primary map within a map user interface:
in accordance with a determination that the electronic device has access to a first supplemental map for the first geographic area, displaying, in the first geographic area in the primary map, information about one or more locations in the first geographic area from the first supplemental map; and
in accordance with a determination that the electronic device does not have access to the first supplemental map for the first geographic area, displaying, in the first geographic area in the primary map, information about one or more locations in the first geographic area from the primary map without displaying the information about one or more locations in the first geographic area from the first supplemental map.

34. A non-transitory computer readable storage medium storing one or more programs, the one or more programs comprising instructions, which when executed by one or more processors of an electronic device that is in communication with a display generation component and one or more input devices, cause the electronic device to perform a method comprising:
while displaying, via the display generation component, a first geographic area in a primary map within a map user interface:
in accordance with a determination that the electronic device has access to a first supplemental map for the first geographic area, displaying, in the first geographic area in the primary map, information about one or more locations in the first geographic area from the first supplemental map; and
in accordance with a determination that the electronic device does not have access to the first supplemental map for the first geographic area, displaying, in the first geographic area in the primary map, information about one or more locations in the first geographic area from the primary map without displaying the information about one or more locations in the first geographic area from the first supplemental map.

35-241. (canceled)
